(19) United States
(12) Patent Application Publication
(10) Pub. No.: US 2014/0038729 A1
(43) Pub. Date: Feb. 6, 2014

(54) A Method for Creating and Running A Tournament by the Means of Time, A Tournament Time-Schedule and the Interactions of the Tournament Entrants Over A Network With A Server

(71) Applicant: Christian Morten Borge, Snaroya (NO)

(72) Inventor: Christian Morten Borge, Snaroya (NO)

(21) Appl. No.: 14/113,237

(22) PCT Filed: Apr. 26, 2012
(86) PCT No.: PCT/NO12/50080

§ 371 Date: Oct. 22, 2013

(30) Foreign Application Priority Data
Apr. 26, 2011 (NO) 20110622

(51) Int. Cl. A63F 13/12

(52) U.S. Cl. CPC A63F 13/12
USPC 463/42

(57) ABSTRACT

A computer implemented method for managing a tournament using a server and an arena database, wherein the method comprises operating a first process of registering community data and assigning at least one role to a user identified in said community data, operating a second process of creating the tournament by registering tournament data on basis of registered community data and the assigned at least one role and retrieving arena data from the arena database, and operating a third process of running the tournament using registered tournament data, registered community data and the assigned at least one role.

### FIELD OF THE INVENTION

The invention relates to tournament management, and a method, an apparatus, and a computer program product therefore.

### BACKGROUND FOR THE INVENTION

To create a tournament in existing software a tournament director must first to do basic tasks.

If there shall be referees in a tournament the tournament director must contact the referees to find out if they are willing to take part in the tournament and then manually set referees from a database in the software. Messages may be generated to the referees from a software database and entries may be gathered from an online service but it must still be done as a separate task.

The tournament director must also reserve courts for the tournament. Some clubs offer online booking but the tournament director must still do the separately and then enter the times manually in the software.

Having done the basic settings the tournament director will normally export the tournament details to a website where teams/players can enter online.

When the entry for teams/players is due then the tournament director must re-enter the software, get the online entries and then make draws and genereate a schedule. Then tournament director must generate messages to teams/players about when and where to play the next match or generate messages to teams/players about about a website or other place where they can get information about when and where to play.

When results from first matches have been processed the tournament director must enter the same PC again and enter results manually. The tournament director must gather results from the matches himself, either through players, the tournament director's assistants or referees before they can be processed in the software.

The tournament schedule may be updated by hand and published on a board for smaller tournaments or a tournament director may enter results again and again in the software and print an updated schedule. If processed in the software the tournament director can generate new messages to the players/teams with information about the new matches.

After a tournament has been played the results are typically updated in a separate rating software doing the calculations and generating new rating lists.

This is how tournament software has worked for many years now. Tournament directors must enter the software many times during a tournament.

### The Invention

M1. A computer implemented method for managing a tournament using a server and an arena database, wherein the method comprises
operating a first process of registering community data and assigning at least one role to a user identified in said community data,
operating a second process of creating the tournament by registering tournament data on basis of registered community data and the assigned at least one role and retrieving arena data from the arena database, and
operating a third process of running the tournament using registered tournament data, registered community data and the assigned at least one role.

M2. The method of M1 above, wherein the first process comprises the server assigning a manager role to a user registering the community by entering community data.

M3. The method of M2 above, wherein the first process comprises giving the manager access to a community data register for the manager to assign users different roles selected from a group of roles, which group of roles includes at least one of a court manager, a tournament director, and a further manager, and which user assigned role gives the user a corresponding tool required to create a tournament.

M4. The method of M1 above, wherein the first process comprises sending a request (1) to a user to select license; then receiving a response from a user specifying at least one selected license, the server sending a request (2) to the user to select year of license and a maximum number of members (license details); and then receiving a response from the user specifying the year of license and the maximum number of members. sending a request (3) to the user to select sport(s); then receiving a response from the user.

M5. The method of M1 above, wherein the first process comprises the server sending a request (4) to the user to set community details like name of community; then receiving a response from the user including name of community, the server sending a request (5) to the user to select if the community has an arena or not; then receiving a reponse from the user including the users selection of one of the community has an arena or not: and
if receiving the response “the community has no arena” the server will send a request ( 6) to the user asking if the user is a registered user (already has a username and password); receiving a response from the user indicating yes or no; and
a) if yes, sending a request (7a) to the user to enter username and password, then receiving a response from the user, then sending a new request (8) to the user to pay for the license if the license is not for free; then accepting or rejecting the registration, if accept assigning the user the role as manager of the community, and
b) If no, sending a request (7b) to the user to enter user details like email address; then receiving a response from the user, then sending a new request (8) to the user to pay for the license if the license is not for free; then accepting or rejecting the registration, if accepting the server assigns the user the role as manager of the community and sends login information to the user; and
If receiving the response “the community has an arena”,
the server sending a request (9) to the user to select sport(s), and to enter a keyword for a search or to select a location of the arena; and
on receiving a response from the user including the keyword or selection of location of the arena, sending the user a list of arenas on basis of the arena database.

M6. The method of M4 above, wherein the first process comprises the server then sending a request (10) to the user to select an arena;
if receiving the response that the user has selected an arena listed in the arena data base, then
   if the arena has a management; sending information to let the user know the arena already has a management, and
   if the arena has no management; sending a request (6) to the user to if the user has a username and password in the solution; then receiving a response from the user indicating yes or no, and
   If yes sending a request (7a) to the user to enter username and password, then receiving a response from the user, then sending a new request (8) to the user to pay for the license if the license is not for free; then accepting or rejecting the registration, if accepting the server assigns the user the role as manager of the community, and
   If no sending a request (7b) to the user to enter user details like email address; then receiving a response from the user, then sending a new request (8) to the user to pay for the license if the license is not for free; then accepting or rejecting the registration, if accepting the server assigns the user the role as manager of the community and sends login information to the user, and
if receiving the response that the arena was not listed in the arena database, then sending a request (6) to the user to asking if the user has a username and password; then receiving a response from the user indicating yes or no, and
   If yes sending a request (7a) to the user to enter username and password, then receiving a response from the user, then sending a new request (8) to the user to pay for the license if the license is not for free; then accepting or rejecting the registration, if accepting the server assigns the user the role as manager of the community, and
   If no sending a request (7b) to the user to enter user details like email address; then receiving a response from the user with user details like email address, then sending a new request (8) to the user to pay for the license if the license is not for free; then accepting or rejecting the registration, if accepting the server assigns the user the role as manager of the community and sends login information to the user.

M7. The method of M1 above, wherein the second process comprises the server requesting (9) the user to select a sport and a discipline and a time zone and to enter a tournament name; and
1) on receiving a response from the user including the user selected sport and discipline data and entered tournament name data,
the server requesting (10) the user to select tournament details comprising rules, gender, registered community data usage (openness), tournament format and maximum number of players; and
2) on receiving a tournament details response from the user including the user selected rules, gender, registered community data usage (openness), tournament format and max number of players data, and based on the max number of players and therefore the max number of matches is known, the server requesting (11) the user to set age class and skill levels; and
3) on receiving a response from the user including age class and skill levels data, the server requesting (12) the user to set tournament official roles and qualifications for all the matches in the tournament, and to assign to a role a processing results task, and
4) on receiving a response from the user including set tournament official roles and qualifications data and task to role assignment data, and based on the tournament format (eg single elimination schedule), the server requests (13) the user to set prize and prize ceremony data for the tournament; and
5) on receiving a response from the user including prize and prize ceremony data, and on basis of set sport, discipline, tournament format and the max number of matches data, the server requesting (14) the user to set match format for the matches (eg. best of 3 sets in tennis); and
6) on receiving a response from the user including match format data for the matches, the server requesting (15) the user to set a tournament plan including a player entry period and, optionally, tournament officials, officials entry period, and prize ceremony; and
7) on receiving a tournament plan data response from the user including a player entry period data and, optionally, tournament officials, officials entry period, and prize ceremony data, the server requesting (16) the user to set or book times for the matches, and to select arena(s) for the matches; and
8) on receiving a response from the user including set or booked times data for the matches and selected arena(s) data, the server requesting (17) the user to set sport specific equipment details for the tournament; and
9) on receiving a response from the user including sport specific equipment details data for the tournament, the server requesting (18) the user to set select messages to be generated throughout a tournament; and
10) on receiving a response from the user including selected messages to be generated data, the server calculating a tournament cost on basis of at least the received tournament officials data, prizes data and set or book times data, and requesting (19) the user to review and accept calculated cost tournament and optionally calculated tournament income, and
11) on receiving a response from the user including calculated cost tournament acceptance data, requesting the user to submit a confirmation; and
12) on receiving a response from the user including submitted confirmation data, then the server validating the data included in responses received in 1) through 10) for use in the third process of running the tournament, and starting the third process.

M8. The method of M1 above, wherein the third process comprises the server
sending invitation to players 156 on basis of community data usage (openness) data and an user provided conditions; and
opening a player entry register for registration of players during a player entry period, the player entry period being the date and time players can enter from 140 to the date and time the players can enter to 142, with access for players to record player entry data in the player entry register; and
closing the register for registration of players at end of the player entry period or at registration of a number of player entries that equals a preset maximum number of players; and
autogenerating a first tournament schedule on basis of tournament data registered when operating the second process and player entries in the player entry register, and generating and sending a message to a registered player with information about when and arena where to play a first match; and
receiving first match results data, and autogenerating a further tournament schedule on basis of the first tournament schedule, actual date and time data, and the first match results data, and generating and sending a further message to a registered player with information about when and arena where to play a further match; and
reperatedly receiving further match results data, and autogenerating yet further tournament schedules on basis of the further tournament schedule, actual date and time data, and the further match results data, and generating and sending a yet further message to a registered player with information about when and arena where to play a yet further match until further match results data have been received for all matches identified in the tournament plan.

M9. The method of M8 above, wherein the third process comprises the server generating the tournament schedule includes seeding players according to player rating data, and giving some players byes if byes on basis of the tournament schedule rules (selecting tournament format is selecting tournament schedule: tournament schedules are known so not explained in patent application).

M10. The method of M8 above, wherein the third process comprises the server
if tournament officials for the tournament are set with the roles and qualifications within the tournament, first sending information to tournament officials 152 requesting them to enter the tournament within an entry period for tournament officials, the entry period for tournament officials being the date and time tournament officials enter from 134 to the date and time the tournament officials can enter to 136, and in that period receiving a response from users with tournament officials entry data; and
on receiving the tournament officials entry data for the maximum number of matches within the entry period for tournament officials, then
   If a tournament official role (eg. match referee) is assigned the role to processing results in the tournament data, then sending result reports to the tournament officials' task lista, and based on the tournament schedule data and set book times for prize ceremony data, sending information to the players in the tournament schedule about when and where to play the first match 162; and distributing reports to the users' task table(s), on basis of the entry data and on the tournament official settings data; and
   If players are assigned the task of processing results in the tournament data, then adding result reports to a players' task list.

M11. The method of M8 above, wherein the third process comprises the server sending information to tournament official entry data about cancelled matches due to byes 162.

M12. The method of M8 above, wherein the third process comprises the server on basis of set
prizes settings data and message settings data sending information to players registered in the player entry register about where and when the prize ceremony will take place, including, optionally, on basis of prize settings data, sending or printing out diplomas to players.

M13. The method of M8 above, wherein the third process comprises the server autogenerating the tournament schedule by using a the tournament schedule autogeneration algorithm as illustrated in the 8ballpool tournament schedule autogeneration algorithm example in the description.

M14. The method of M9 above, wherein the third process comprises the server operating a rating formula, and on receiving match results data, instantly generating player rating data on basis of the received match results data.

A1. A computer apparatus for managing a tournament, the apparatus comprising a server and an arena database, wherein the apparatus further comprises a server having computer means and interface means adapted to perform respective ones of the actions of the method of any one of M1 to M14 above.

P1. A computer program product storing executable code for the method of any one of M1 to M14 above.

### SUMMARY OF THE INVENTION

The invention provides a method as recited in the accompanying patent claims 1-13, an apparatus as recited in the accompanying patent claim 14, and a computer program product as recited in the accompanying patent claim 15.

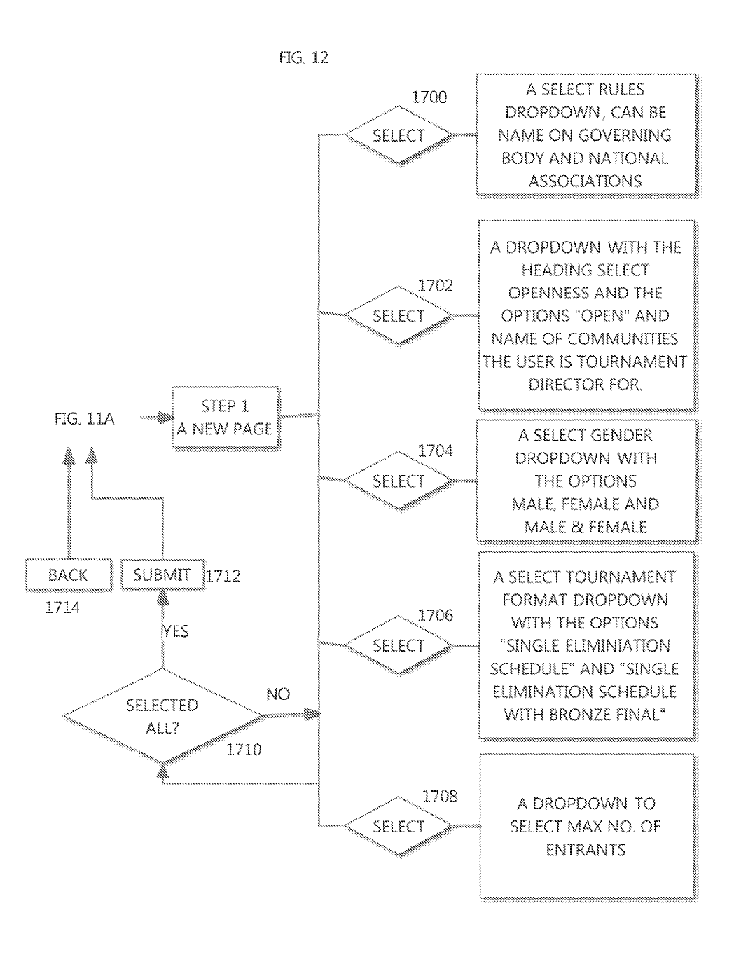

### BRIEF DESCRIPTION OF THE FIGURES

| Description | FIG. |
|---|---|
| A page that shows how a user's roles | 1A |
| A page illustrating frontoffice, backoffice | 1B |
| and the server | |
| A page that shows users entering at different | 1C |
| stages in a tournament | |
| A page that shows the tournament process | 1D |
| and what happens during a tournament as | |
| time changes. | |
| A page that very simple shows main | 1E |
| elements of the solution | |
| A page that describes the main page of the | 2A |
| solution seen from the users side | |
| A page that describes the administrator's | 2B |
| side of the solution | |
| The main page of a sport | 2C |
| The register page | 3 |
| Register process for International association | 4A |
| Register process for National association | 4B |
| Register process for sports club | 4C-4E |
| Register process for an arena | 4F |
| A page to search for communities and obtain | 4G |
| membership | |
| When a user wants to buy membership in a | 4H-4i |
| community when the community's setting is | |
| “charge fee for membership” | |
| When a user wants to obtain membership in | 4J |
| a community when the community's setting | |
| is “Membership by application” or “No | |
| requirement to obtain membership”. | |
| A page to register as a user/player | 4K |
| A login page | 5A |
| A user menu seen by a user | 5B |
| The contents of a user menu when the user | 5C |
| has no specific role except being a player | |
| The contents of a user menu | 5D |
| The contents of a user menu | 5E |
| The contents of a user menu | 5F |
| The contents of a user menu | 5G |
| The contents of a user menu | 5H |
| The contents of a user menu and court tools. | 5i |
| The manage sports page seen from | 6A |
| administrators side | |
| Director Tools for a sport | 6B |
| A page to manage license prices | 6C |
| A page to set license prices for National | 6D |
| Associations | |
| A page to set license prices for cup and court | 6E |
| management professional version, and to | |
| set price for cup and court management | |
| limited version | |
| A page to set license prices for court | 6F |
| management professional version | |
| A page to manage income from license sales | 6G |
| A page to manage disciplines and match | 6H-6i |
| formats | |
| A page to manage age levels | 6J |
| A page to manage skill levels | 6K |
| A page to manage tournament official | 6L |
| certificates | |
| A page to set certificate details | 6M |
| A page with tournament officials within the | 6N |
| sport | |
| A page to search for users and add as | 6o |
| tournament official | |
| A page to enter user details if user is not | 6P |
| registered earlier | |
| A page to add (or remove) certificates to the | 6Q |
| user | |
| A page with details about the governing | 6S |
| body | |
| A page with National Associations and | 7A |
| Director tools for a National Association | |
| The first step to add a new association | 7B |
| Pages to add a National Association | 7C-7E |
| User Tools | 8A |
| Memberships | 8B |
| Invitations | 8C |
| Roles | 8D |
| Manager Tools | 9A |
| Manage members | 9B |
| Applications for membership | 9C |
| The menu for inviting people to the | 9D |
| community | |
| A page to search and invite registered users | 9E-9F |
| to the community | |
| A page to enter user details and generate | 9G |
| username and password to a user | |
| A page to invite users to a community | 9H |
| A page to invite users to a community | 9i |
| Manage messages | 9K |
| Community administration | 9L |
| A page to manage a community's license | 9M |
| A page to manage license | 9N |
| Upgrade/renew a cup and court | 9o |
| management professional license, or a court | |
| management professional license | |
| Settings | 9P-9Q |
| Set prices on memberships | 9R-9W |
| Tournament Director Tools, create | 10A |
| tournament | |
| Tournament director tools, Worklist | 10B |
| Tournament director tools, Active | 10C |
| tournaments | |
| Create tournament main page | 11A |
| Create tournament step 1 | 12 |
| Create tournament step 2, set age class/skill | 13 |
| levels | |
| Create tournament step 3, a page to set | 14A |
| tournament officials | |
| Create tournament step 3, a page to set | 14B |
| qualifications for tournament officials | |
| Create tournament step 3, a page to set | 14C |
| tournament officials in different matches | |
| Create tournament step 4, a page to set | 15A |
| prizes and diploma | |
| Steps to add prizes | 15B |
| Create tournament step 5, a page to set | 16 |
| match format | |
| Create tournament step 6, a page to set | 17A |
| tournament plan | |
| Create tournament step 6, a page to set | 17B |
| tournament plan | |
| Create tournament step 7, a page to set time | 18A |
| and place for matches | |
| Create tournament step 7, The page to | 18B |
| select arena | |
| Create tournament step 7, The page to | 18C |
| select arena; use pre-booked times | |
| Create tournament step 7, A page showing | 18D |
| that a menu can look different for arenas | |
| depending on the arenas properties | |
| Create tournament step 7, A page showing | 18E |
| there can be different outcomes when | |
| selecting an arena, depending on the arenas | |
| properties and the user's roles. | |
| Create tournament step 7, Having selected | 18F |
| an arena: A page showing the About Arena | |
| page. | |
| Create tournament step 7, Having selected | 18G |
| an arena: Upper half of a page showing the | |
| Courts belonging to the arena. | |
| Create tournament step 7, Having selected | 18H |
| courts by an arena: Lower half of page 18F. | |
| Create tournament step 7, Having selected | 18i |
| an arena that offers automatic court booking | |
| and the user selects Booking. 18i is upper | |
| half of the page. | |
| Create tournament step 7, Having selected | 18J |
| an arena that offers automatic court booking | |
| and the user selects Booking. 18J is lower | |
| half of the page. | |
| Create tournament step 7, Payment page for | 18K |
| automatic bookings | |
| Create tournament step 7, The Tournament | 18L |
| director selects request an offer from an | |
| arena | |
| Create tournament step 7, Request an offer | 18M-18O |
| page | |
| Create tournament step 8, Set sport specific | 19 |
| equipment | |
| Create tournament step 9, Set messages | 20 |
| Create tournament step 10, income and | 21 |
| costs | |
| Reservations in the user menu, private | 22A |
| reservations and community reservations | |
| Tables for Requests sent, New offers, Offers | 22B-22c |
| accepted, offers declined, offers expired, | |
| expired requests and declined requests. | |
| Details of a request sent | 22D |
| A new offer | 22E |
| Accept or decline an offer from an arena? | 22F |
| Details of an accepted offer | 22G |
| Details of a declined offer | 22H |
| Details of an expired offer | 22i |
| Details of an expired request | 22J |
| Details of a declined request | 22K |
| Court Tools | 23A |
| Manage courts | 23B |
| Add court | 23C |
| Set Booking intervals | 23D-23F |
| Set prices on booking intervals | 23G |
| A page to manage opening hours | 23H |
| Court reservation report | 23i |
| Invoice details | 23J |
| A booking table for the court manager | 23K |
| A page to manage prices on courts for | 23L |
| members and non-members | |
| New requests, offers given, offers accepted, | 23M-23o |
| declined offers, expired offers, expires requests, | |
| declined requests | |
| A request (give offer page) | 23P |
| What happens when an offer is given | 23Q |
| A page with details of given offers o a | 23R |
| community and a page with details of | |
| accepted offers | |
| Declined and expired offers | 23S |
| Expired and declined requests | 23V |
| A page to manage agreements | 23X |
| A page to manage photos of the arena | 23Y |
| A page with statistics | 23Z |
| License properties for an International | 27A |
| Association | |
| License properties for a national association | 27B |
| Licenses for a community (eg. sports club) | 27C |
| When a National association is registered It | 28 |
| must be accepted by the Director of the | |
| sport. When an International association | |
| register it must be accepted by the admin. | |
| A page with applications from International | 29A |
| and National Associations | |
| A page with details of an application from an | 29B |
| International Association and what happens | |
| when an application is declined | |
| What happens when an application from an | 29C |
| International Association is accepted | |
| What happens when an application from a | 29D |
| National Association is accepted | |
| What happens after an International and a | 30A |
| National association has registered? | |
| What happens after a community has | 30B |
| registered? | |
| When a community selects an arena from | 30C |
| the arena database add report in arena | |
| changes | |
| When a community register a new arena add | 30D |
| report in arena changes | |
| My tasks in usermenu | 31A-31B |
| Register page from the link in email | 38A |
| Register page from the link in email | 38B |
| Register page from link in email | 38C |
| A page to search for tournaments | 39A |
| A table with tournaments | 39B |
| A page to view prices and diplomas, seen | 39C |
| from a user's side | |
| Tournament details | 40 |
| Display an Enter Tournament dropdown in | 41 |
| the tournament details page? | |
| A page to enter the tournament as | 42A |
| tournament referee | |
| A page where another tournament official | 42B |
| can enter the tournament (eg. match | |
| referee) | |
| When auto-generating schedule | 43 |
| Auto-distribute reports when a tournament | 44 |
| schedule has been generated | |
| Distribution of reports to process results and | 45 |
| absence | |
| A report/page to process results and | 46A |
| absence | |
| A tournament referee report and | 46B |
| tournament director's report | |
| A page to generate/email diplomas | 47 |
| A page showing tournament officials in the | 50 |
| tournament | |
| A table with time and place for matches | 51 |
| Change of players ratings in the tournament | 52 |
| A page with a list of entrants | 53 |
| A page showing income and costs of the | 54 |
| tournament | |
| A page with summary of reports from the | 55 |
| tournament | |
| A page with a tournament schedule | 56 |
| A page with tournament details submitted in | 58 |
| FIG. 11-21 | |
| A page with a table of arenas | 60 |
| The main page of an arena | 61A |
| A table with courts | 61B |
| A booking table | 61C-61D |
| A page that illustrated a user entering an | 61E |
| agreement for regular booking | |
| A page to contact the Arena | 61F |
| A page with users seen from backoffice | 62 |
| A page with communities seen from | 63A |
| backoffice | |
| A page with courts and court logs seen from | 63B |
| backoffice | |
| A page with Arenas seen from backoffice | 64 |
| A page with Arena changes seen from | 65A |
| backoffice, to be acceoted or rejected by | (remember change in |
| admin | arena details) |
| A page showing details of a new arena and | 65B |
| court manager, and a new court manager, to | |
| be accepted or rejected by admin | |
| Manage messages from backoffice | 66A-66B |
| A page with court changes | 67 |
| Manage receipt pages | 68A-68B |
| A page to manage VAT rates | 69 |
| Add court type | 70A-70D |
| A page to do international settings | 71 |

### DETAILED DESCRIPTION OF THE INVENTION

In the following, the invention is described by way of example, with reference to the accompanying drawings.

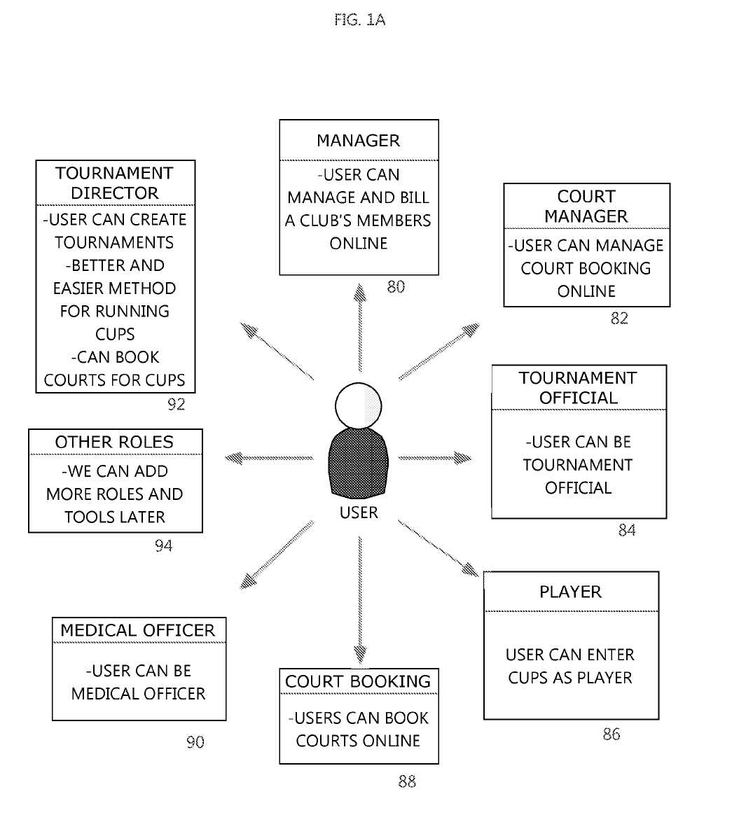

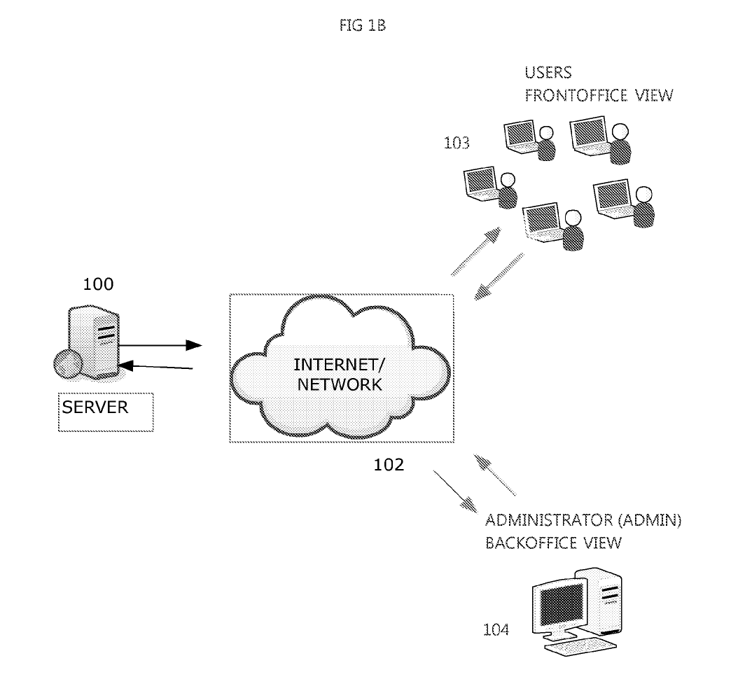

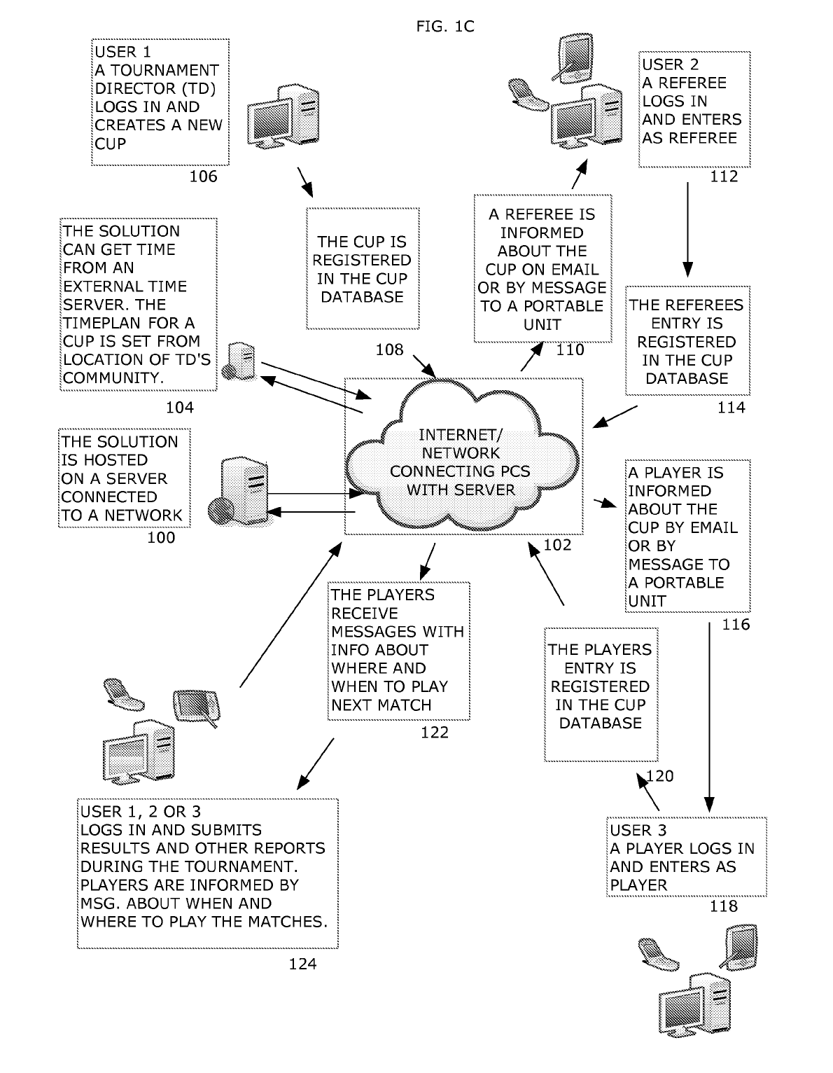

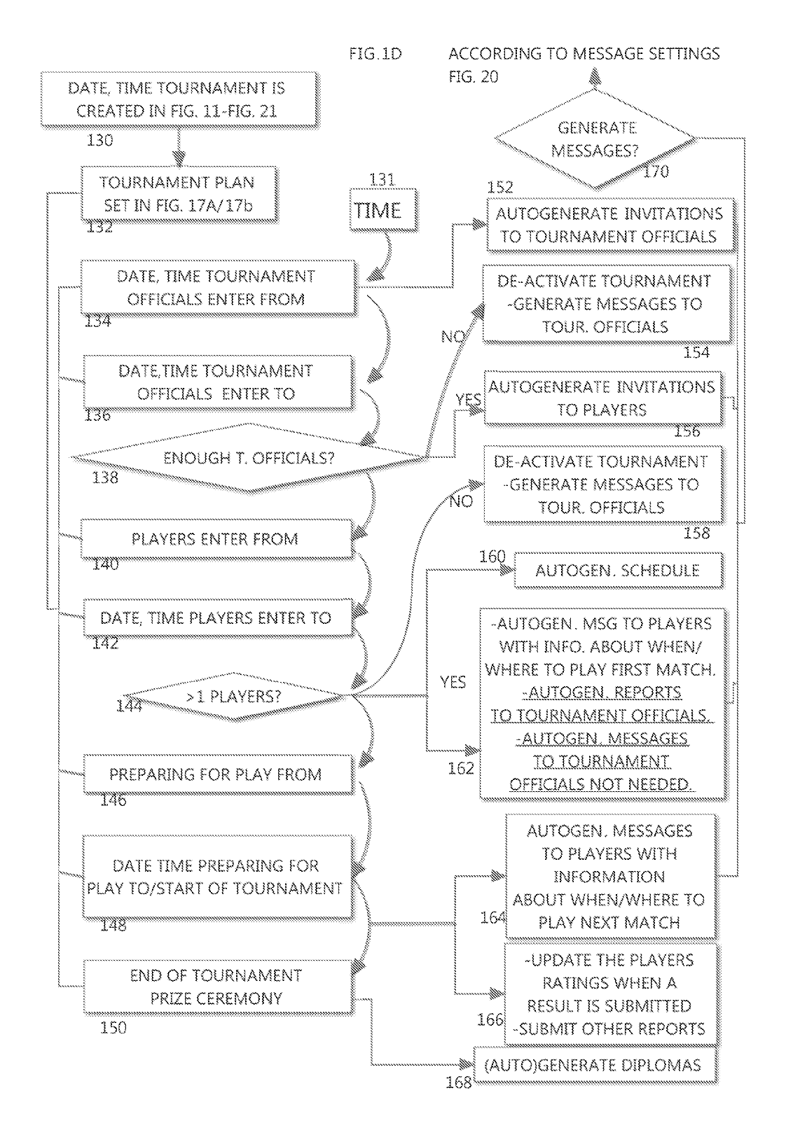

FIG. 1A is an illustration showing that a user can have multiple roles in the solution with a common login. A user can be Player, Tournament Director, Manager, Court Manager, Tournament official and Medical officer. Roles like photographer, cameraman, salesperson and reporter can be added later. With each role comes different rights and/or tools that will be described in detail later.

FIG. 1B illustrates a frontoffice view 103 for users, a backoffice view 104 for an administrator, the internet/network and the server 100.

FIG. 1C is a simplified illustration showing users with different roles engaged in a tournament at different times during the tournament. It shows a tournament director who creates a new tournament 106 and that the tournament is then registered in the tournament database of the solution 108. A referee is then informed about the tournament 110 and the referee logs in and enters the tournament as referee 112. The referee's entry is registered in the cup database 114. A player is then informed about the cup 116, logs in and enters the tournament as player 118. The players entry is registered in the tournament database 120. The players then receives messages with information about then and where to play the matches 122. Result reports are given to the users set to report results when the cup was created, either by players themselves, the tournament director or by the referees. Other reports, like tournament referee's report, tournament director's report and match referee's reports are also given to the users. Users log in and submit reports during and after the tournament 124.

FIG. 1D shows a tournament plan 132 and message settings 170 all set when the tournament was created 130 and what happens as time 131 changes during a tournament. When there are tournament officials in a tournament invitations to tournament officials 152 are automatically generated when a tournament has been created. The tournament officials will enter from a time set in the tournament plan 134 to a time set in the tournament plan 136. When a tournament is created the tournament director selects a maximum number of players/entrants. When tournament officials enter they enter all the possible matches of the tournament as the number of players is not yet known. If sufficient tournament officials have not entered all possible matches of the tournament 138 within the due time set in the tournament plan 136 then the tournament is de-activated. A message is then sent to the tournament officials saying that the tournament is cancelled. If tournament officials have entered all possible matches of the tournament 138 then entry is opened for players 140. Invitations are then automatically generated to players 156 and the players can enter until the to time set in the tournament plan 142. If no more than one player has entered within the due date the tournament is de-activated 158 and a message is sent to the tournament officials saying that the tournament is cancelled. When two or more players have entered then generate the tournament schedule automatically 160 when the entry period is due for players 142. Then also generate messages to players with information about when and where to play first match, reports to tournament officials and messages to tournament officials not needed 162. Some tournament officials may not be needed when the number of players are less than the maximum number of players set when the tournament was created. The time after the entry period for players is due until the first match begins is named the “preparing for play from” 146 and “preparing for play to” 148. As results is submitted messages can automatically be generated to players about when and where to play next match 164. Players ratings are also automatically updated when results are submitted 166. At the end of the tournament 150, when results for the final match has been processed, diplomas can be automatically generated to the players of the tournament 168.

FIG. 1E illustrates important parts of the system: Communities of different categories like associations, sport clubs, cafés. employers, hotels, schools/universities, arenas with management and other categories 172, Users with different roles like player, tournament official and medical officer 174, arenas with and without management (an arena with management is managed by a community) 176, different tools like user tools, manager tools, tournament director tools and court tools 178, Teams 180 and one or more rating formulas 182. The methods for registering, creating and running a tournament is explained for sports with one player versus one player (eg tennis singles) but can also be applied for team sports a team replacing the player.

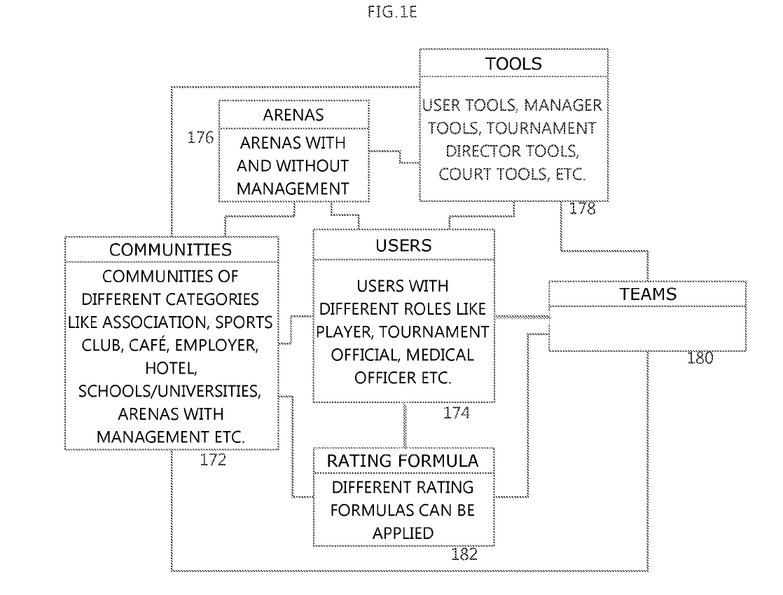

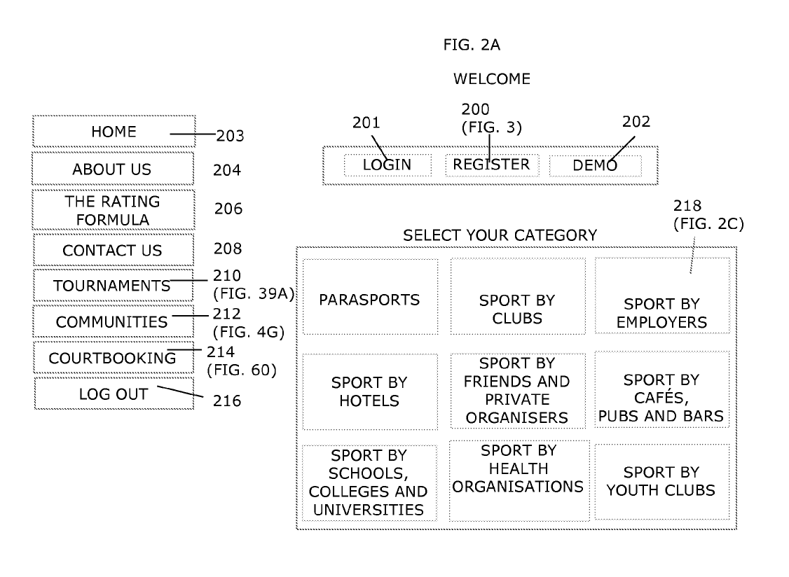

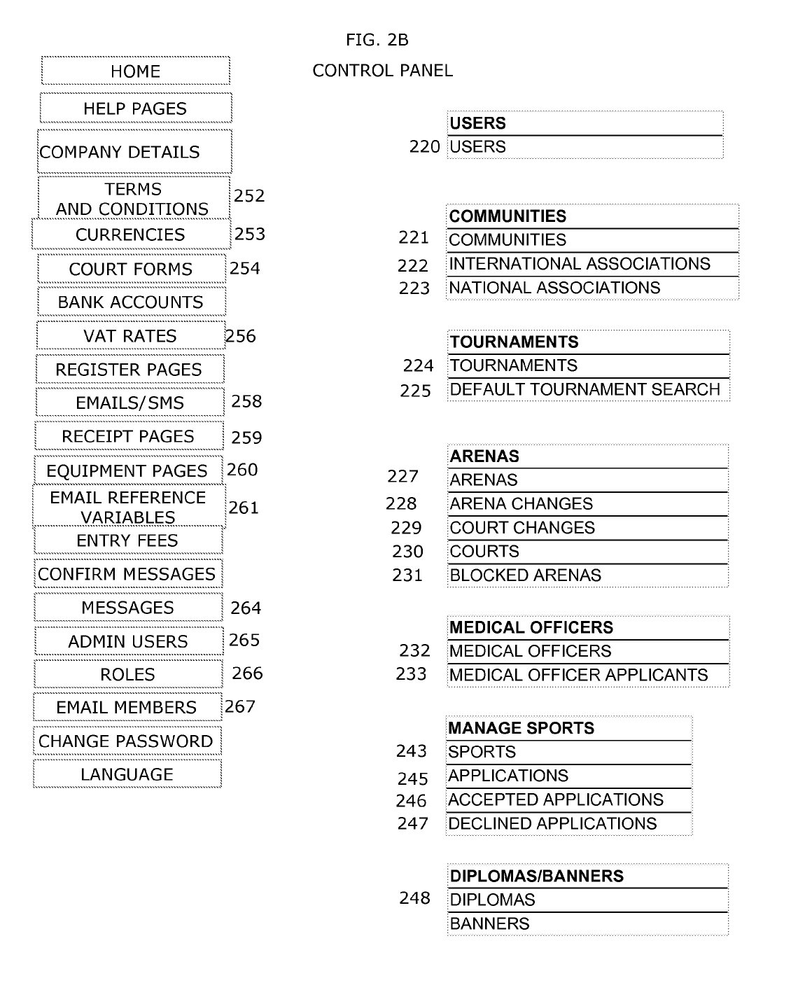

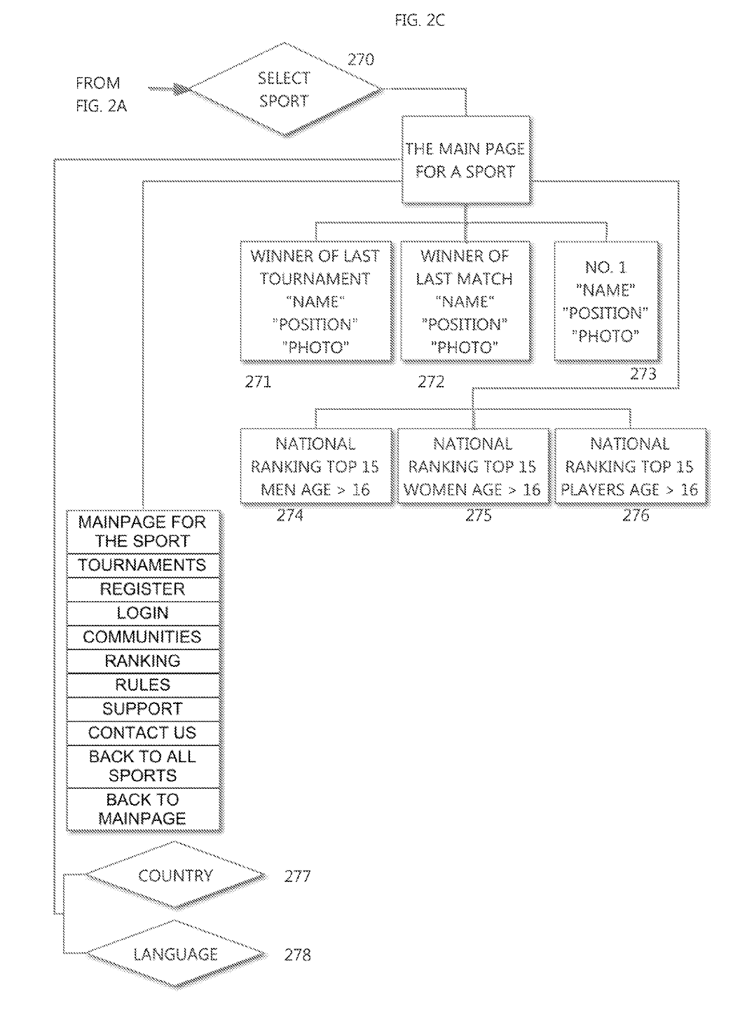

FIG. 2A shows the main page of the solution seen from a user's side. The text in FIG. 2A is links to other webpages within the solution: Login 201, Register 200, Demo 202, Home 203, About us 204, The rating formula 206, Contact us 208, Tournaments 210, Communities 212, Courtbooking 214, Logout 216 and different categories like Sport by employers 218, Parasports, Sport by clubs, Sport by hotels, Sport by friends and private organisers, Sport by cafés, clubs and bars, Sport by school, colleges and universities, Sport by Health organisations and sport by youth clubs.

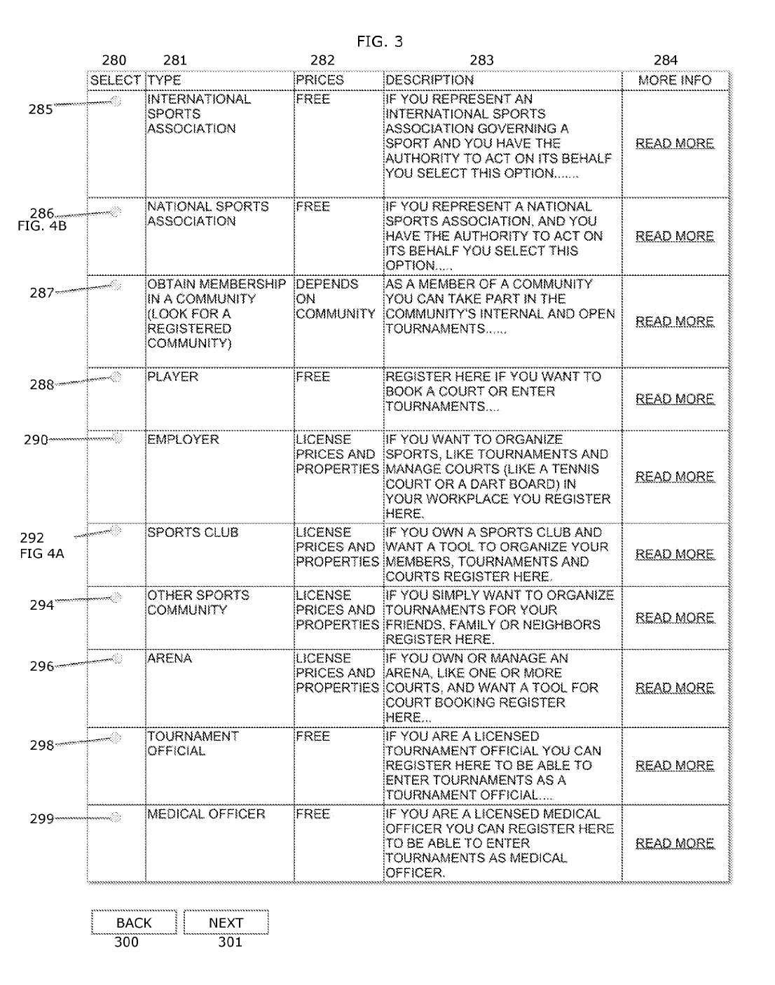

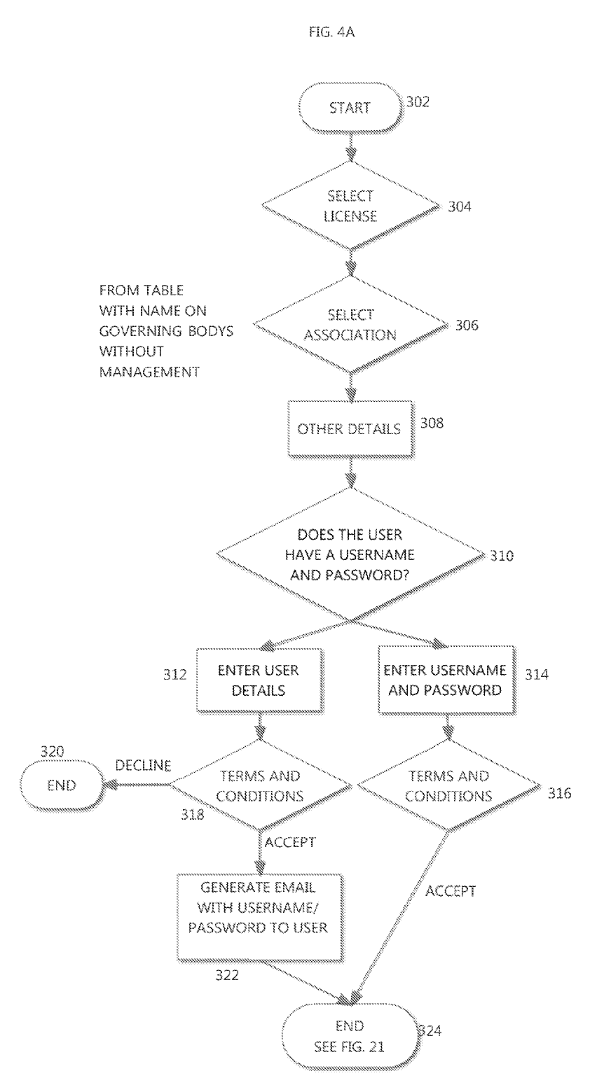

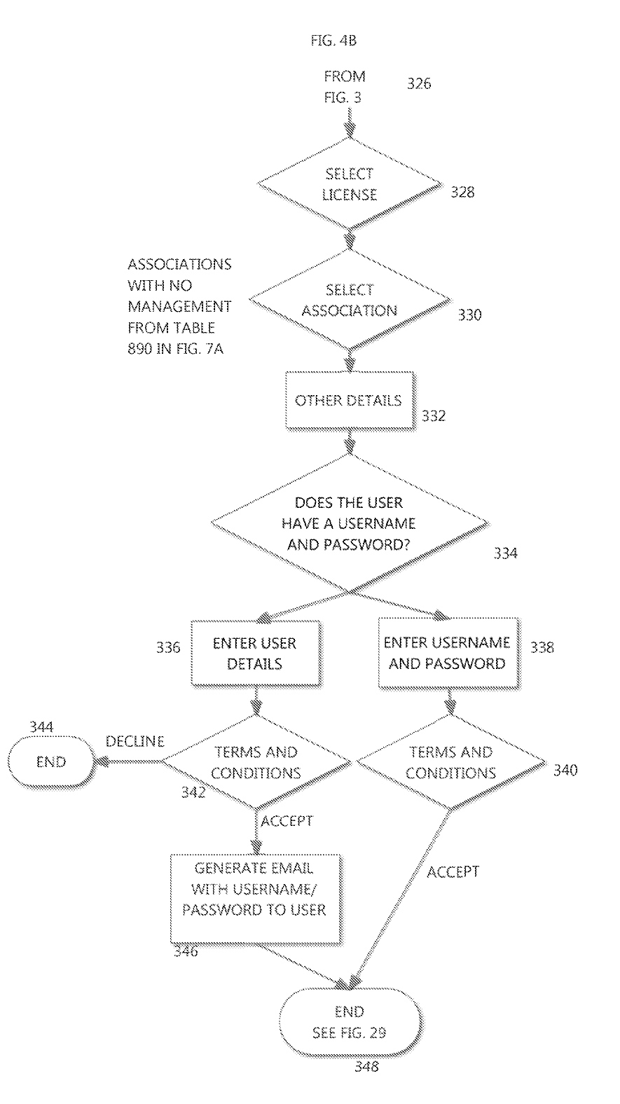

Selecting Register 200 the user will proceed to a page described in FIG. 3 Selecting Login 201 the user will proceed to a standard login page. Selecting demo the user will enter a demo page of the solution. Selecting About us 204 the user will proceed to a page describing the company and/or solution. Selecting The rating formula 206 the user will proceed to a page describing the rating formula(s) in the solution. The current rating formula used is Glicko/Glicko 2 by professor Mark Glickman but also other rating formulas can be applied. Contact us 208 is a link to a page where the user can contact support or the management, Tournaments 210 is a link to a page to search for tournaments described in FIG. 39A. Court Booking 214 is a link to a page where the user can search for arenas within the solution as described in FIG. 60. Sport by Employers 218 is a page where the user can enter a page FIG. 2C to select sport and view the main page of the solution for that sport.

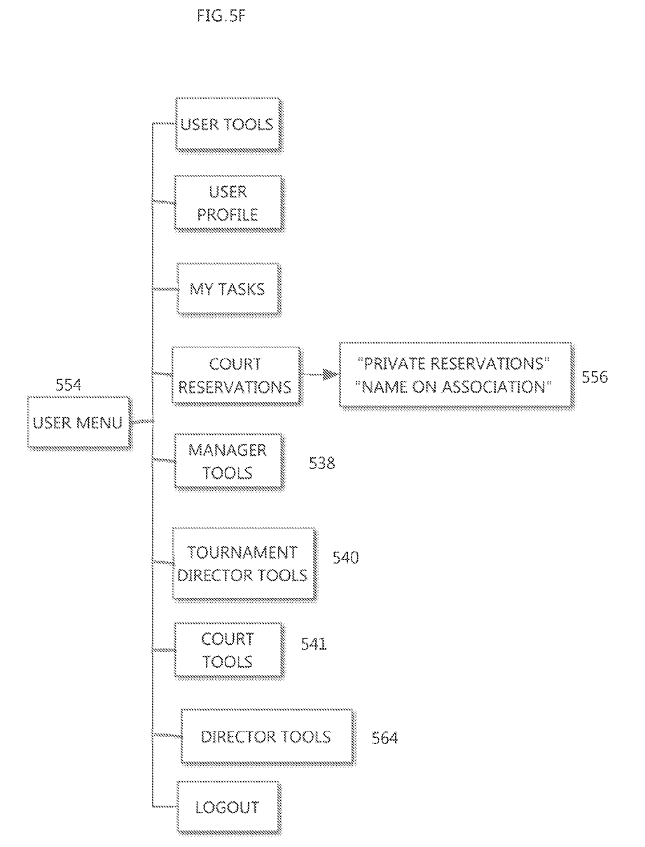

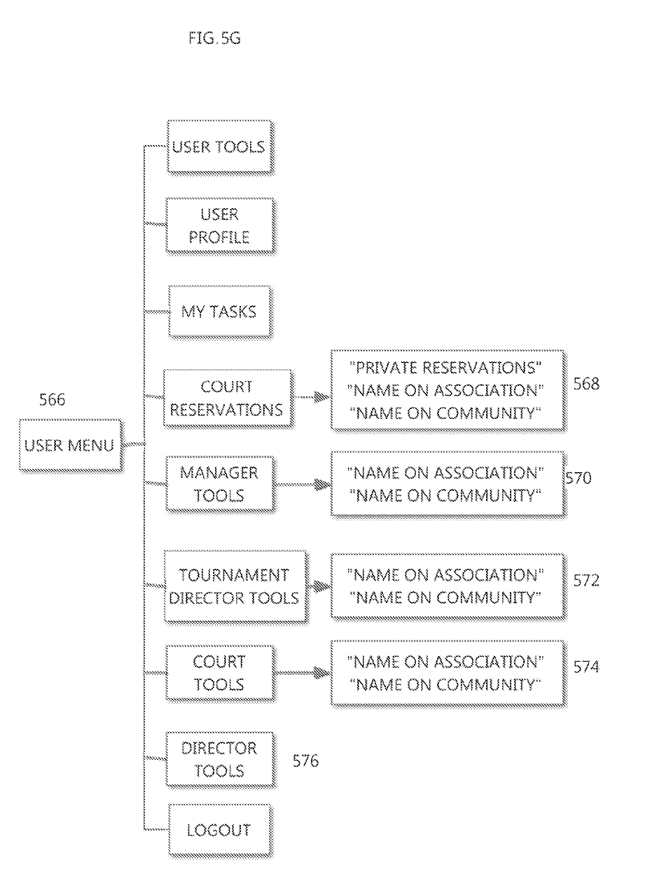

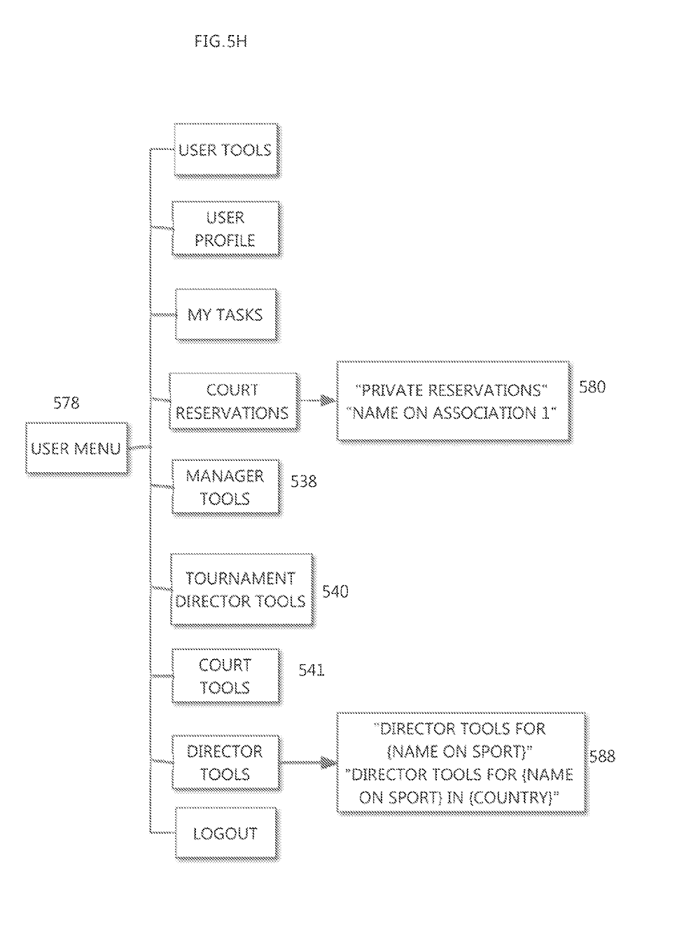

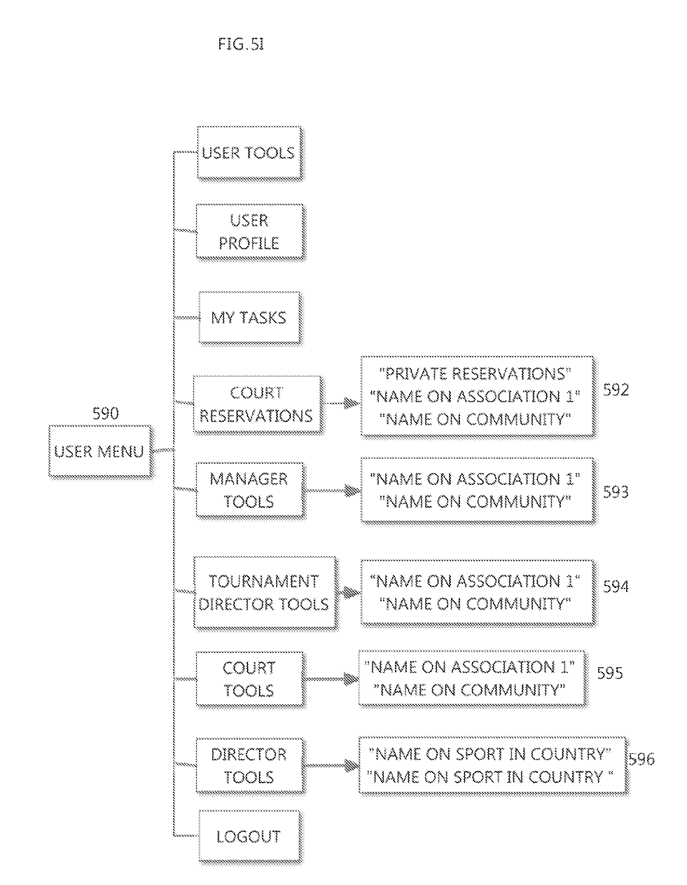

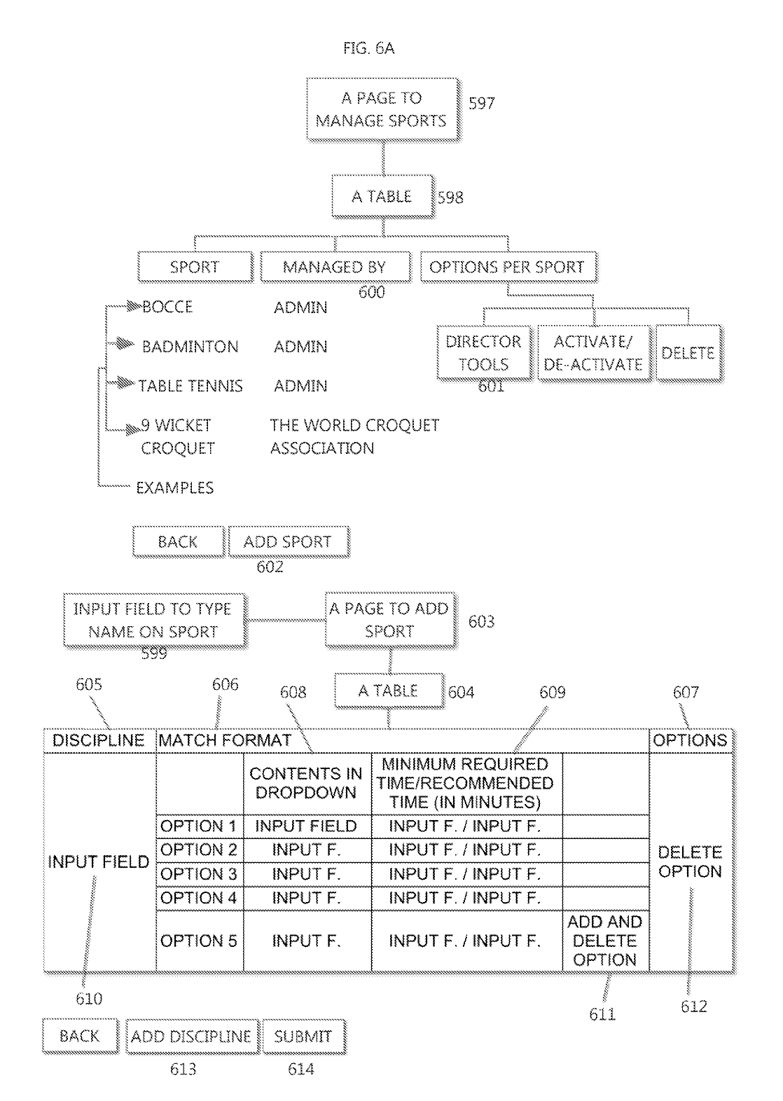

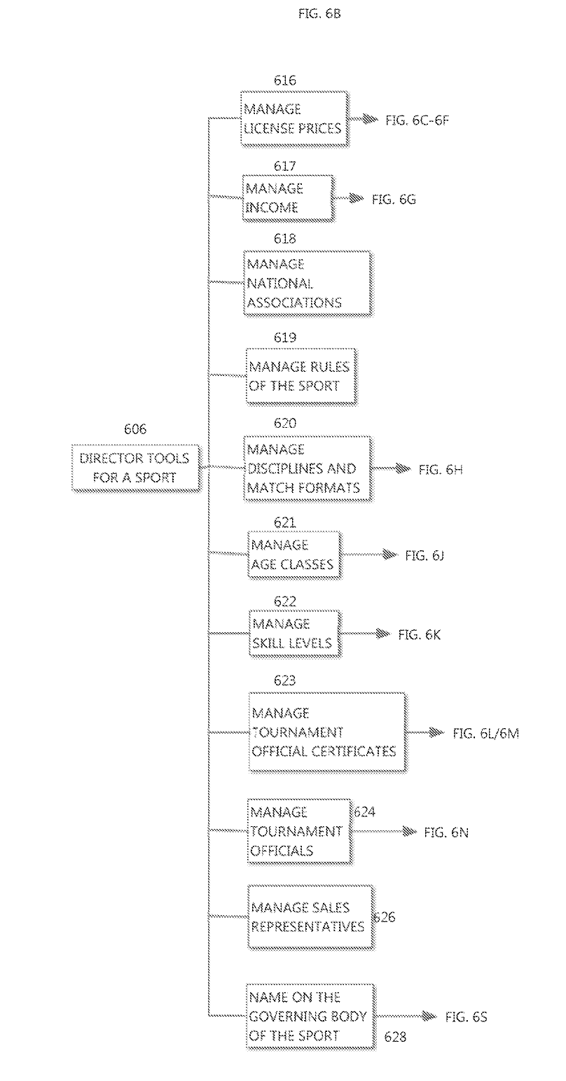

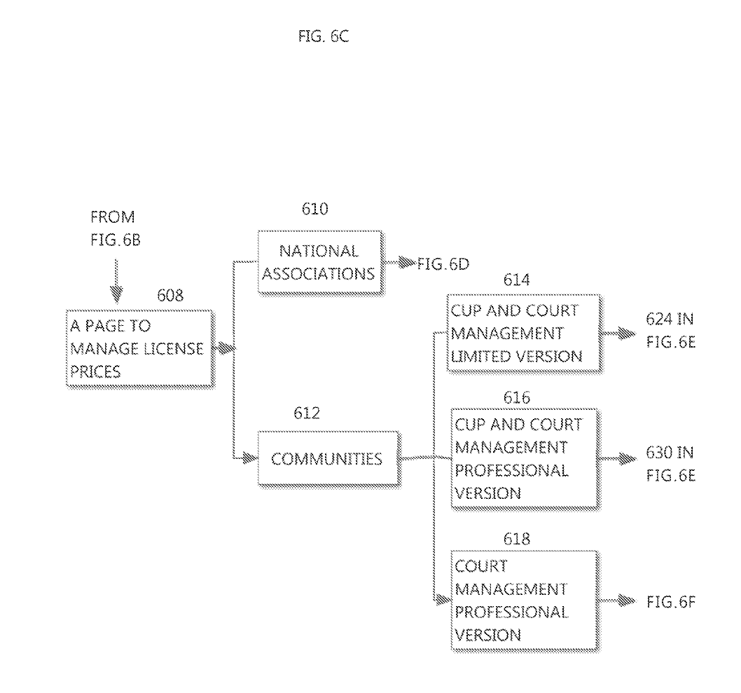

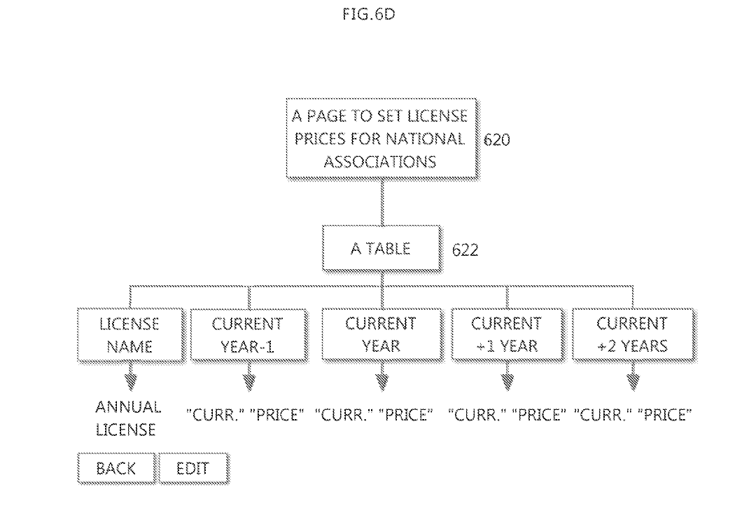

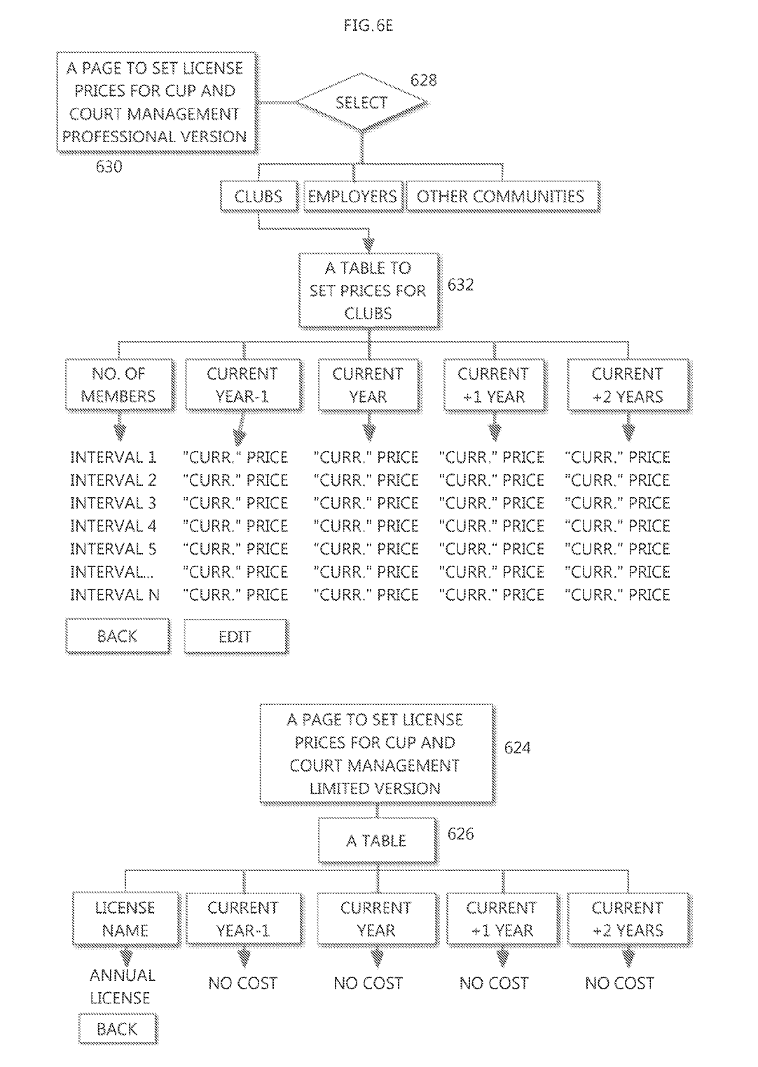

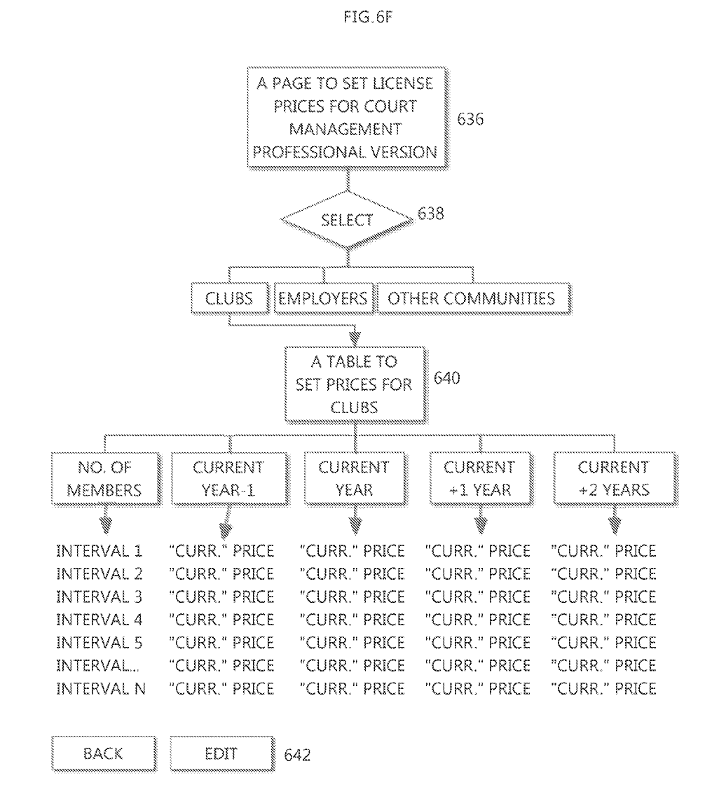

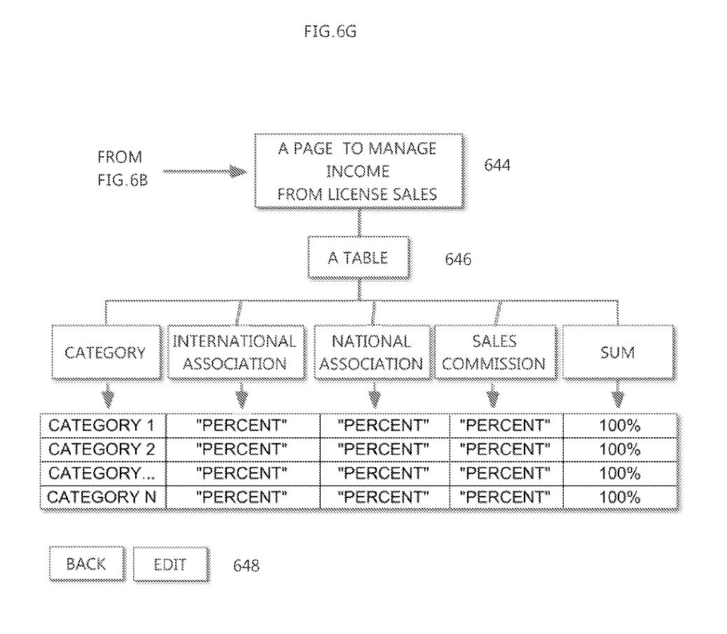

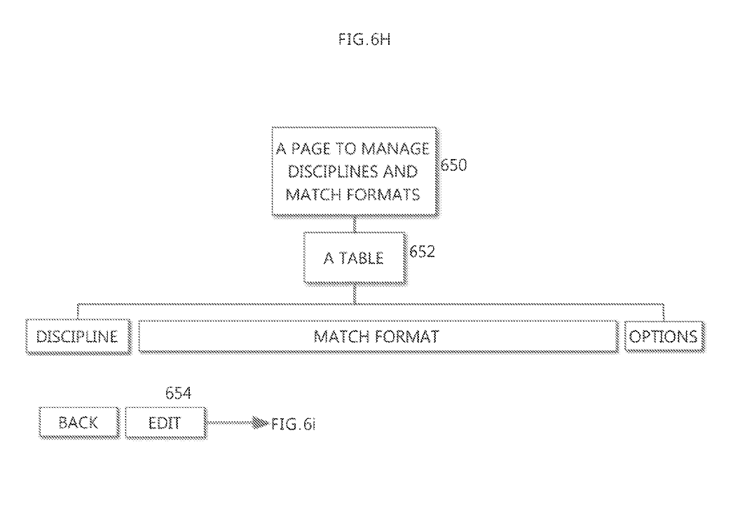

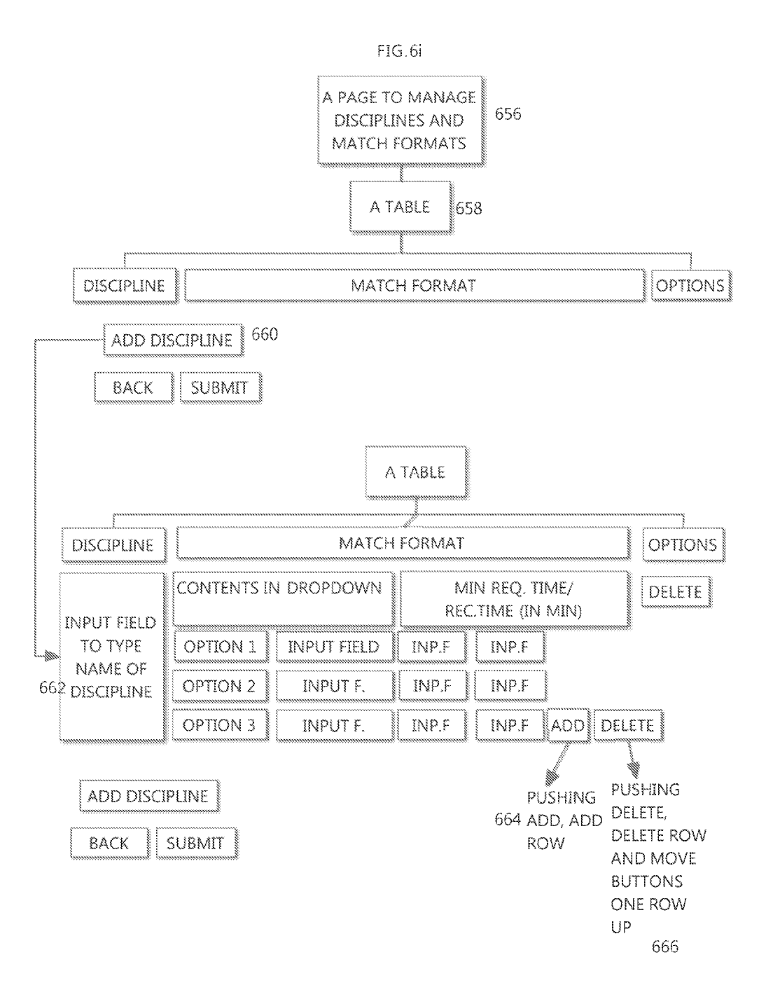

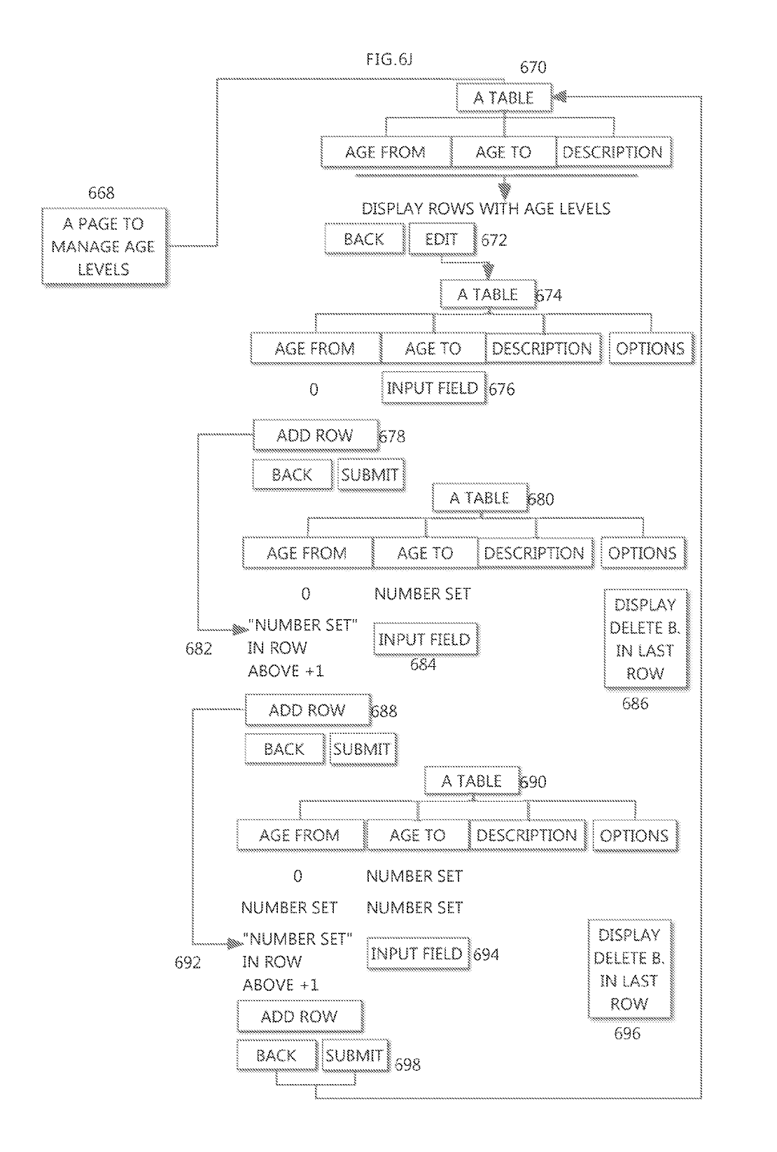

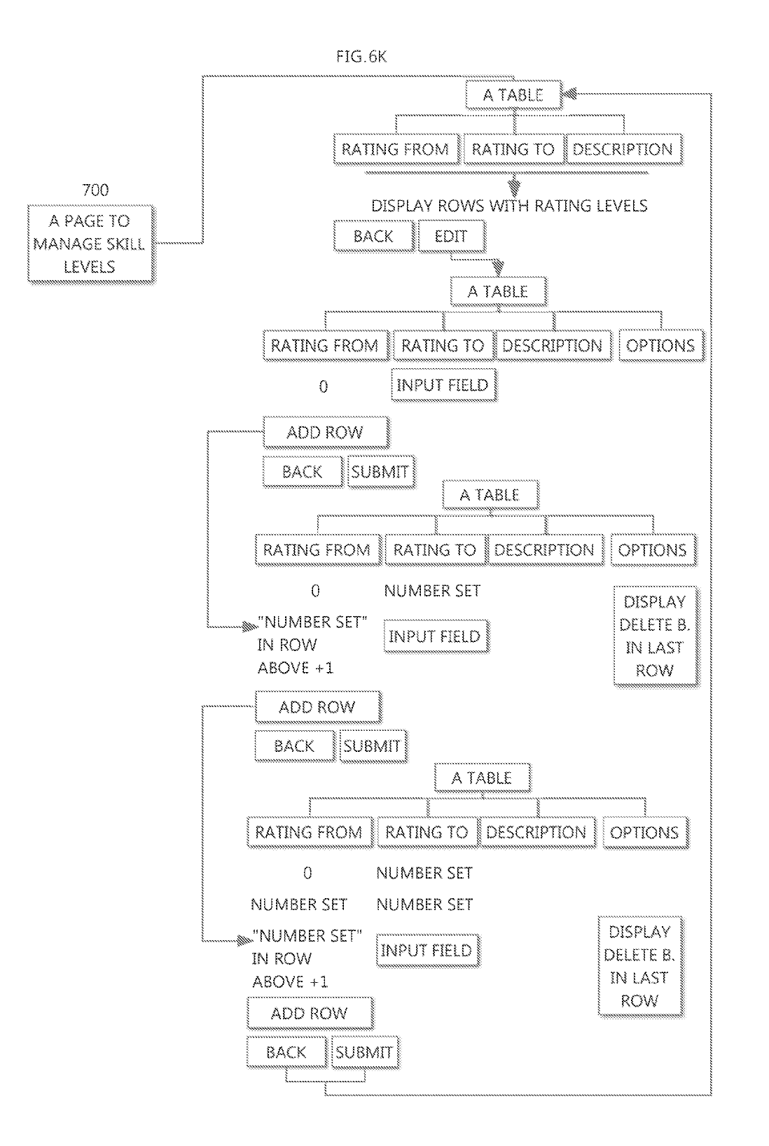

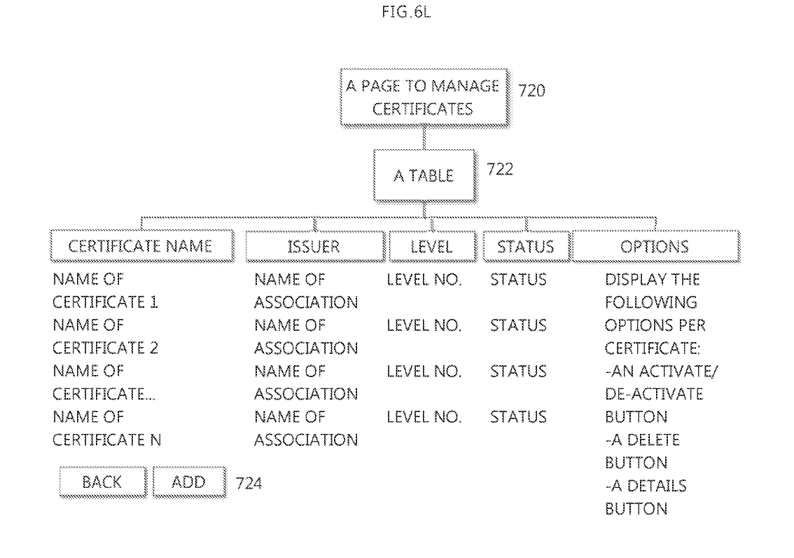

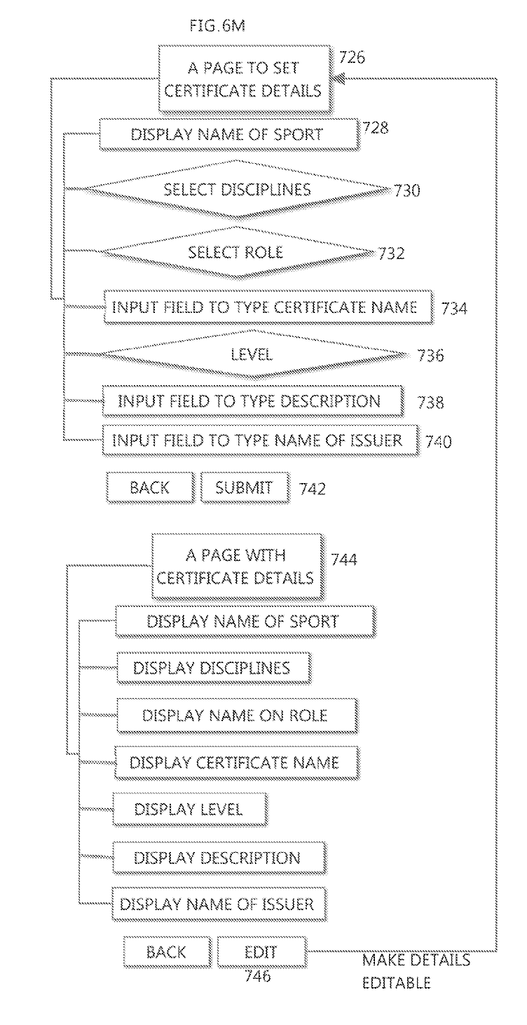

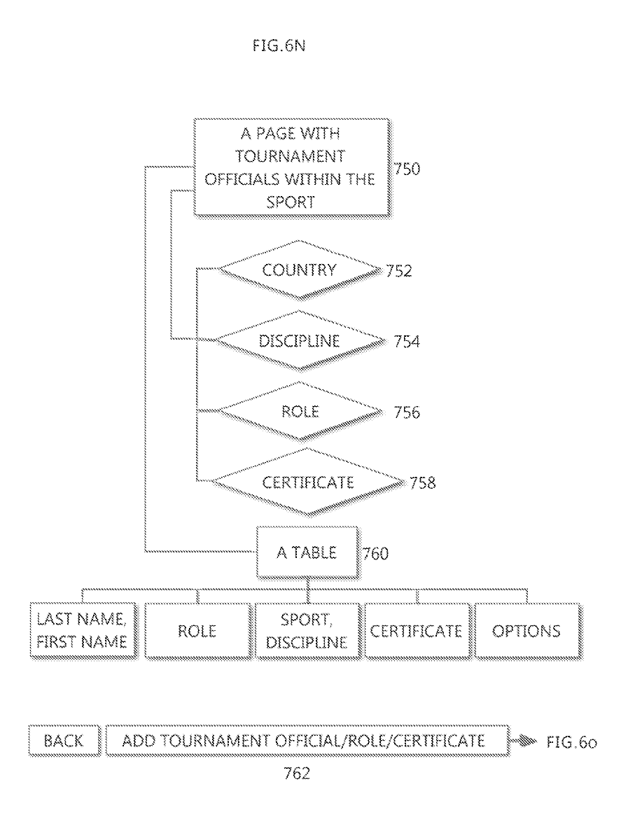

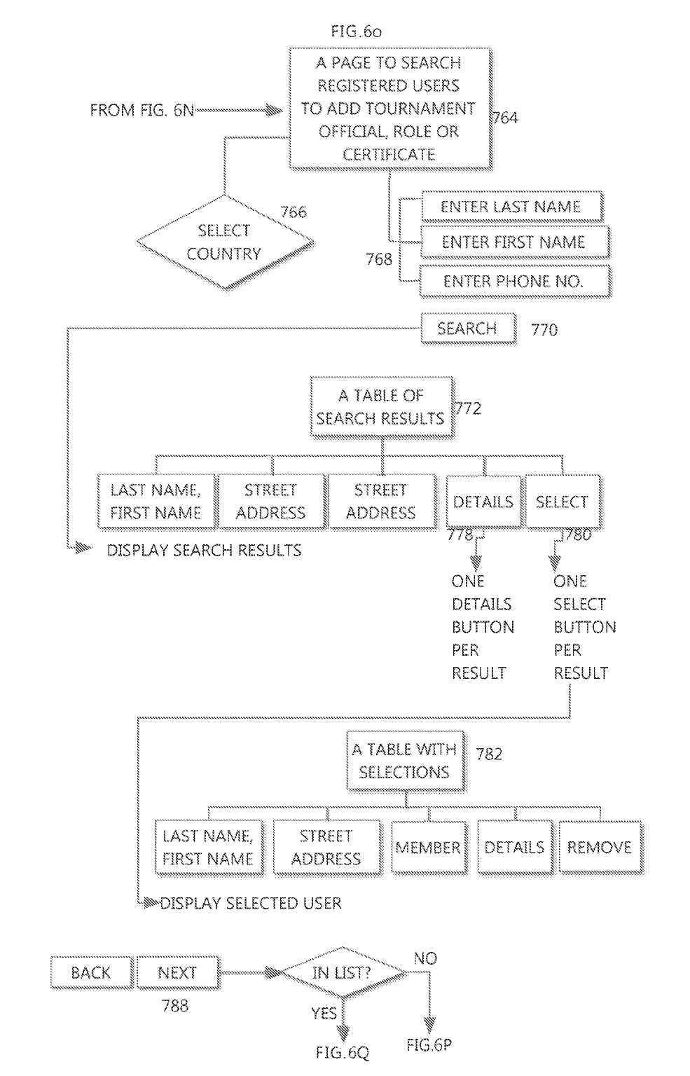

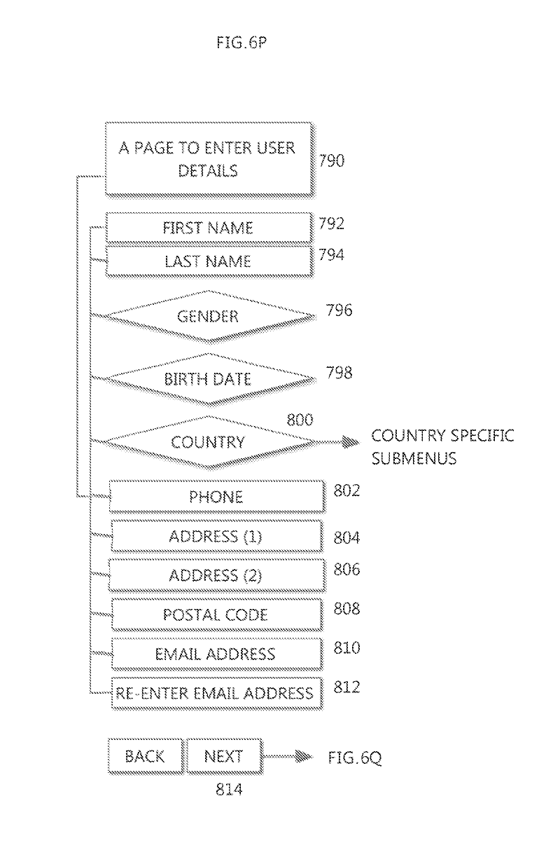

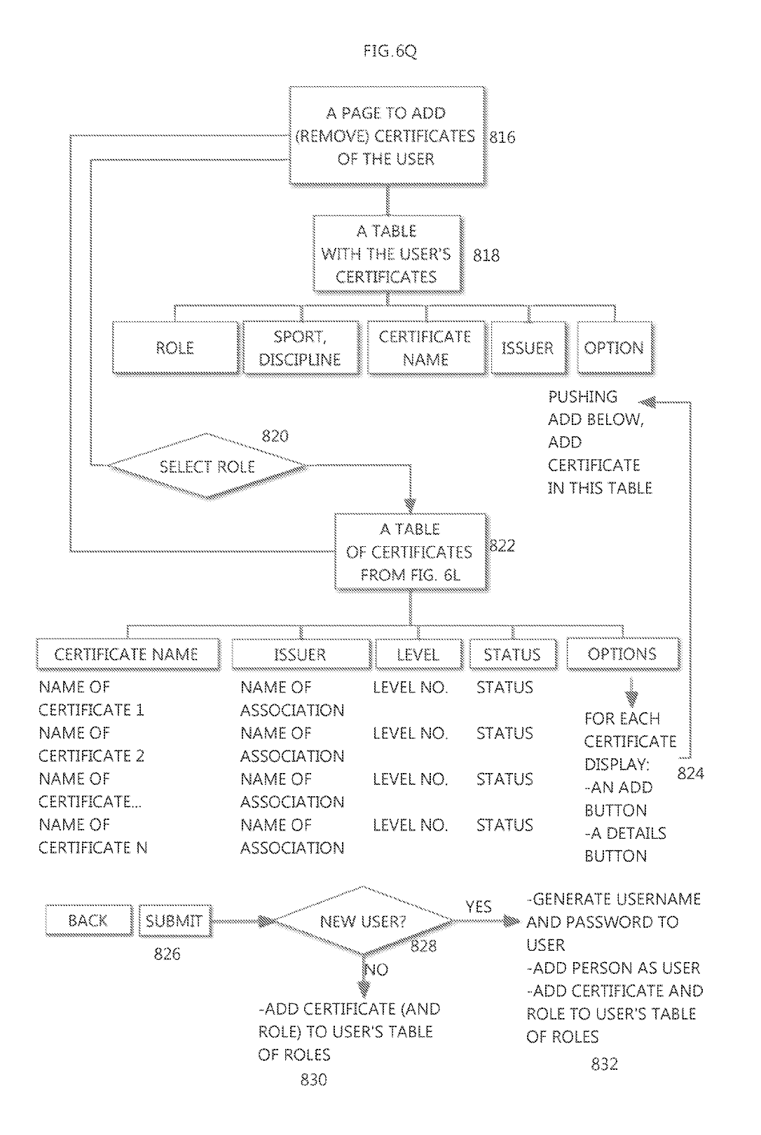

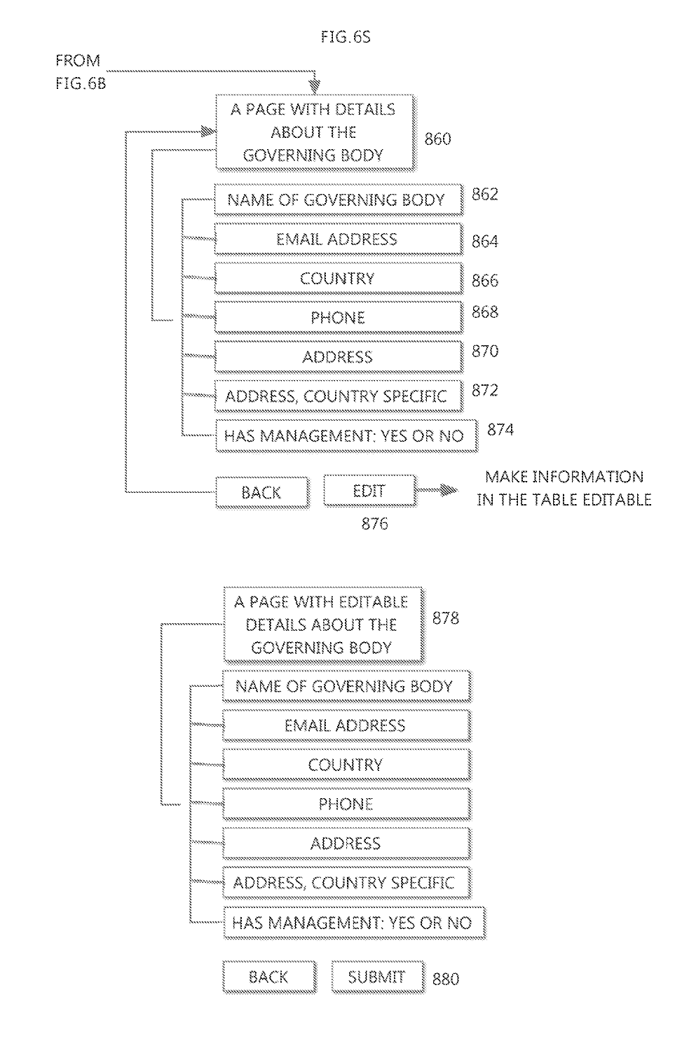

FIG. 2B shows the backoffice of the solution only viewable and accessible for the solution's administrator(s) (hereby admin). Backoffice is not viewable by regular users. Users 220 is a link to a table of users in the solution. Communities 221 is link to a table of communities in the solution (FIG. 26). International Associations 222 is link to a table of communities in the solutions being International Associations. National Associations 223 is link to a table of communities in the solutions being National Associations. Tournaments 224 is link to a page to search for tournaments. Default tournament search 225 is a default setting that can be done by admin. Arenas 227 is link to a page FIG. 25 where the admin can view a table of arenas in the solution. Arena changes 228 is link to a page where the admin can manage arena changes in the solution. Court changes 229 is a page where the admin can manage court changes in the solution, such as accepting or rejecting new open courts registered by court managers. Courts 230 is link to a table of all courts under all arenas registered in the solution. Blocked arenas 231 is link to a page with a table of blocked arenas. Sports 243 is link to a page FIG. 6A where the admin can manage sports in the solution. Applications 245 is link to a page where the admin can manage applications from persons from International and National Associations. Accepted applications 246 is link to a page with a table of accepted applications. Declined applications 247 is link to a page with a table of declined applications. Diplomas 248 is link to a page with a list of diplomas being used in the solution. Help pages 250 is link to a page where the admin can manage text on different pages to provide the user with information about how to use the solution. Company details 251 is link to a page where the admin can manage details about the Management of the solution, like company name, address, phone number and so on. Terms and Conditions 252 is link to a page where the admin can set terms and conditions for different parties using the solution like International Associations, National Associations, Clubs, Employers, players, tournament officials etc. Currencies 253 is link to a page where the admin can manage currencies and set main currency for the solution. Court forms 254 is link to a page where the admin can manage variables for different kind of courts in the solution. Bank accounts 255 is link to a page where admin can manage bank accounts for the solution. VAT rates 256 is link to a page where the admin can manage VAT rates in different countries. Emails/SMS 258 is link to a page where the admin can manage default contents of communities' emails/SMS in the solution. Receipt pages 259 is link to a page where the admin can manage different receipt pages in the solution. Equipment pages 260 is link to a page where the admin can manage equipment pages for different sports in the solution. Confirm messages 263 is link to a page where the user can manage text in different areas of the solution. Admin users 265 is link to a page where the admin can manage admin user in the solution. Roles 266 is link to a page where the admin can manage roles in the solution. Email members 267 is link to a page where the admin can email users. Change password 268 is link to a page where the admin can change password for login. Language 269 is link to a page where the admin can manage languages in the solution.

FIG. 2C shows the main page for the sport. The user enters this page having selected category and sport 270. The page contains a table showing winner of last tournament 271, the winner of last match 272 and the person being ranked as number one in the solution 273, all with name, position and photo. It also shows National ranking top 15 men 274, National ranking top 15 women 275 and National ranking top 15 players 276. The page also contains a select menu for country 277 and language 278.

FIG. 3 show the register page of the website. Users can have different roles in the solution so when a user register he will first select what to register for 280. Each option is named by “Type” 281, given a price 282 a “description” 283, and a link to a more detailed description 284.

If the user represents an international sports association governing a sport, and has the authority to act on its behalf, he can select “International Sports Association” 285. Doing so the user will be able to manage the rules of the sport within the solution, manage tournament official certificates, tournament officials, disciplines, match formats and do other settings that will impact on the sport in the solution internationally. The cost for this license is free.

If the user represents a national association, and has the authority to act on its behalf, he can select “National association” 286. Doing so he will be able to manage tournament officials, tournament officials fees, etc. The cost for this license is free.

If the user just wants to obtain membership in a registered community he can select the option “Obtain membership in a community” 287. Being a member of a community a user can obtain advantages such as participating in tournaments of the community and get discounts on court booking. The cost for this license will depend on the community.

If the user just wants to register as a player the user will select the “Player” option 288. As a player the user can participate in tournaments and book courts. Being a player users can also obtain membership in communities on the communities terms.

If the user represents a company and wants to organize sports for the company's employees the user will select the option “Employer” 290. As an employer the user can manage tournaments and courts for its employees. The cost for this license will depend on the number of members.

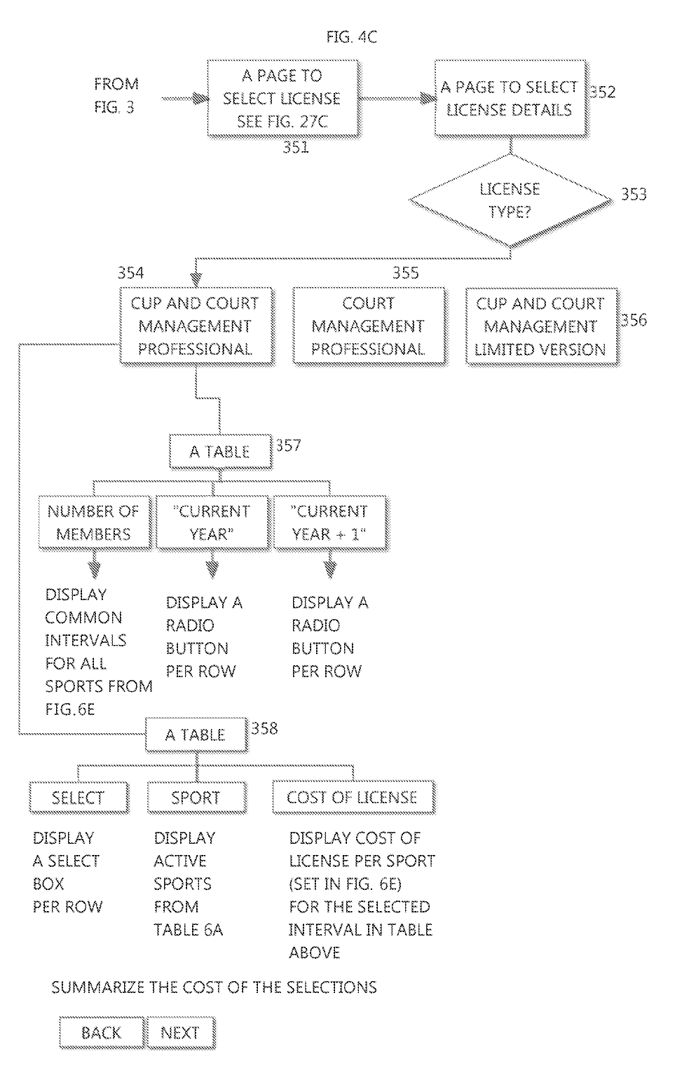

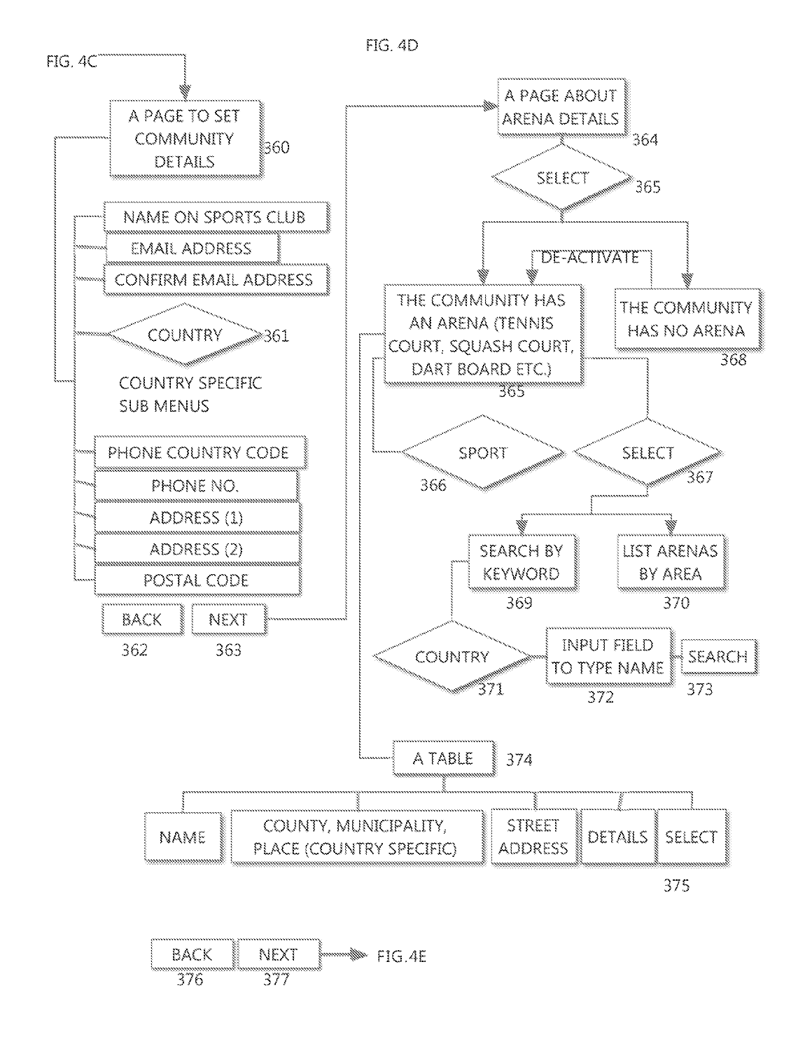

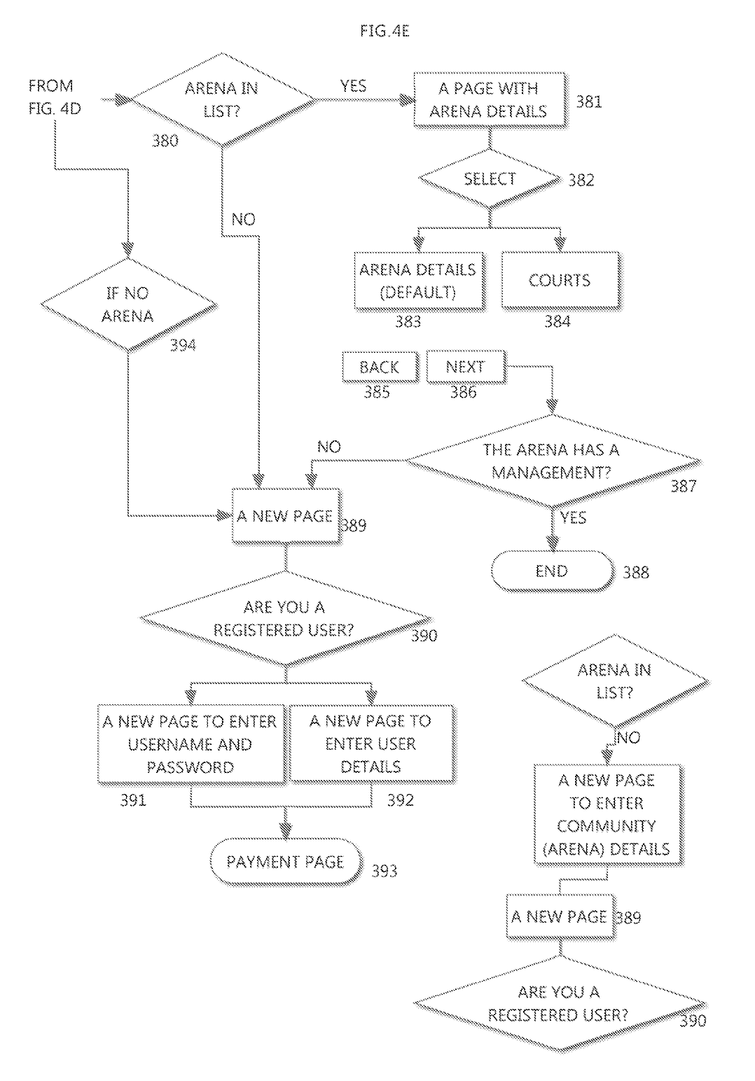

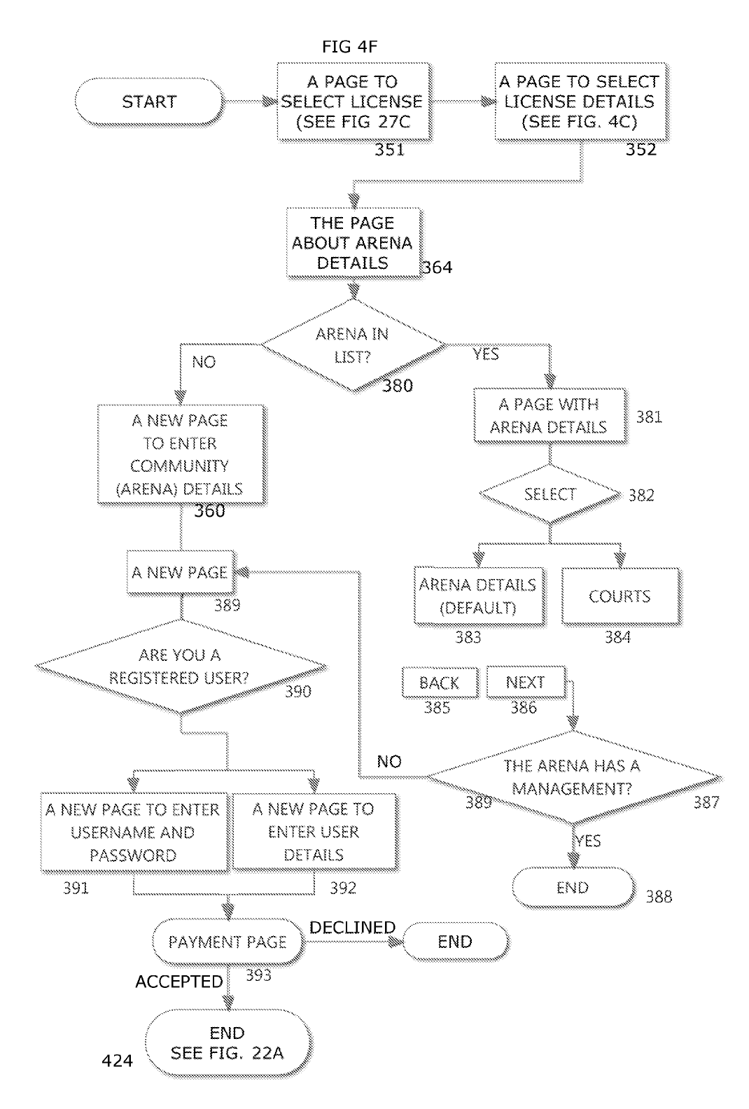

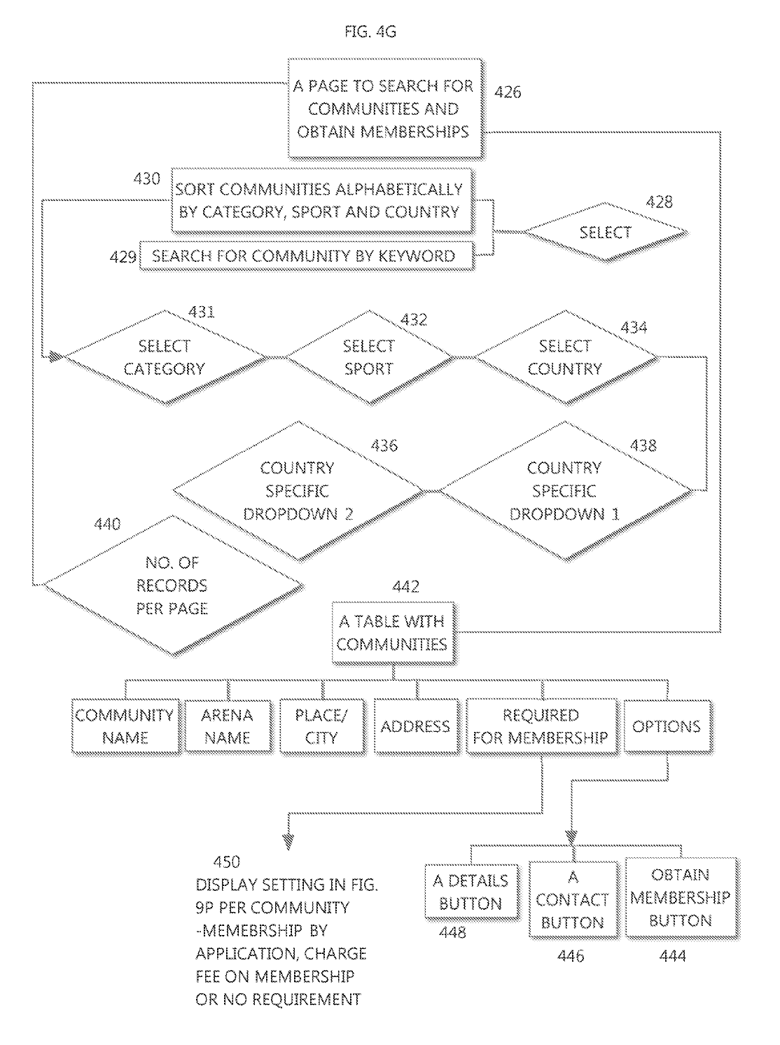

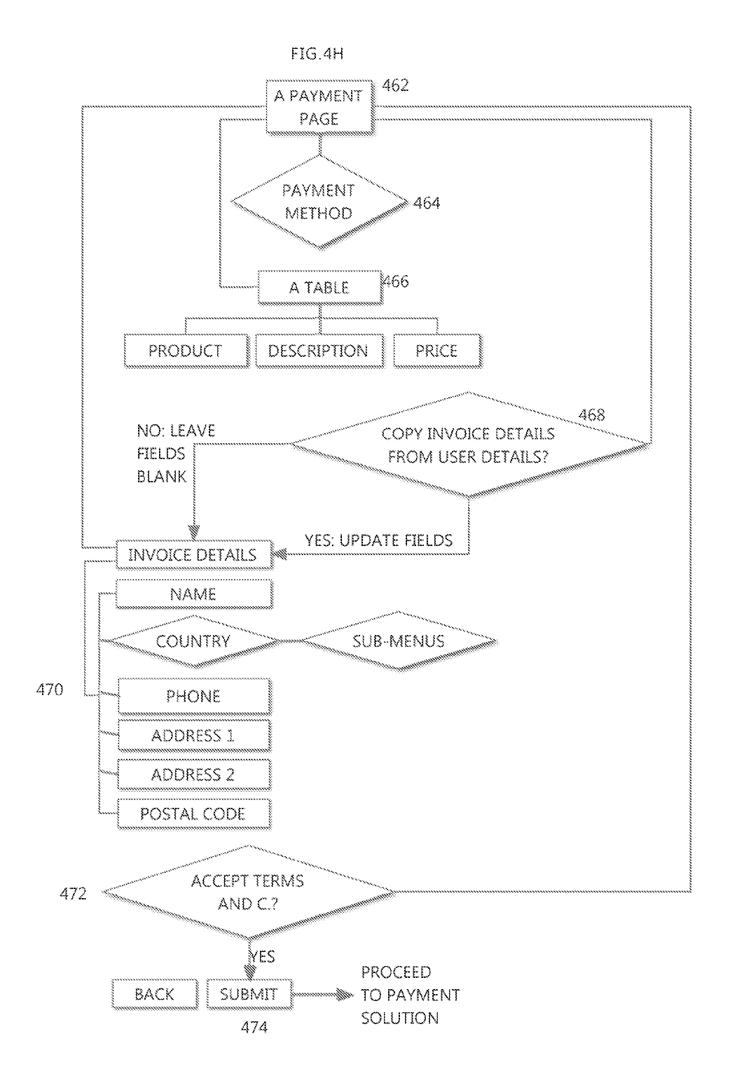

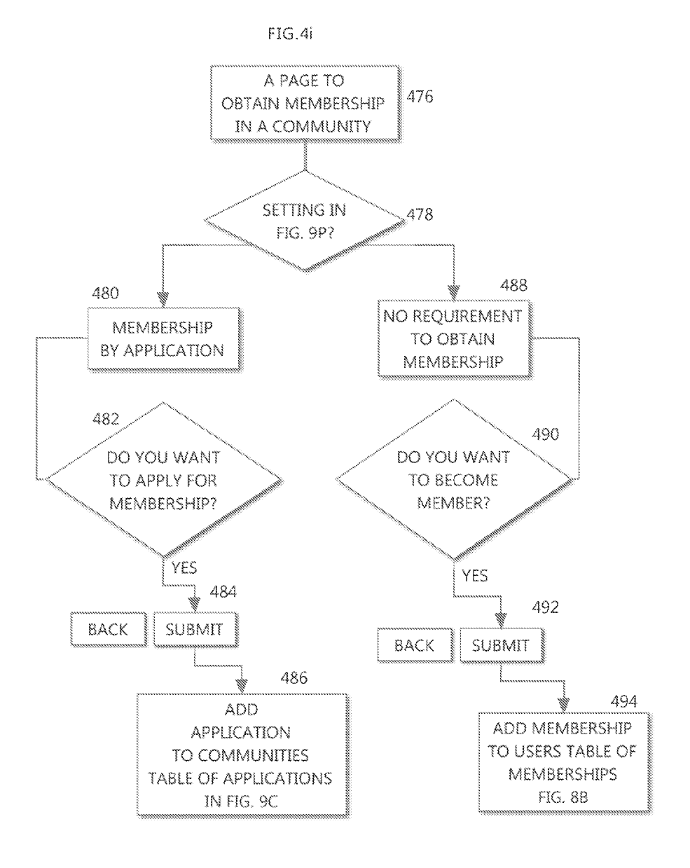

If the user represents a sports club and wants to organize sports for the clubs's members the user will select the option “Sports club” 292 and enter the process to register in FIG. 4C. As a Sports club the user can manage tournaments and courts for its members. The cost for this license will depend on sports selected and the number of members.

If the user just wants to organize sports for the friends, neighbours or family the user will select the option “Other sports community” 294. Here the user can manage tournaments and courts for friends, neighbours or family . The cost for this license will depend on sports selected and the number of members.

If the user represents an arena and just wants to use the solution for managing courts he will select the option “Arena” 296. From there the user will be able to manage online court booking. The user can also set up tournaments in vacant times to maximize the courts use. The cost for this license will depend on sports selected and the number of members.

If the user wants to enter tournaments as tournament official the user will register as “Tournament official” 298.

If the user wants to enter tournaments as medicial officer the user will select the option “Medical officer” 299.

The solution allows International Associations to apply for management of their sports from the registry page, but that option may be de-activated by admin if the Management of the solution wants to manage all sports. Then the admin of the solution will govern all sports.

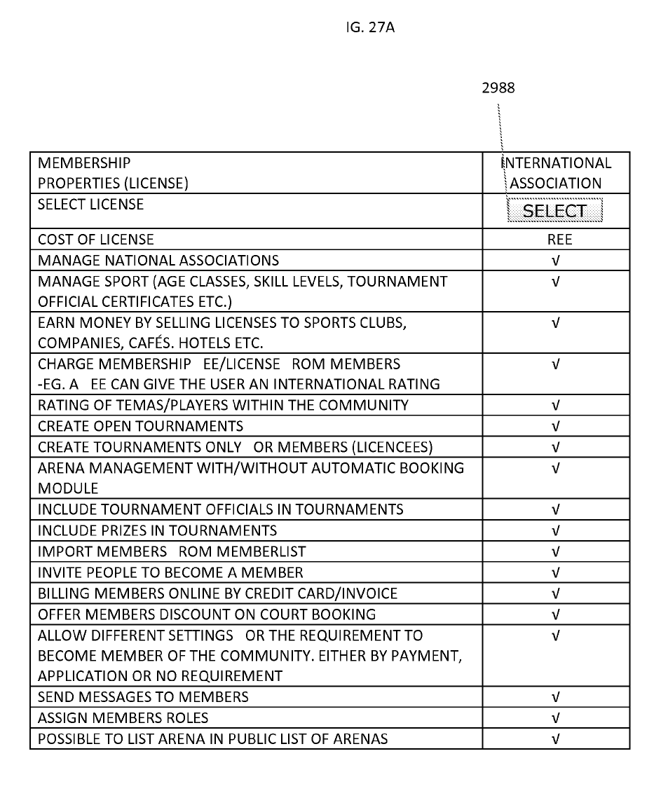

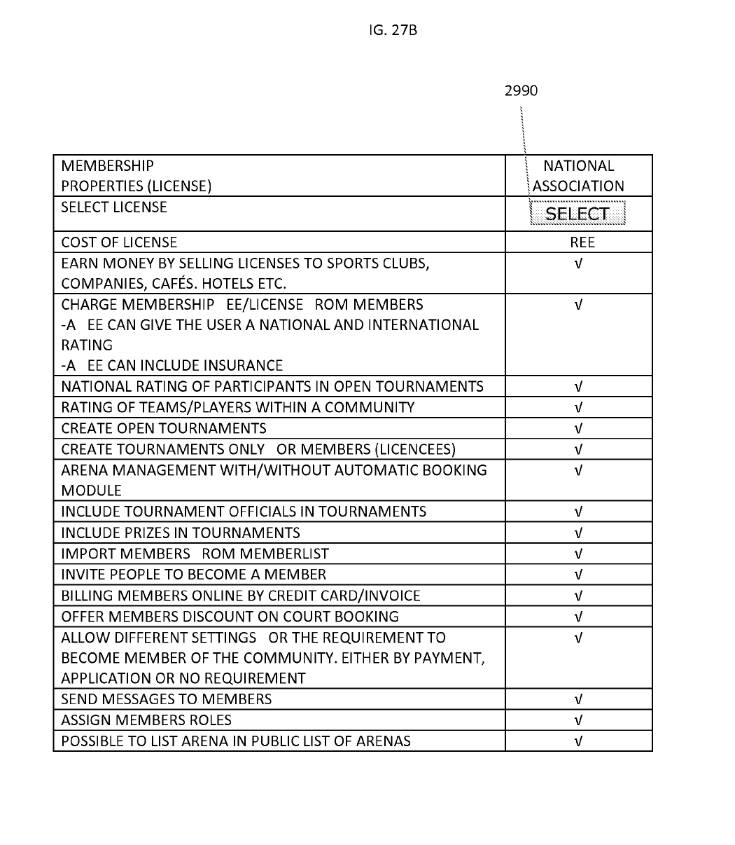

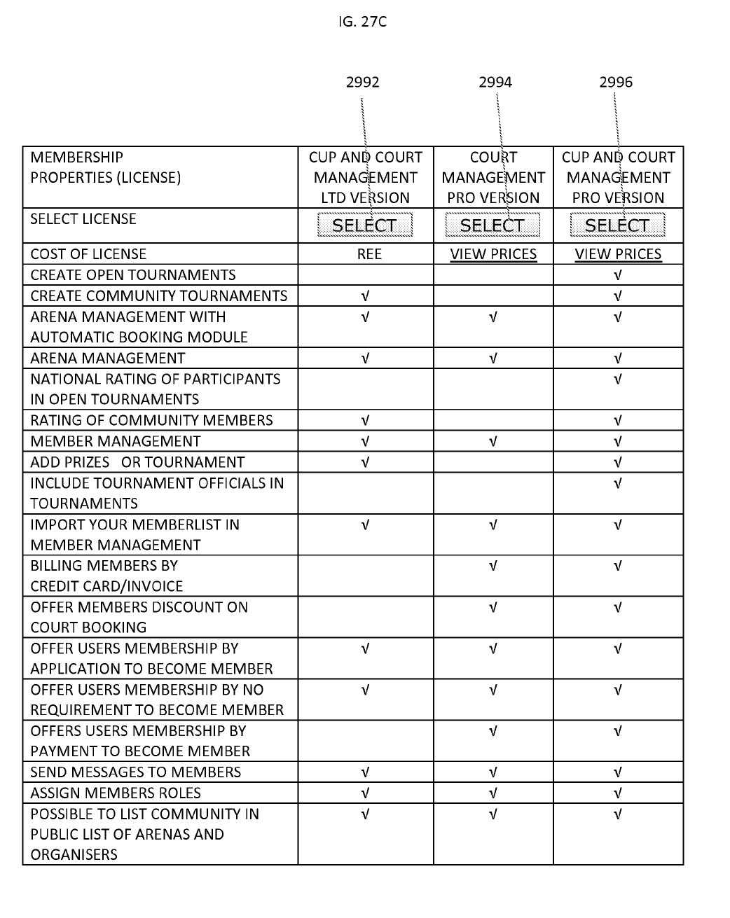

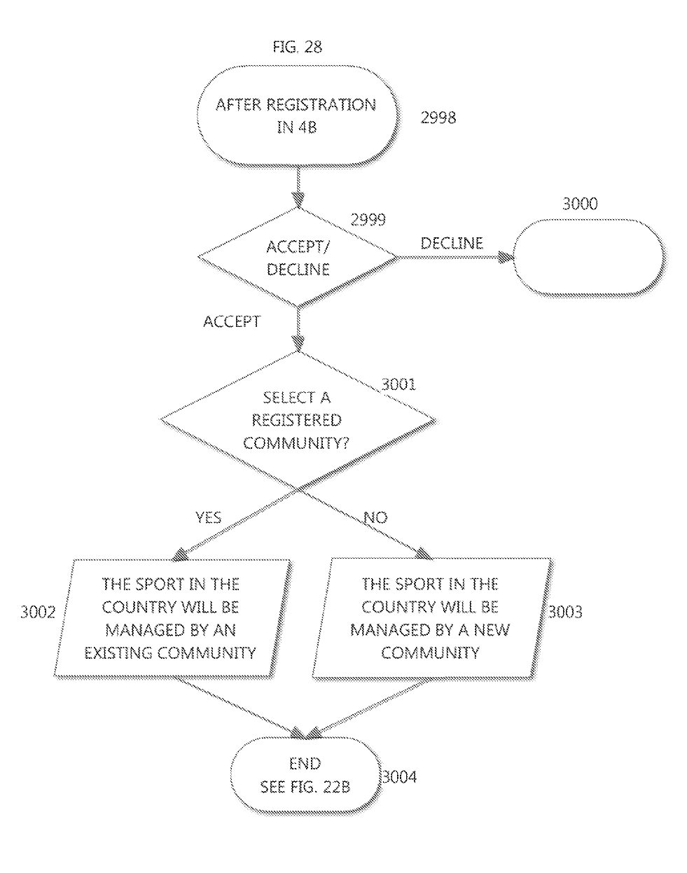

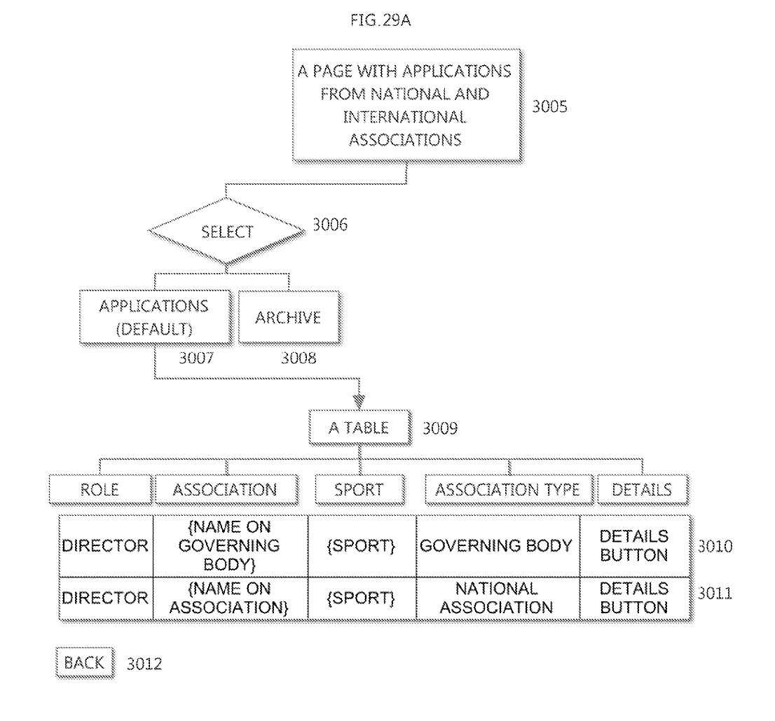

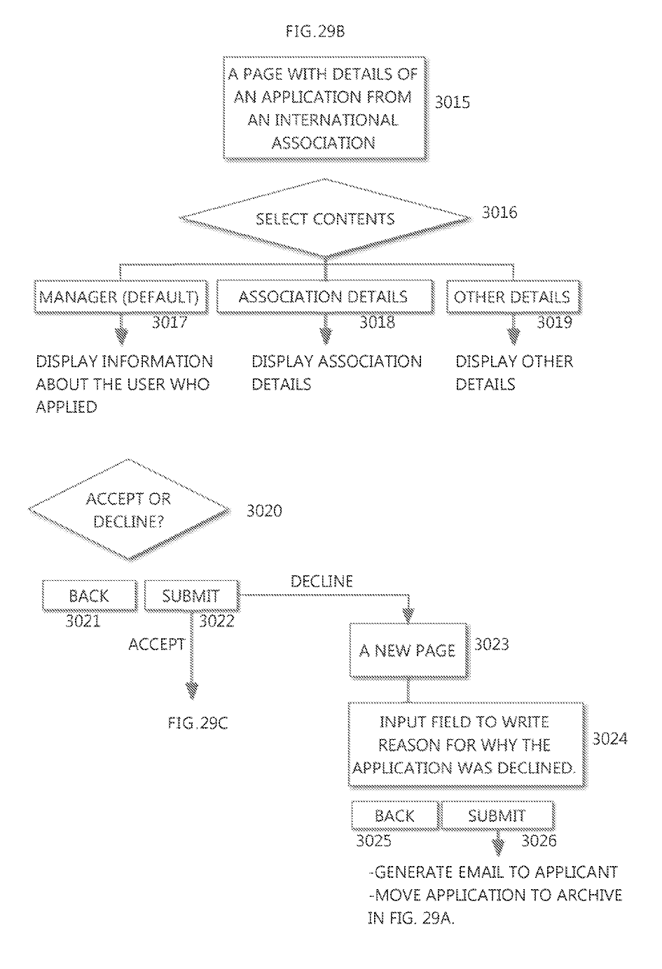

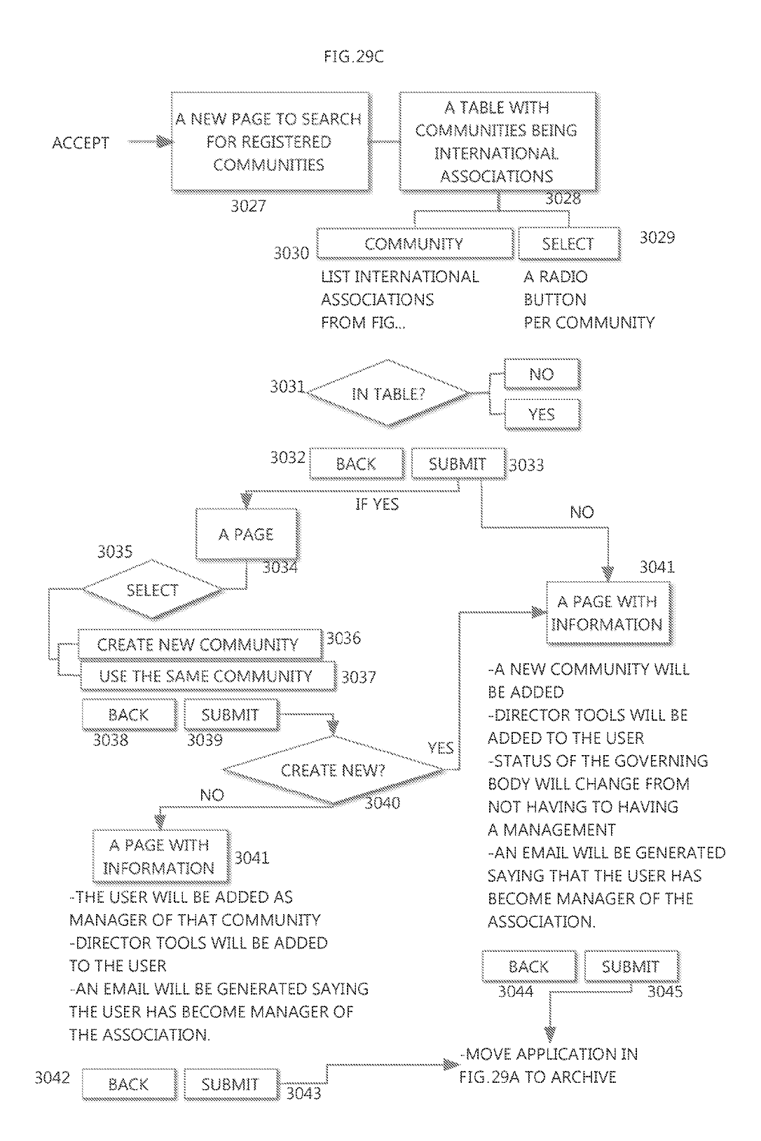

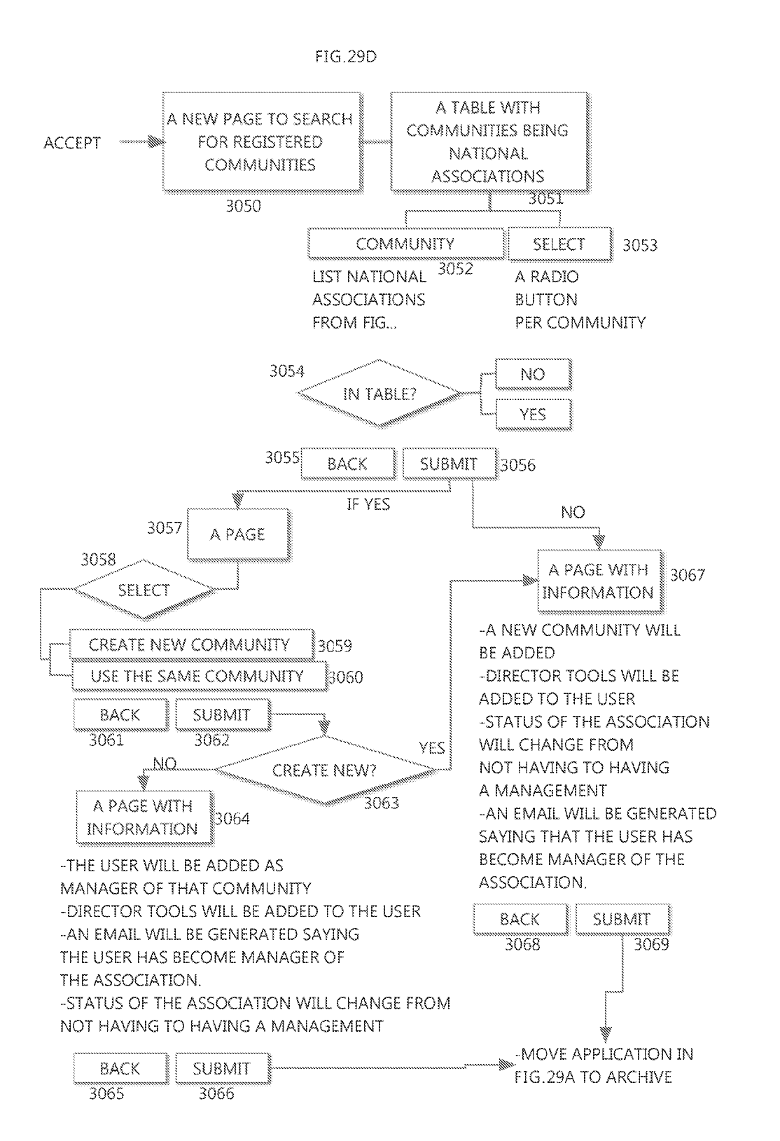

The registry process for an International Association consists of multiple steps and is illustrated in FIG. 4A. Selecting International Sports Association in FIG. 3 the user will proceed to a page showing license properties as in FIG. 27A for International Associations. After selecting license 304 the user will proceed to a page 306 with a select menu for sport and country and a table showing International association(s) without a management. The table lists Governing bodies (International associations) from each sport, downloaded from FIG. 6S. If the name of the association the user register on behalf is not listed the user cannot proceed. When selecting an association the user proceeds to a new step 308 to set other details like the persons role/position at the association, how many years the person has been with the association, the name of a co-worker, the co-workers role/position, phone number and email address. The user then proceeds to next step 310 to enter user details 312 or username and password 314. The user must then accept terms and conditions 316/318 to complete the registration. The application is then added as an application to the management of the solution in table 3009 of FIG. 29A.

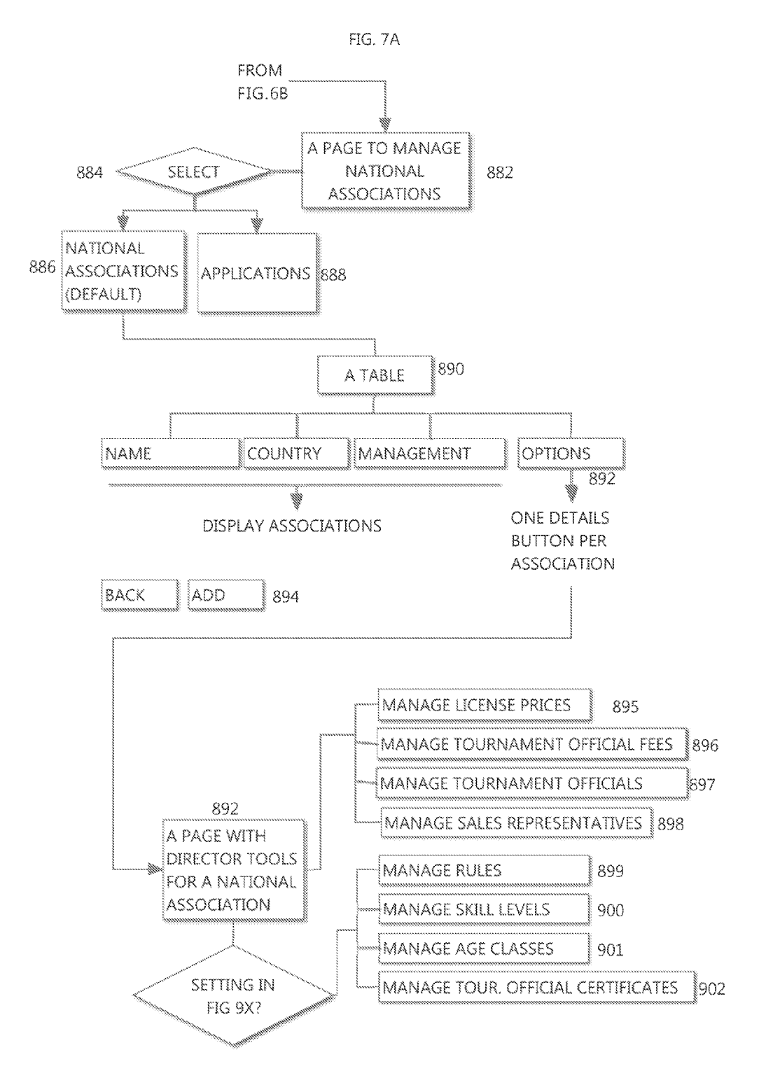

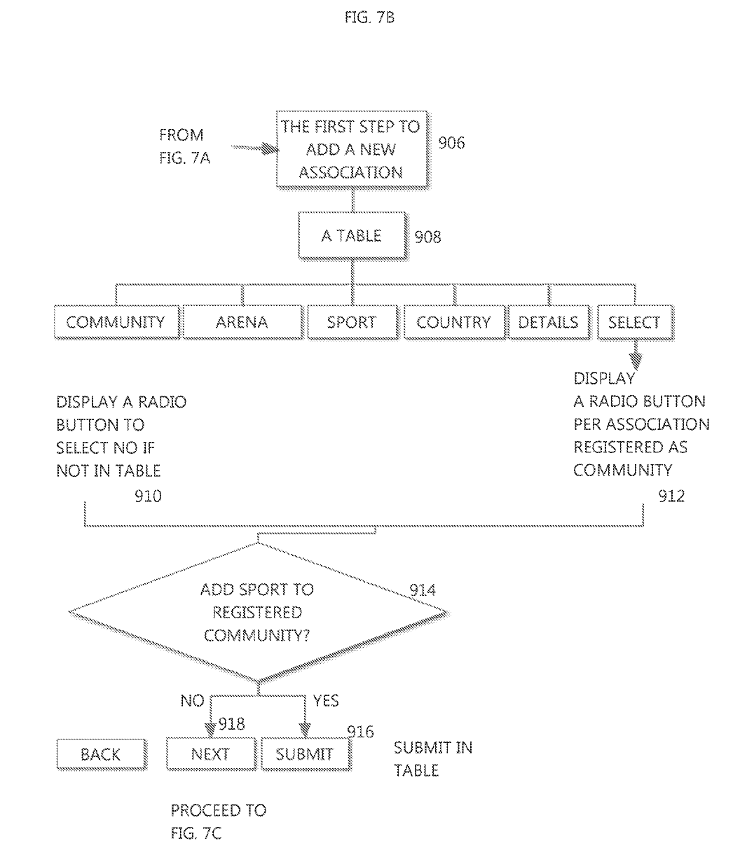

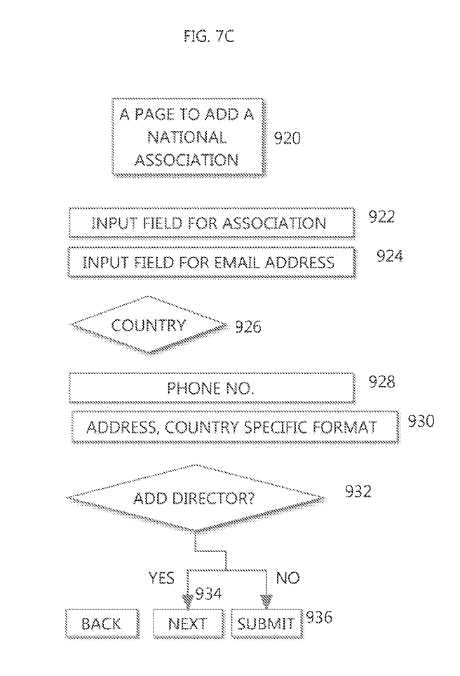

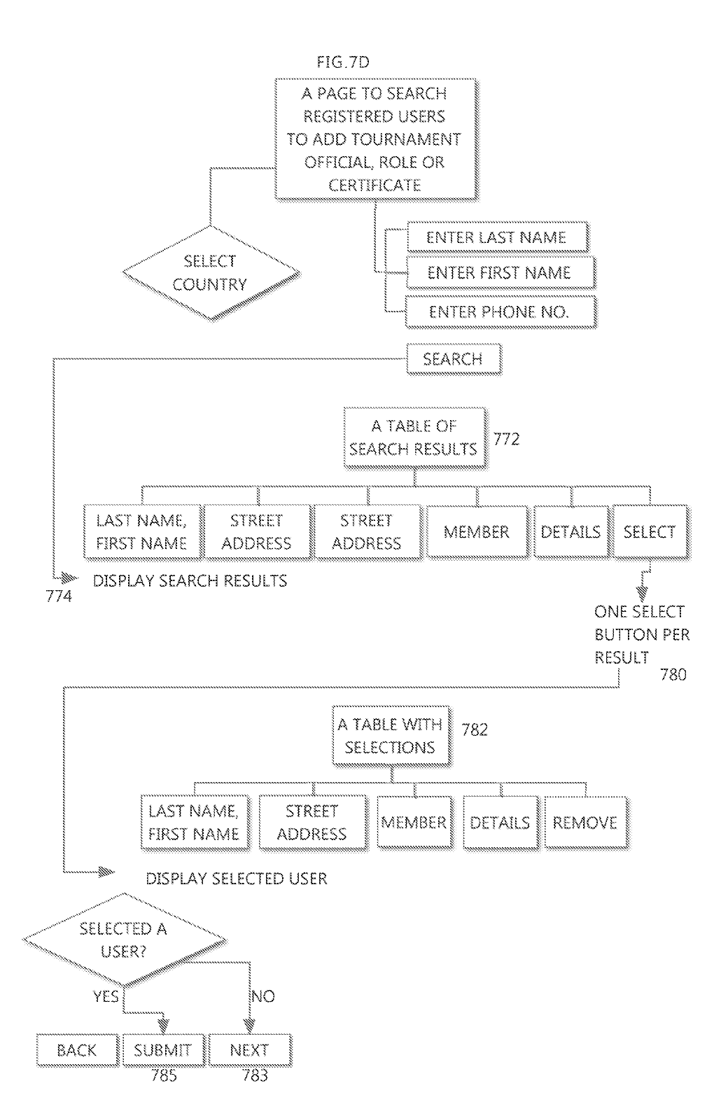

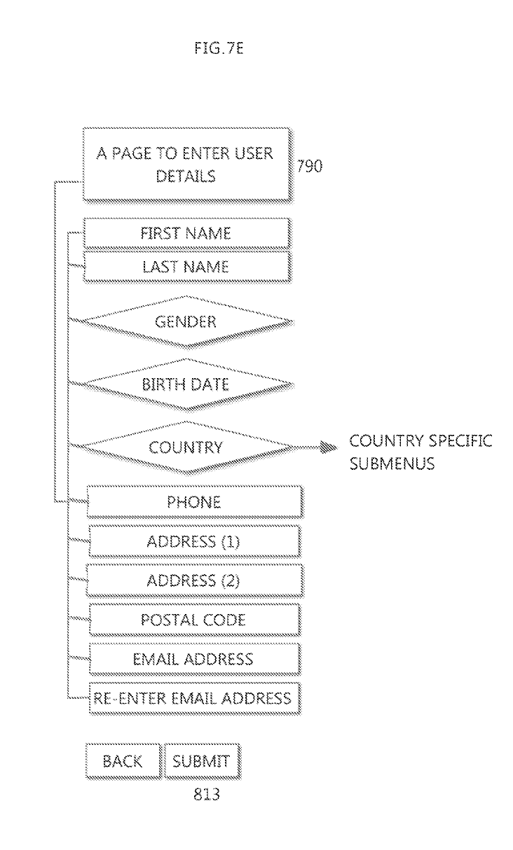

The registry process for a National Association consists of multiple steps and is illustrated in FIG. 4B. Selecting National Sports Association in FIG. 3 the user will proceed to a page showing license properties as in FIG. 27B for a National Association. After selecting license 328 the user will proceed to a page 330 with a select menu for sport and country and a table showing association(s) without management from table 890 in FIG. 7A. If the association is not listed the user cannot proceed. When selecting an association the user proceeds to a new step 332 to set other details like the persons role/position at the association, how many years the person has been with the association, the name of a co-worker, the co-workers role/position, phone number and email address. The user then proceeds to next step 334 to enter user details 336 or username and password 338. The user must then accept terms and conditions 340/342 to complete the registration. The registration in FIG. 4B is then submitted as an application to the Director of the Sport in table 888 of FIG. 7A but also to the management of the solution in table 3009 of FIG. 29A. Normally the party governing the sport would handle the application but listing the application both places ensures that it is followed up by the solution's management, if unanswered by the sport's governing body.

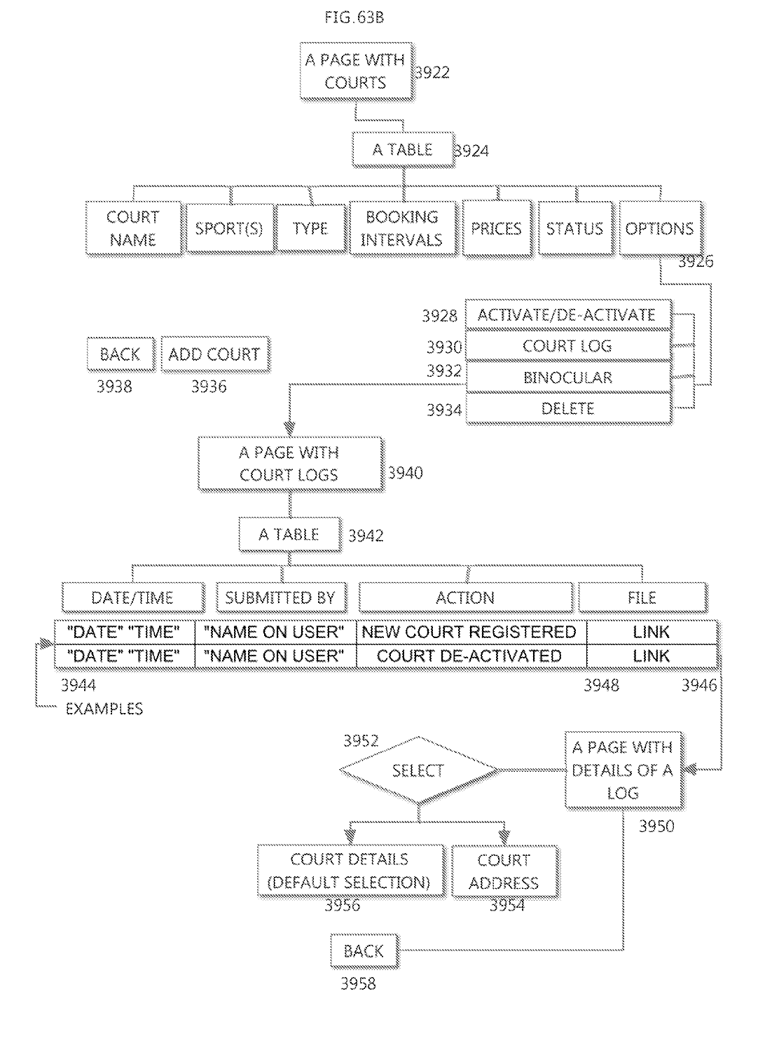

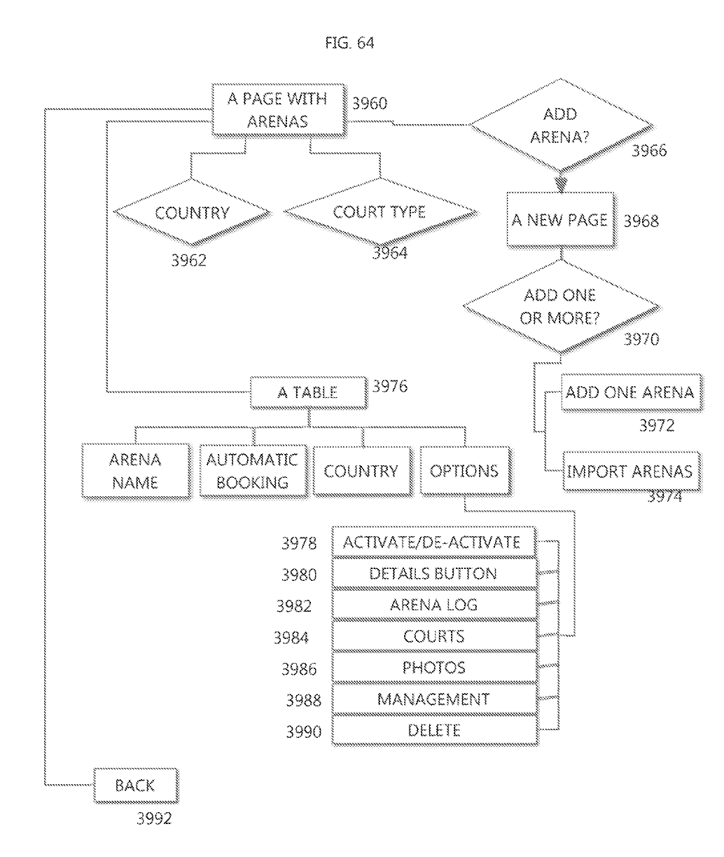

FIG. 4C-4E illustrates the registry process for a sports club. This registry process can also be used for other communities like employers, schools, hotels, cafés etc. FIG. 4C shows what happens when a user selects sports club in FIG. 3. The user first enters a page to select license 351, a page illustrated in FIG. 27C. Having selected license the user proceeds to a page to select license details 352. The contents of the license details page depends on the type of license the user selected 353. If the user selects Cup and Court management professional license the page will contain a table 357 to select the number of members and year of license, and a table 358 below showing different sports and the cost of license per sport for the year and number of members the user selected in table 357. The price on license per sport for different number of members is set by the Director of the sports in FIG. 6E. If the user selected Court management professional license in the select license page 351 the page to select license details would look the same as when the user selects Cup and Court management professional license but with prices set for court management professional license. If the user selected Cup and court management limited version license in the select license page 351 the page to select license details would look different with only two options selectable: A license for “current year” and a license for “current year+1 year”. Cup and court management limited version is free and like trial license. Having selected license details the user will proceed to 360 in FIG. 4D to set community details. Having set community details the user will proceed to a page about arena details. The community may and may not have an arena. Selecting having an arena the user will select sport and either search for the arena by key word or list arenas by area. On basis of these selection a search for arenas is done in table 3976 in FIG. 64 in backoffice and the search result is displayed in table 374. Note that arenas in table 3976 can be arenas with and without a management. If the user selected an arena in table 374 the user will proceed to a page with arena details 381 in FIG. 4E. In this page the user can view different information about the arena, like arena details like address, phone no. etc 383 and registered courts 384. From 381 the user will proceed to a new page: If the arena has a management the user will be informed about that and will not be able to continue registration. If the arena does not have a management the user will continue the registration process and enters a page 390 asking if the user is a registered user or not. A registered user proceeds to 391 to enter username and password while a new user proceeds to 392 to enter user details. From there the user proceeds to the final page in the registration process which is the payment page.

If the user selects Arena 296 in FIG. 3 the register process differs slightly from the register process for a sports club 292 as described in FIG. 4C-4E. The reason why Arena 296 is a separate option in FIG. 3 is that the user may identify more as an Arena than a sports club. In FIG. 4F the register process for an arena is illustrated. The page to select license 351 is the same as when a sports club register. The same with the page to select license details 352. From the select license details page the user will proceed to a page about arena details 364. This page also looks the same as for a sports club, except the option “The community has no arena” 368 is de-activated (see FIG. 4D). If the user can find the arena in the page about arena 364 the user will proceed to a page with arena details 381 and continue the register process as described earlier for a sports club. If the arena was not in the list of the about arena page the user will proceed to a new page to enter arena details and from there proceed to the page asking if the user is a registered user 390. From there the process goes on as for a sports club.

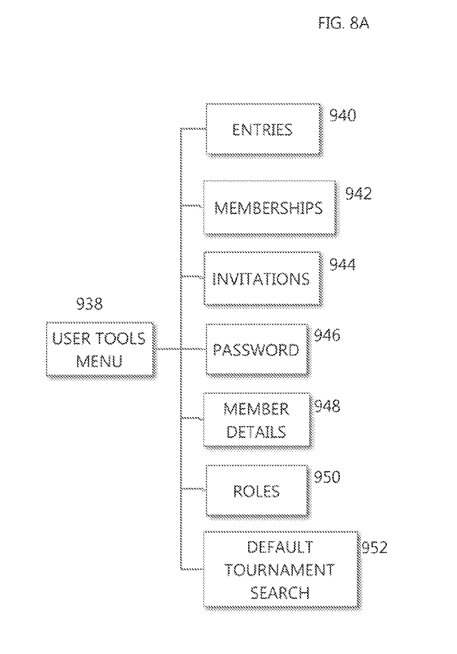

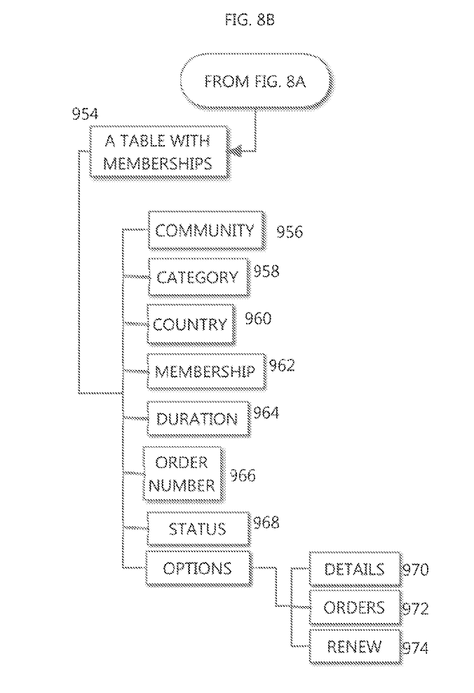

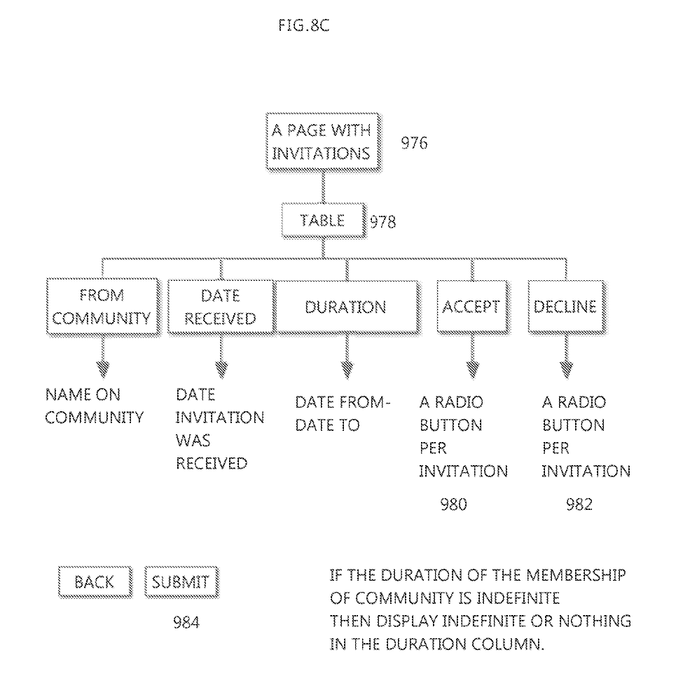

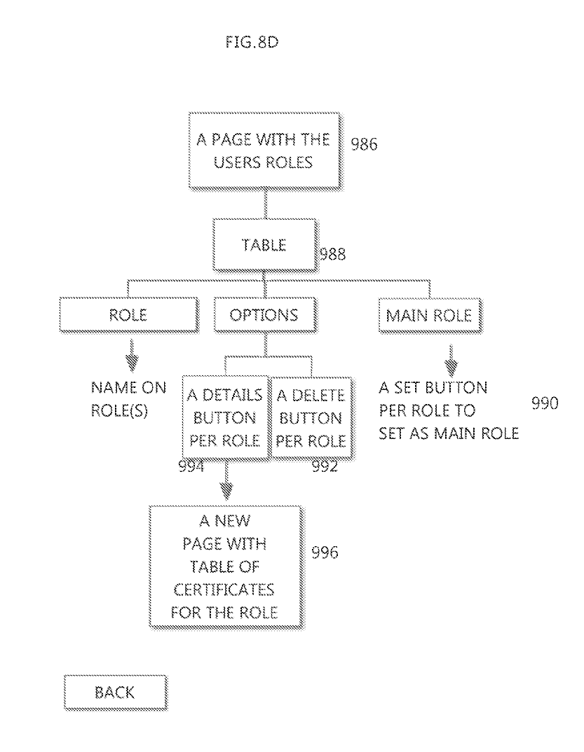

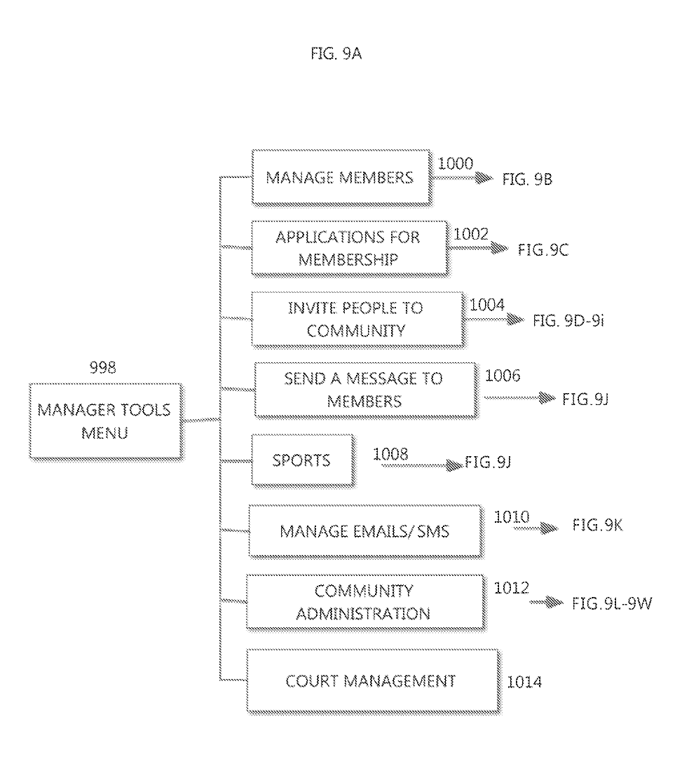

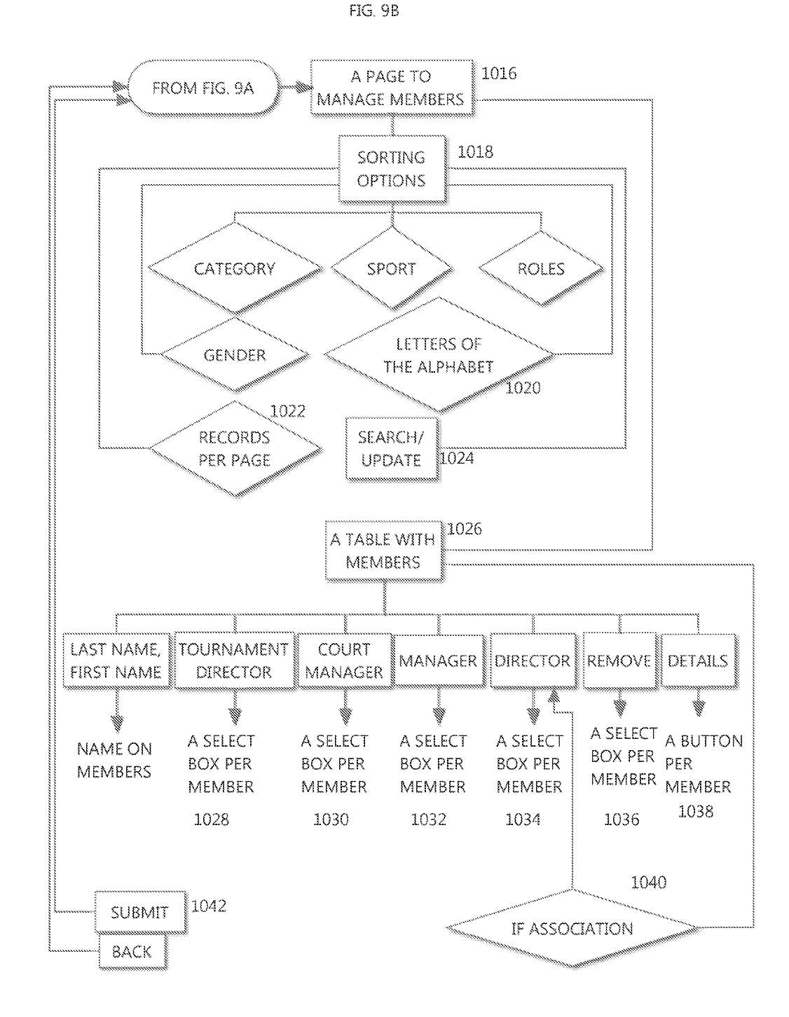

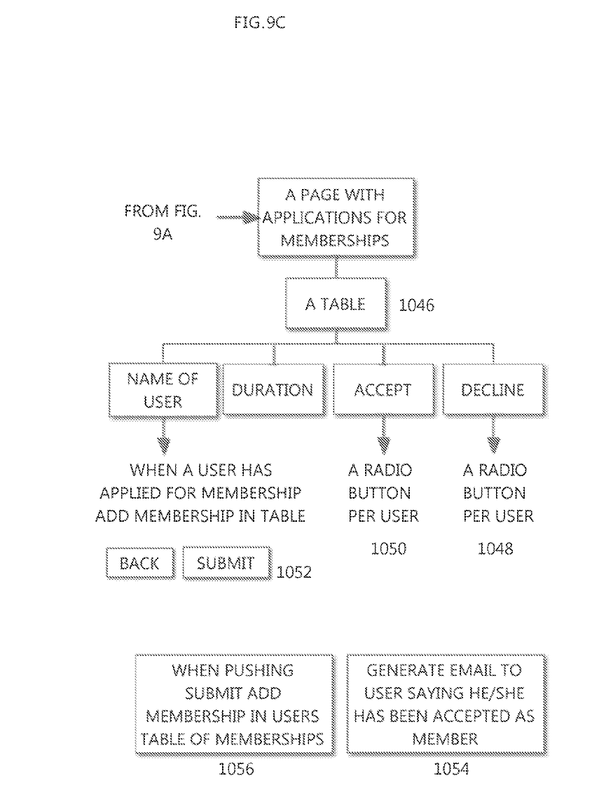

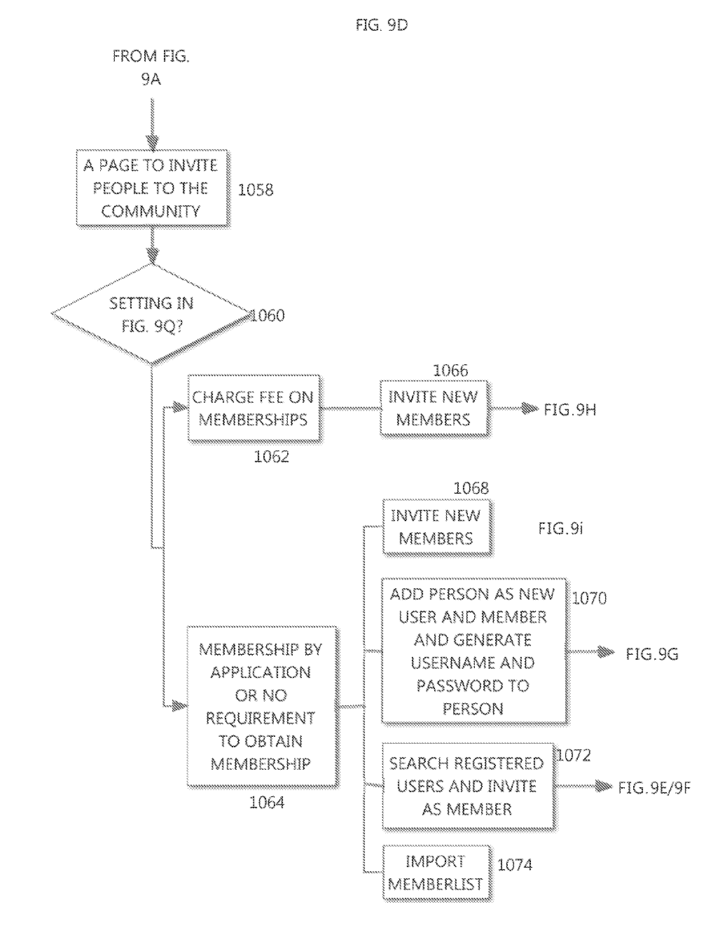

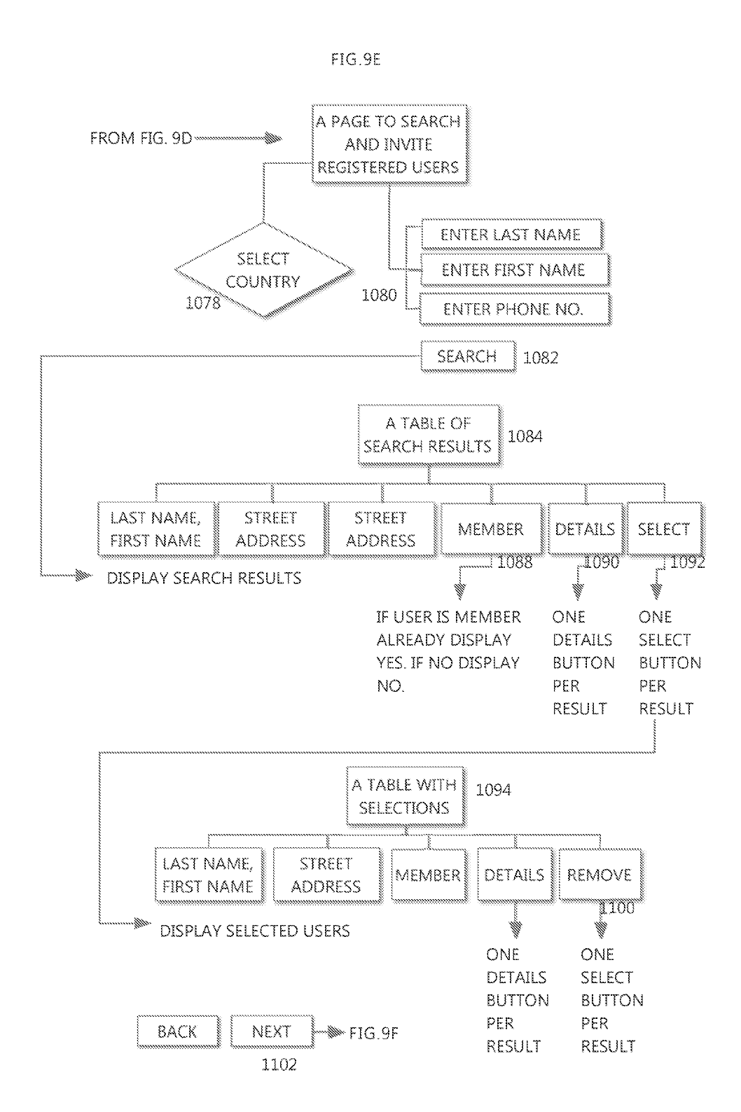

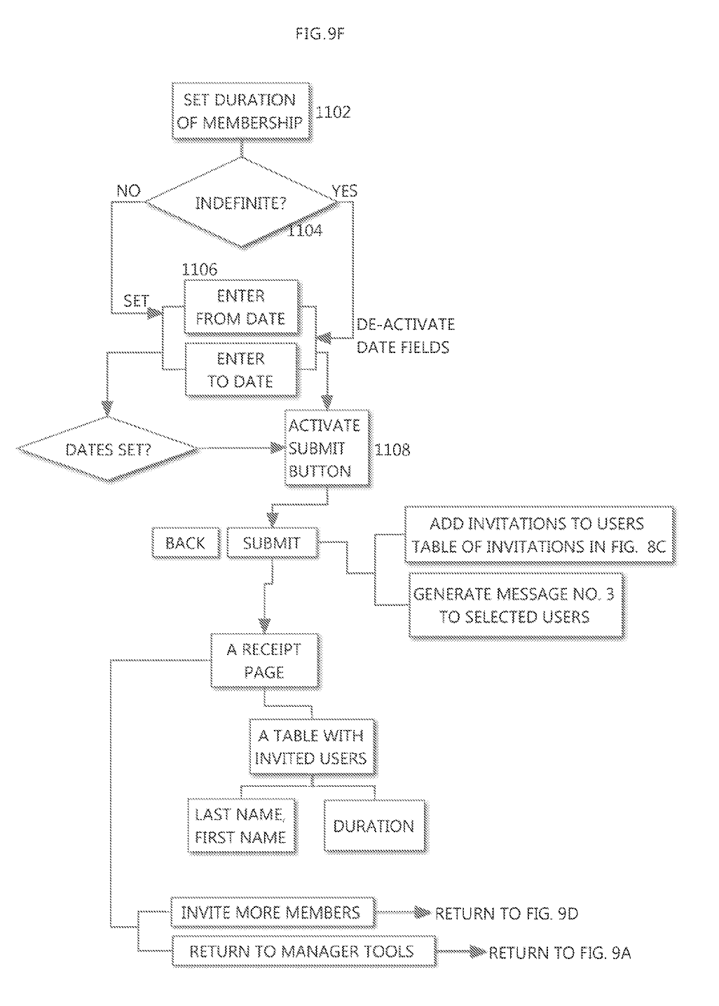

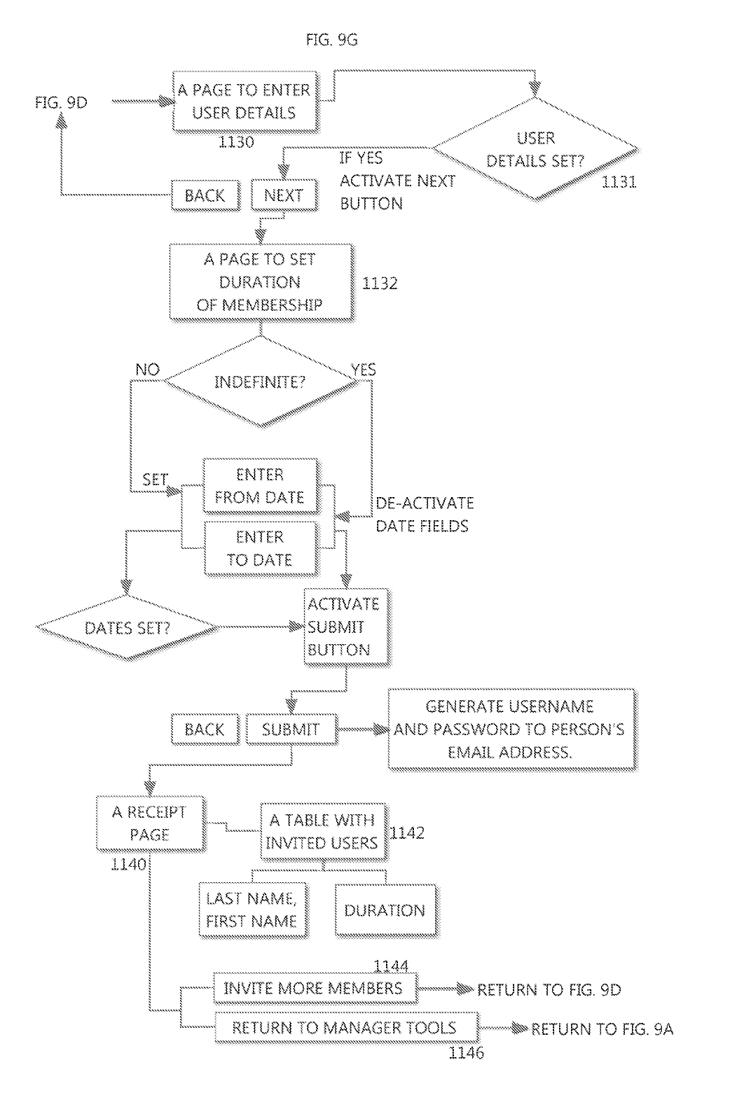

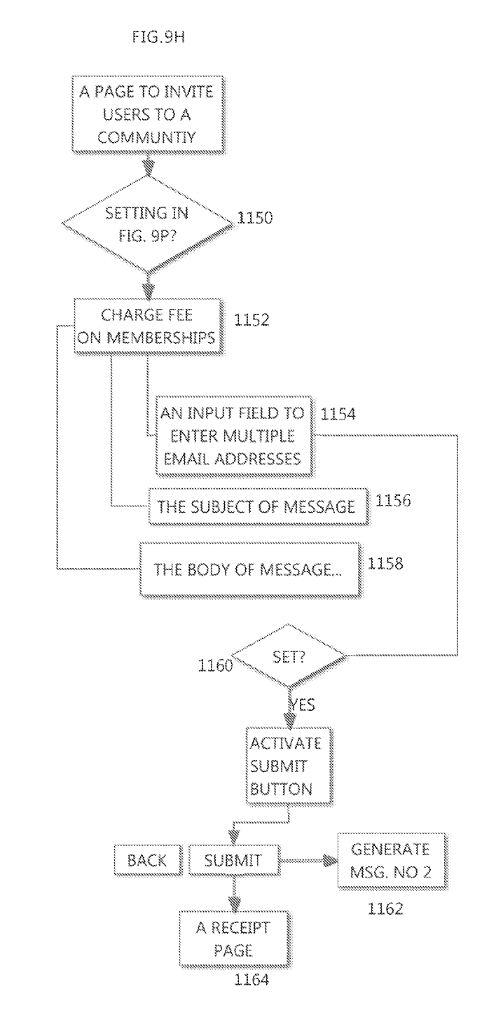

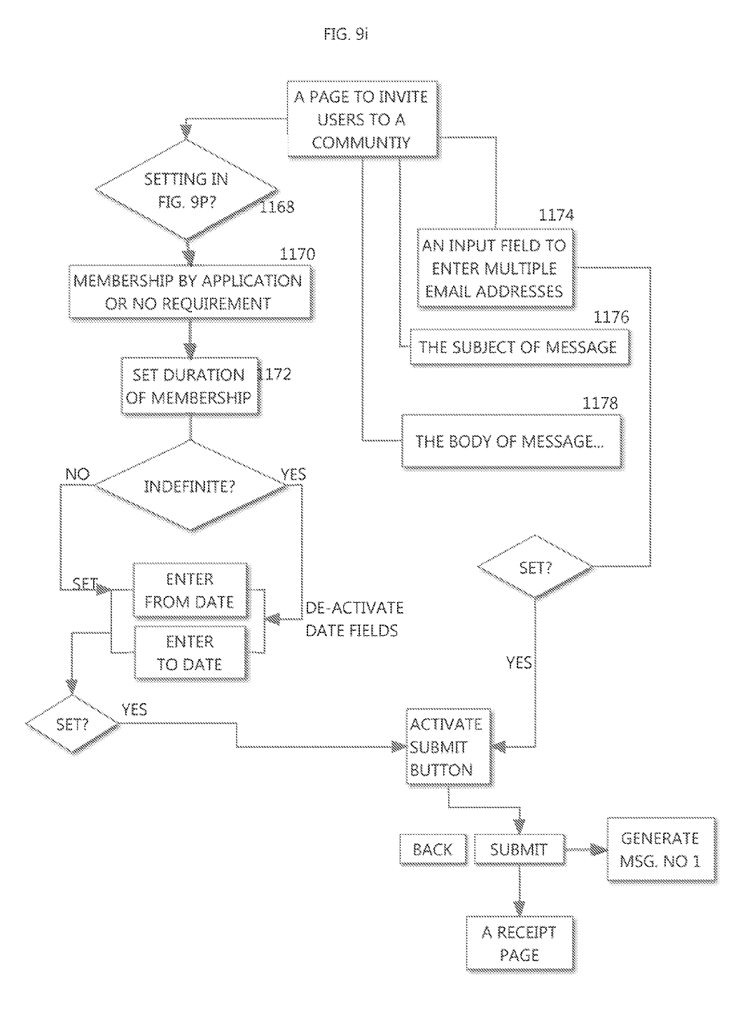

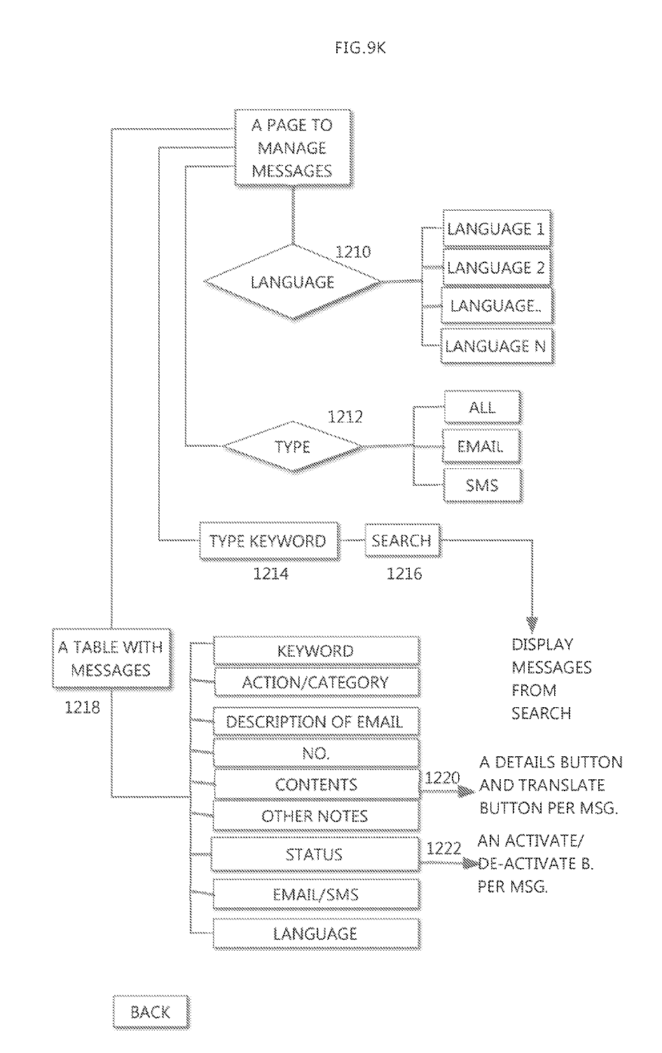

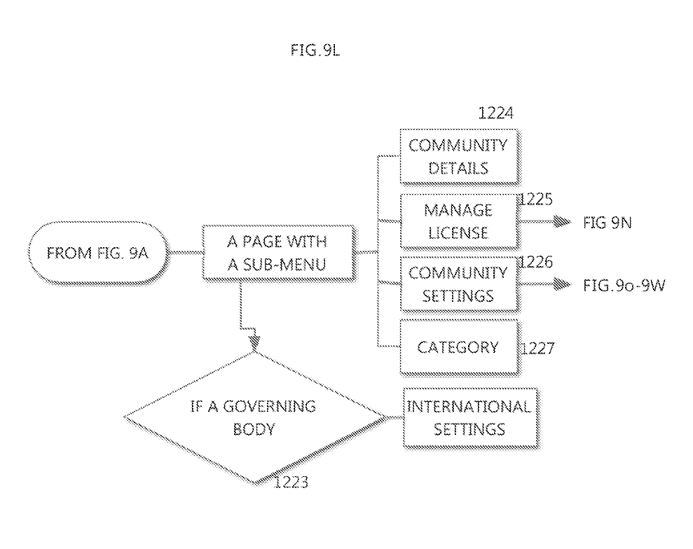

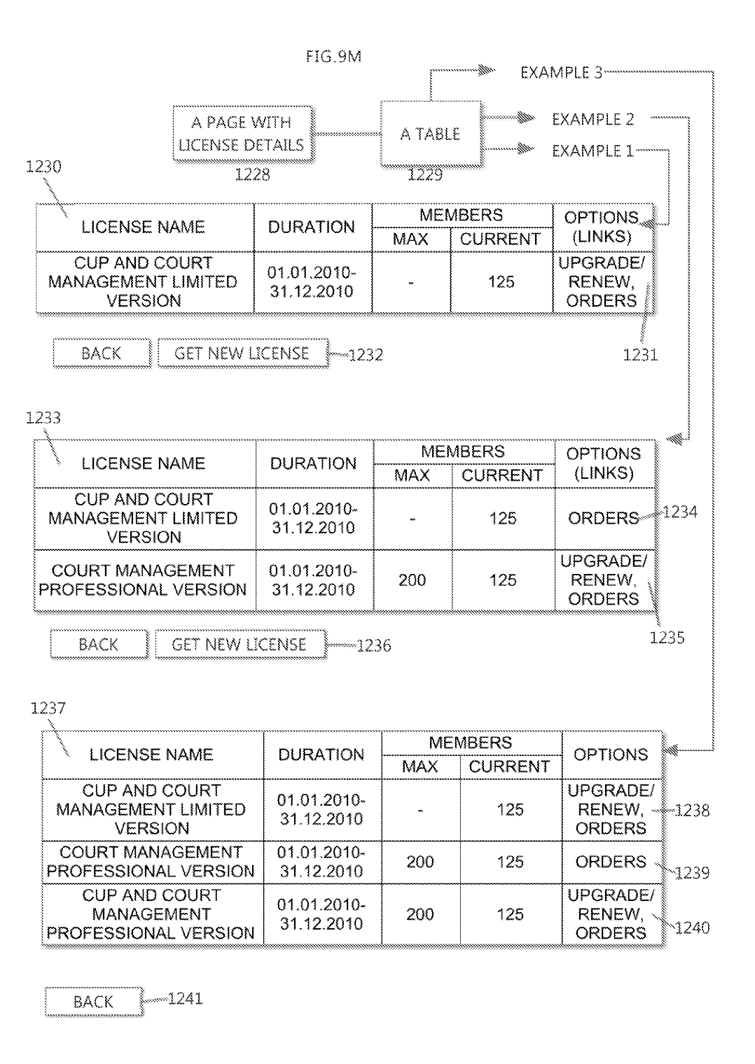

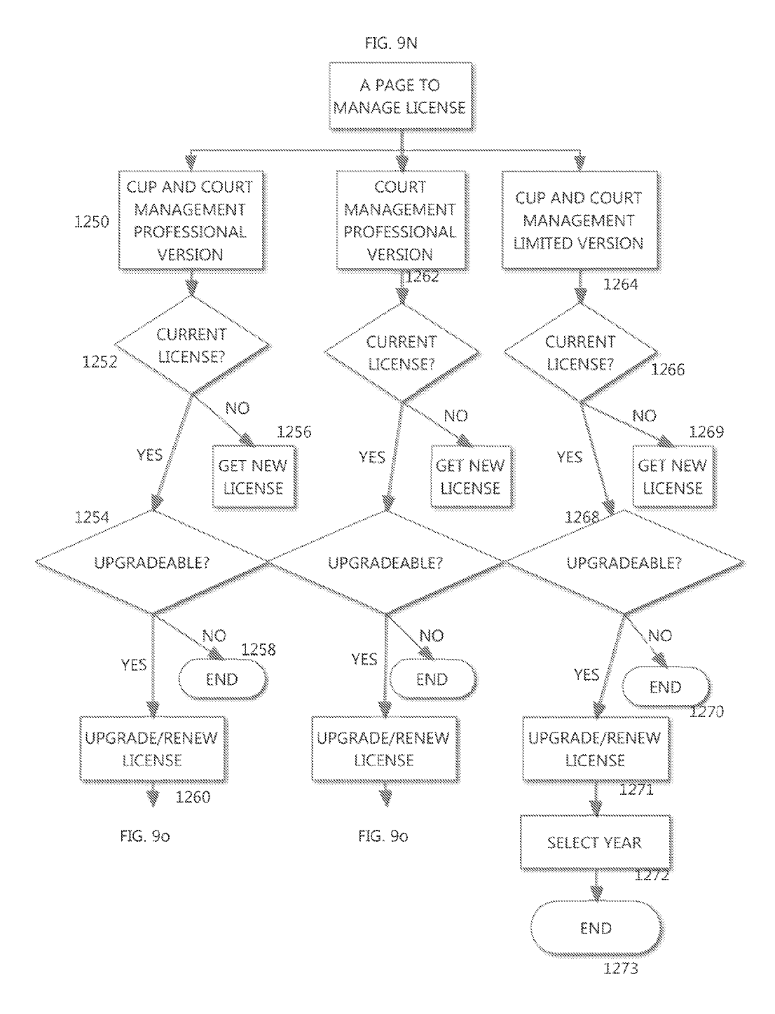

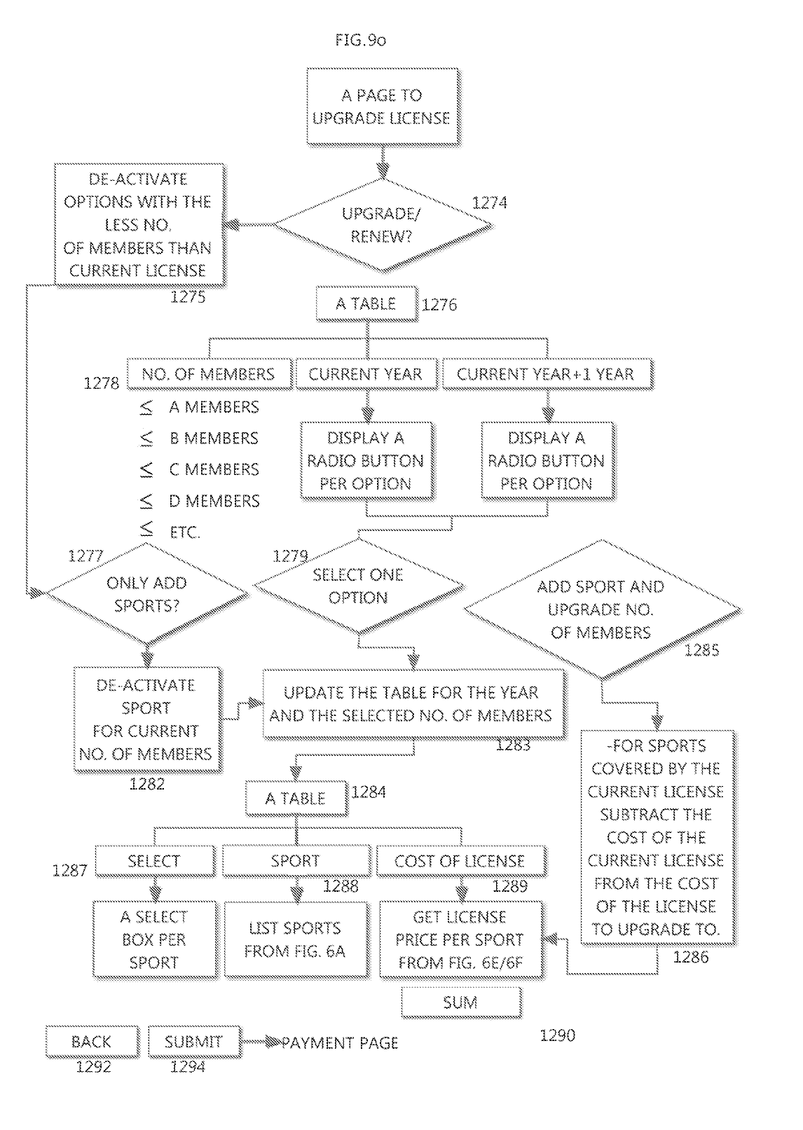

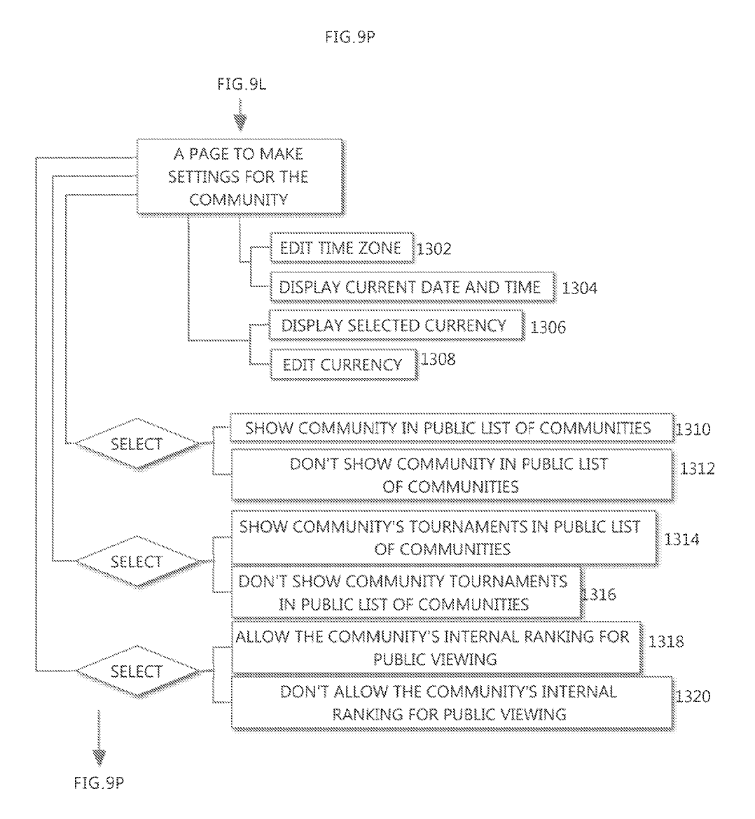

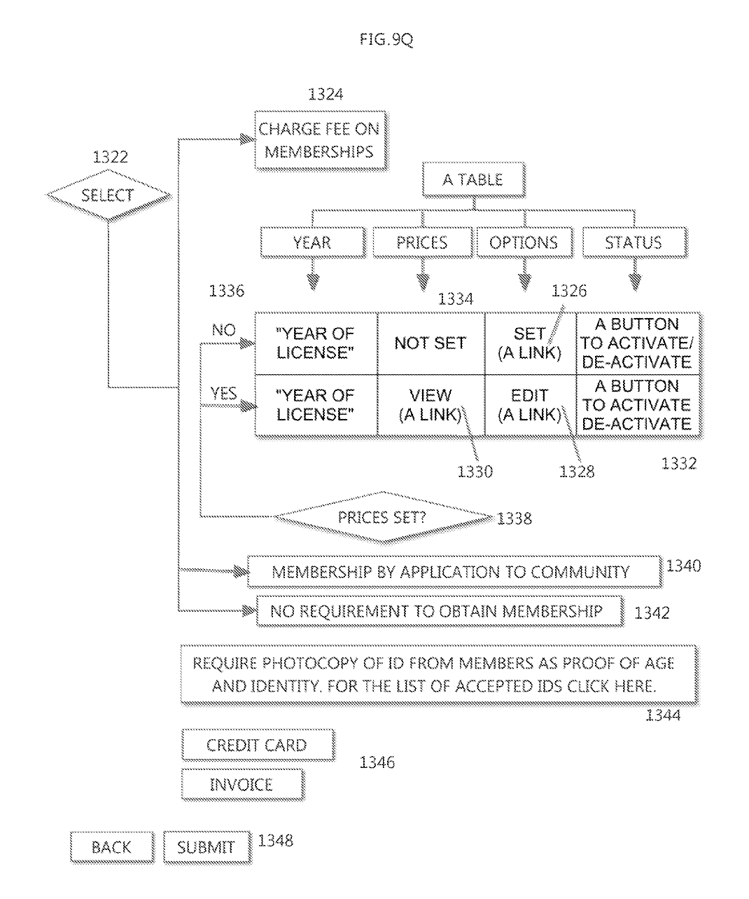

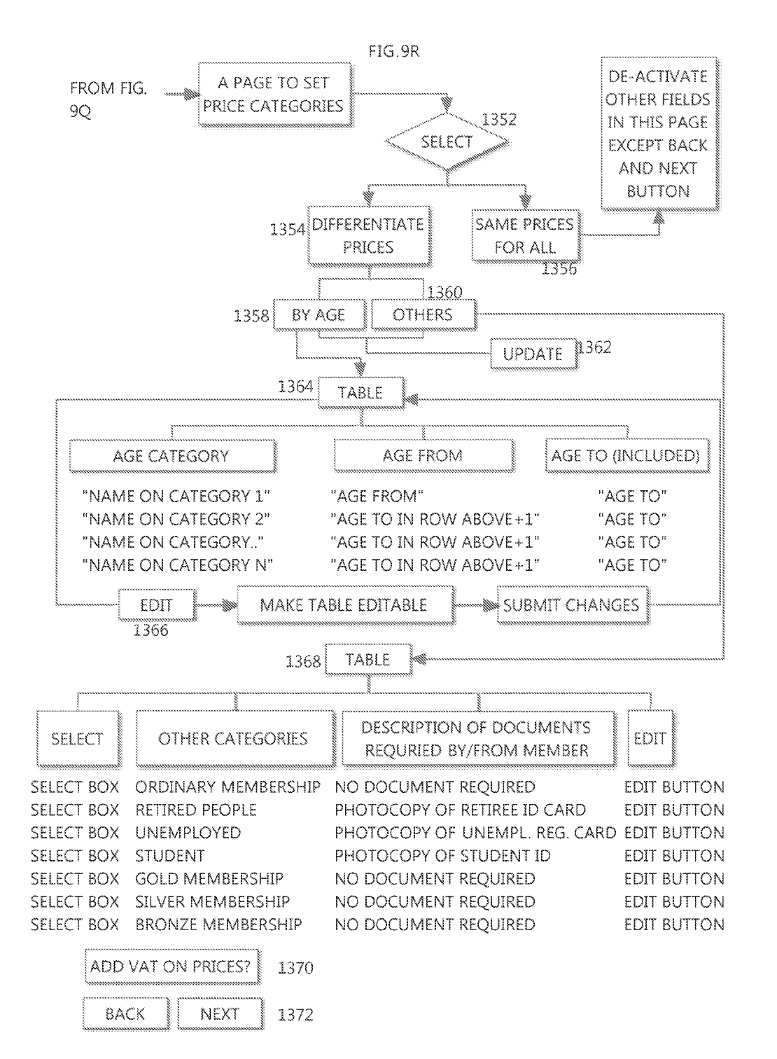

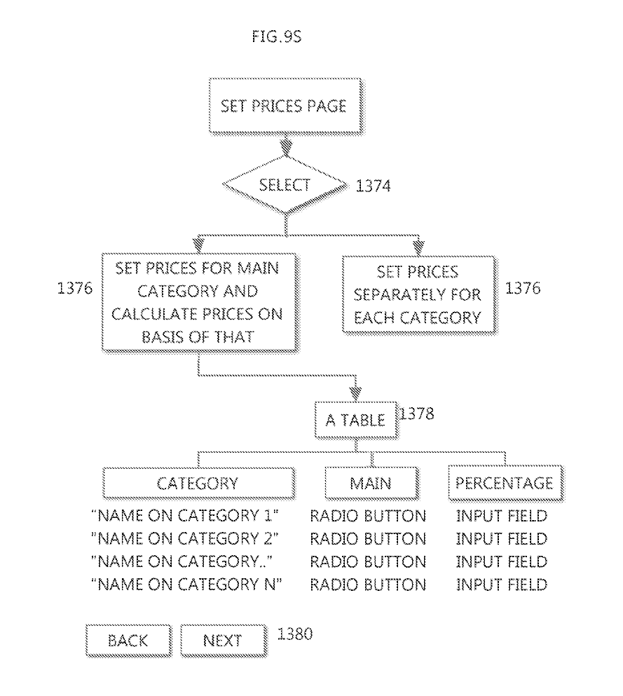

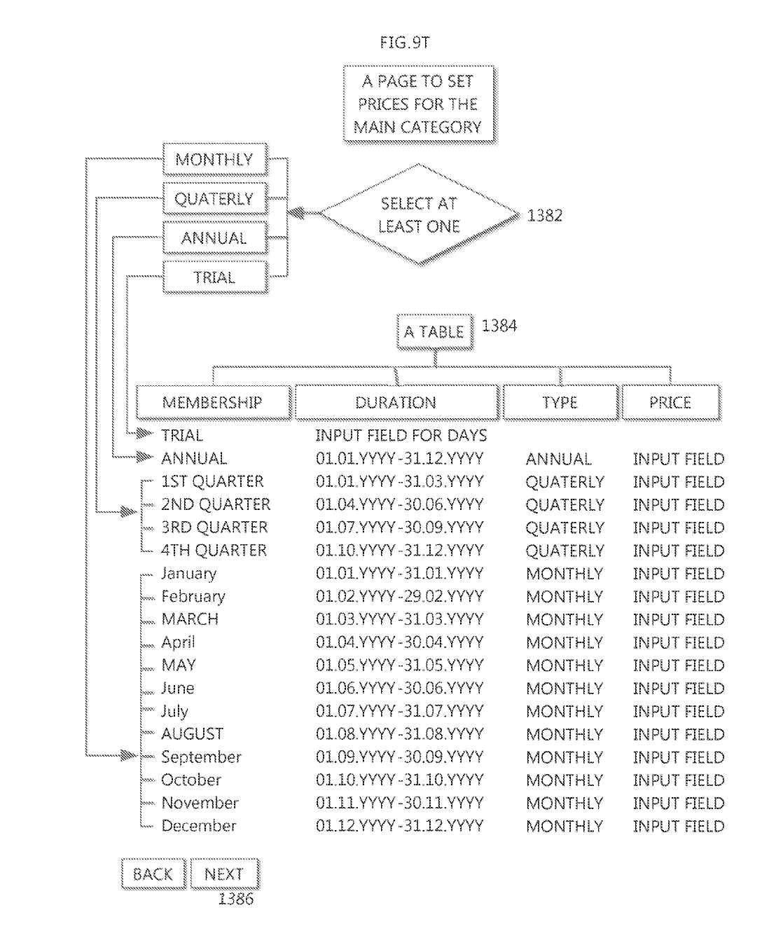

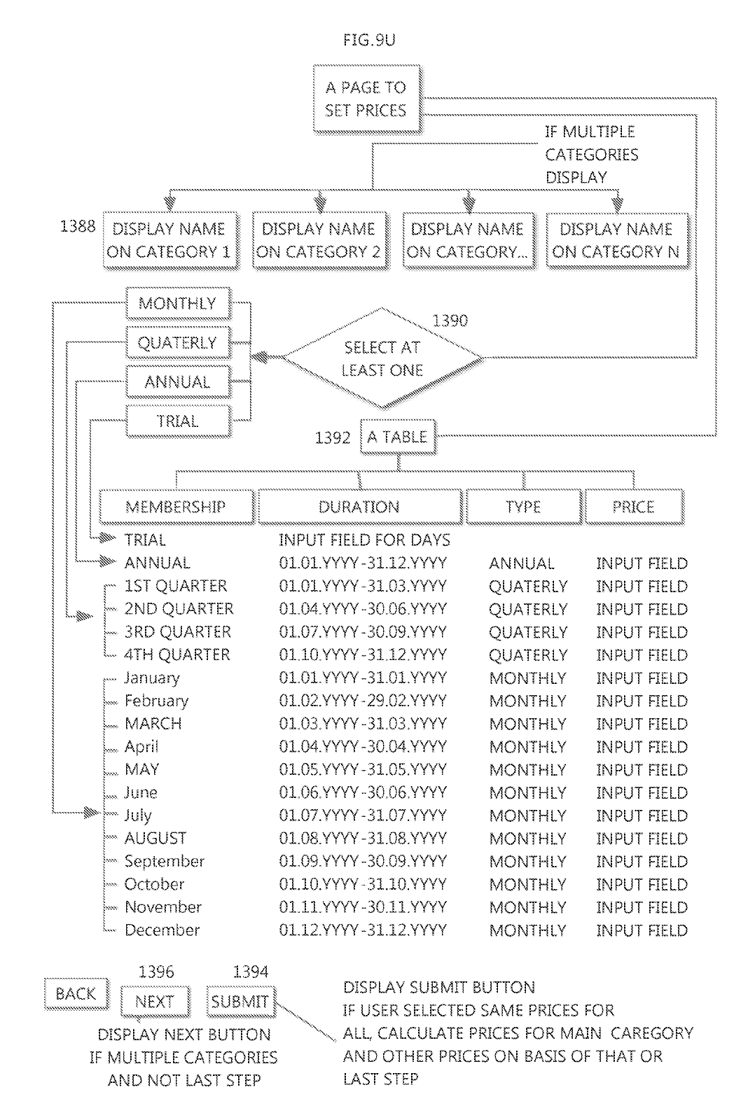

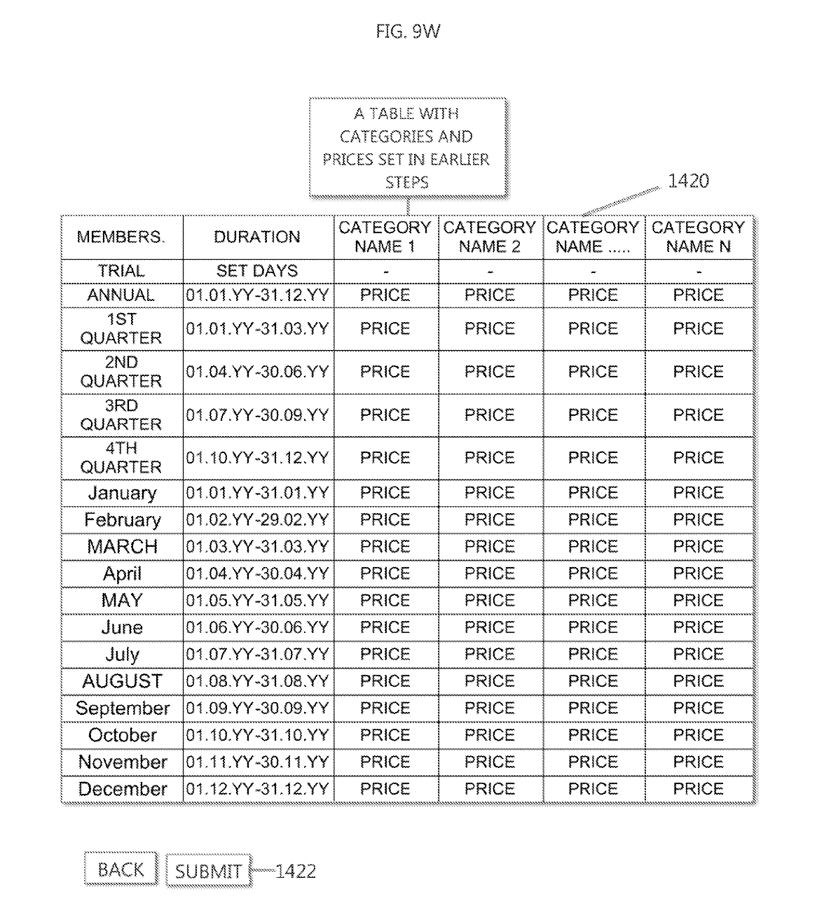

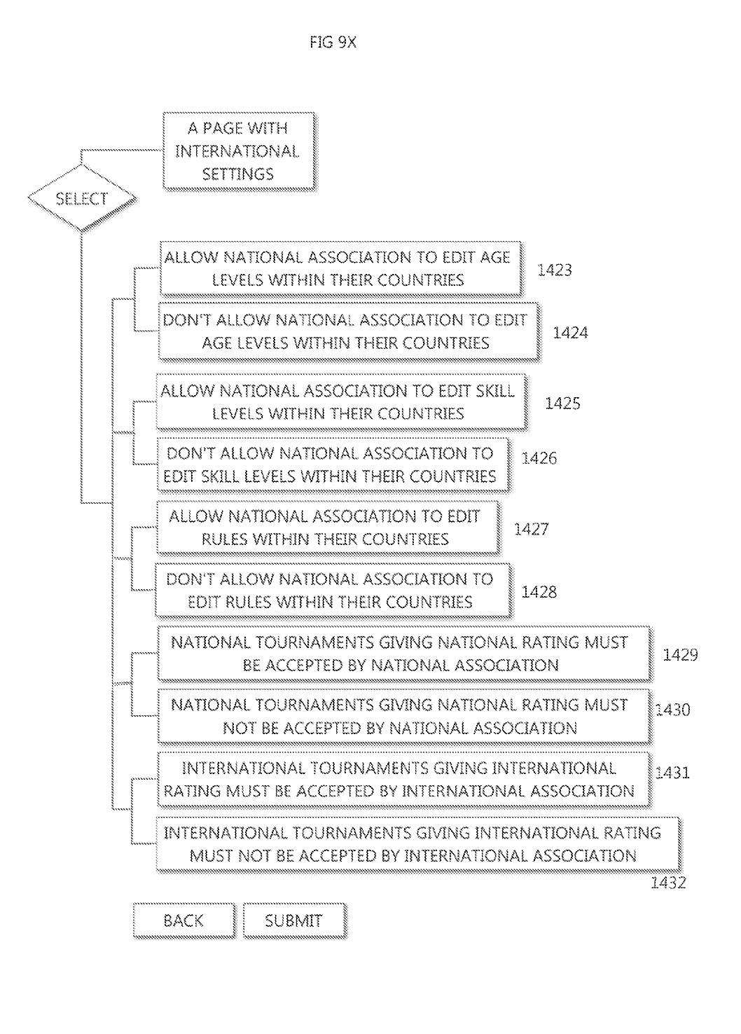

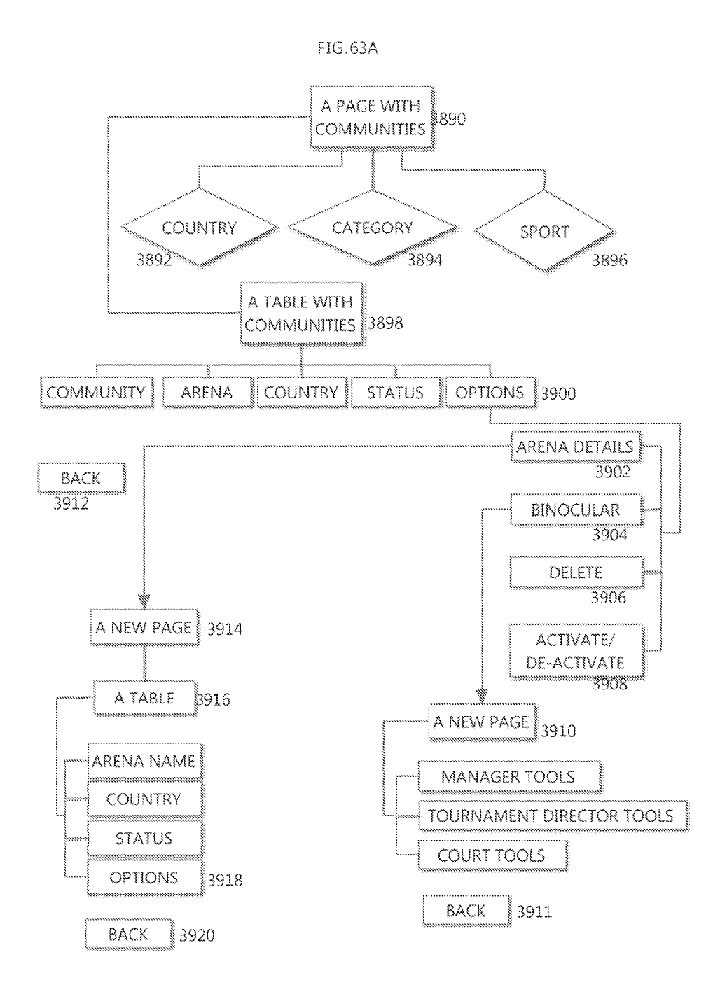

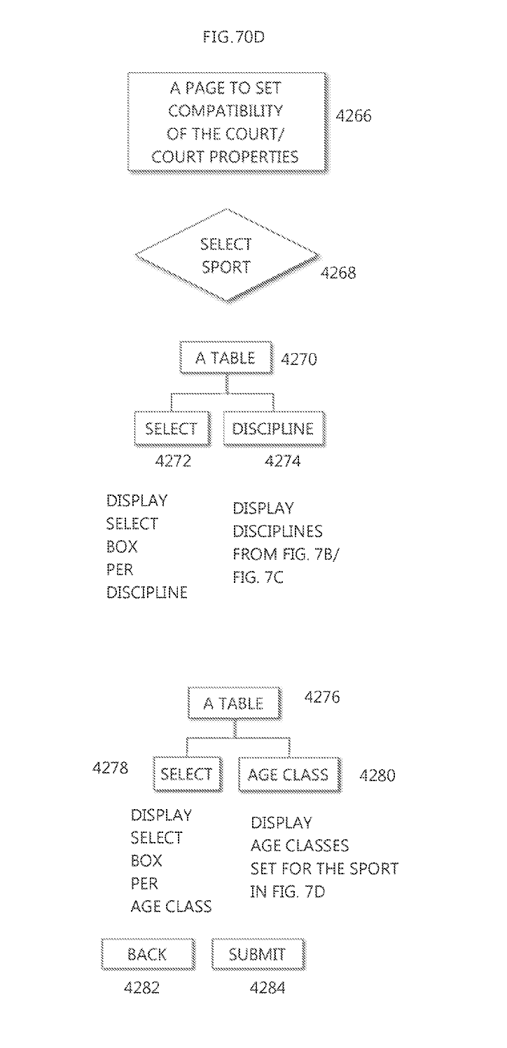

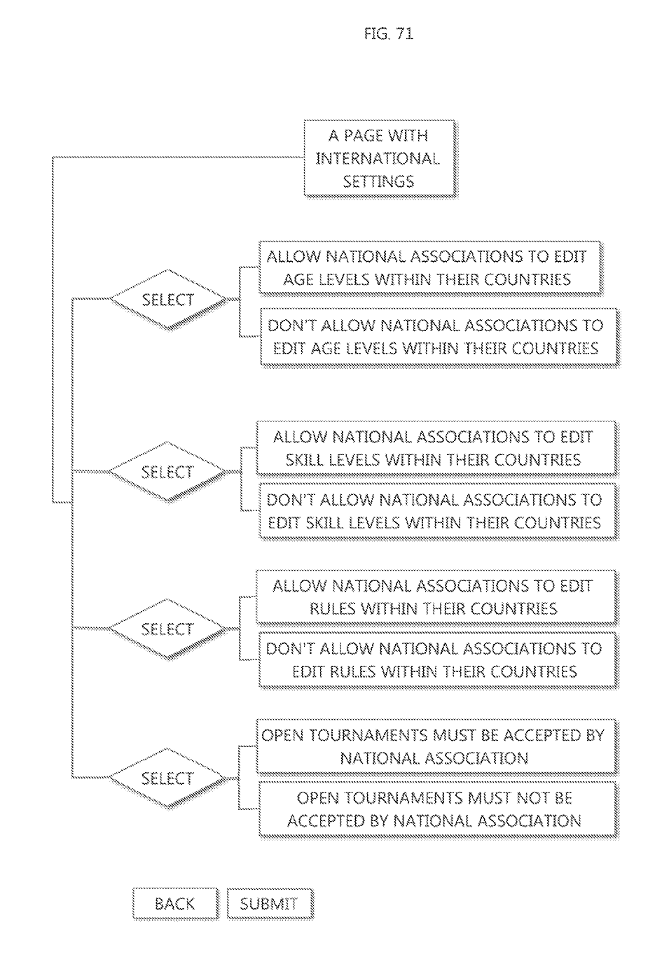

When selecting “obtain membership in a community” 287 the user proceeds to a page to search for and obtain membership in communities 426 as depicted in FIG. 4G. As illustrated the page contains a table with communities 442 and different sorting/search options above. The user can sort communities alphabetically by category, sport and location 430 or search for community by keyword 429. When selecting sort communities alphabetically the user can select from menus like select category, select sport, select country and country specific menus (a dropdown or equal). The communities that will show in the table 442 of FIG. 4G are communities from table 3898 of FIG. 63A where all communities are registered. The communities can have different requirements for how users obtain memberships. Each community makes a setting for how users shall obtain membership in the settings page FIG. 9P-9Q in Manager Tools. This settings is shown in FIG. 442. In the options column of the table there is a details option 448, a contact option 446 and an obtain membership option 444. If the user selects to obtain membership in a community with “charge fee on membership” the user will proceed to a page illustrated in FIG. 4H. The page contains a select menu year of membership 456 and a table with the columns name on membership, duration, name on category 1, name on category 2 etc. The rows display memberships and price on membership set by the community as illustrated in FIG. 9Q-9W. Having selected a membership the user can proceed to a payment page illustrated in FIG. 4i. If payment is accepted the membership is added to the user's table of memberships in FIG. 8B and the user is added in the community's table of members 1026 in FIG. 9B.

If the community's setting was “membership by application” 480 as depicted in FIG. 4J the user would proceed to a page 482 requesting a confirmation if the user wants to apply for a membership in the community. The user can select yes and submit an application 484 to the community. The application would be added to the community's table of applications from members in FIG. 9C.

If the community's setting was “no requirement to obtain membership” 488 as depicted in FIG. 4J the user would proceed to a page requesting a confirmation if the user wants to become a member in the community. Selecting yes the membership will be added in the user's table of memberships in FIG. 8B and in the community's table of members 1026 in FIG. 9B.

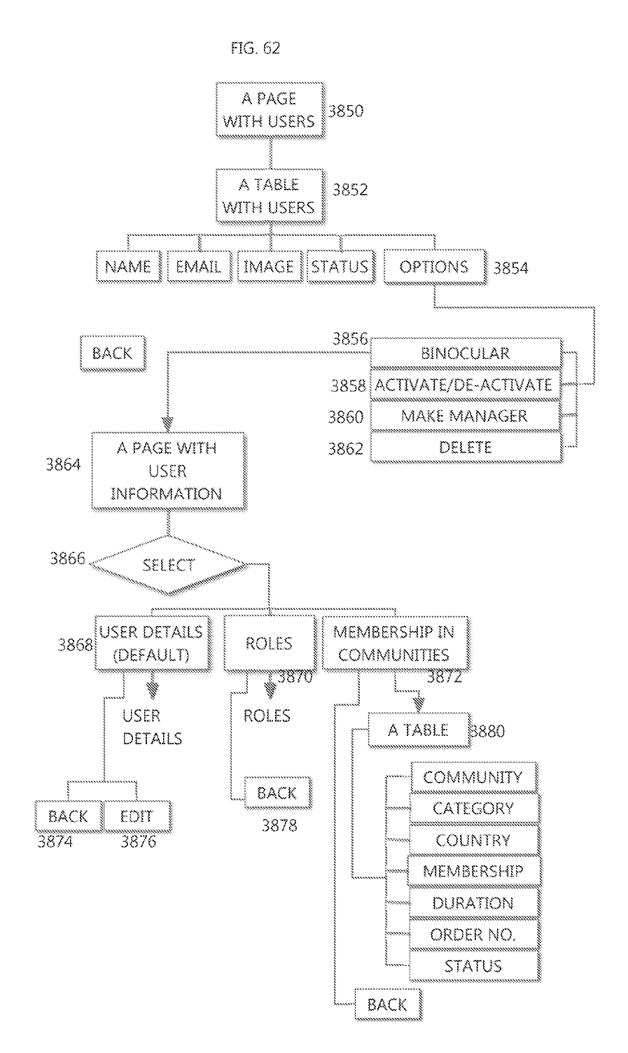

If the user selects “player” 288 (or user) in FIG. 3 the user proceeds to a page as depicted in FIG. 4K to enter user details 498 like first name, last name, gender, birth date, to select country and from country specific submenus, phone, address, postal code, email address and upload a photo. Pushing the submit button 504 the user will be added in the table of users as depicted in FIG. 62. The role “player” will be added in the user's table of roles in FIG. 8D. Login details will be sent and/or generated on email to the user.

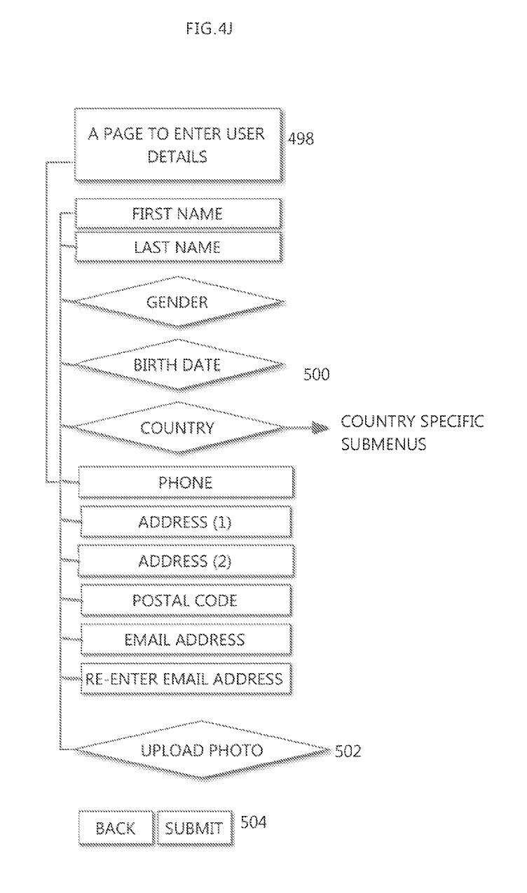

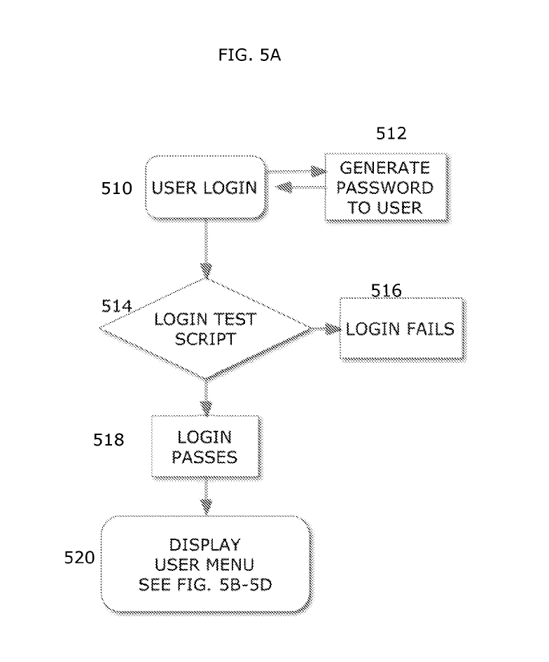

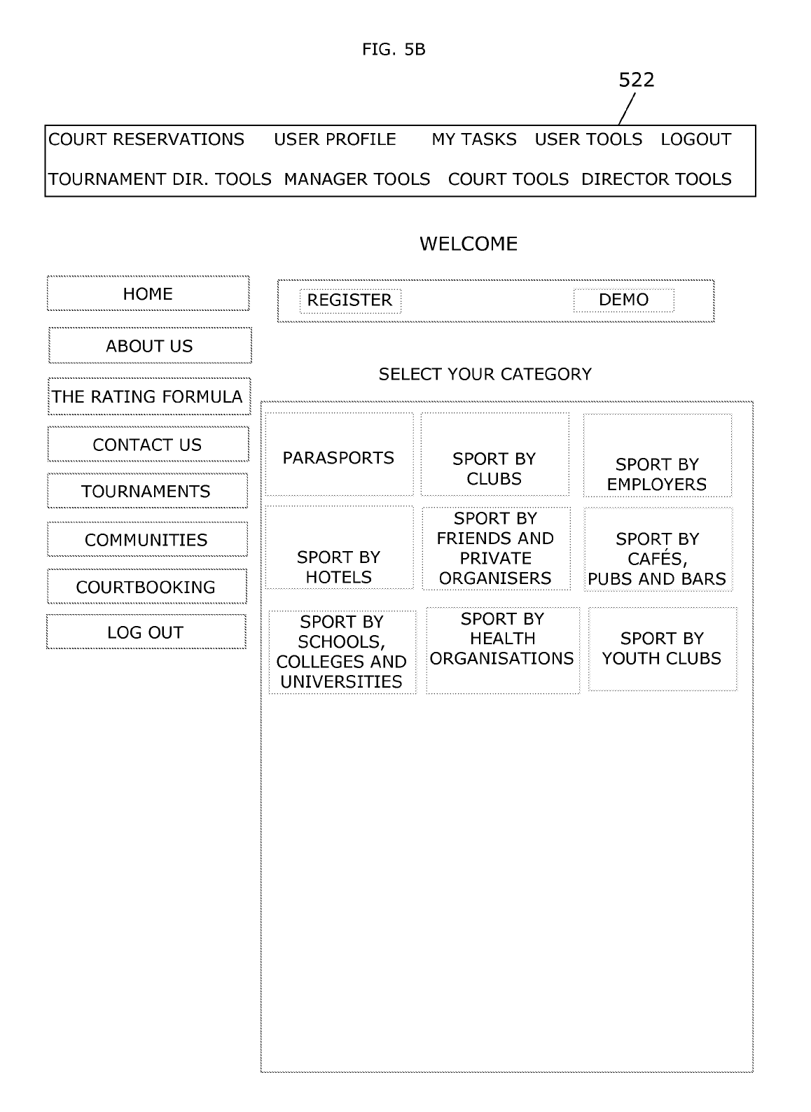

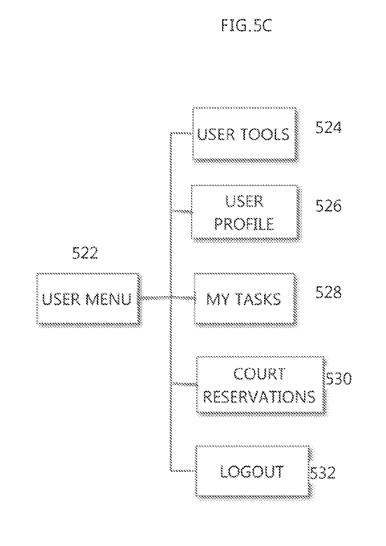

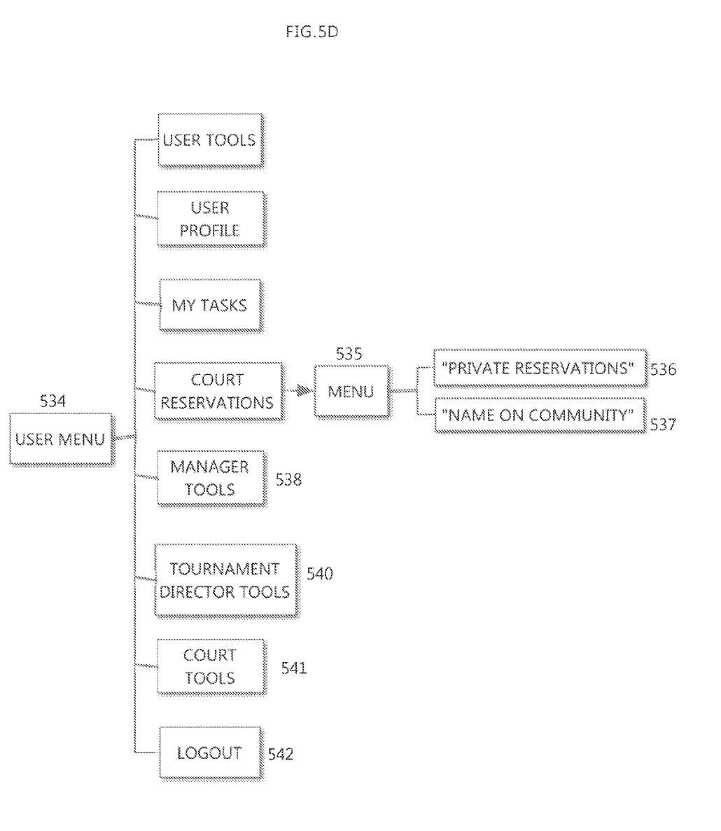

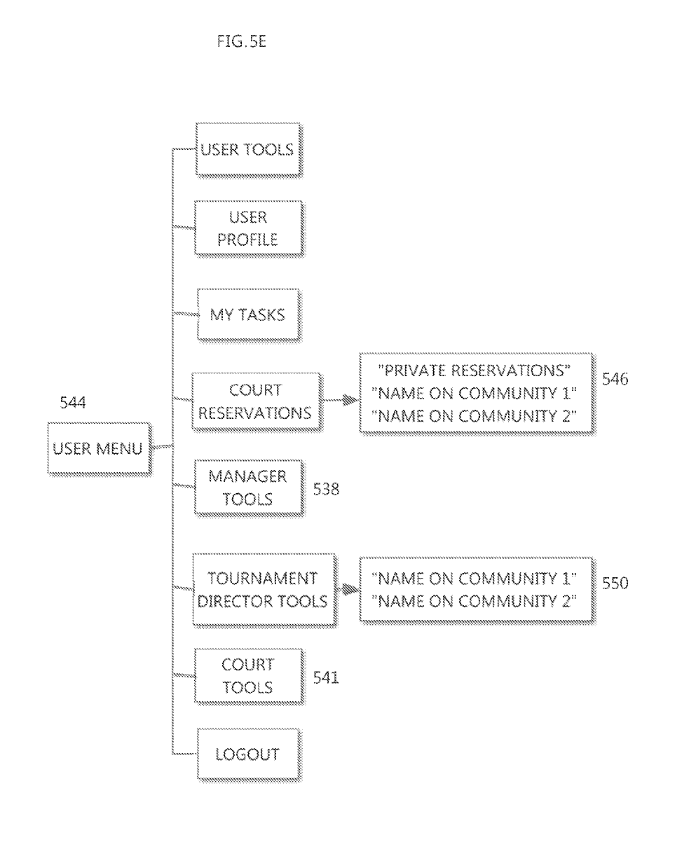

FIG. 5A illustrates a wellknown login procedure. If login passes 518 the user enters a page as illustrated in FIG. 5B showing the user's menu 522 and the main page of the solution.

Illustrated in FIG. 5C is a user who only has role has player (or tournament official) with user tools 524, user profile 526, my tasks 528, court reservations 530 (for private reservatons) and a logout option 532. All users have these options.

A user's menu will vary depending on the user's roles and can be managed by a manager in manager tools in table 1026 of FIG. 9B. A user being manager will have Manager tools, a user being tournament director will have tournament director tools, a user being court manager will have court tools, a Director of a National association will have Director tools for a national association and a Director of an International Association will have Director Tools for an International Association.

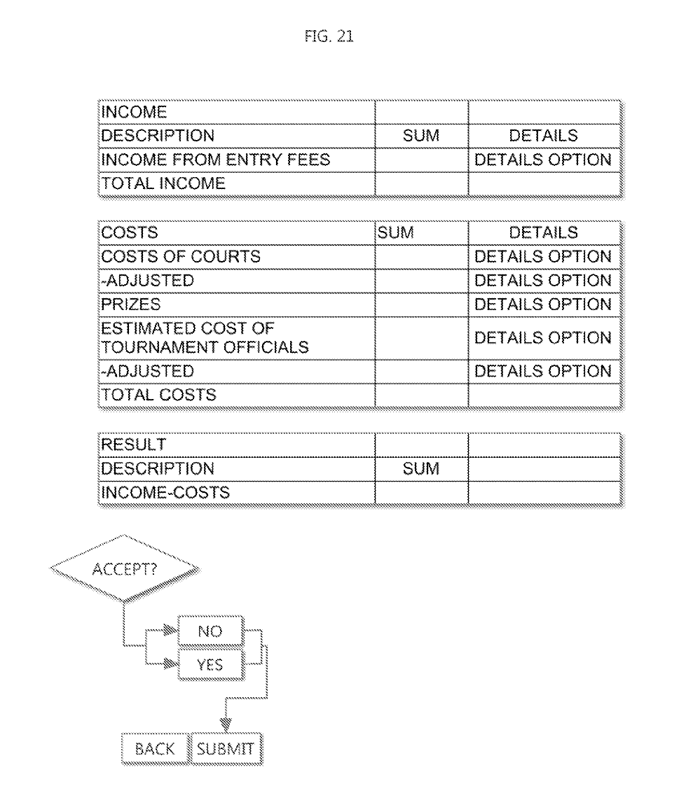

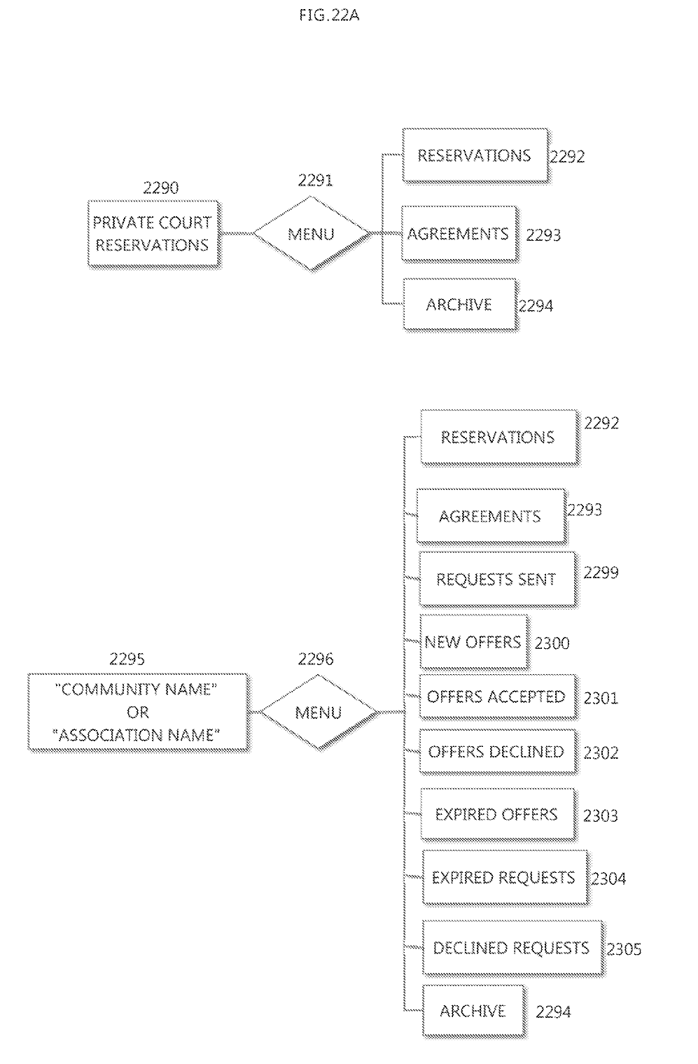

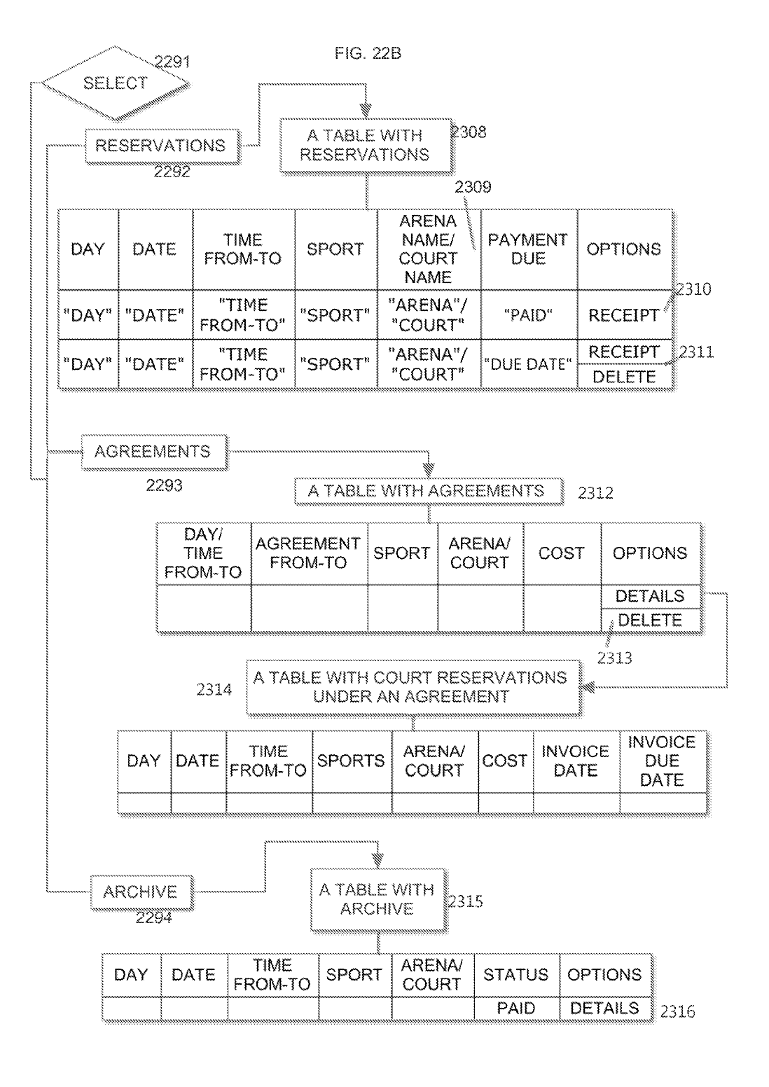

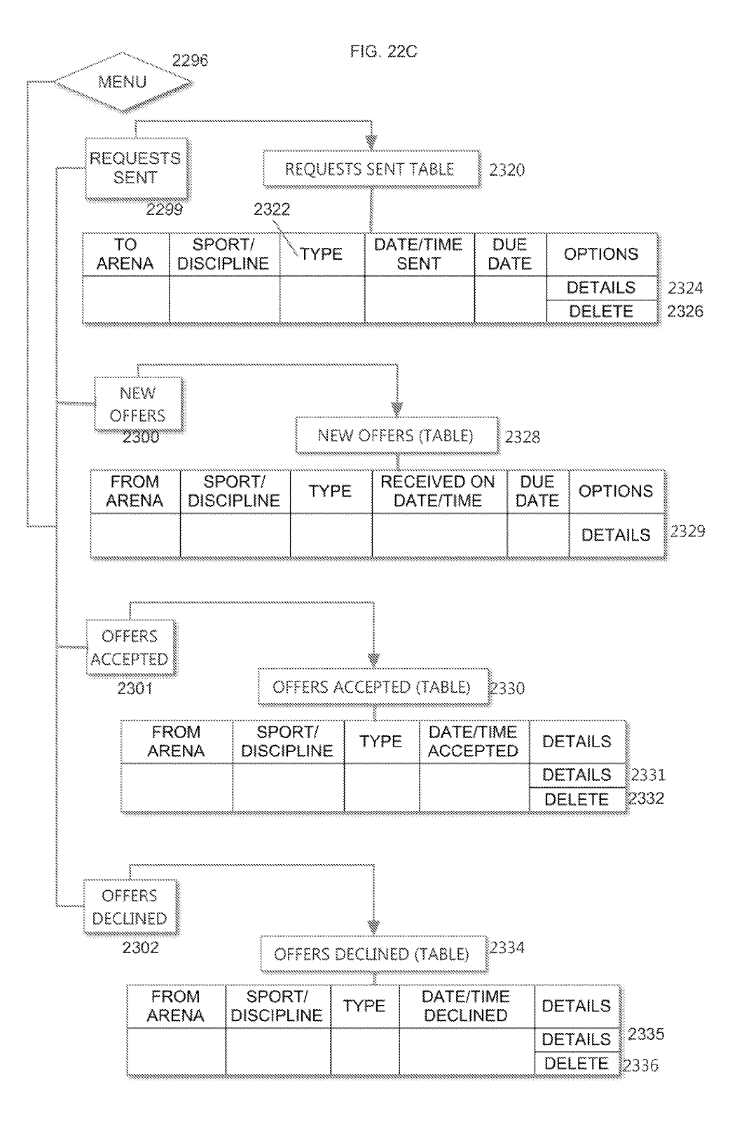

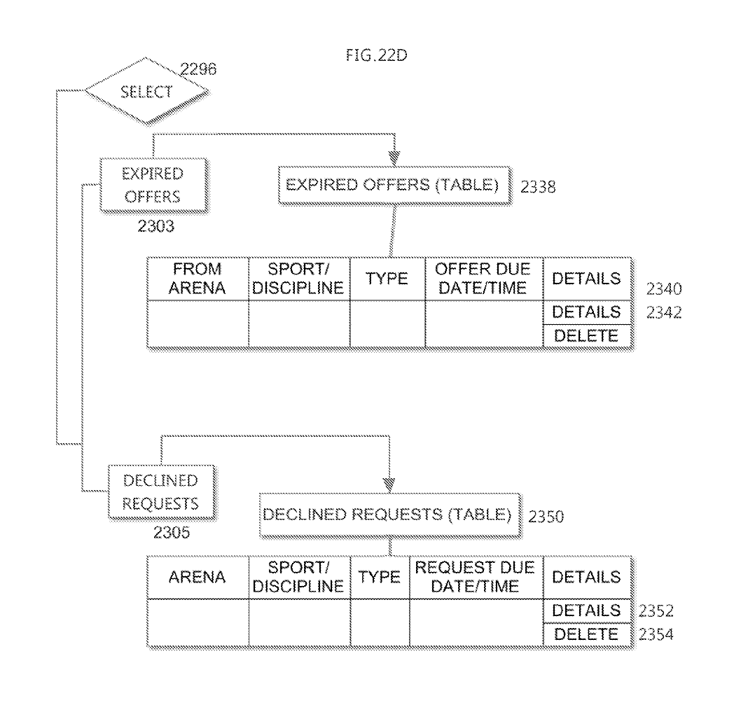

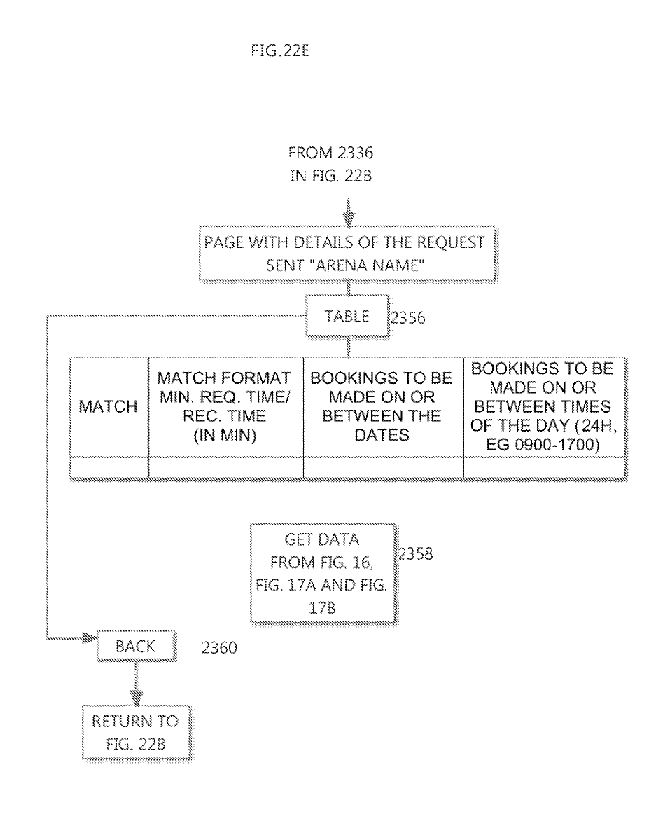

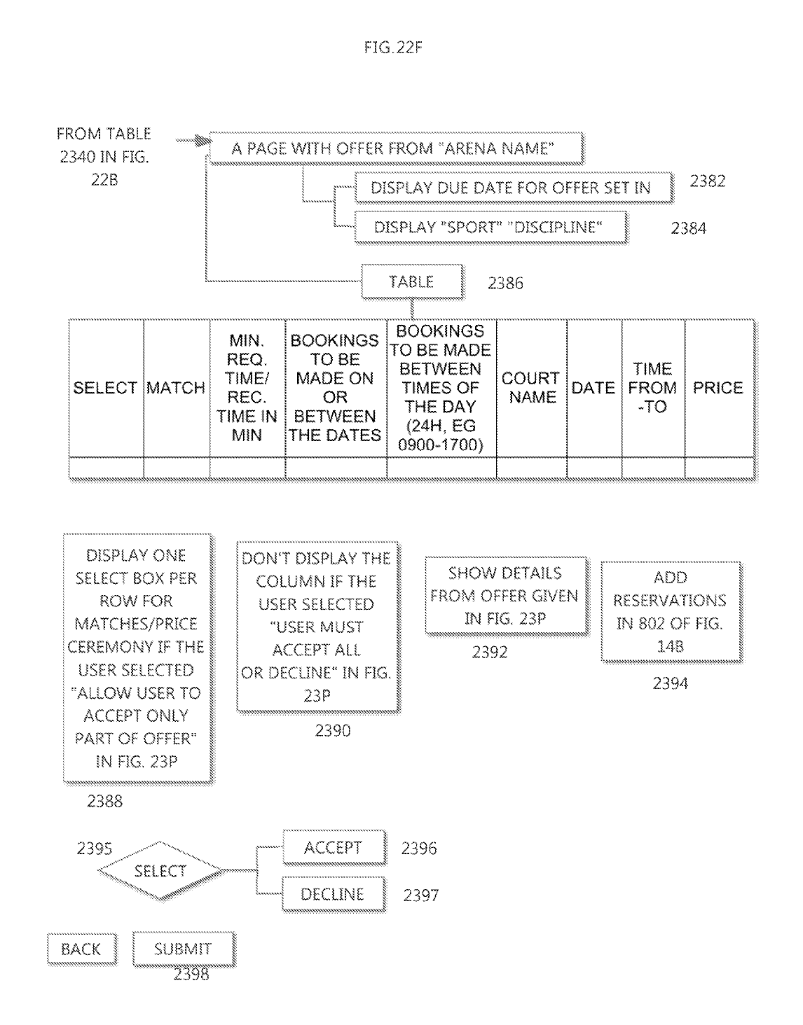

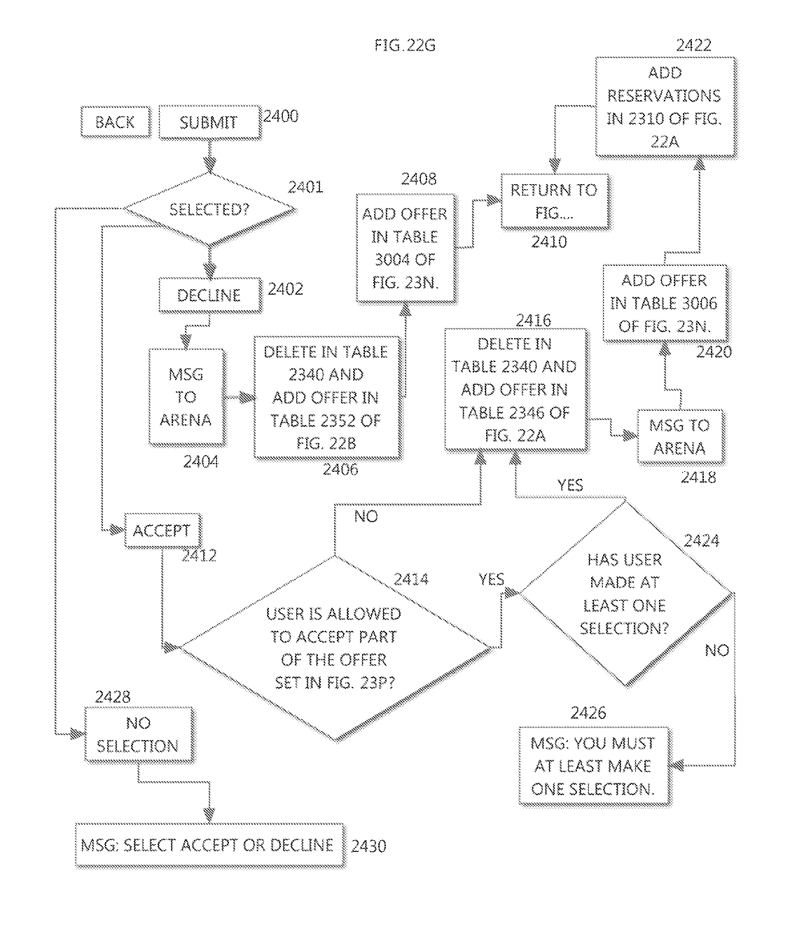

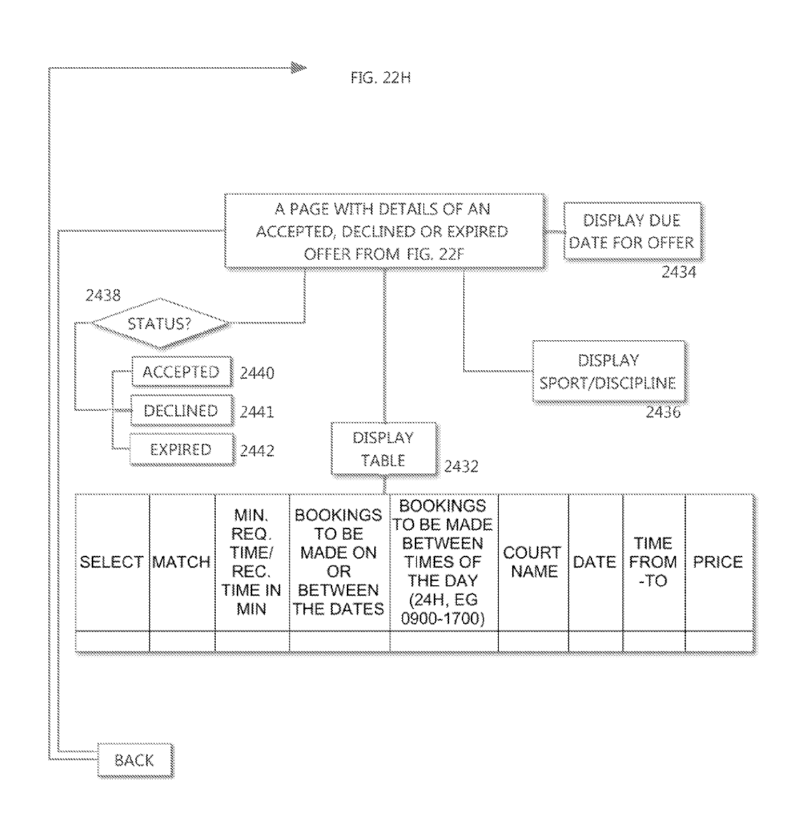

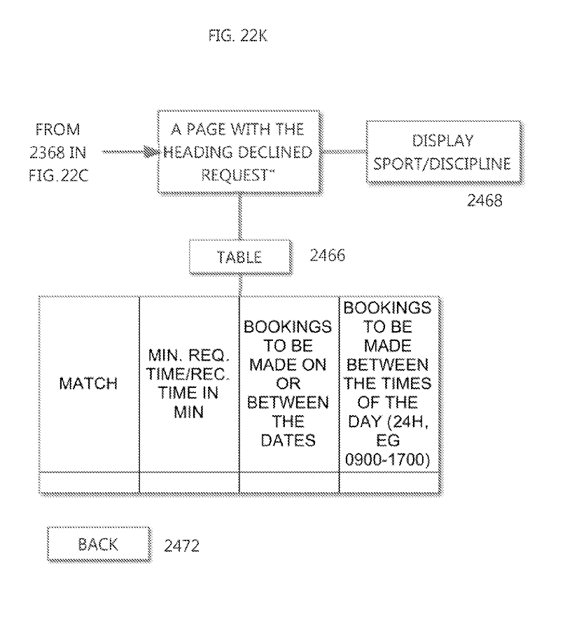

FIG. 5D shows a user having different roles for a community, being manager having manager tools 538, tournament director having tournament director tools 540 and court manager having court tools 541. In the court reservations menu the user has the options “private reservations” 536 and “name on community” 537. Option 537 will lead to a page with a menu 2296 illustraded in FIG. 22A.

A user will have a sub-menu in the court reservations menu with the name of the community/association if having at least one role for the community/association either as manager, tournament director, court manager or Director.

FIG. 5E shows a user being Manager of one community 538, tournament director for two communities 550 and court manager for one community 541. When the user has the same role for more than one community the user will have a sub-menu for that role. In the court reservations menu the user now has a sub-menu with the three options “private reservations”, “name on community 1” and “name on community 2”.

FIG. 5F shows the default setting for a user who is director, manager, tournament director and court manager for an association. The user has a sub-menu in court reservations 556 [private reservations] and [name on association], manager tools 538, tournament director tools 540, court tools 541 and director tools 564.

FIG. 5G shows a user being director for an association and manager, tournament director and court manager for the association, and also being manager, tournament director and court manager for a community (like a sports club). In the court reservations menu 568 the user now has the three options “private reservations”, “name on association” and “name on community”.

FIG. 5H shows a user being Director for a National Association and Director for an International Association 588. For the International Association the user would have “Director tools for {name on the sport}” and for the National Association “Director tools for {name on the sport} {in country}”. The same user is also manager, tournament director and court manager for one of the associations.

An association may manage more than one sport and may want common tools to manage tournaments, members and courts. In that case the user will have common manager tools, tournament director tools and court tools for the associations, and separate tools to manage details for each sport in director tools. FIG. 5i illustrates a user being Director of two National Associations in a country. The user has “Director tools for {name on the sport 1} in {country}” and “Director tools for {name on the sport 2} in {country}”, a common manager tools, tournament director tools and court tools for the plus an option for the association in the court reservations sub-menu. In addition to being director for two national associations the user in FIG. 5i is manager, tournament director and court manager of a community (eg. sports club).

FIG. 6A illustrates a page to manage sports 597 and a table 598 with sports in the solution. The table consists of the columns “sports”, “managed by” and “options”. The sport can be managed by admin if the governing body is not interested in using the solution, then applying distinctive rules to avoid legal conflicts. If the governing body uses the solution the name of the body will be written in the “managed by” column. Each sport has the three options director tools, activate/de-activate and delete. Selecting Director tools 601 the user will proceed to FIG. 6B with Director tools for the sport. Selecting the add sport option 602 the user will proceed to a page to add sport 603. That page consists of input field to type the name of the sport 599 and a table 604 with the columns discipline 605, match format 606 and options 607. The table allows the user to set a name on the discipline 610 and add several match formats per discipline 608/611 with a minimum required time/recommended time per match format 609. Selecting the add discipline button 613 the user can add disciplines to the sport. For each time add discipline 613 is selected all the contents seen in table 604 is added in new rows in the table except the headings discipline 605, match format 606 and options 607.

FIG. 6B illustrates the Director tools for a sport. Options in Director tools are manage license prices 616, manage income 617, manage national associations 618, manage rules of the sport 619, manage disciplines and match formats 620, manage age classes 621, manage skill levels 622, manage tournament official certificates 623, manage tournament officials 624, manage sales representatives 626 and name on the governing body of the sport 628.

Selecting manage license prices 616 in FIG. 6B the user will proceed to a page to set prices for national associations and communities as illustrated in FIG. 6C. Setting prices for national associations 610 is illustrated in FIG. 6D with a table 622 showing name of the license “Annual license” and the cost of the license for “current year minus one year”, “current year plus one year” and for “current year plus two years”. Settings prices for communities is different: A page to set prices for“cup and court management professional license” 630 for a sports club is illustrated in FIG. 6E. Prices are are set for a different number of members (a club with few members will pay less than a club with a lot of members), and prices can be set different for different categories of communities 628. A page to manage cup and court management limited version is also illustrated in FIG. 6E with a table 626 showing license name “annual license” and that the license is free for communities for communities for the different years “current year minus one year”, “current year plus one year” and for “current year plus two years”. Setting prices for a court management professional license is done exactly the same way as for cup and court management professional license.

Manage income 610 in FIG. 6B is link to a page FIG. 6G to manage income from license sales. It contains a table 646 with the columns category, International Association, National Association, Sales commission and Sum. For different categories of communities it allows the user to set how income from license sales shall be distributed on the governing body, the national associations and to salespersons in percent. The sum for each category is always fixed at hundred.

Manage National Associations 618 is link to a page to manage National Associations 882 as illustrated in FIG. 7A. In the page is a sub-menu to select national associations 886 or applications 888. Selecting National associations the user will see a table 890 with the columns name, country, management and options. In the options part a details option per association 892 that leads to a new page with Director tools for the national association 896, also illustrated in FIG. 7A.

Selecting the add option 894 the user will proceed to a page to add a National association FIG. 7B. The page contains a table 908 with the columns community, arena, sport, country, details and select. The table shows national associations already having a management. Selecting an association in the table 914 the user will add the Director tools of the sport in the country to the users being Directors of the existing community when hitting a submit button 916. It is done in this way because an association can be responsible for more than one sport and it allows sharing manager tools, tournament director tools and court tools for different sports (like 9-wicket and 6-wicket croquet). If not selecting a community in the table the user will proceed to FIG. 7C when selecting the submit button 916. FIG. 7C illustrates a page to add and add details for a national association 920 such as name of the association 922, email address 924, country 926, phone no. 928 and address 930 with country specific formats. In the same page the user must decide to add a Director or not. If not wanting to add a Director to the association the user will add the national association to the table of associations 890 in FIG. 7A when hitting a submit button. If wanting to add a Director to the association the user will proceed to a page like FIG. 7D, in which many fields are described in details earlier in FIG. 6o. If the user can find the person in the user database 3852 in FIG. 62 the user will select the user 780 before pushing the submit button 785. If the person cannot be found in the user database the user will proceed to a new page to enter user details of the person as illustrated in FIG. 7E before pushing the submit button 813.

Director tools for an International and National Association can be accessed by the admin of the solution and by any user being Director for the association having the menu with Director tools for the association as illustrated in 588 of FIG. 5H (being assigned the right of being Director for the association in table 1026 of FIG. 9B). When the term “user” is used for Director tools it always refers to admin and/or the user representing the association.

The contents of Director Tools for a national Association differs from an international association and contains manage license prices 895, manage tournament official fees 896, manage tournament officials 897 and manage sales representatives 898. Depending on settings by the governings body/international association (as illustrated in FIG. 9X) the tool can also contain an option to manage rules 899, manage skill levels 900, manage age classes 901 and manage tournament official certificates 902.

Selecting manage rules of the sport 619 in FIG. 6B the user will proceed to a page where the rules of the sport can be written and edited.

When selecting Manage disciplines and match formats 621 in FIG. 6B the user will proceed to a page with a table to manage discipline and match formats as set when the sport was added in table 604 in FIG. 6A.

When selecting manage age classes 621 in FIG. 6B the user will proceed to a page illustrated in FIG. 6J to manage age classes for the sport.

When selecting manage skill levels 622 the user will proceed to a page FIG. 6K to manage skill levels.

When selecting manage tournament official certificates 623 the user will proceed to a page illustrated in FIG. 6L to manage certificates within the sport. FIG. 6M illustrates a page to view certificate details 744 and a page to edit/add a certificate 726.

When selecting manage tournament officials 624 in FIG. 6B the user will proceed to a page illustrated in FIG. 6N with tournament officials in the sport 750. The page contains select menus for country 752, discipline 754, role 756 and certificate 758, and a table 760 with columns for name, role, sport/discipline, certificate and options. Selecting the “Add tournament official/role/certificate” the user will proceed to a page illustrated in FIG. 6o. In that page is a select menu for country 766 and fields to enter name and phone number to perform a search. Pushing a search button 770 a search will be done in the user database of the solution of FIG. 62. The search result is shown in table 772. From the details column 778 of table 772 the user can view details of the user and in the select column 780 the user can select a person. Below table 772 is another table 782 showing the selected user with the columns name, street address, details and remove. When the user has made a selection from table 772 the person is shown in table 782. The user can remove the person from the selected table by selecting a remove option in the remove column 786 and get details about the user as in table 772. If the person is not registered in the database the user will proceed to a new page FIG. 6P to enter user details before proceeding to a page to add certificates illustrated in FIG. 6Q. If the person is already registered the user will proceed directly to the page to add certificates in FIG. 6Q from 6o. FIG. 6Q contains a table 818 with the columns role, sport/discipline, certificate name, issuer and options and lists all the users current certificates. The page also contains a select menu for role 820 and a table 822 showing certificates of the selected role. Table 822 contains the columns certificate name, issuer, level, status and options 824. Options per certificate is an add option and a details option. Selecting the add option by a certificate it will be added to the user's table of certificates 818. Selecting the details option the user will see details about the certificate. When hitting the submit button the outcome depends of the user was already registered: If the person was not found in the database then login details is sent/emailed to the user, the person is added as user in the user database in FIG. 62, the role (if new role to the user) and certificate will be added to the user's table of roles/certificates. If the person was found in the database then only add role/certificate to the user's table of roles/certificates.

When selecting name on the governing body of the sport the user will proceed to FIG. 6S, a page with details about the governing body 860. This is an editable page to set information about the governing body like name, email address, country, phone and address. It also shows if the governing body has a management or not.

Selecting User Tools in 524 in FIG. 5C the user proceeds to a page FIG. 8A with the options Entries 940, Memberships 942, Invitations 944, Password 946, Member details 948, Roles 950 and Default tournament search 952.

Selecting Entries the user enters a page with a table with a user's entries as player, tournament official, medical officer or with other roles.

Selecting Memberships the user enters a page with a table 954 as illustrated in FIG. 8B with the columns community, Category, Country, Membership, Duration, Order number, status and Options. In the options column the user will find options like details 970, orders 972 and renew 974.

Selecting Invitations the user enters a page with invitations as illustrated in FIG. 8C with a table of the 5 columns from community, date received, duration, accept and decline. The accept and reject column displays a radio button per invitation. On the bottom of the page a back and submit button 984.

Selecting “Password” the user will proceed to a page to change password.

Selecting “Member Details” the user proceeds to a page with user details like name, address, phone no, email address and photo. Here the user can change his/her user details.

Selecting “Roles” the user enters a page with the user's roles as illustrated in FIG. 8D with a table with the three columns Role, Options and Main role. In the Role column display role, in the options column display a link to view details of the role (like certificates of the user) 996 and in the main role column display a set button. Pushing the button by a role define that role as the main role of the user.

Selecting “Default tournament search” the user will proceed to a page as illustrated in FIG. 39A.

When selecting Manager tools 538 in FIG. 5D the user proceeds to the community's Manager Tools as illustrated in FIG. 9A. In manager tools the manager has the options Manage members, applications for membership, invite people to community, send a message to members, sports, manage emails/sms, community administration and court management. Selecting manage members 1000 the user will proceed to a page as illustrated in FIG. 9B to manage members. The page contains a table 1026 and sorting/search options with menus to select category, sport, roles, gender and options to sort members alphabetically and to set how many members to be shown per page. The table contains columns with the headings name, tournament director 1028, court manager 1030, manager 1032, director (if the community is an association) 1034, remove 1036 and details 1038. In the tournament director column, court manager column, manager column and director column a select box will be displayed per user so that the manager can assign the users different roles/tools.

The application for membership option 1002 in FIG. 9A is only active or in use by a community if the community's setting in FIG. 9Q is membership by application to community 1340.

If selecting applications for memberships 1002 in FIG. 9A the manager will proceed to a page illustrated in FIG. 9C. The page contains a table 1046 with the columns name of user, duration, accept and decline. When a user applies for membership the application is added in this table. The manager can then decide to accept or reject the application. Accepting the application the user will be added to the table of members and an email will be generated to the user saying the application has been accepted. If rejecting the application an email is generated to the user saying the application has been rejected.

Through the invitations page as illustrated in FIG. 9D the manager can invite people to the community. Options available for the manager depends on the settings 1060 in FIG. 9Q. If the setting is charge fee on memberships the only selectable option is Invite new members 1066. Selecting this option the user will proceed to a page as illustrated in FIG. 9H. The page contains an input field to type one or multiple email addresses, an input field to type subject of the message and an input field to type the body of the message to be generated. If all is set activate a submit button and the message can be submitted. Display a receipt page 1164 and generate the message 1162.

If the settings in FIG. 9Q is membership by application or no requirement to obtain membership the manager is given the four options Invite new members 1068, Add person as new user and generate username and password to the person 1070, search registered users and invite as member 1072 and import member list. Selecting Invite new members 1068 the manager will proceed to a page illustrated in FIG. 9i. The manager will first set the duration of the membership 1172: if the membership offered is indefinite or limited by dates. The page will also contain an input field to type email addresses 1174 the invitation shall be sent to, a subject of the message 1176 and the body of the message 1178. The subject and the contents of the message has default contents set in manage messages/sms of FIG. 9K. When everything is set the submit button is activated and the manager can generate the message.

If selecting Add person as new user and member and generate username and password to the person 1070 the manager will proceed to a page as illustrated in FIG. 9G to enter user details 1130. Having typed user details 1131 the manager will proceed to a page to set duration of the membership offered: Indefinite or limited by a from and to date. When duration is set the manager can submit the invitation and a username and password will be generated to the user. The manager will proceed to a receipt page 1140 showing invited in a table 1142 with the two columns name and duration. From this page the manager can select to invite more members 1144 or return to manager tools 1146.

If selecting Search registered users and invite as member 1072 the manager will proceed to a page illustrated in FIG. 9E. The page contains a select menu for country 1078, fields to type last name, first name and phone number 1080 and a search option 1084. The result of the search will be shown in a table below 1084 with the columns name, street address, member, details and select. In the member column 1088 the manager can see if the user already is a member, from the details column 1090 get detailed information per user and in the select column 1092 make one or more selections. The selections will be added in the table 1094 below with the columns name, member, details and remove.

When one or more selections have been made the manager can proceed to next step 1102 to set duration of the membership offered: indefinite 1044 or limited by dates 1106. When selections have been made the submit button is activated and invitations can be sent. Invitations are added to the users' table of invitations in FIG. 8C and a message is generated to the user. The manager will proceed to a receipt page showing invited people in a table with the two columns name and duration. From this page the manager can select to invite more members and return to the main invitations page or return to manager tools FIG. 9A.

Selecting Import member list 1074 the manager will proceed to a page to import a memberlist.

Selecting send messages to members 1006 in FIG. 9A the user will enter a process to generate messages to members.

Selecting sports 1008 the user will enter a page showing what sports the community's license is valid for.

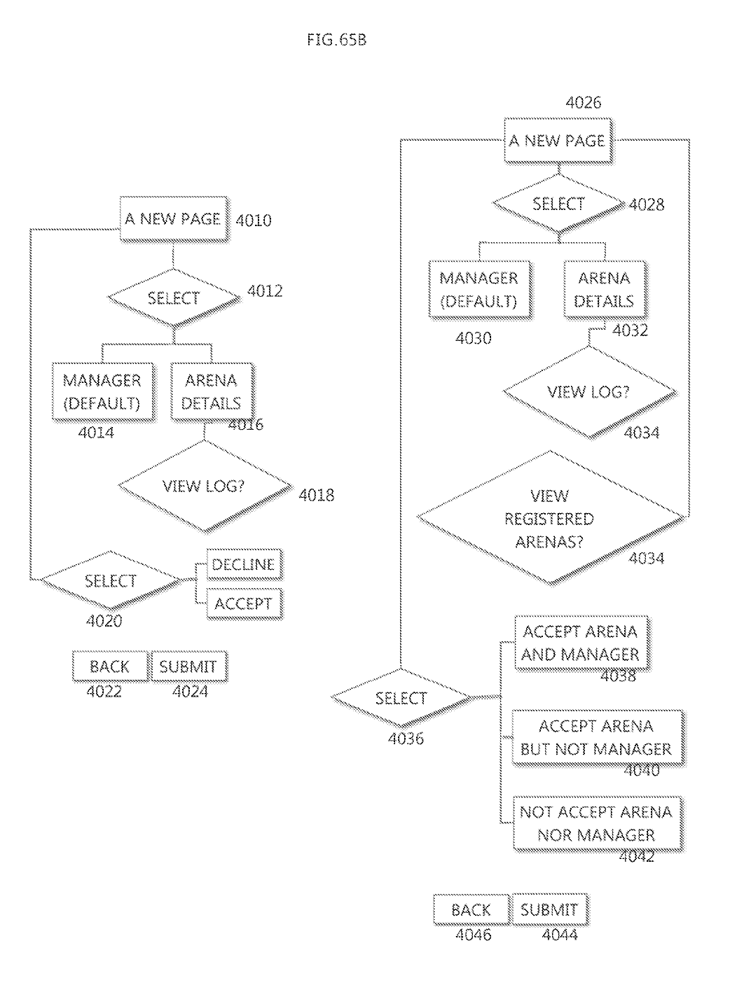

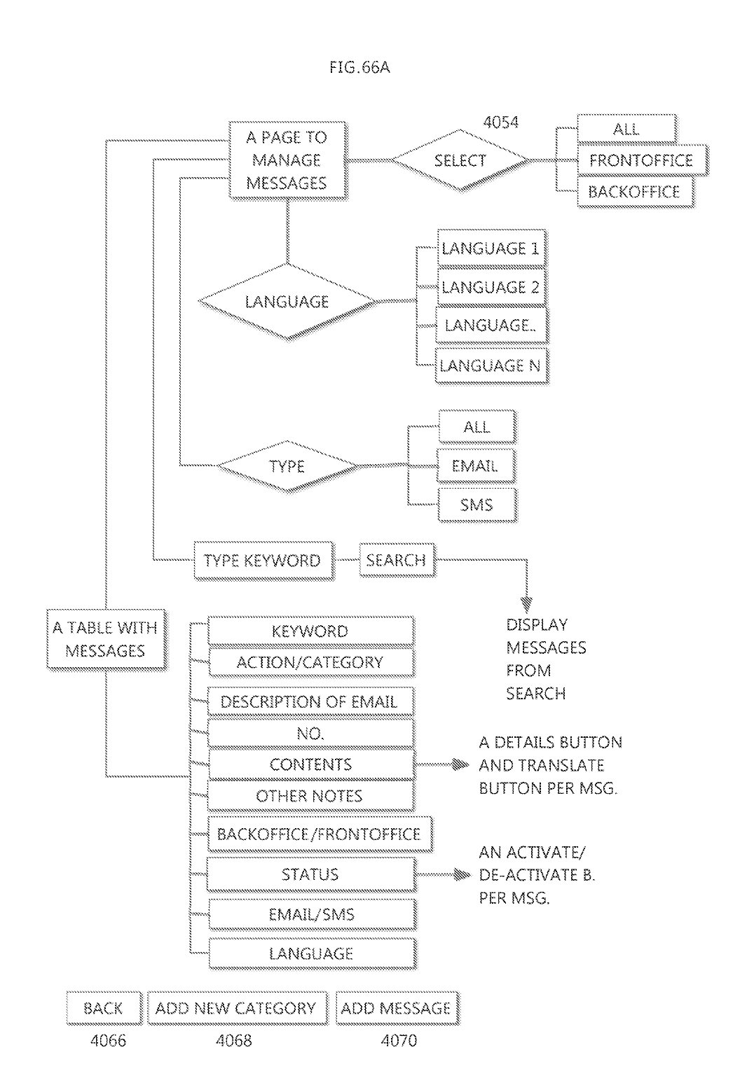

Selecting manage emails/sms 1010 the manager will proceed to a page illustrated in FIG. 9K. The page consists of a select menu for language 1210 and a select menu for type 1212 with options to select email, sms or all. There is also an input field 1214 to type a keyword and a search button to perform a search. The search result is shown in a table 1212 with the columns keyword, action/category, message number, contents, other notes, status, email/sms and language. The messages in the table is set as default for every community by admin in backoffice in FIG. 66A.

Selecting community administration 1012 in FIG. 9A the manager will proceed to a page with a sub-menu with the options community details, manage license, community settings and category as illustrated in FIG. 9L. If the community is an International association for of a sport the option International settings 1223 will also be displayed in FIG. 9L.

Selecting community details 1224 the manager will proceed to a page to view or edit community details like community name, address, email address, phone no., etc.

Selecting manage license 1225 the manager will proceed to a page FIG. 9M to manage the community's license. The page consists of a table with columns license name, duration, max number of members, current number of members and options. Ilustrated in FIG. 9M is three examples.

Example 1 table 1230 shows a community with a cup and court management limited version. Selecting get new license 1232 the manager will proceed to a page illustrated in FIG. 27C. Since the community already has a cup and court management limited license the option 2992 is de-activated in FIG. 27C. Selecting either Cup and court management professional version or Court management professional version the manager will proceed to a page to select license details 352 in FIG. 4C. From there the manager will proceed to a payment page.

Example 2 table 1233 shows a community with a cup and court management limited license and a court management professional license. Selecting the upgrade/renew link 1235 the manager will proceed to a page illustrated in FIG. 90 with a table 1276 with the columns number of members 1278, current year and current year plus one year. The column for number of members 1278 contains different intervals of members and the year columns a radio button for each interval. Since the community already has a license of this type, options with a less number of members than the current license is de-activated 1275. In the same page there is also another table 1284 with the columns select 1287, sport 1288 and cost of license 1289. In the sports column active sports from FIG. 6A are listed, and in the cost of license column—price per sport for the selected year and number of members in table 1276. For sports covered by the current license subtract the cost of the current license from the cost of the license to upgrade too (if upgrading within the year). If the community only wants to upgrade the number of sports, and not the number of members, then de-activate the sports covered by the current license. From FIG. 90 the manager will proceed to a payment page. If the manager selects Get new license 1236 by table 1233 the manager will proceed to a page to select license, as illustrated in FIG. 27C, with de-activated options for cup and court management limited version 2992 and court management professional version 2994 as these are licenses the community already has.

### Example 3 shows a community with one of each license so the get new license options is not active. The user can here only upgrade one of the current licenses. The manager can also view order history for each license by selecting the order link.

When selecting community settings 1246 in FIG. 9L the manager will proceed to a page with settings for the community, illustrated in FIG. 9P (upper part of the page) and FIG. 9Q (lower part of the page). The page contains fields to set/edit the timezone for the community 1302, the current date and time 1304 for the community and the currency to be used by the community 1306. The manager can also select if the community shall show in a public list of communities 1310 or not 1312 (in table 442 in FIG. 4G). The manager can select if the community's tournaments shall show in the public list of communities 1314 or not 1316. And the manager can select if the community's internal ranking shall be open for public viewing 1318 or not 1320. These are examples of some possible options in this page. Besides especially timezone and currency, selecting how users shall obtain membership is an important part of this page. The manager can select if the community shall charge a fee for memberships 1324, if memberships are obtained through an application 1340 or if there shall be no requirement to obtain memberships 1342. These options makes the solution flexible and usable for users with different needs. If selecting charge fee on memberships 1324 the manager must set prices on memberships before the setting has an effect.

In table 1336 the manager can set prices for the community. The table has the columns year of license, prices, options and status. If the community has a license valid for 2012, the year of the license will display in the year of license column, “not set” 1334 will show as default setting in the prices column and a set link 1336 will show in the options column. Selecting the set link the manager will proceed to a page illustrated in FIG. 9R to set the price categories. The page contains a select menu to set the same prices for all 1356 or to differentiate prices for members 1354.

If selecting Same prices for all 1356 the manager will proceed to a page illustrated in FIG. 9U and then to a page illustrated in FIG. 9W to submit the prices.

If selecting differentiate prices 1354 in FIG. 9R the manager will be given options to differentiate prices by age 1358 and/or by other categories 1360. When selecting to differentiate prices by age the age classes/categories can be set in table 1364. When selecting other categories the manager will select other categories from table 1368. The table has the columns select, name on other categories, description of documents required by/from user and an edit column. Example of other categories can be “Students”, “Gold membership”, “Silver membership” etch. Categories listed in the table are default settings but can be changed to other names by the manager. The manager can also set if value added tax shall be added to prices 1370 in this page (country specific, VAT rates managed in backoffice).

Having set price categories the manager will proceed to a new page to set the prices as illustrated in FIG. 9S. In the page is a menu that allows the manager to select 1374 between setting prices for a main category and to calculate prices for other categories on basis of that or to set prices separately for each category 1376. If the manager selects the first option 1376 prices must be set in percent in table 1378. Table 1378 contains the columns category, main and percentage. The categories selected earlier will be listed in the category column of this table, a radio button and an input field to set percentage by each category. The radio button is to define the main category.

When the mangager selects a category as main category it will be given a fixed number of 100%. Other categories will be calculated on from prices set for this selected category. Having set values in the table 1378 the manager will proceed to a page illustrated in FIG. 9T to set prices for the main category. The page allows the manager to select different duration on the memberships: monthly, quarterly, Annual and a free trial. Contents in the table 1384 adjusts on basis after selections in the select menu 1382. Selecting annual and quarterly in 1382 the manager must set a price for an annual membership and a price for each quarter. Having set prices for the main category the manager will then proceed to a page illustrated in FIG. 9W. Prices for other categories have been calculated on basis of the percentages set in table 1378 in FIG. 9S. Submitting the prices in FIG. 9W the manager will return to FIG. 9Q.

If the manager selected to set prices separately for each category 1376 in FIG. 9S the manager will proceed to a new page FIG. 9U to set prices step by step for each category. On top of the page it shows the different categories set by the manager 1388. Below a select menu 1390 with the options annual, quarterly, monthly and trial. And a table 1392 that adjusts on basis of the selections in menu 1390. Having set prices for the first category in the page illustrated in 9U the manager will proceed to a page looking the same to set prices for the next category. The manager will proceed like this until prices for all categories have been set and finally proceed to a table with all prices set as illustrated in FIG. 9W. When submitting the prices the manager will return to FIG. 9Q.

When prices have been set the set link 1326 changes to an edit link 1328 and the Not set text 1334 changes to a View link 1330.

If the community is an international association (a governing body) the manager of the community will also get the option International settings 1223 in the community's settings page. Selecting international settings 1223 the user will proceed to a page illustrated in FIG. 9X with international settings for the sport. The manager can decide to allow national associations to edit are levels within their countries 1423 or not 1424, allow national associations to edit skill levels within their countries 1425 or not 1426, allow national associations to edit rules within their countries 1427 or not 1428, if national tournaments must be accepted by the national association 1429 or not 1430 and if international tournaments must be accepted by the international association 1431 or not 1432. HA MED DETTE?

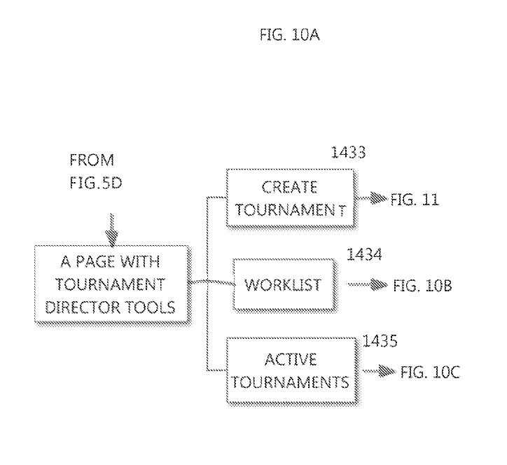

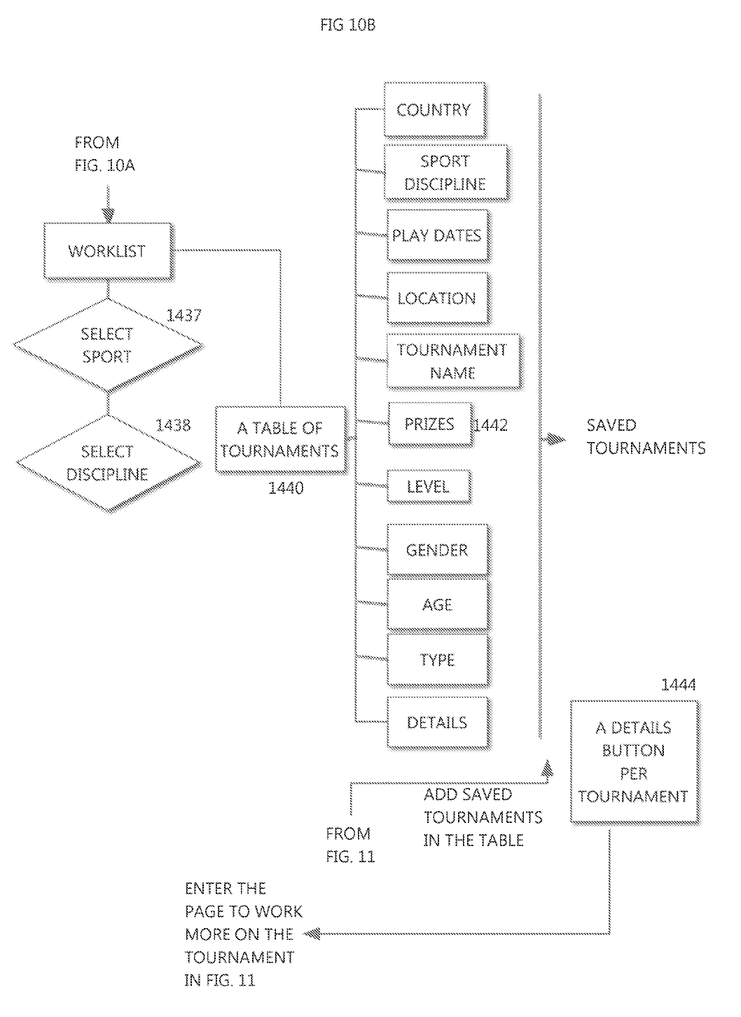

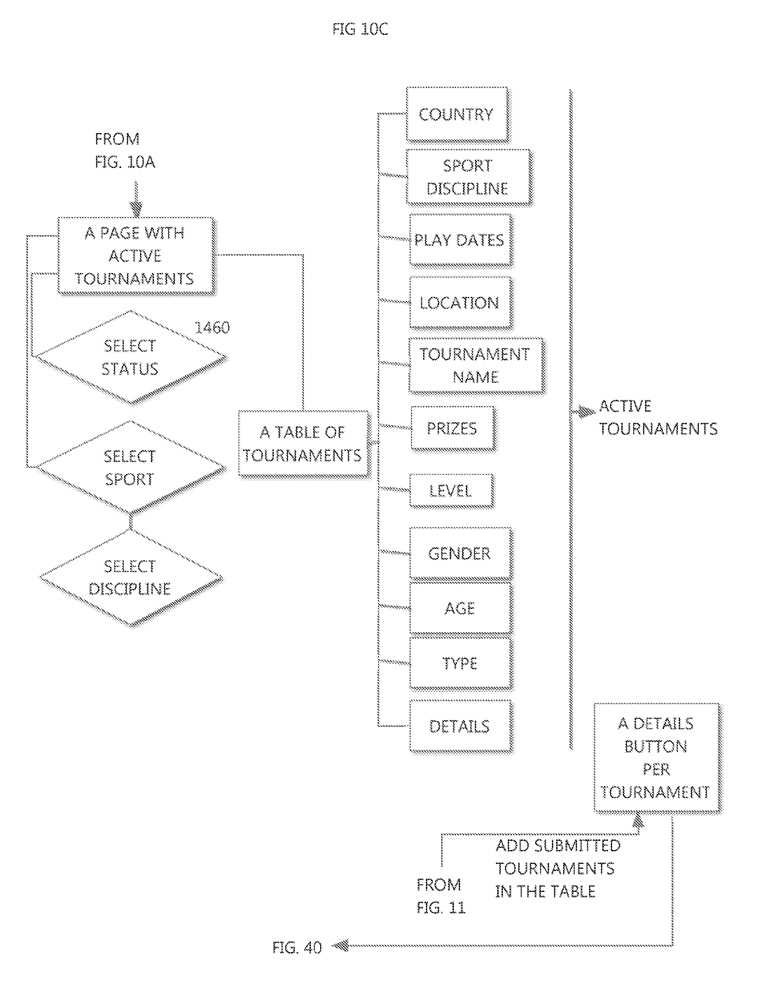

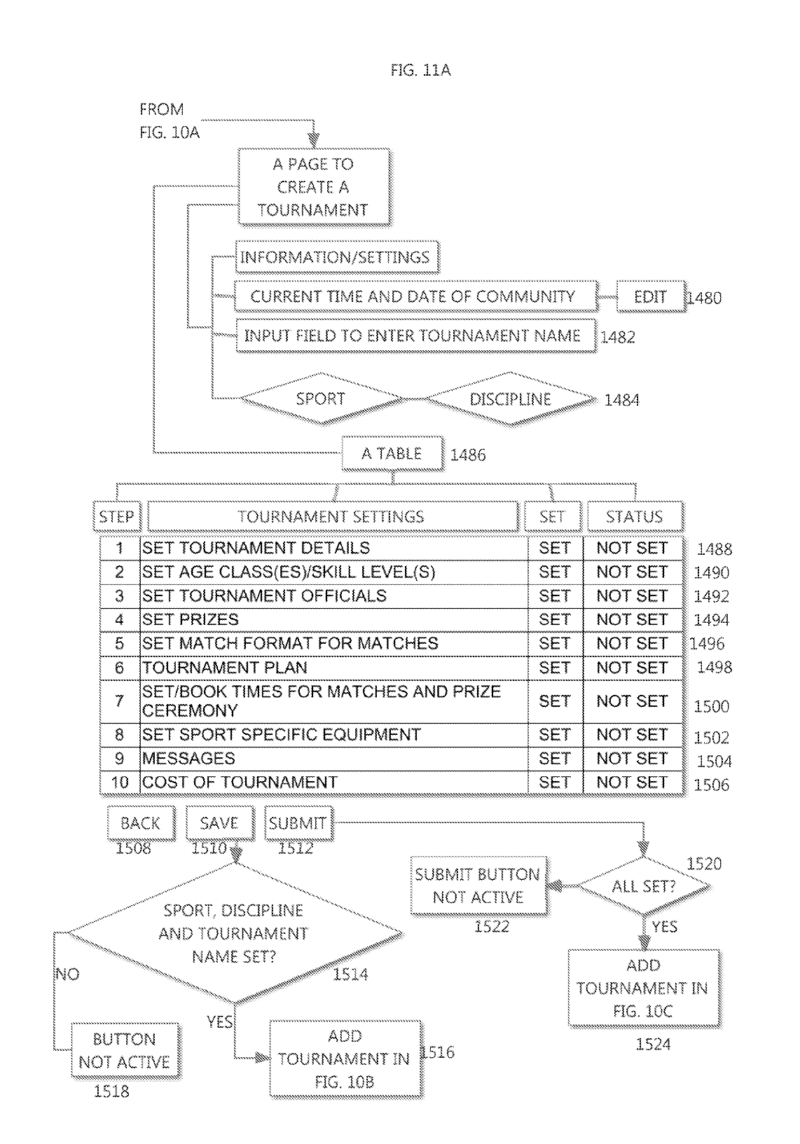

FIG. 10A illustrates a page with tournament director tools. It contains an option to create tournaments 1433, a worklist 1434 and active tournaments 1435. The worklist consists of a select menu for sport 1437 and discipline 1438 and a table with tournaments 1440 with columns country, sport/discipline, play dates, location, tournament name, prizes, level, gender, age, type and details. In the prizes column a link 1442 will be shown per tournament to view the prizes for a tournament, and in the details column a link to view details about each tournament 1444.

FIG. 10C illustrates a page with active tournaments. The page looks the same as FIG. 10B except it also has a select status menu 1460.

FIG. 11A depicts a page to create a tournament for players. It contains an editable field showing the current date and time (timezone) at the community's location 1480 (from the settings page of the community in FIG. 10P). When setting the tournament plan in step 6 it is based on the community's timezone. In that way the solution works in any country with a database of tournaments and arenas in any country. The page also contains an input field to type the name on the tournament 1482, a select menu for sport and discipline 1484 and a table 1486 with the columns step, tournament settings, set and status with different steps to create a tournament. The set links in the table are not selectable when entering the page and becomes active in preceding order: First step 1 must be set, then step 2, then step 3, then step 4 etc. That is to simplify that some steps must be set before others. Before setting tournament details 1488 in step 1 and age class(es)/skill level(s) in step 2, sport and discipline must be selected.

Selecting the set option in step 1 the tournament director enters a page illustrated in FIG. 12. The page contains a menu 1700 to select rules for the tournament. The contents of the menu depends on the setting 1427 and 1428 in FIG. 9X if national associations are allowed to edit rules within their countries. If not the only option in the menu is name on the governing body for the sport in FIG. 6S. If they can also national associations within the sport is added in menu 1700. It also contains a select menu 1702 with the title or heading openness to select if the tournament shall be open for all or just for players within the community, a select menu for gender 1704 with the options male, female or male & female, a select menu for tournament format with the options single elimination schedule and single elimination schedule with bronze final 1706 (other tournament formats can be added), a select menu 1708 to select the max number of entrants and a back button 1714 and submit button 1712 to submit the data. When a selection has been made in all the menus the user can submit the data and return to the main page for creating the tournament in FIG. 11C where the Set link has changed to an Edit link and the Not set text changed to “set” for step 1

Selecting age class(es)/skill level(s) 1490 in step 2 the tournament director will proceed to a page that is illustrated in FIG. 13. The page contains a table 1716 with age classes and columns named select, age from, age to and description, and a table with skill levels 1718 with columns named select, level name, level from, level to and description. The contents in the table depends on the selection in the rules menu 1700 in step 1. If the selection was the governing body of the sport in menu 1700 then the age classes and skill levels set by the governing body would be the selectable options. If the selection was a national association then age and skill levels set by the national association would be the selectable options.

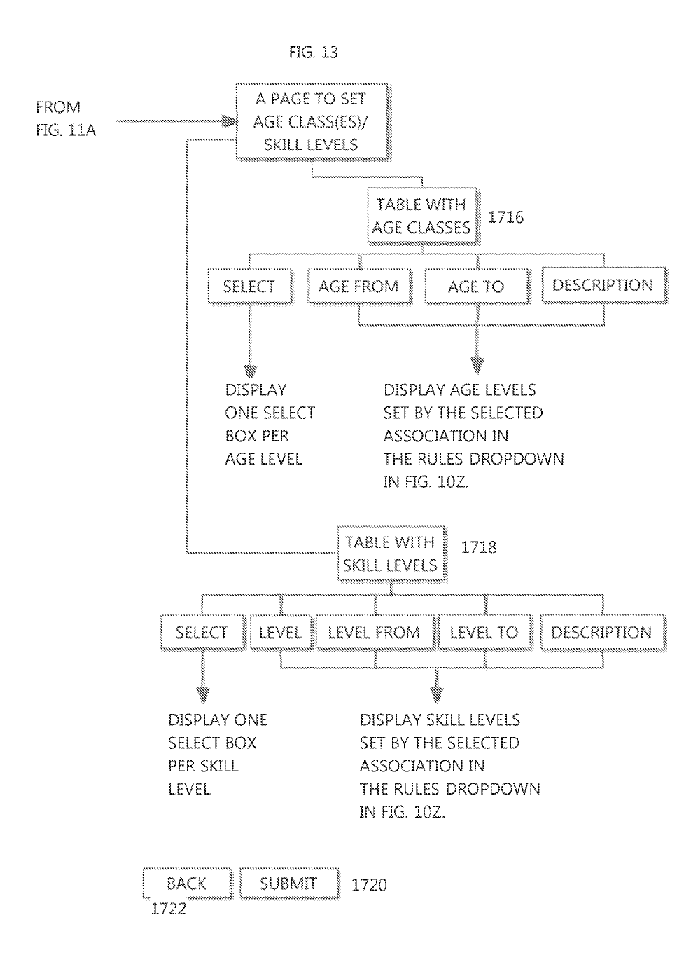

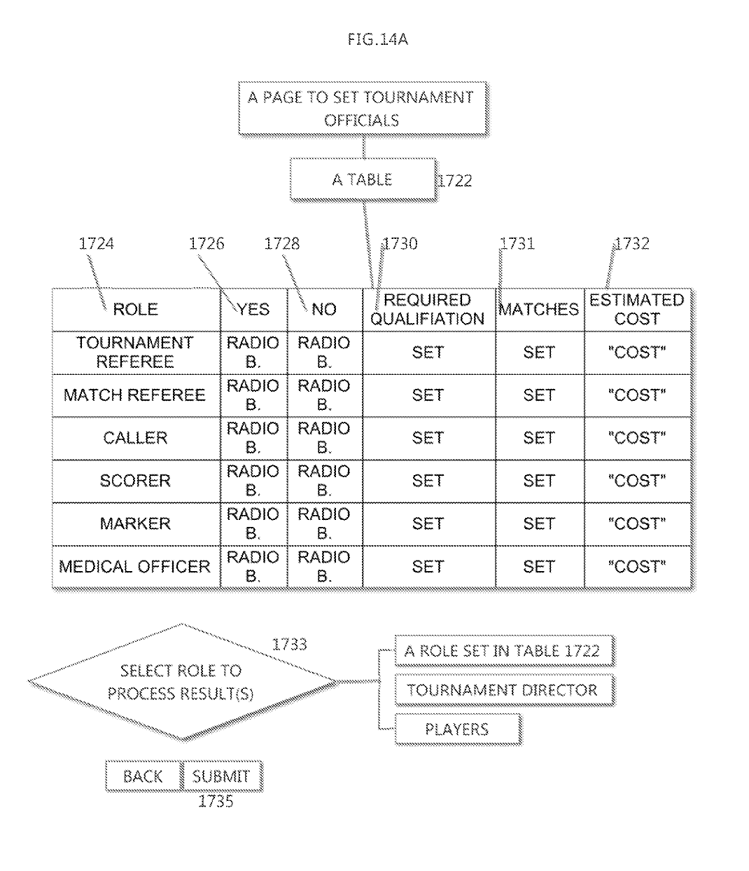

Selecting set in step 3 the tournament director will proceed to a page illustrated in FIG. 14A to set tournament officials. The page contains a table 1722 with the columns role 1724, yes 1726, no 1728, required qualification 1730, matches 1731 and estimated cost 1732. The role column contains different roles for the sport selected in FIG. 11A using darts as an example with the roles Tournament referee, match referee, caller, scorer, marker and medical officer. In the yes and no column the tournament director can decide what roles to include in the tournament and in the required qualification column 1730 the set link will lead to a page FIG. 14B to set the required qualification per role. FIG. 14B illustrates a table 1736 with the columns select 1738, certificate/qualification 1740 and number of registered tournament officials holding the certificate 1742. The certificates shown in the table depends on the rules selected in step 1, either certificates set by the governing body of the sport or by a national association. Having selected the required qualifications for the tournament the tournament director will submit the details and return to FIG. 14A. The tournament director must also set in what matches to include selected roles. Selecting the set link 1732 the tournament director will proceed to a page illustrated in FIG. 14C with a table 1748 and the columns Round/match 1750, main 1752, reserve 1754 and estimated cost 1756. The table shows all the possible matches of the tournament in the first column, a select box by each match in the second and third column and the cost per selection in the fourth column. As an example the tournament director can add a role only for the semi-finals and final if that is required in the tournament. In case of absence reserves can also be set for each match.

When settings have been made in table 1722 the tournament director can select role to process results 1733, either the tournament director, the players or another role set in table 1722. Then the tournament director can submit 1758 the data and return to FIG. 14A.

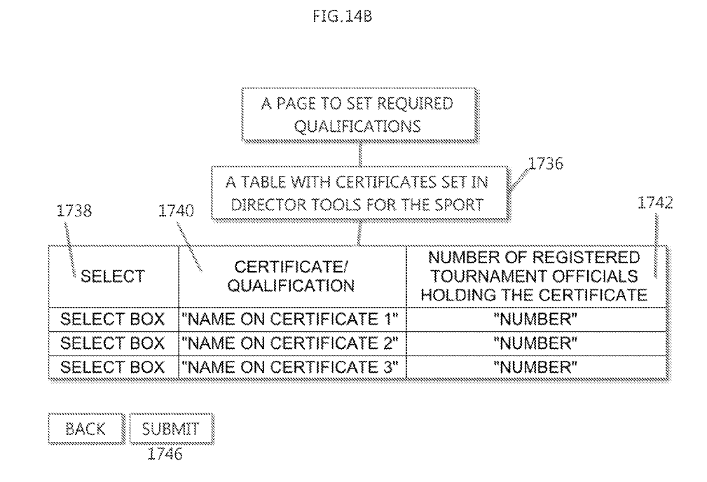

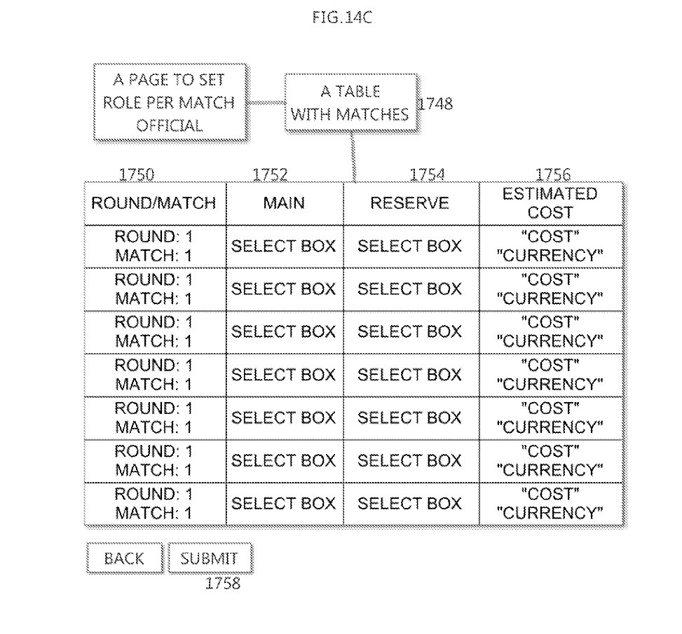

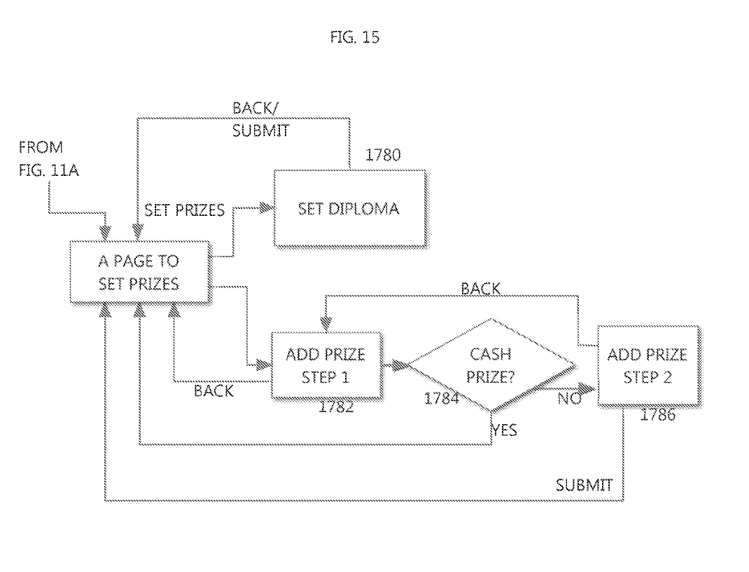

The set option 1494 in step 4 in FIG. 11A is active if step 1 has been set. Selecting set in step 4 the tournament director will proceed to a page illustrated in FIG. 15A to set prizes for the tournament. The page contains a table 1759 with the options prize, description, photo(s), cost/value in the currency of the community and options. By the table there is also an add prize option 1763 and for each prize added in the table there are three selectable options in the options column, details 1760, edit 1761 and delete 1762 as shown in the example in the page. Selecting the details option 1760 the tournament director will proceed to a page 1786 illustrated in FIG. 15B showing details of the prize. FIG. 15A also contains a select option to set if prizes/trophies will be engraved 1764, and options to select if prizes will handed out in a prize ceremony (and money prizes transferred to players bank or paypal account)or sent to player by postal service 1765 (and money prizes transferred to players bank or paypal account). It contains a photo of the diploma selected 1766 and an edit option to edit diploma 1767, and a select menu 1768 to select if diploma shall be automatically generated and emailed to players when results from the last match of the tournament has been processed, if diplomas shall be handed out to players in the prize ceremony or if the diplomas shall be sent to players by a postal service.

Selecting the add prize option 1763 in FIG. 15A the tournament director will proceed to a new page as illustrated in FIG. 15B to set details for the prize. The select menu 1779 contains options to select if the prize shall be a first prize, second prize or a third prize if the tournament format selected in step one was single elimination schedule with bronze final, and first prize and second prize if the selection was single elimination schedule without bronze final. In a second select menu 1780 the tournament director must select type of prize from options like Trophy, Medals prize money and other. Selecting other an input field is added so that the tournament director can type with letters. The page also contains an input field to add a more detailed description of the prize 1781 and a field to set a value on the prize 1782. If the tournament director selects prize money in 1780 a submit button will show below in the page. If the tournament director selects another kind of price in 1780 then a next button 1784 will show in the page. Selecting Next 1784 the tournament director will proceed to a page 1792 to browse and upload photos of the prize and a table 1794 with the columns photos, order and options. The table allows to edit the number the photos 1795 where photo number 1 is the main photo to be shown in table 1759 in FIG. 15A and FIG. 39C. The option column contains a delete button 1797 per prize and below the table is a submit button 1798 to submit the prize. Submitting the prizes the user will return to FIG. 11A.

The set option 1496 in step 5 in FIG. 11A is active if step 1 has been set. Selecting set in step 5 the tournament director will proceed to a page to set match format for the matches in the tournament. The tournament director is given the options set same match format for all matches 1806, set match format per round 1804 and set match format per match 1802. The page also contains a table 1814 with the columns match, match format and minimum required time/recommended time per match (in minutes). In the match column display all the possible matches in the tournament (tournament format and max number of entrants was set in step 1), in the match format column display a select menu (eg dropdown) with match formats for the sport/discipline set in FIG. 6H either per match 1812, per round 1810 or one common select menu 1808 for all matches in the tournament. Having set match format for all the matches the tournament director can submit the details and return to FIG. 11A.

The tournament plan to be set in step 6 will vary depending on settings in step 3 and step 4. Therefore step 3 and step 4 must be set before step 6.

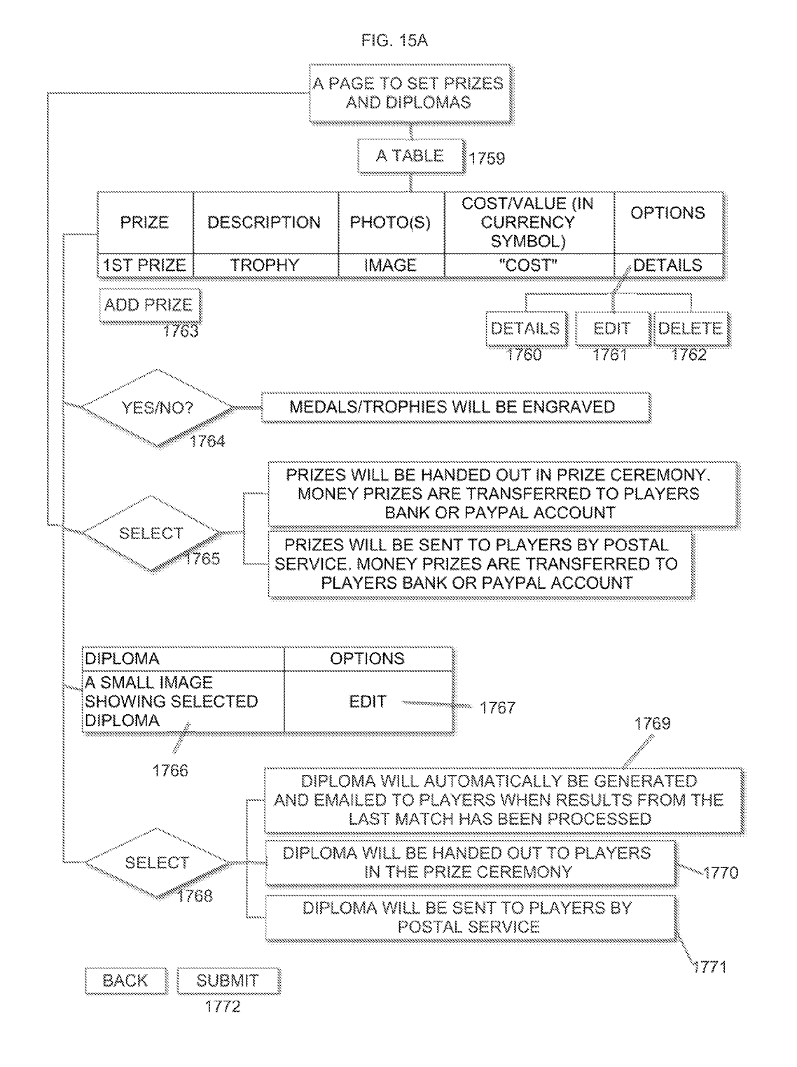

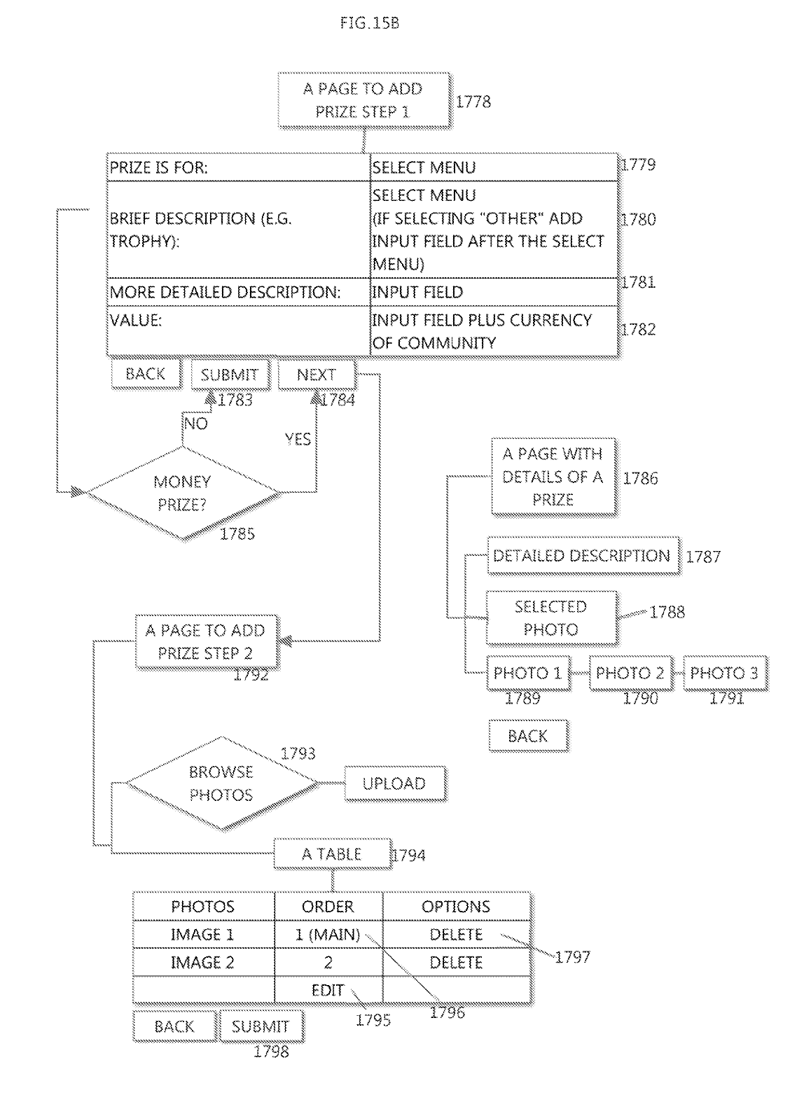

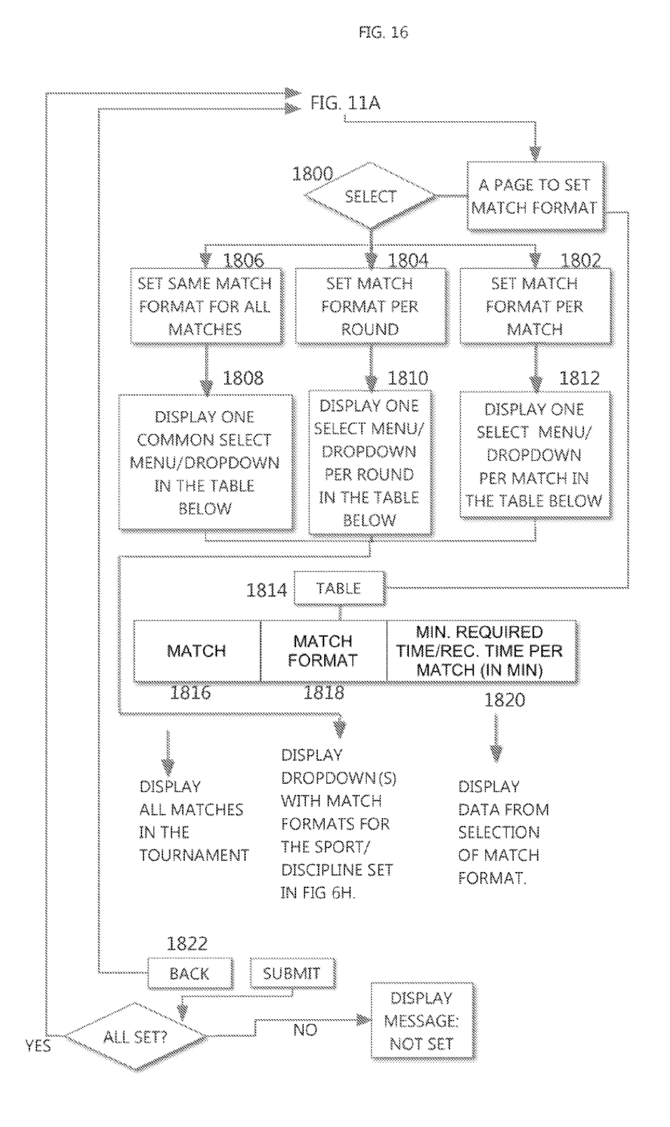

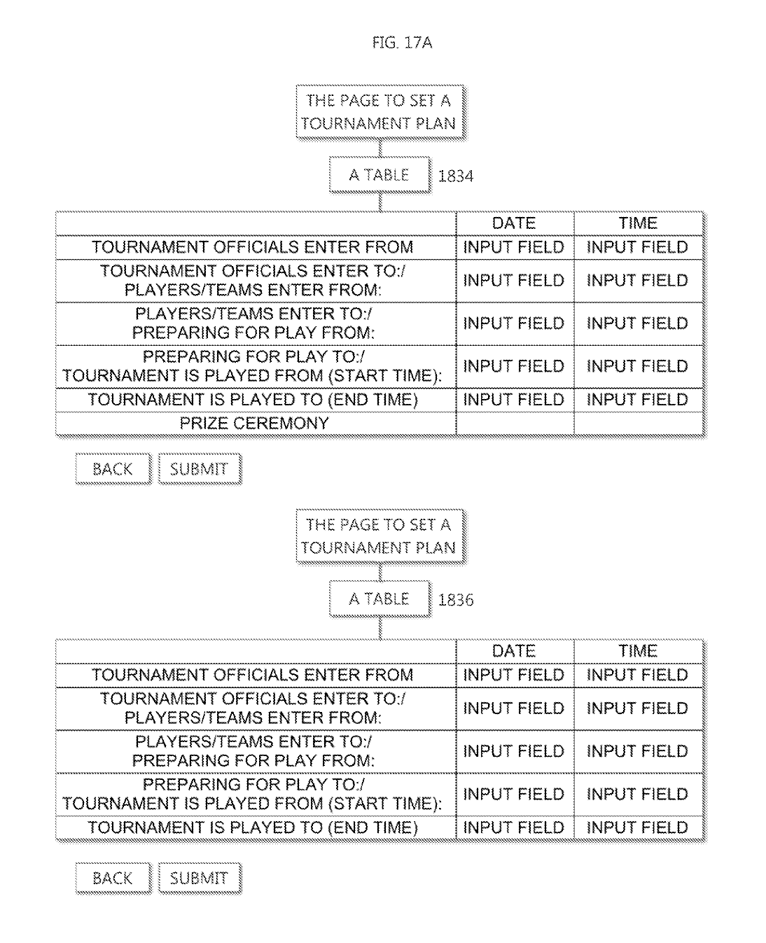

If the tournament director sets that there shall be tournament officials in the tournament in step 3 and that prices and/or diplomas shall be handed out in a prize ceremony in step 4 then the tournament plan will have the contents as in table 1834 in FIG. 17A. A time and date must set for when the tournament officials can enter from, a time and date must set for when the tournament officials can enter to and players can enter from, a time and date must be set for when players can enter to and prepare for play from, a time and date must be set for when players can prepare for play to and the start of the first match, and a time and date must be set for when the tournament is played to. The prize ceremony marks the end of the tournament plan.

If the tournament director sets that there shall be tournament officials in the tournament in step 3 and that prices and diplomas shall not be handed out in a prize ceremony in step 4 then the tournament plan will have the contents as in table 1836 in FIG. 17A. A time and date must set for when the tournament officials can enter from, a time and date must set for when the tournament officials can enter to and players can enter from, a time and date must be set for when players can enter to and prepare for play from, a time and date must be set for when players can prepare for play to and the start of the first match, and a time and date must be set for when the tournament is played to.

If the tournament director sets no tournament officials in in step 3, and that prices and/or diplomas shall be handed out in a prize ceremony in step 4, then the tournament plan will have the contents as in table 1838 in FIG. 17B. A time and date must set for when the players can enter from, a time and date must be set for when players can enter to and prepare for play from, a time and date must be set for when players can prepare for play to and the start of the first match, a time and date must be set for when the tournament is played to. The prize ceremony marks the end of the tournament plan.

If the tournament director sets no tournament officials in in step 3, and that prices and diplomas shall not be handed out in a prize ceremony in step 4, then the tournament plan will have the contents as in table 1840 in FIG. 17B. A time and date must set for when the players can enter from, a time and date must be set for when players can enter to and prepare for play from, a time and date must be set for when players can prepare for play to and the start of the first match, and a time and date must be set for when the tournament is played to.

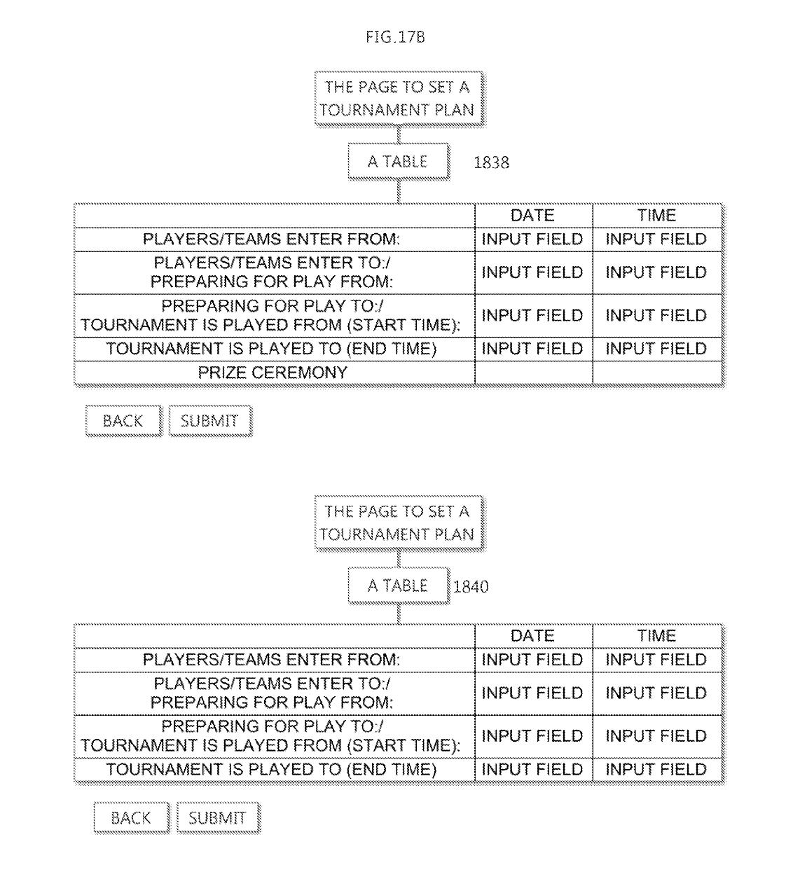

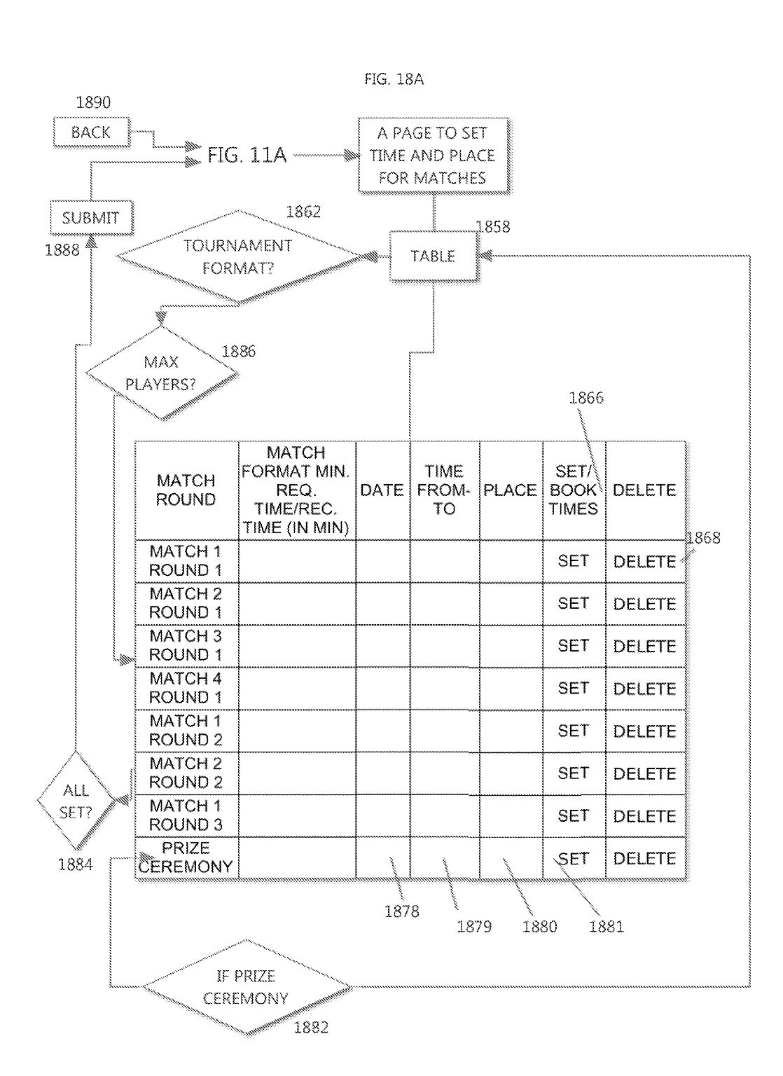

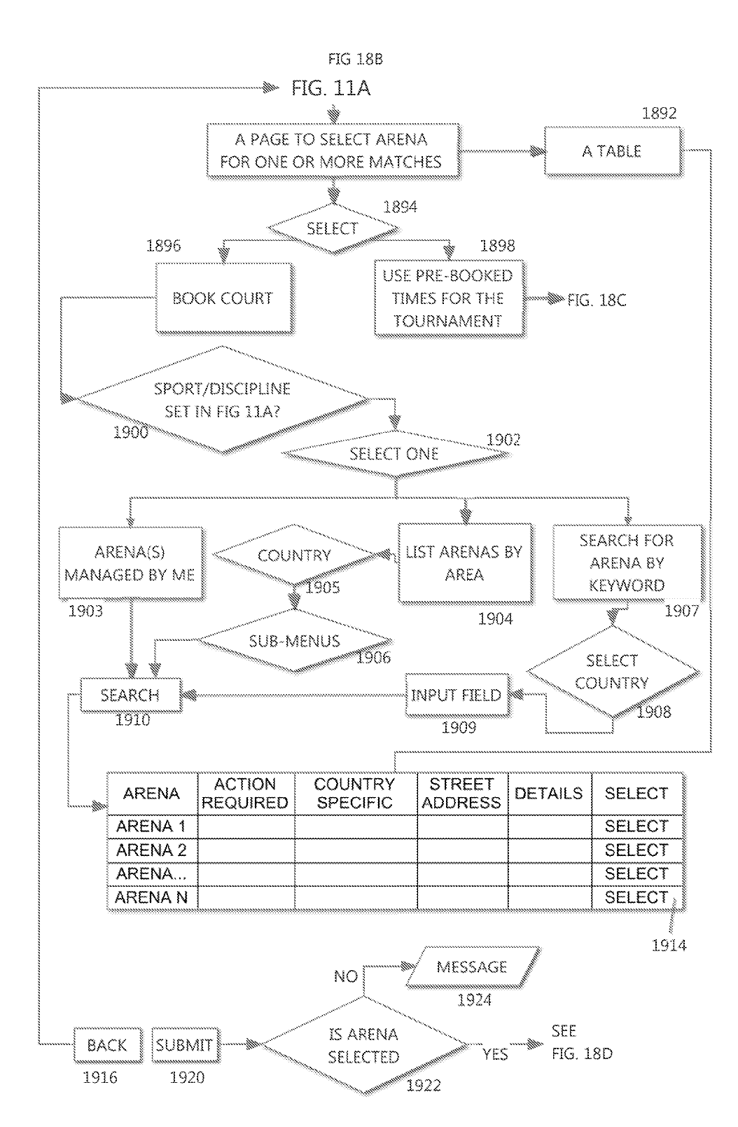

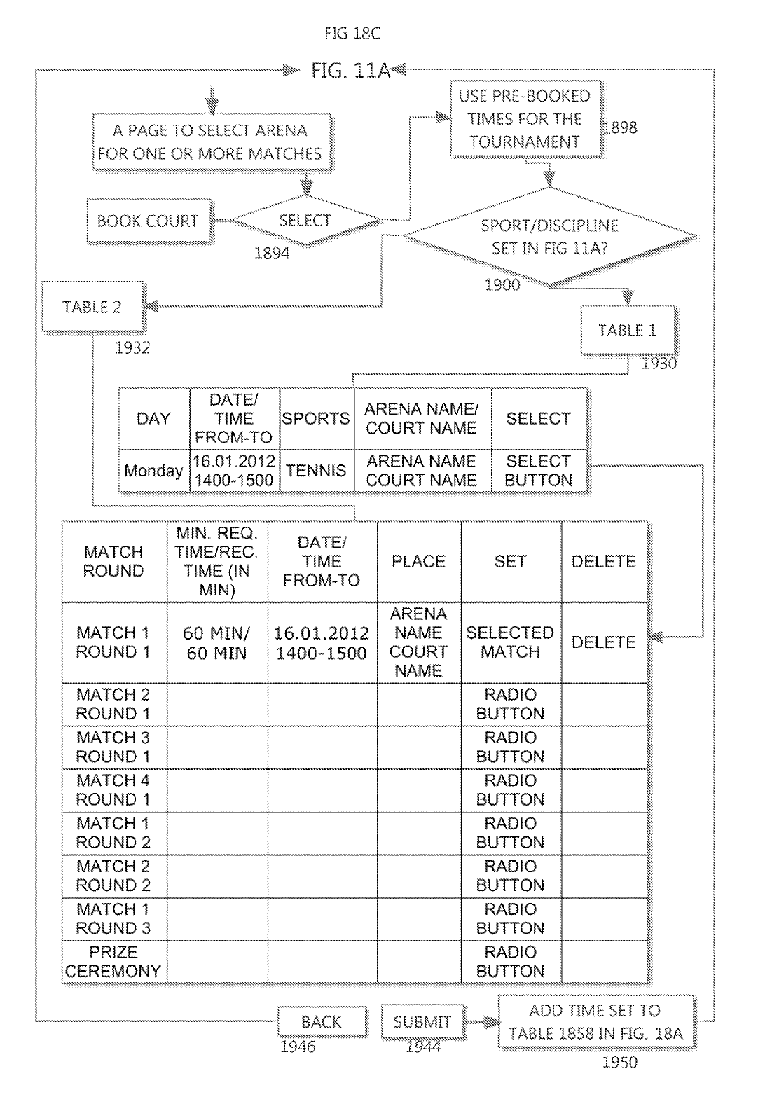

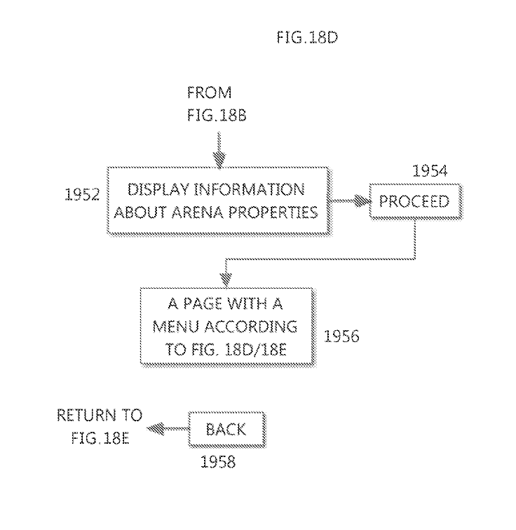

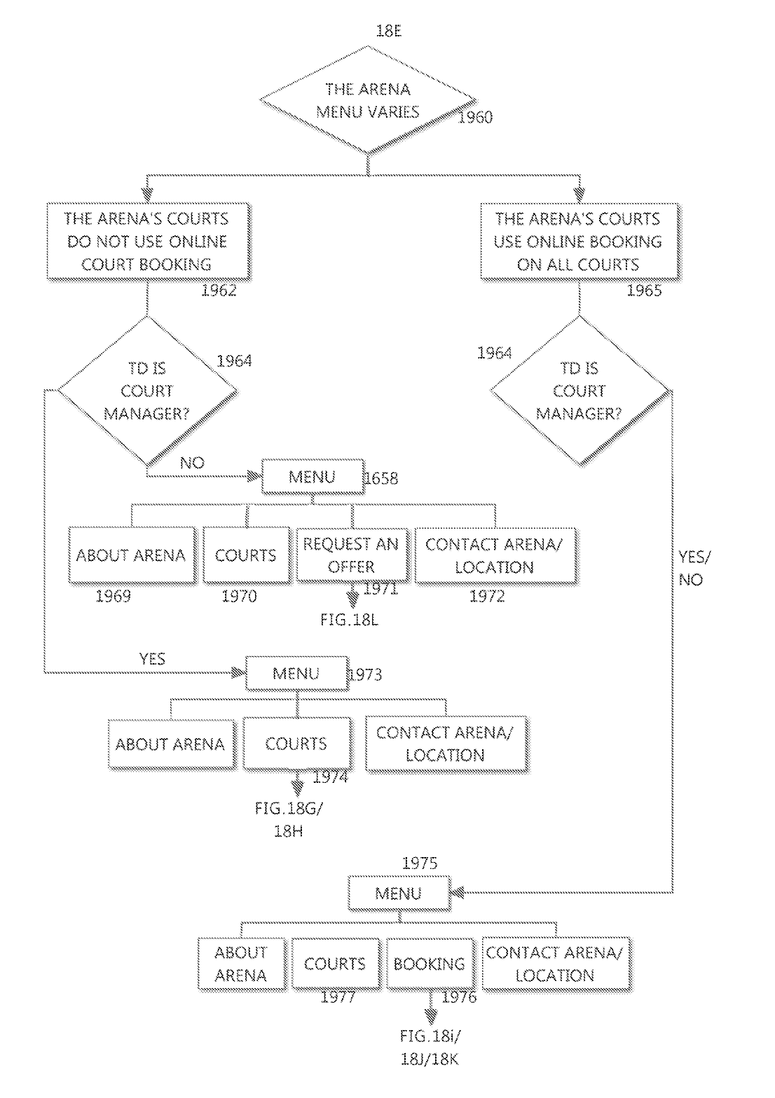

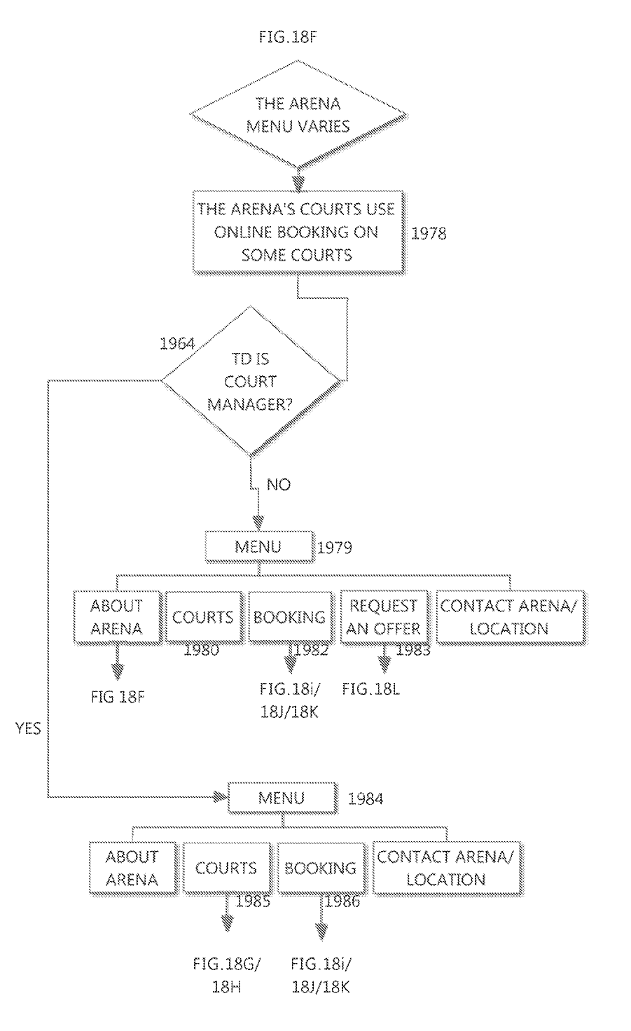

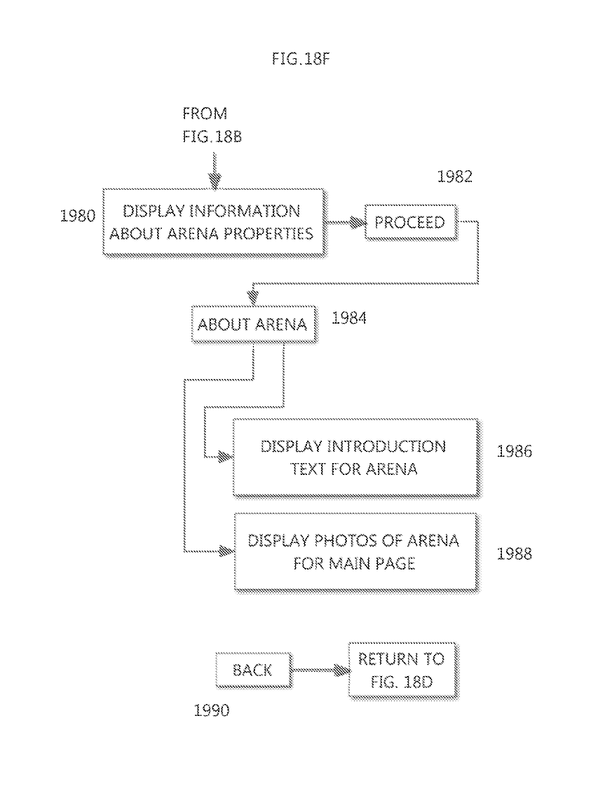

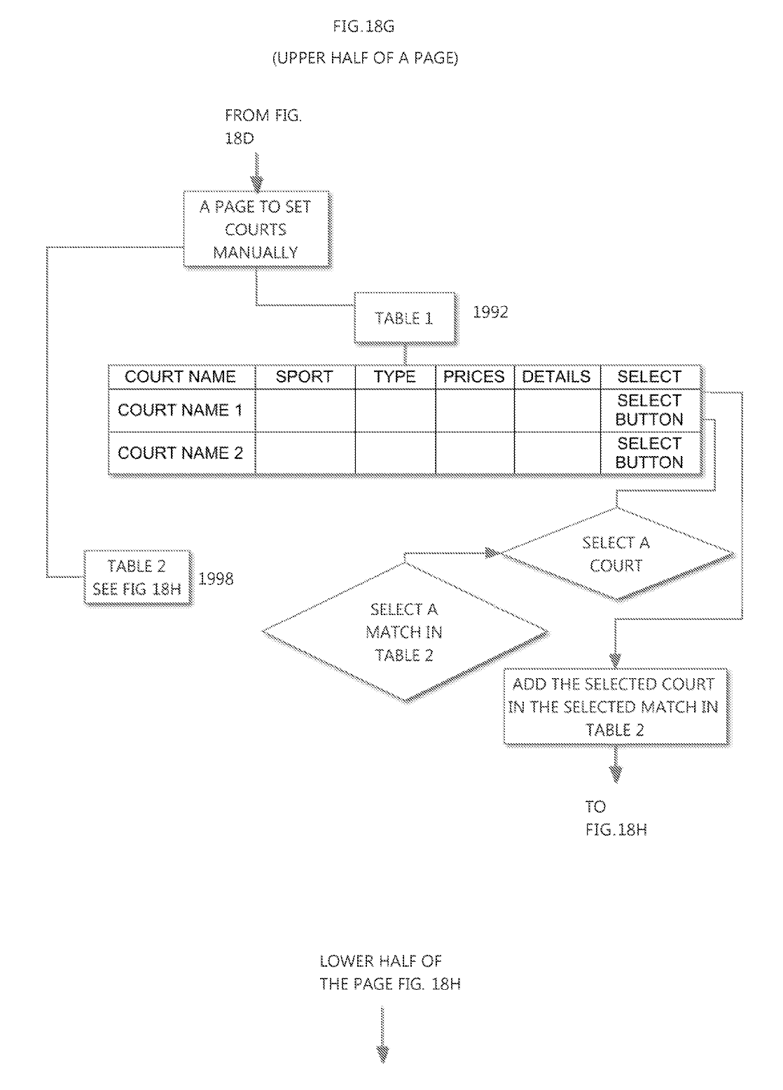

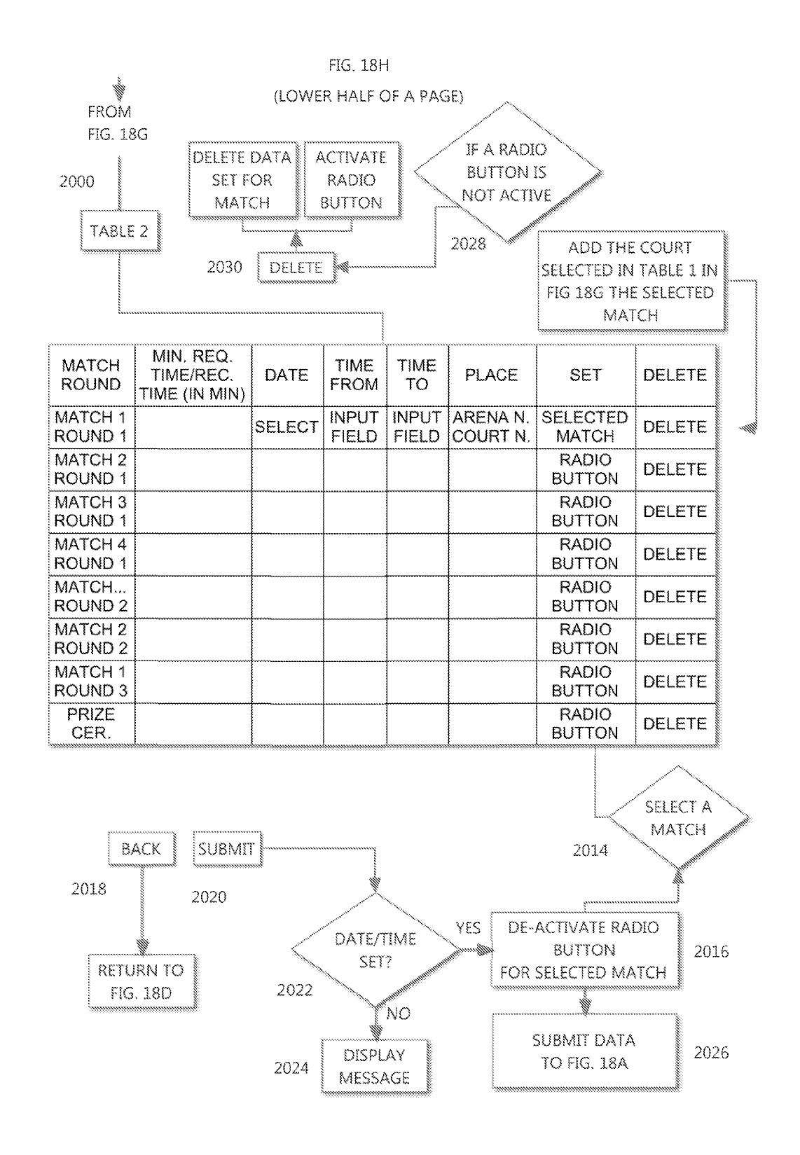

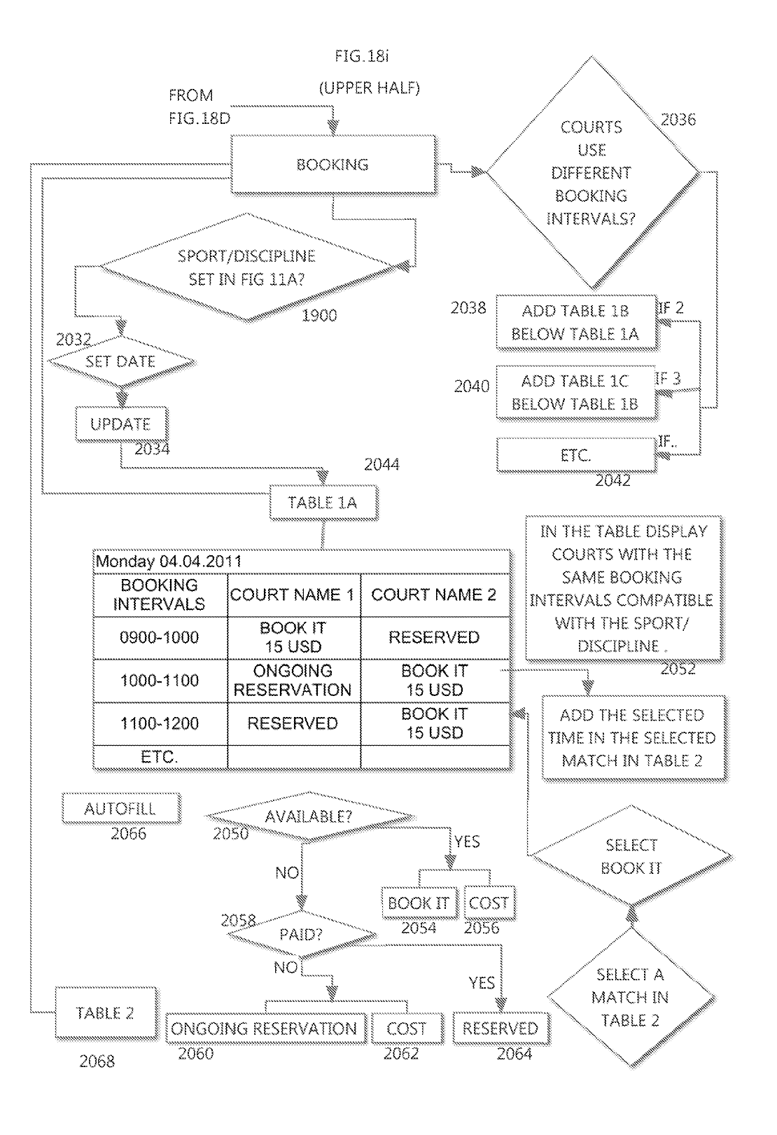

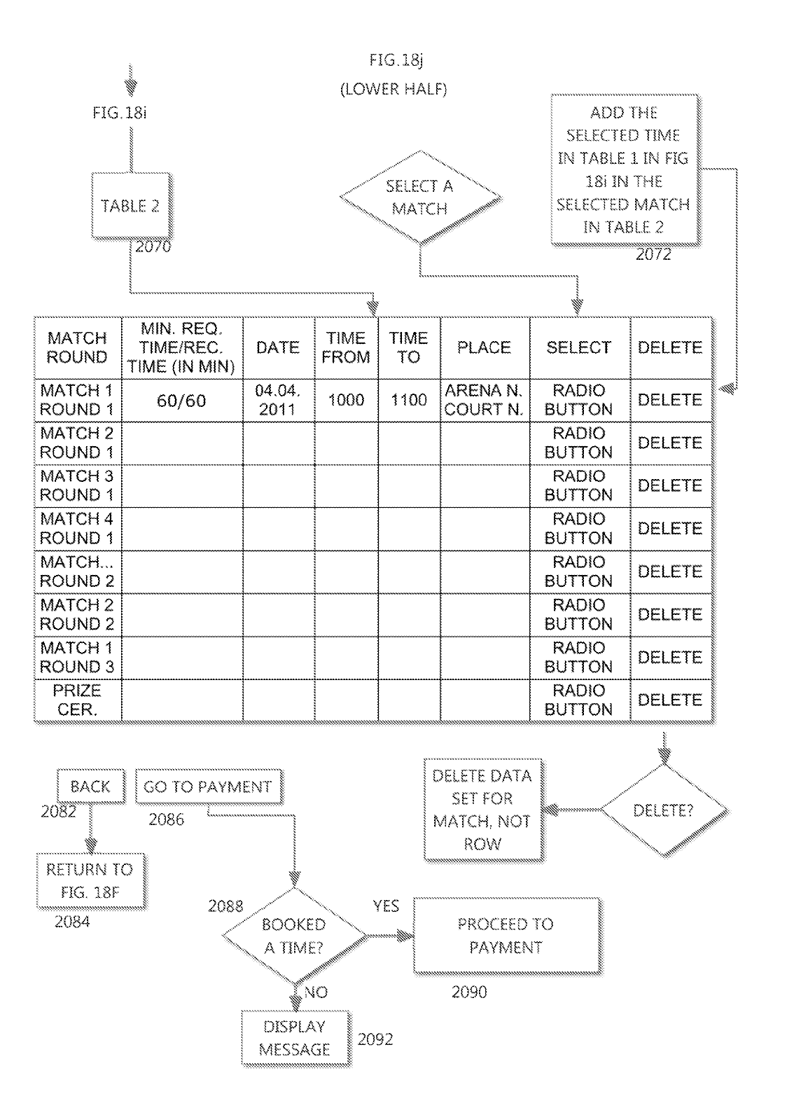

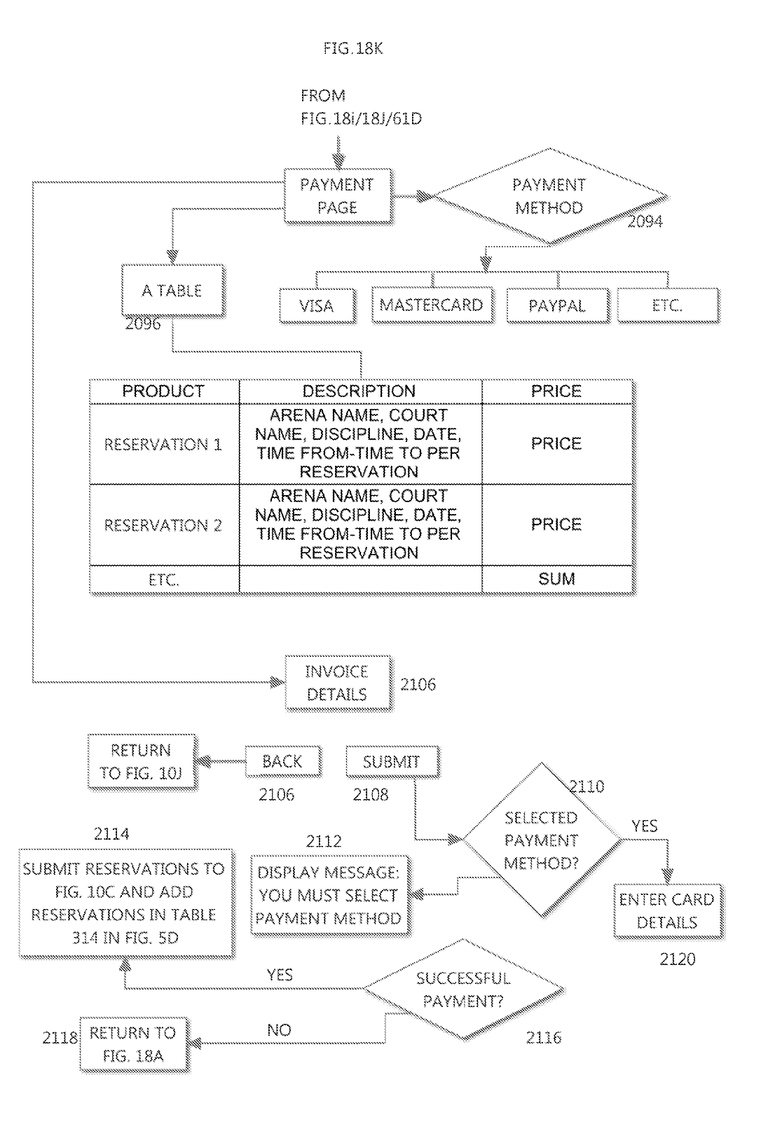

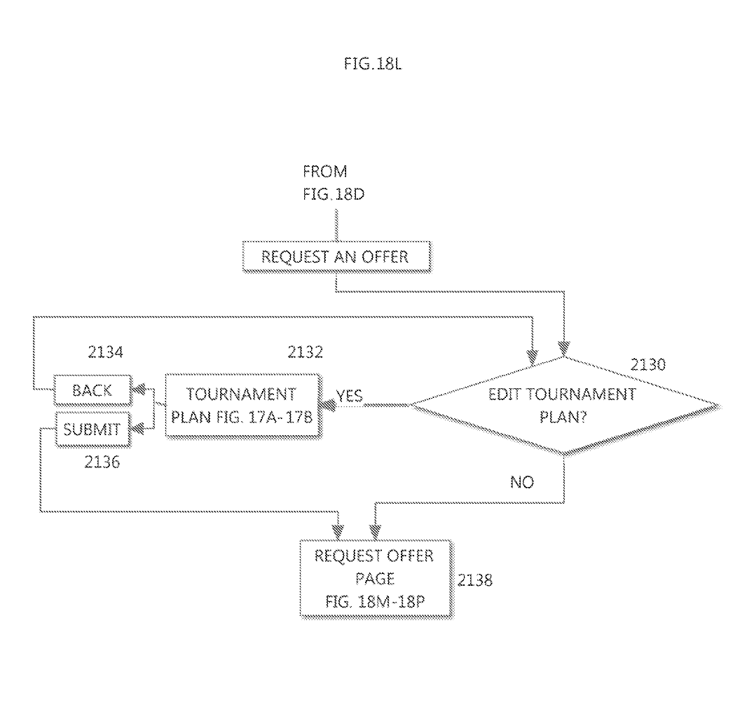

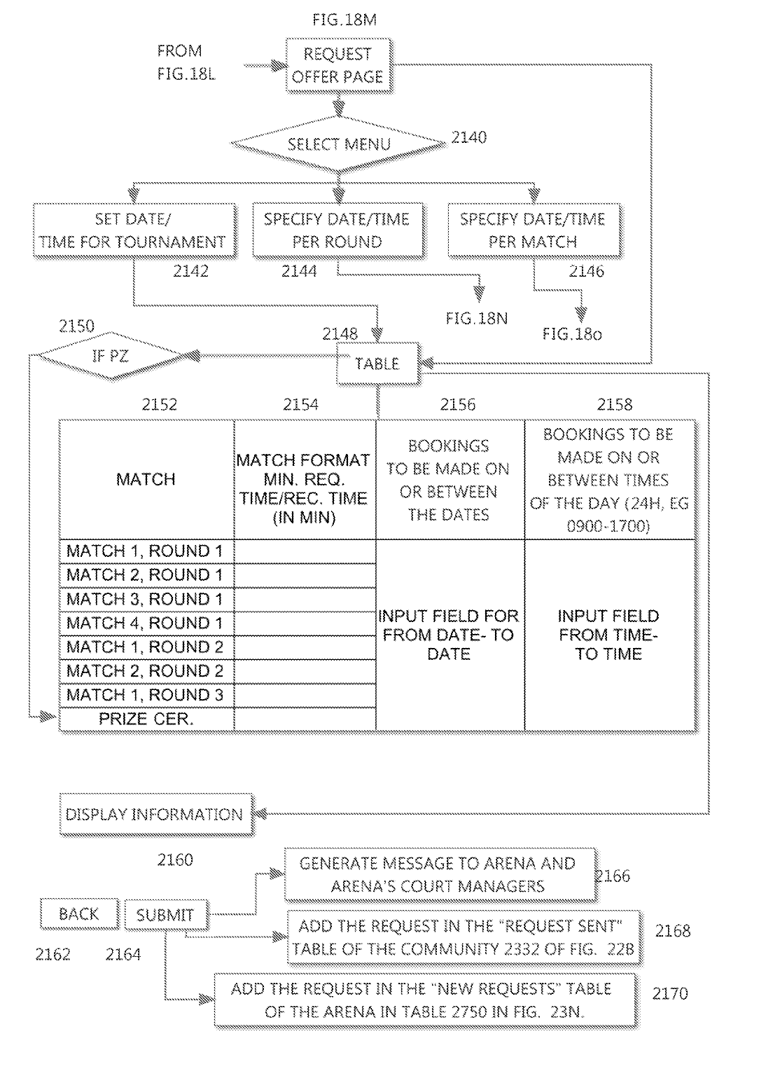

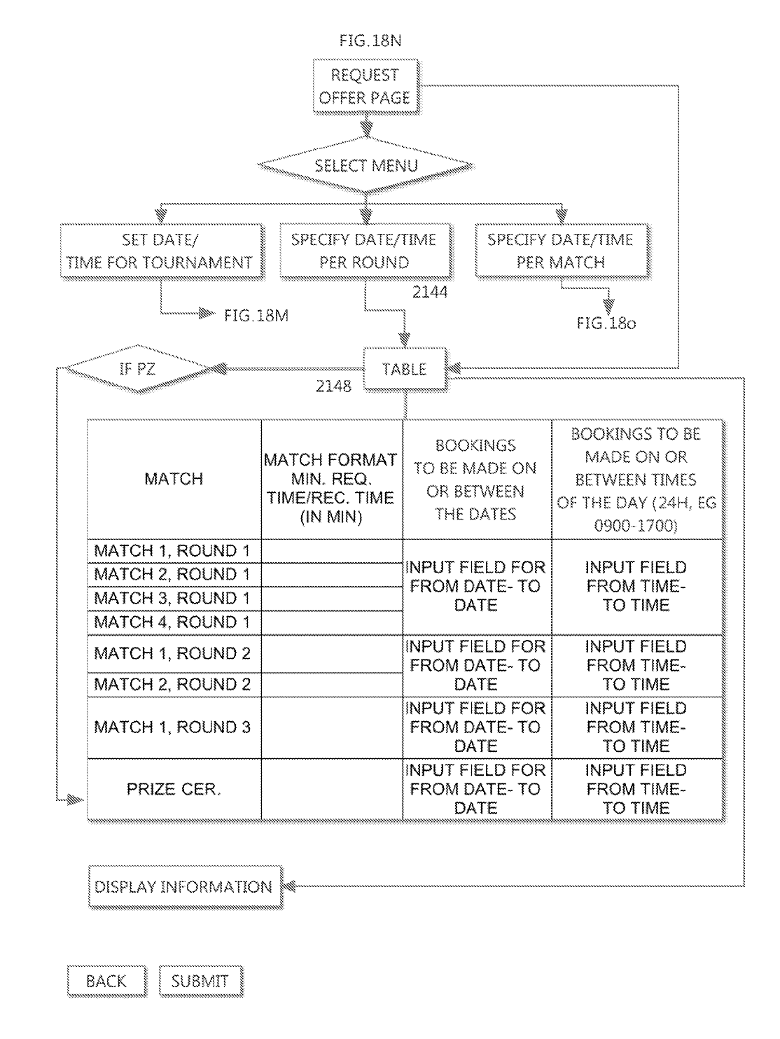

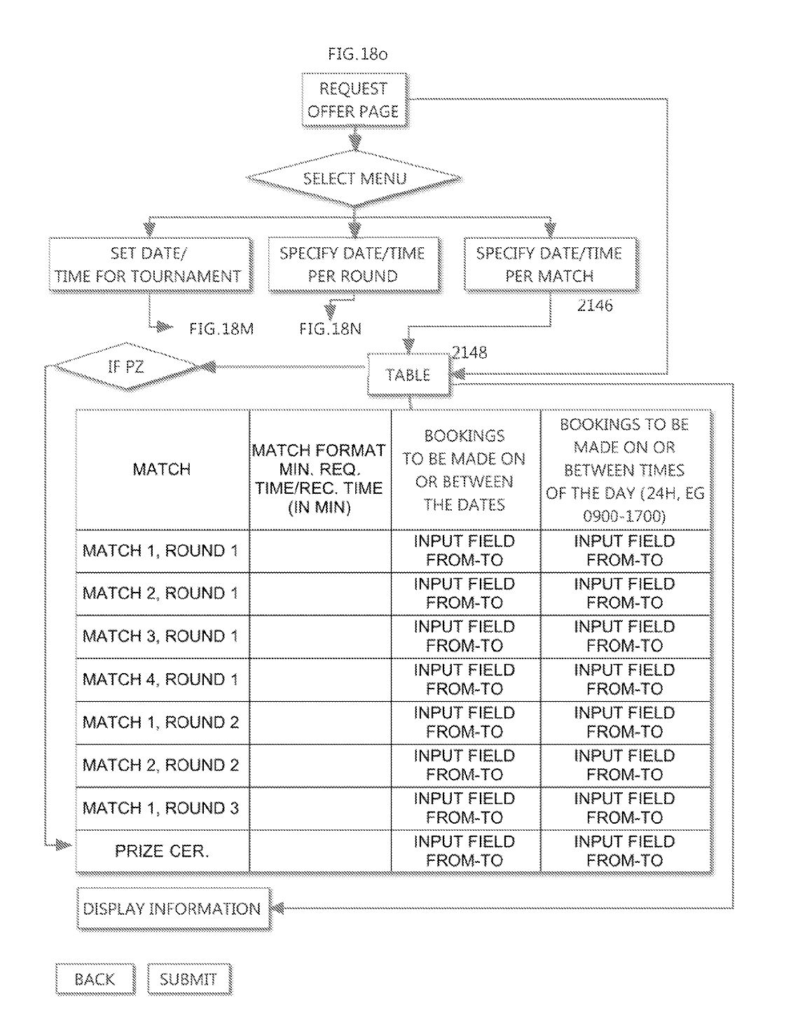

When selecting Set/Book times for matches and prize ceremony in step 7 of FIG. 11A the tournament director will proceed to a page illustrated in FIG. 18A to set time and place for the matches. The page contains a table 1858 with the columns [match/round], [match format, min required time/recommended time (in min)], [date], [time from-to], [place], [set/book times] 1866 and [delete] 1868. In the table 1858 all the possible matches in the tournament will be listed on basis of tournament format 1706 and the max number of players (entrants) 1708 set in step 1. If there shall be a prize ceremony in the tournament set in step 4 then there shall be a row 1882 for prize ceremony as illustrated in the table 1858 in FIG. 18A. The set/book times link will lead the tournament director to a new page as illustrated in FIG. 18B to select arena for the selected match and/or for other matches in the tournament.

In FIG. 18B the tournament director can select 1894 between using pre-booked times for the tournament 1898 or booking a court for the tournament 1896. If selecting to use pre-booked times in the tournament contents of the page will change from FIG. 18B to FIG. 18C, with a table 1930 showing pre-booked times table 2308 in FIG. 22B if the community already has reservations within the sport/discipline.

If selecting to book a court 1896 the sport and discipline 1900 is pre-selected with the setting in FIG. 11A. If selecting arenas managed by me 1903 the output in the table 1892 will be arenas where the tournament director is court manager. If selecting list arenas by area 1904 the tournament director must also select country and from country specific menus like county and municipality 1906. If selecting search for arena by keyword 1907 the tournament director must select country 1908 and type keyword in an input field 1909. Having selected an arena 1914 the tournament director will proceed to a page illustrated in FIG. 18D with information about the arenas properties 1952. Going forward will lead to a page 1956 with a menu and details for the arena 1956 described in FIG. 18E.

The menu in the selected arena will vary depending on if the arena's courts use online court booking and if the tournament director is court manager.

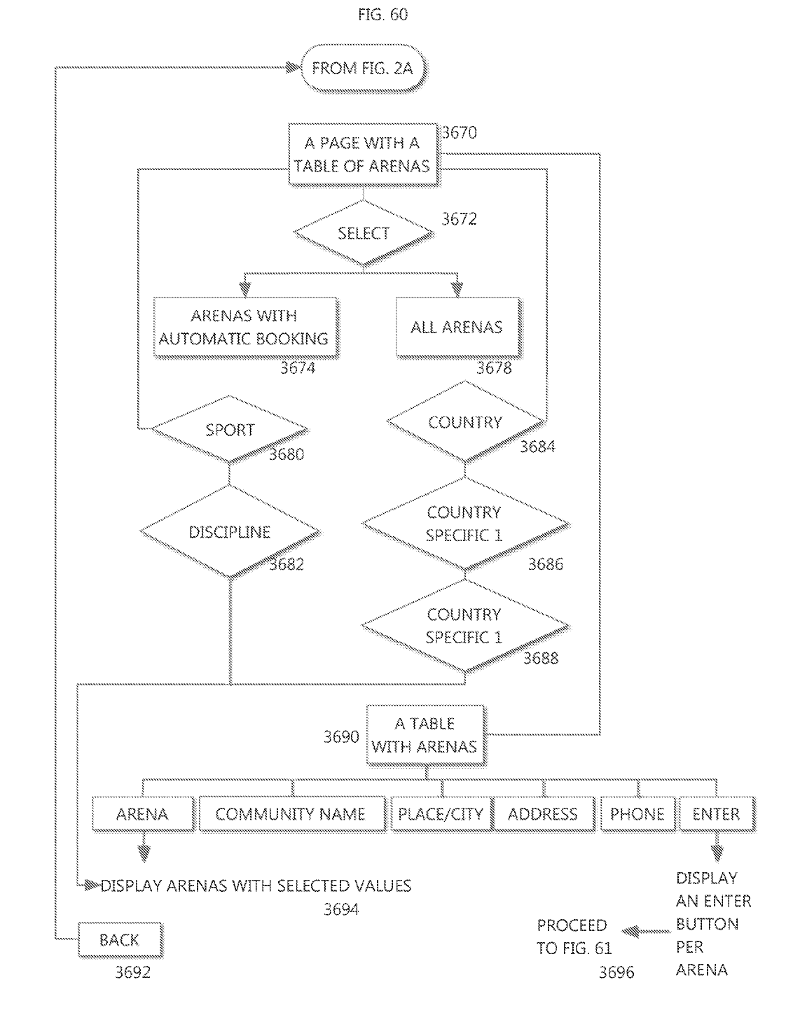

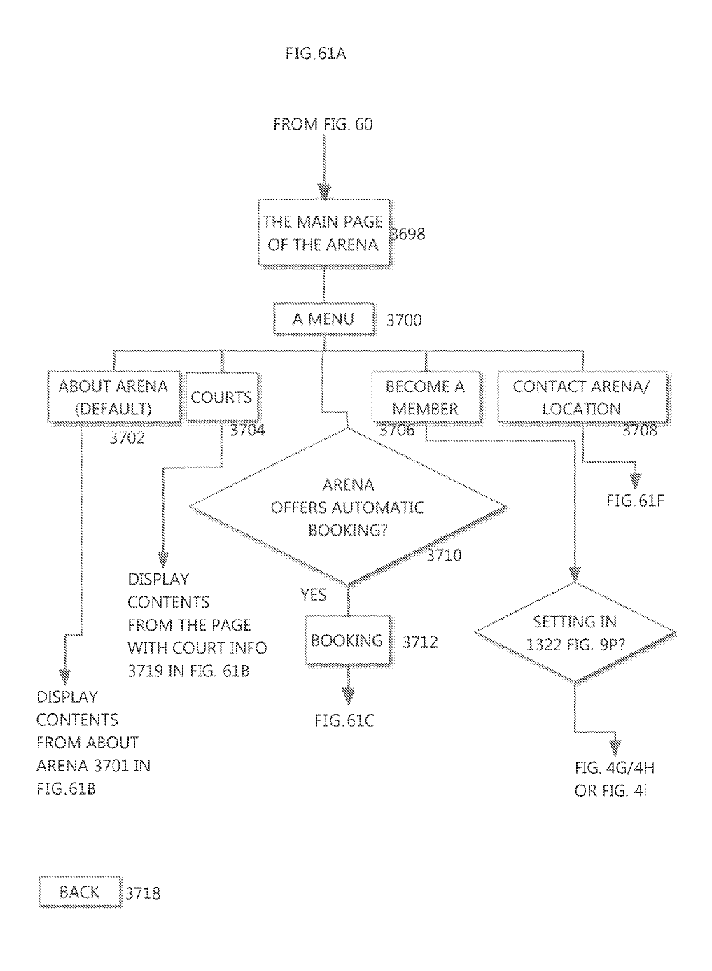

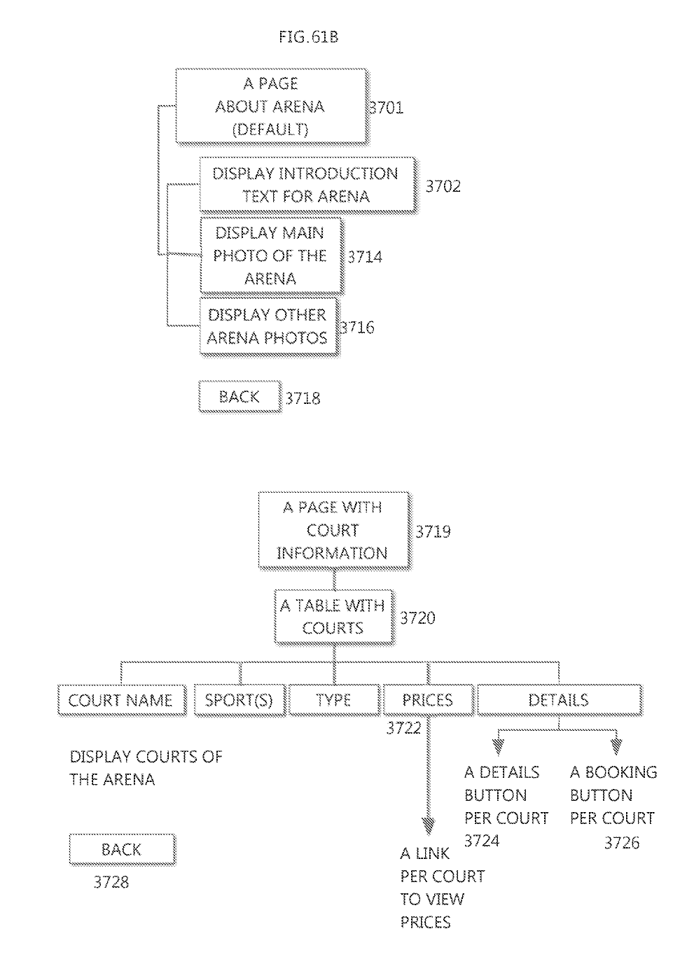

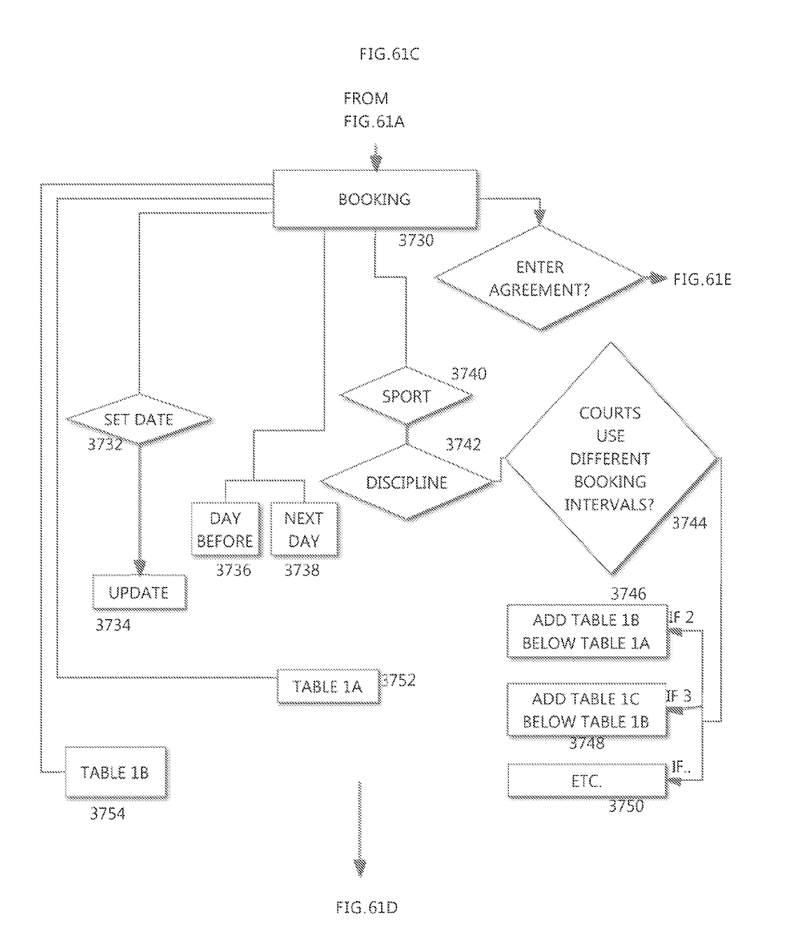

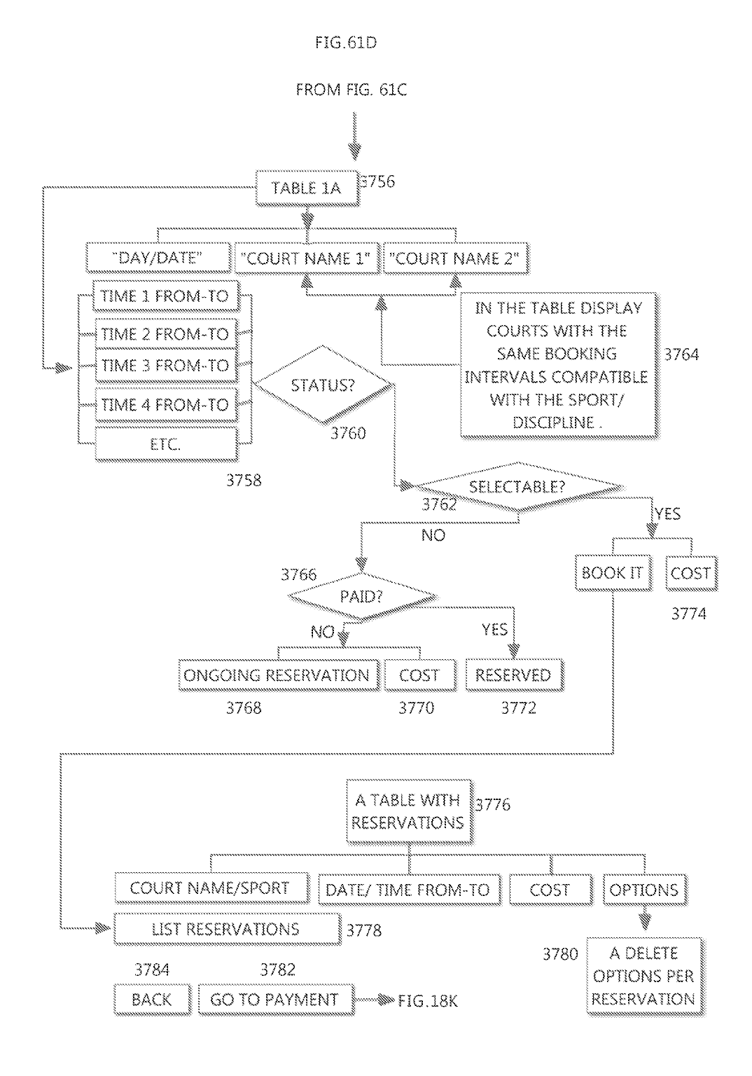

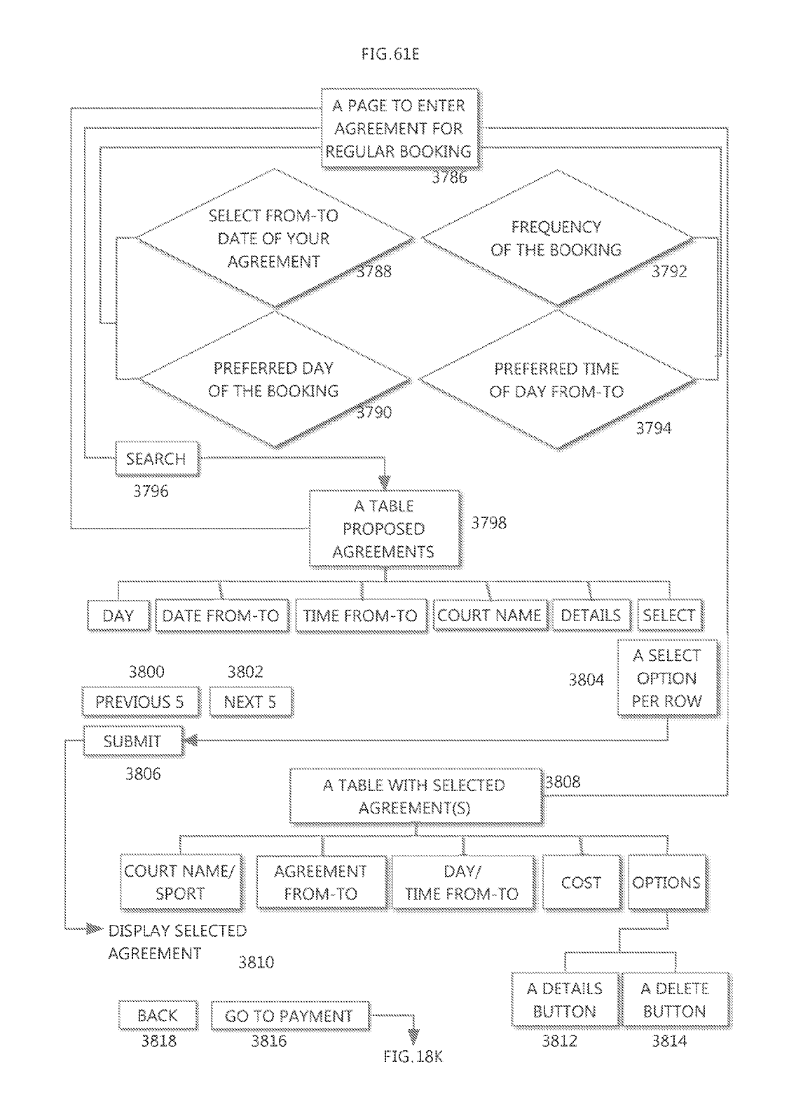

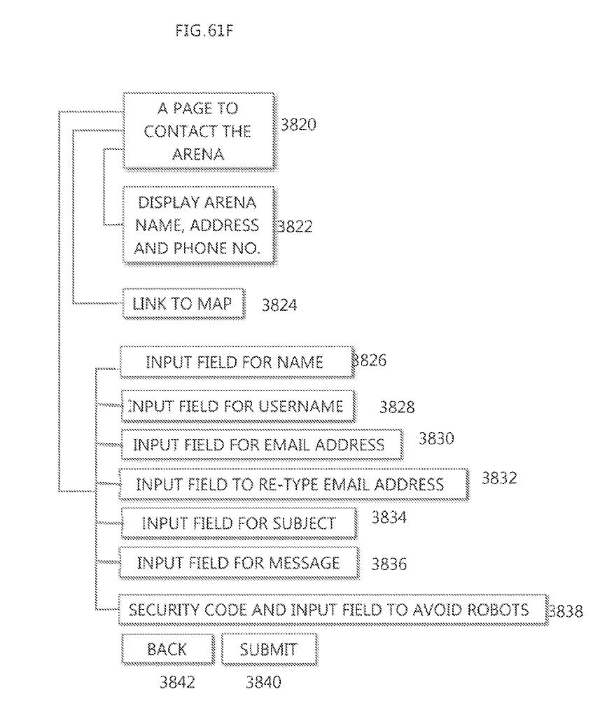

If the arena's courts do not use court booking 1962 and the tournament director is not court manager the menu 1658 will contain about arena 1969, courts 1970, request an offer 1971 and contact arena 1972. Selecting request an offer 1971 the tournament director will enter a page illustrated in FIG. 18L to request an offer on courts for the tournament from the arena. Selecting courts 1970 leads to a page 3719 illustrated in FIG. 61B.

If the arena's courts do not use court booking 1962 and the tournament director is court manager of the selected arena then the menu 1973 will have the options About arena, courts 1974 and contact arena/location. Selecting courts 1974 will take the tournament director to a page 1974 illustrated in FIG. 18G/18H.

If the selected arena uses online booking on all its' courts 1965 then the menu will look the same for a tournament director being and not being court manager 1964. The options in the menu 1975 is then About arena, courts 1977, booking 1976 and contact arena/location. Selecting booking 1976 will take the tournament director to a page illustrated in FIG. 18i/18J/18K. Selecting courts 1977 will lead a page with court information 3719 as described in FIG. 61B.

If the arena uses online booking on only some of its courts 1978 and the tournament director is not court manager then the menu 1979 will contain the options About arena, courts 1980, booking 1982, request an offer 1983 and contact arena/location. Booking 1982 leads to a page illustrated in FIG. 18i/18J/18K and request an offer 1983 to a page illustrated in FIG. 18L.

If the arena uses online booking on only some of its courts 1978 and the tournament director is court manager then the menu 1984 will contain the options about arena, courts 1985, booking 1986 and contact arena/location. Selecting courts 1985 will lead to a page illustrated in FIG. 18G/18H and booking 1986 to a page illustrated in FIG. 18i/18J/18K.

Common for the five sections above is that selecting the about arena option 1969 will always lead to a page 3701 illustrated in FIG. 61B and contact arena/location to a page illustrated in FIG X.

When the tournament director enters FIG. 18G/18H show time and place for those matches already having a court in table 2000 of FIG. 18H. FIG. 18G is an illustration of the upper half of a page where a tournament director is court manager of the selected arena, and the tournament director wants to use courts for the tournament not offering online booking. The page consists of a table 1992 with courts by the arena not offering online booking. In FIG. 18H is an illustration of the lower half of the same page. It contains a second table 2000 with the columns [match round], [minimum required time/recommended time per match (in min)], [date], [time from], [time to], [place], [set] and [delete]. The tournament director will first select a match in table 2000 in FIG. 18H and then select what court to use for the match in table 1 in FIG. 18G. The selected court will be added 2029 by the selected match in the table 2000 with an option to select date in the date column, an input field to set time from in the time from column and an input field to set time to in the time to column. The times set in FIG. 18G/18H will be submitted 2020 to table 1858 in FIG. 18A.

FIG. 18i is an illustration of the upper half of a page when the tournament director selects the booking link in the menu of the arena as illustrated in menu 1975 in FIG. 18E, and in menu 1979 and menu 1984 in FIG. 18F. The page contains a table 2044 (table 1A) with the columns [booking intervals], [court name 1], [court name 2] etc. and a field to update the date of interest. If the arena has different booking intervals for its courts 2036 then table 2038, table 2040 etc. will be added below table 2044. FIG. 18J is an illustration of the lower part of the same page. It contains a table 2070 with the columns [match round], [minimum required time/recommended time per match (in min)], [date], [time from], [time to], [place], [select] and [delete]. If there are matches in the tournament where time and place already have been set then show the data in table 2070 so the tournament director is easily reminded on what matches that still need a court. Having selected a match in table 2070 of FIG. 18J the tournament director can select Book it 2054 in table 2044 of FIG. 18i to reserve the time and court for the match. As illustrated in FIG. 18J the time and place is then added to the selected match 2072. In table 2044 in FIG. 18i the booked time changes status to ongoing reservation 2060. When bookings have been made the tournament director can go to the payment page 2086, a page illustrated in FIG. 18K.

If selecting the autofill option 2066 in FIG. 18i a search for available times will be done based on date and time set in the tournament plan, and based on minimum required time and the recommended time set per match. Vacant times will be set in matches not having a time.

FIG. 18K illustrates the payment page and it contains a menu to select payment method 2094 and a table 2096 with the columns product, description and prize showing the reservations made by the tournament director. Below the table is invoice details 2106 with fields for name on community, address etc. If payment is accepted the booked times changes status in the booking tables from ongoing reservation to reserved 2064. If a tournament director selects an arena, not being court manager of that arena, that only uses online court booking for some of its' courts (or none) the request an offer option may be selected in the arena menu as illustrated in FIG. 18E/FIG. 18F. When selecting request an offer the tournament director will be asked to edit the tournament plan 2130, since to request an offer takes more time than booking courts directly online. Selecting no the tournament director will enter a page as illustrated in FIG. 18M to set details in the request. Selecting yes the tournament director will proceed directly to FIG. 17A/FIG. 17B to change the tournament plan and then proceed to FIG. 18M.

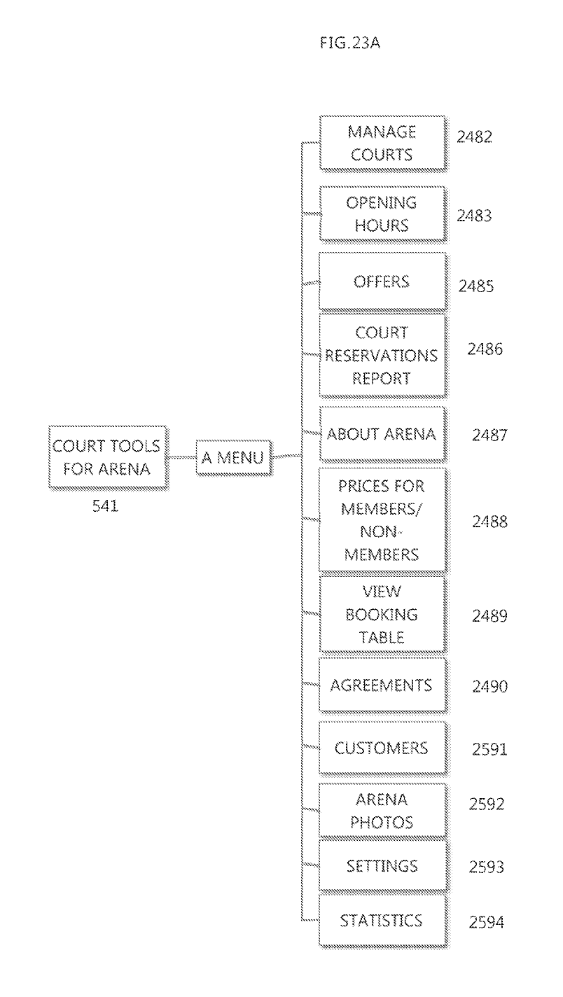

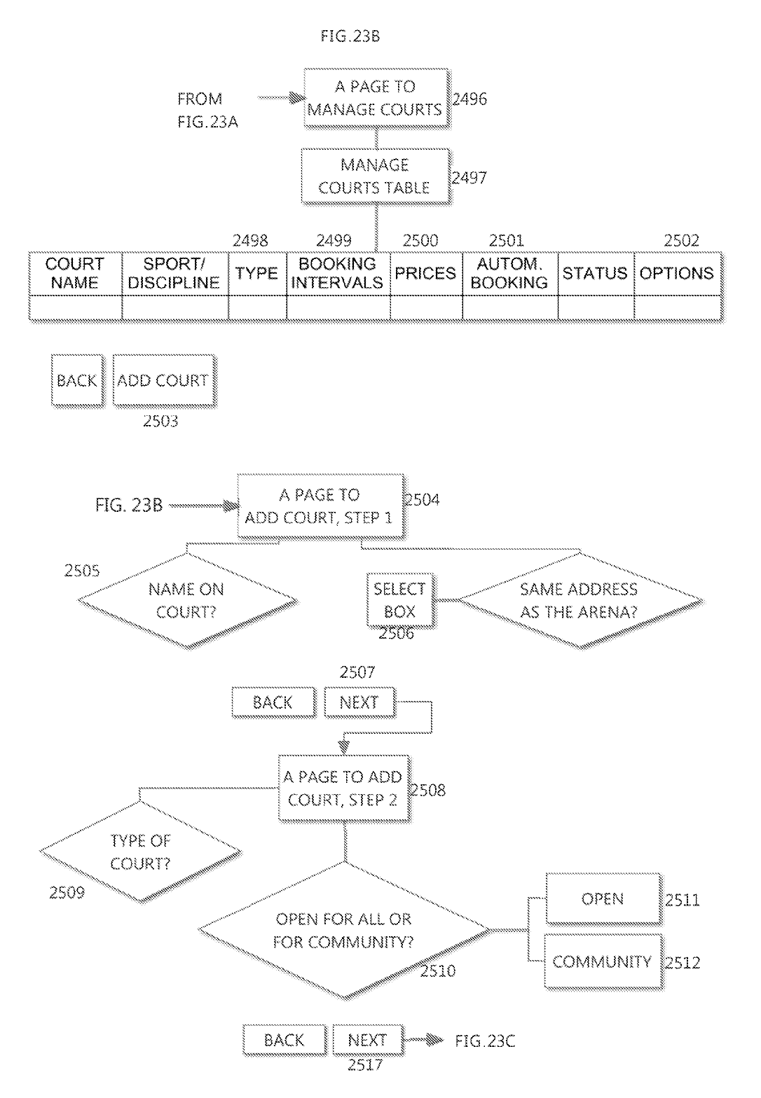

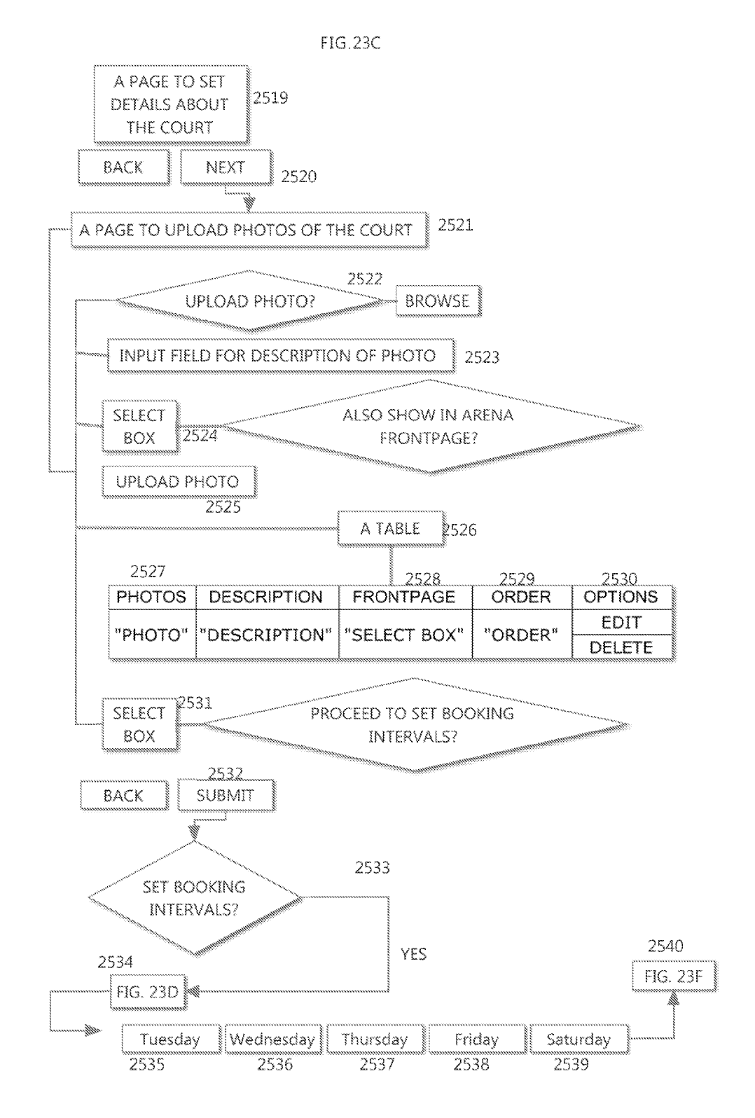

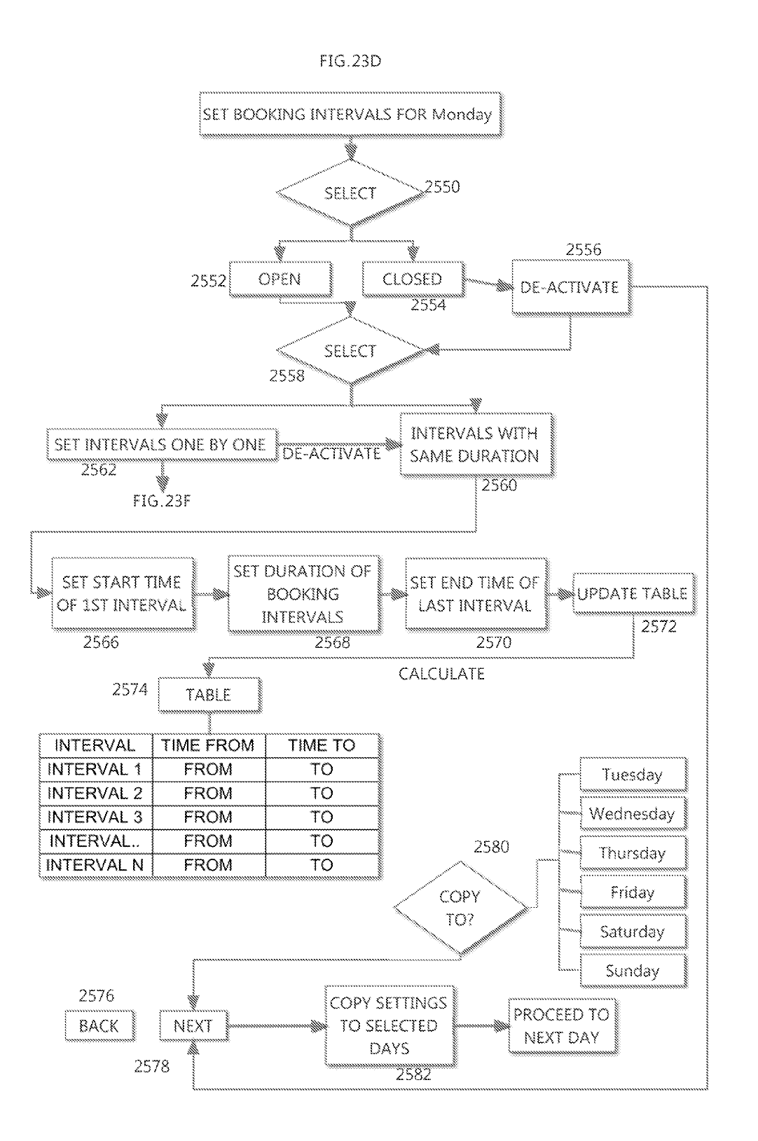

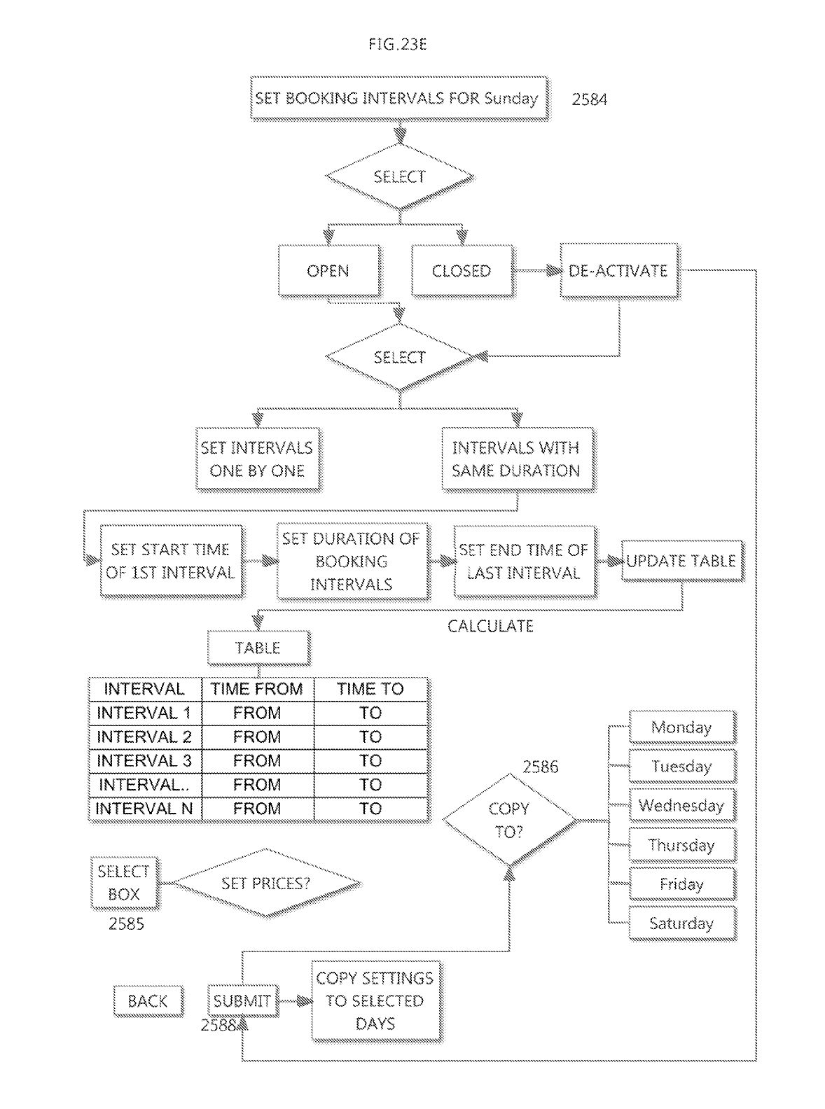

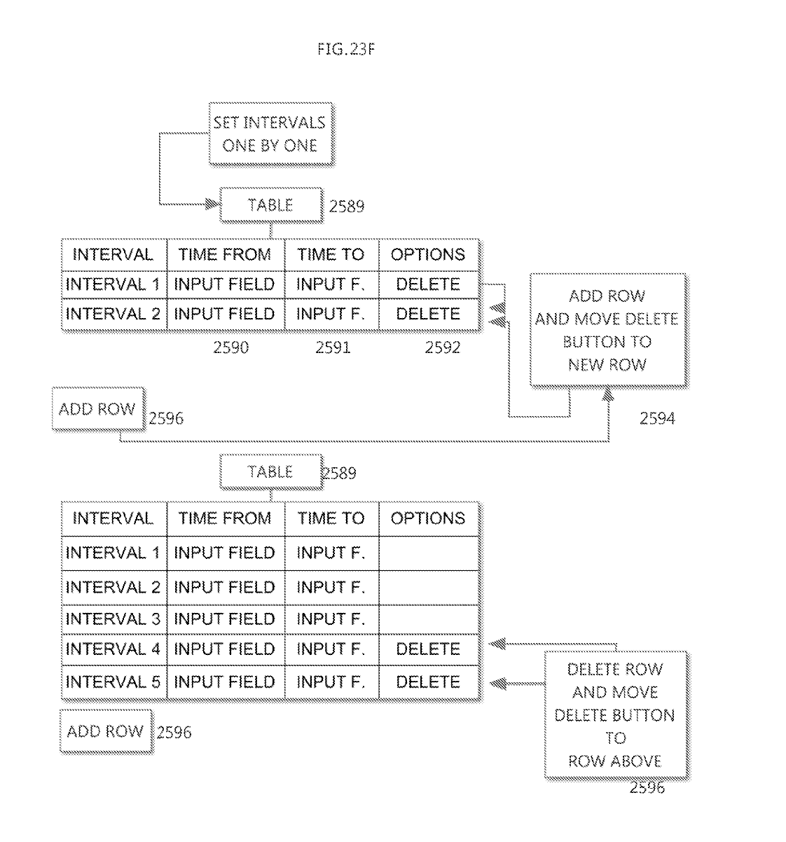

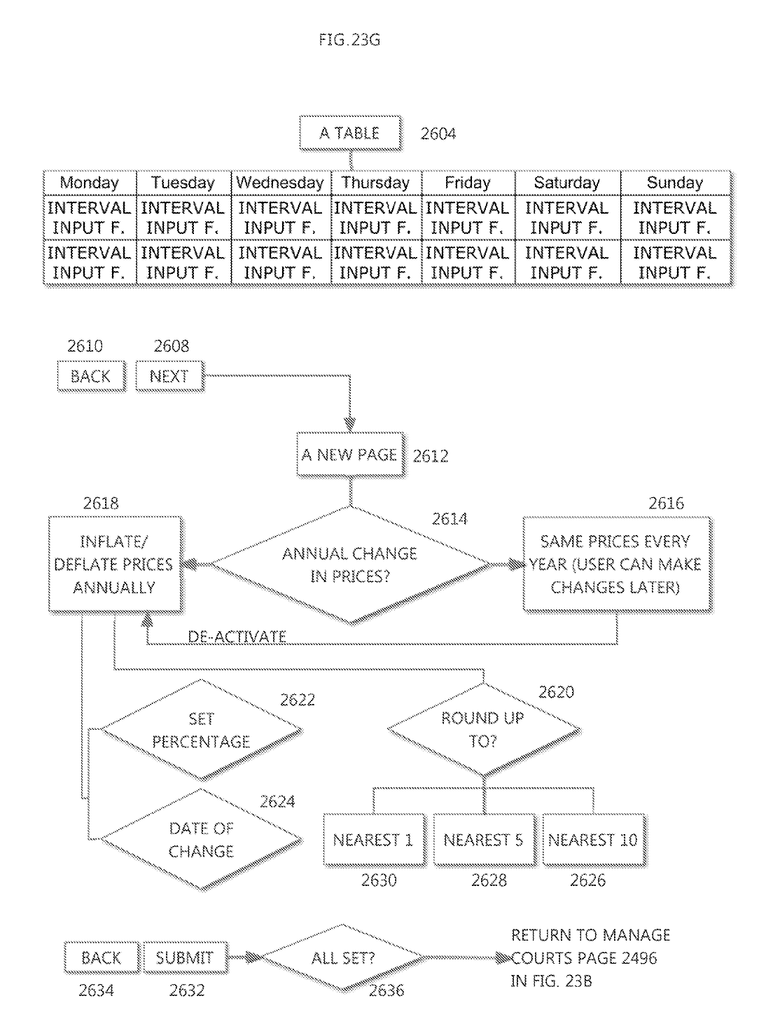

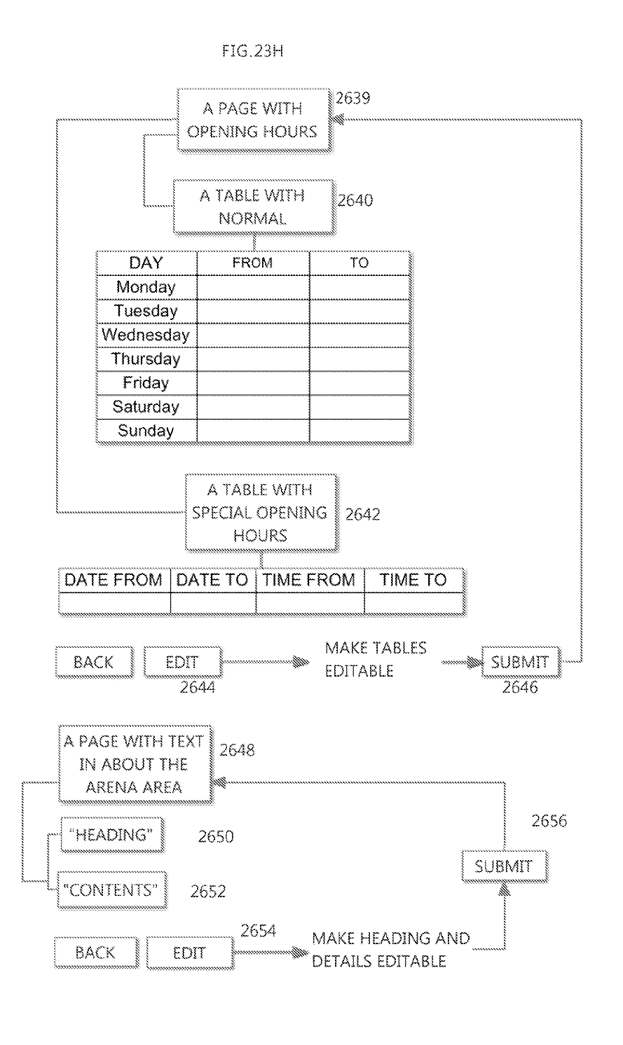

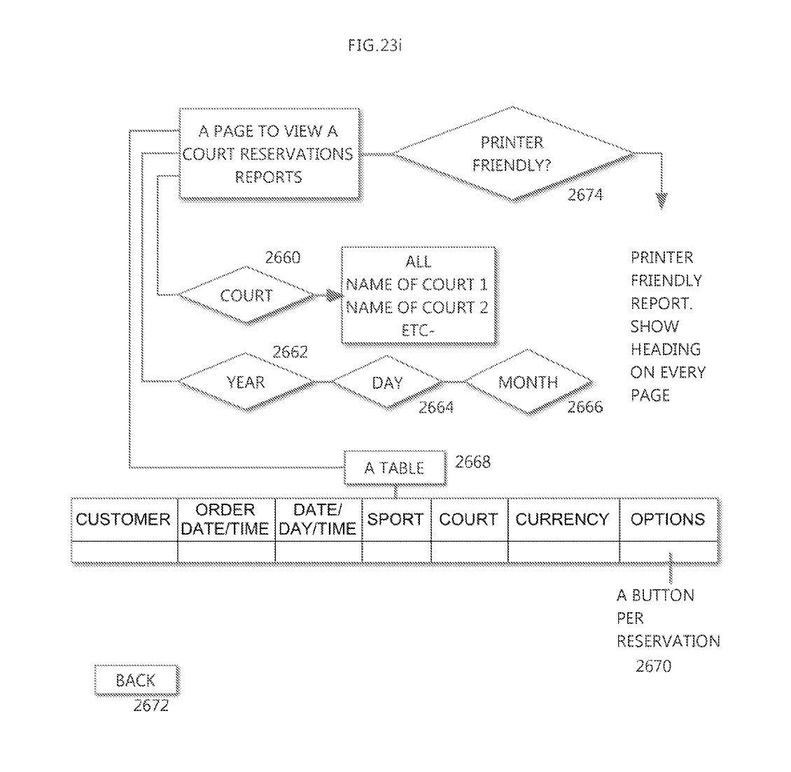

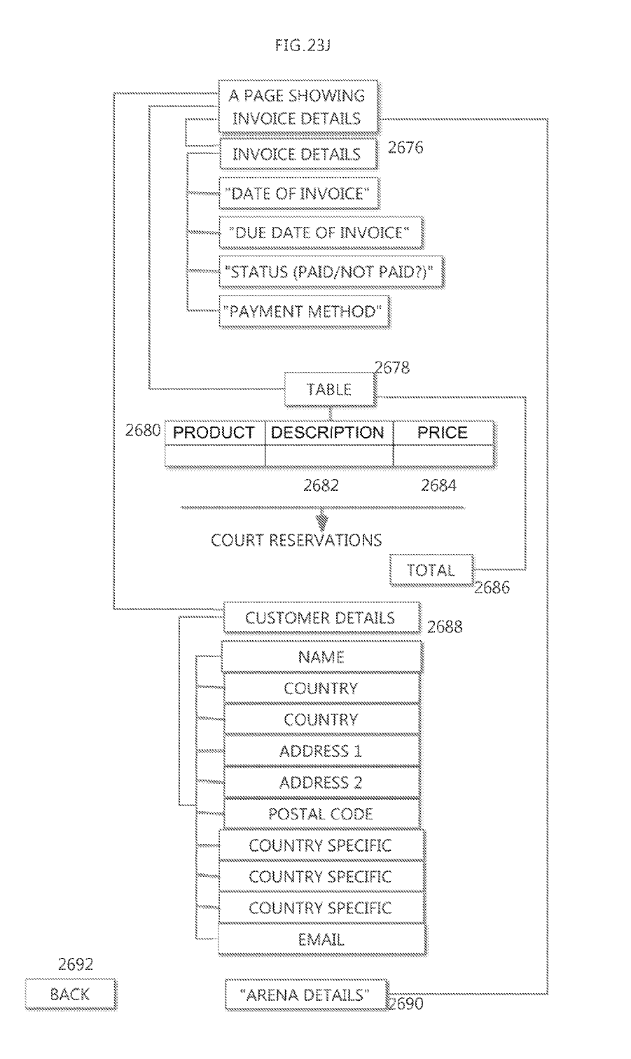

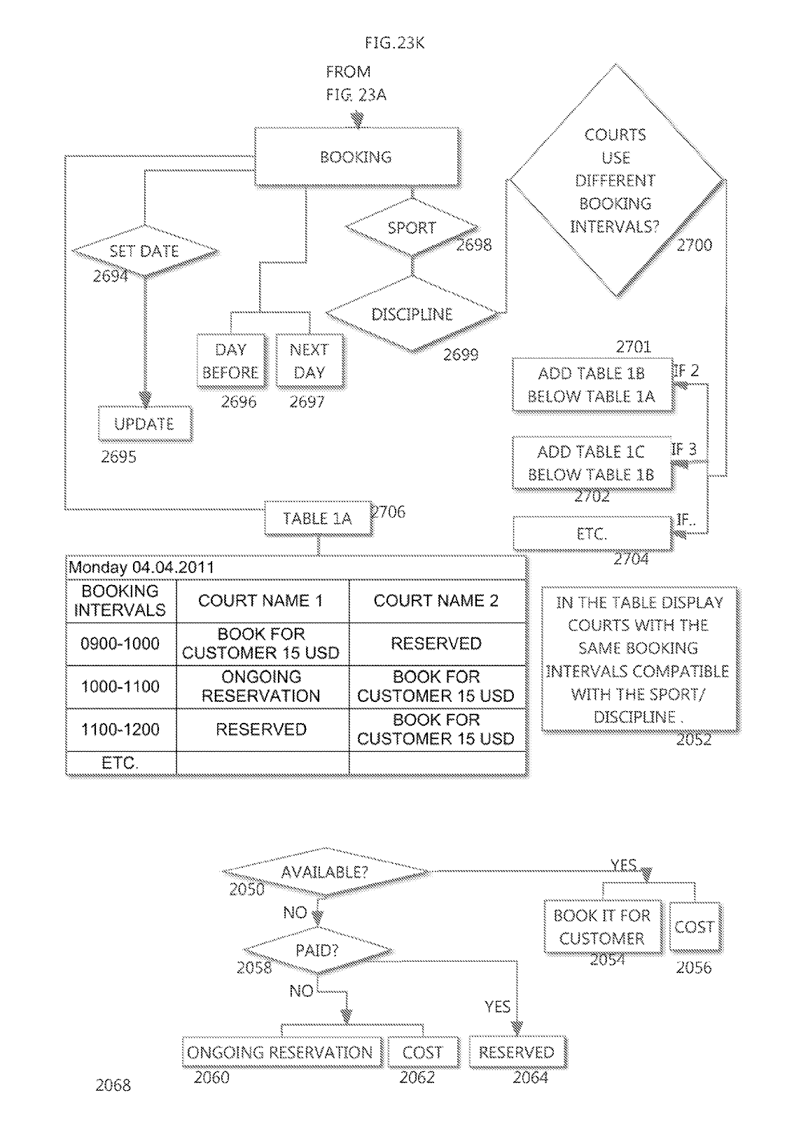

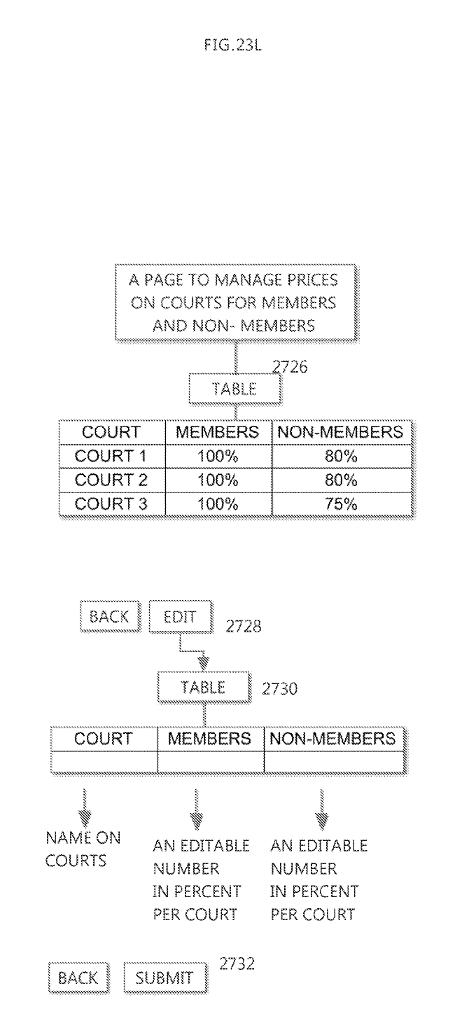

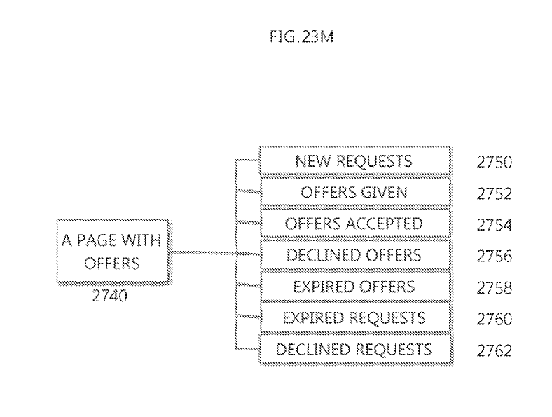

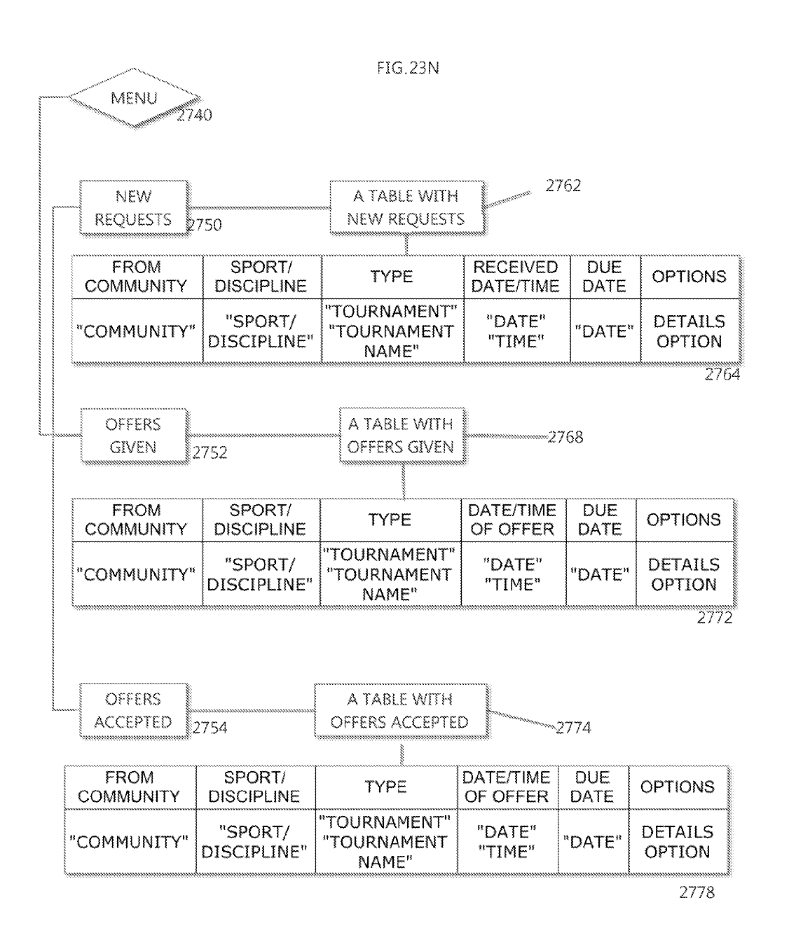

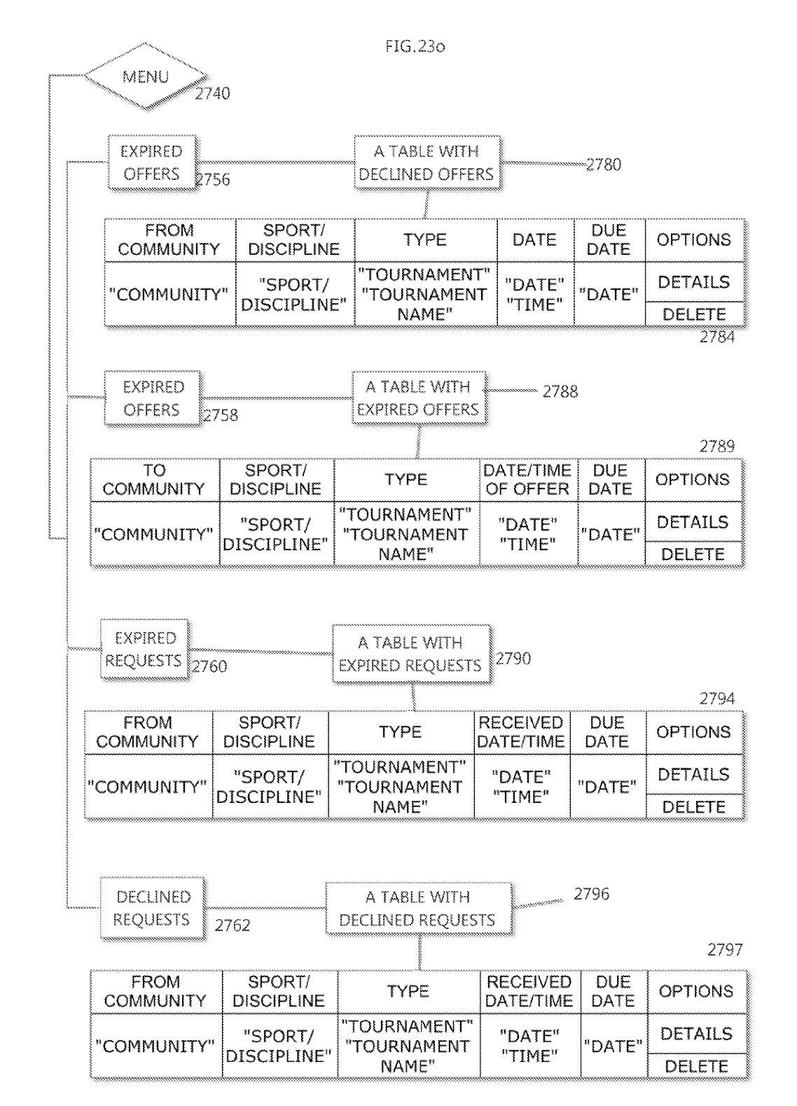

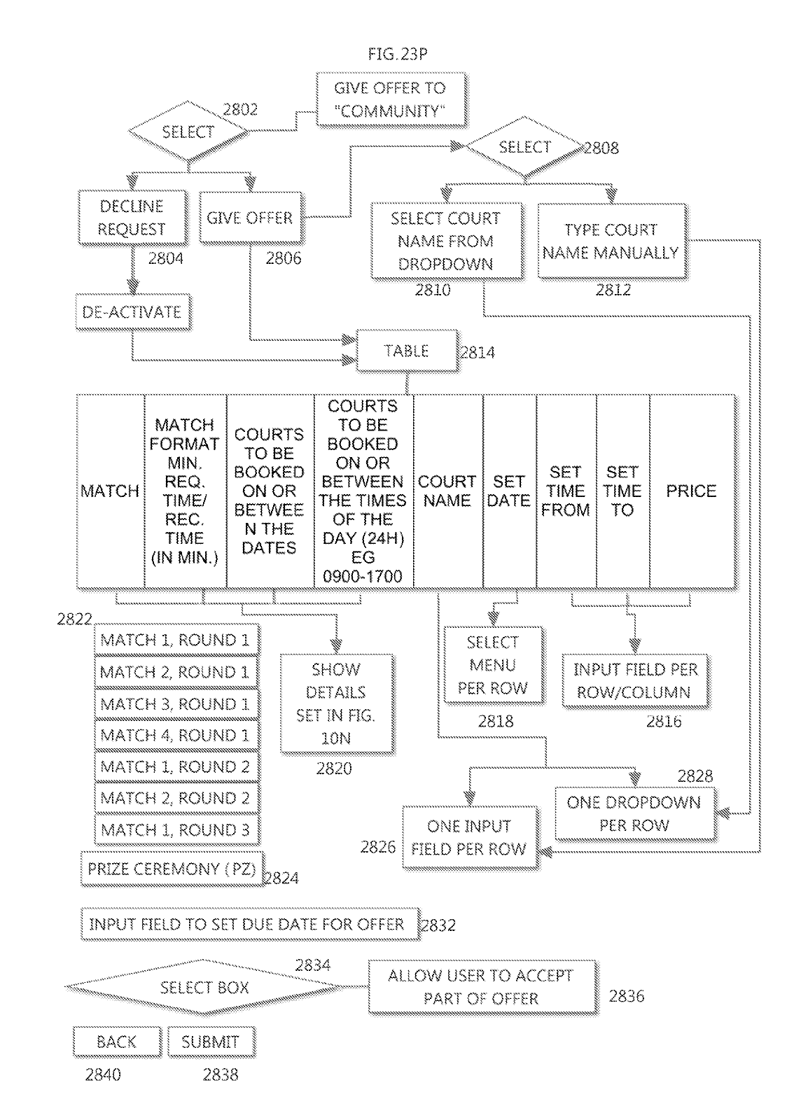

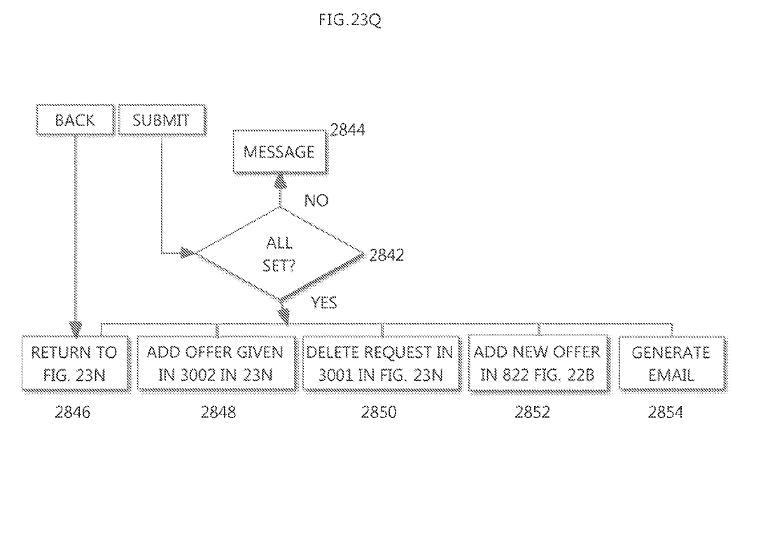

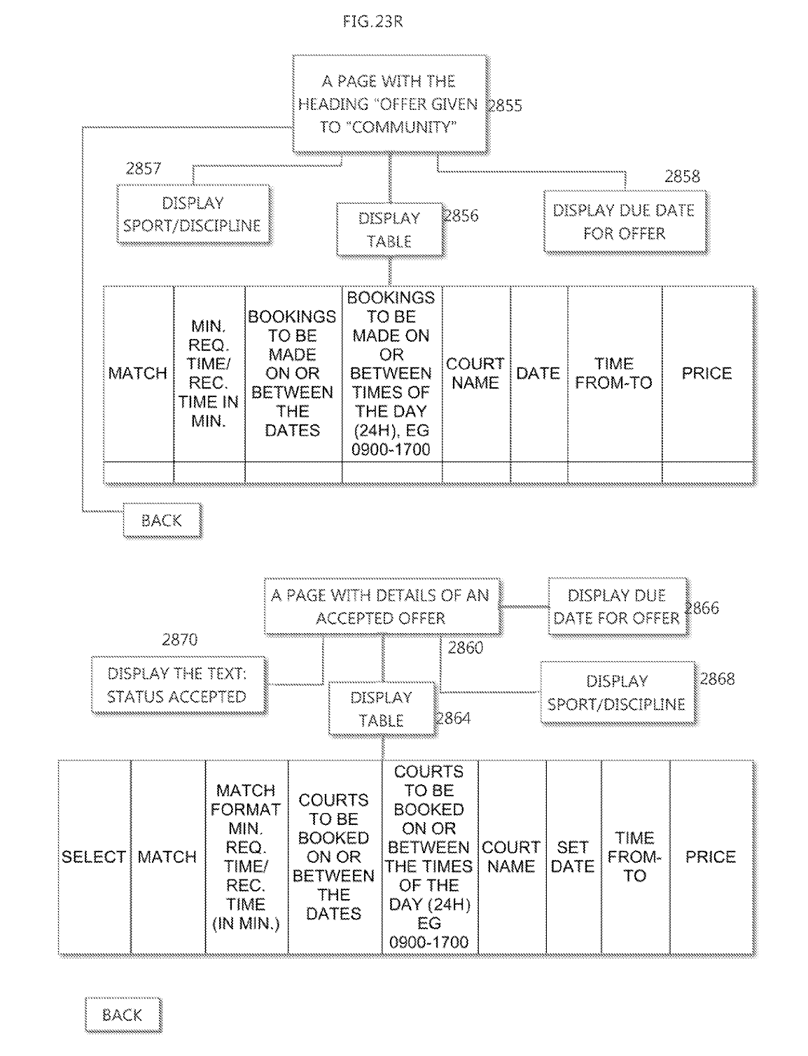

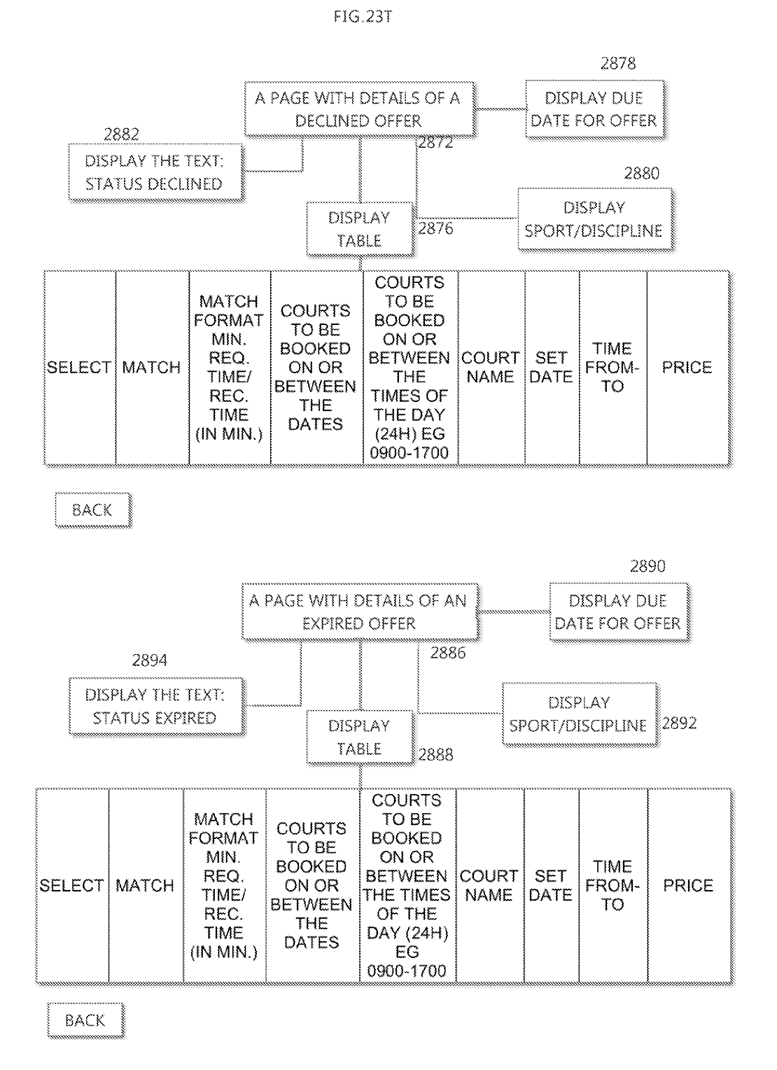

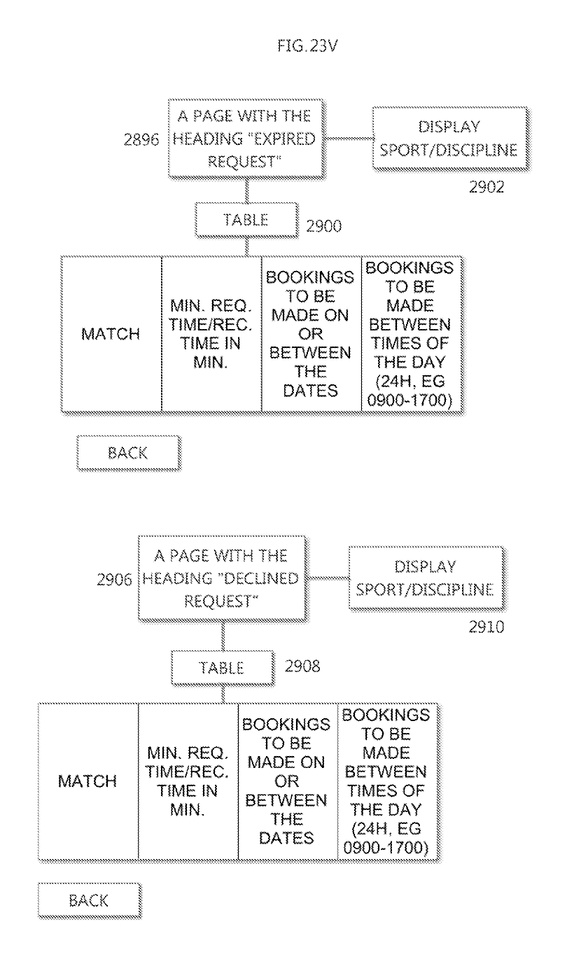

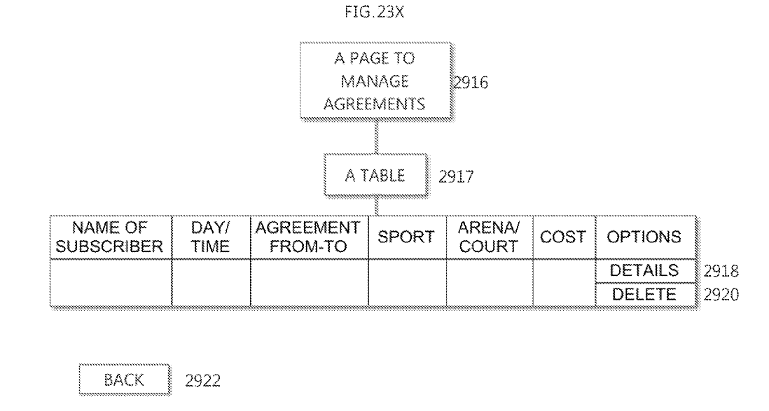

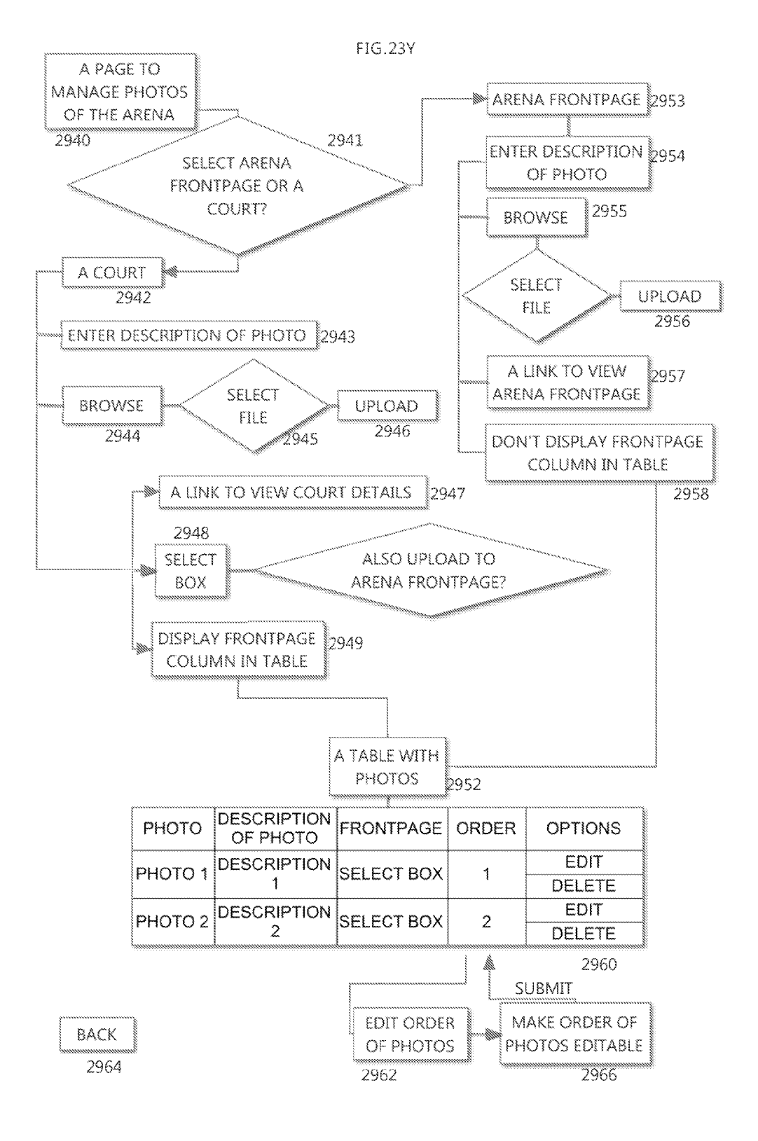

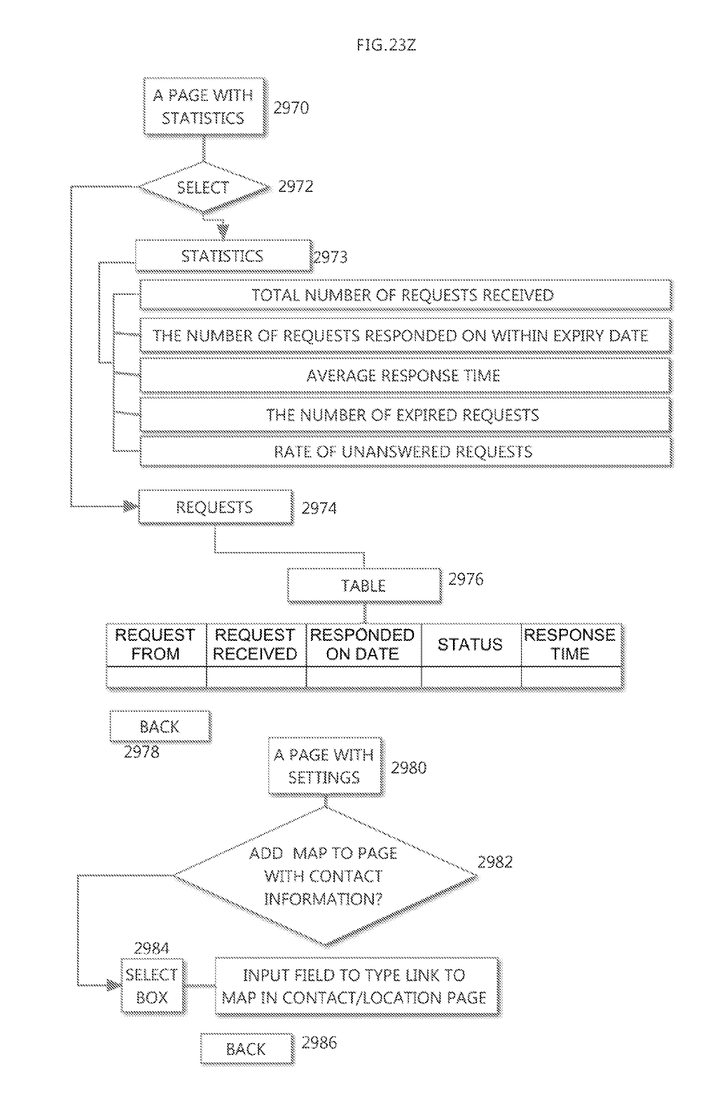

FIG. 18M contains options to set details in a request to be sent to the selected arena and a table 2148 with columns [Match] 2152, [match format, minimum required time per match/recommended time per match] 2154, [bookings to be made on or between the dates] 2156 and [bookings to be made on or between the times of the day] 2158. If selecting the option set time/date for tournament 2142 input fields will be added in column 2156 and 2158 to set date a common from and to date, and from time to time for the tournament. Default values in the date from—date to fields are values from the tournament plan. When a request has been submitted 1264 a message will be generated to the arena 2166, the details of the request sent will be added in the community's table of requests sent 2332 in FIG. 22B and in the arena's table of new requests 2750 in FIG. 23N.

If the tournament director selects specify date/time per round 2144 then table 2148 will change so that the tournament director can specify date/time per round as illustrated in FIG. 18N. If the tournament director selected specify date/time per match 2146 then table 2148 will change so that the tournament director can specify date/time per match as illustrated in FIG. 180.

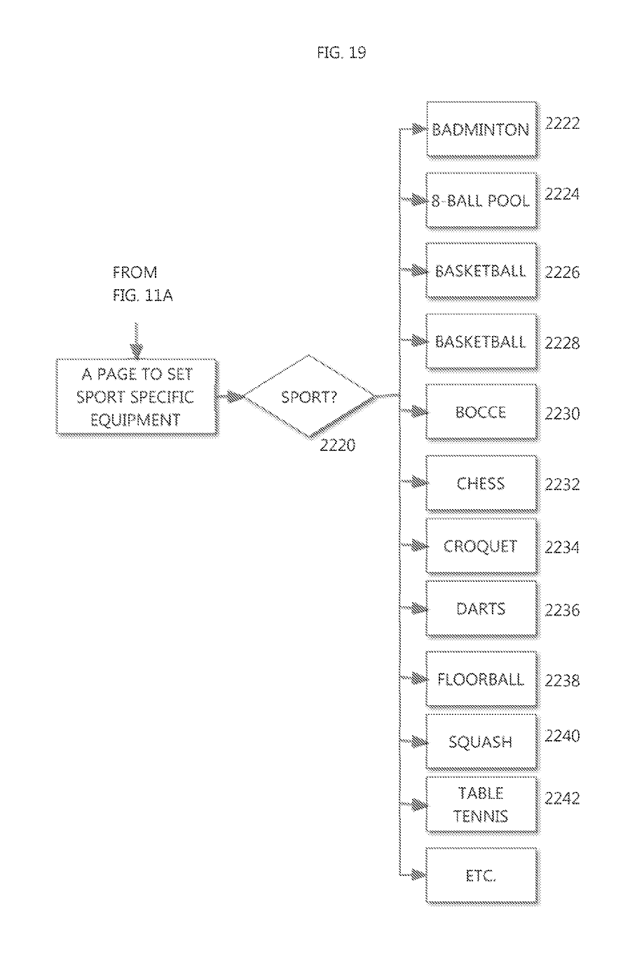

Selecting set by step 8, a page to set sport specific equipment for the sport and discipline 1502 the tournament director will proceed to a page about equipment for the tournament. Contents in the page will vary from sport to sport as illustrated in FIG. 19. Below are some examples for how an equipment page can look like.

For 8-ball pool a menu for cues can consist of [players must bring their own cues], [the tournament director will provide players with cues], and [players will use cues belonging to the court]. A menu for chalk can consist of the options [Players shall bring their own chalk], [The tournament director shall provide players with chalk at the matches] and [Players shall use chalk provided by the court]. An input field in the page can also allow the tournament director to provide users with additional information about equipment.

For Bocce a menu for balls can consist of the options [The tournament director will provide the players with balls at each match] and [The players will use balls provided by the court]. An input field in the page can also allow the tournament director to provide users with additional information about equipment.

For chess a menu for chess board/pieces can consist of the options [The tournament director will provide the players with chess boards/pieces/chess clock at each match] and [The players will use chess board/pieces/chess clock provided by the arena]. An input field in the page can also allow the tournament director to provide users with additional information about equipment.

For croquet a meny with mallets/balls can consist of the options [Tournament director will provide the players with mallets and balls at each match] and [Players will use mallets and balls provided at the court]. An input field in the page can also allow the tournament director to provide users with additional information about equipment.

For darts a menu with darts can consist of the options [Players must bring their own darts for the matches], [Tournament director will provide players with darts and dartboards for the matches] and [Players will use the court's darts and dart board]. An input field in the page can also allow the tournament director to provide users with additional information about equipment.

For badminton a menu with rackets can consist of the options [Players must bring their own rackets], [The tournament director will provide players with rackets] and [Players will use rackets provided by the court]. A menu for shuttle can consist of the options [Players must bring 2 shuttles each], [The tournament director will provide players with shuttles at each match] and [players will use shuttles provided by the court]. A menu for shuttle skirt can consist of [Feather], [Nylon], [Plastic] and [No specific]. A menu for shuttle base can consist of [Cork], [Eva foam], [Plastic] and [No specific]. A menu for shuttle pace can consist of a table with different options for shuttle pace by different measures like Int., metric and wt. grain. Some options in the table can be [No specific], [Slow, for use in highland], [Medium slow, for use in hotter area], [Medium, most sea level areas], [Medium fast, cold area] and [Fast, cold area, below sea level]. The page can also contain (a link to) information about the standard for shuttle pace used in different countries, and an input field in the page can also allow the tournament director to provide users with additional information about equipment.

For squash a menu with rackets can consist of the options [Players must bring their own rackets] and [The tournament director will provide players with rackets]. A menu for balls can consist of the options [Players must bring 1 ball each], [The tournament director will provide players with balls at each match] and [Players will use balls belonging to the court]. A menu for pace of ball will consist of the options [Red], [Yellow] and [Green/Blue]. An input field in the page can also allow the tournament director to provide users with additional information about equipment.

For table tennis a menu with rackets can consist of [Players must bring their own rackets], [The tournament director will provide players with rackets] and [Players will use rackets belonging to the court]. A menu for balls can consist of [Players must bring 4 balls each], [The tournament director will provide players with balls at each match] and [Players will use balls belonging to the court]. A menu for ball type can consist of [0 star ball], [1 star ball], [2 star ball], [3 star ball], [3 star premium ball] and [No specific type]. There can also be a menu for color on the ball and an input field in the page can also allow the tournament director to provide users with additional information about equipment.

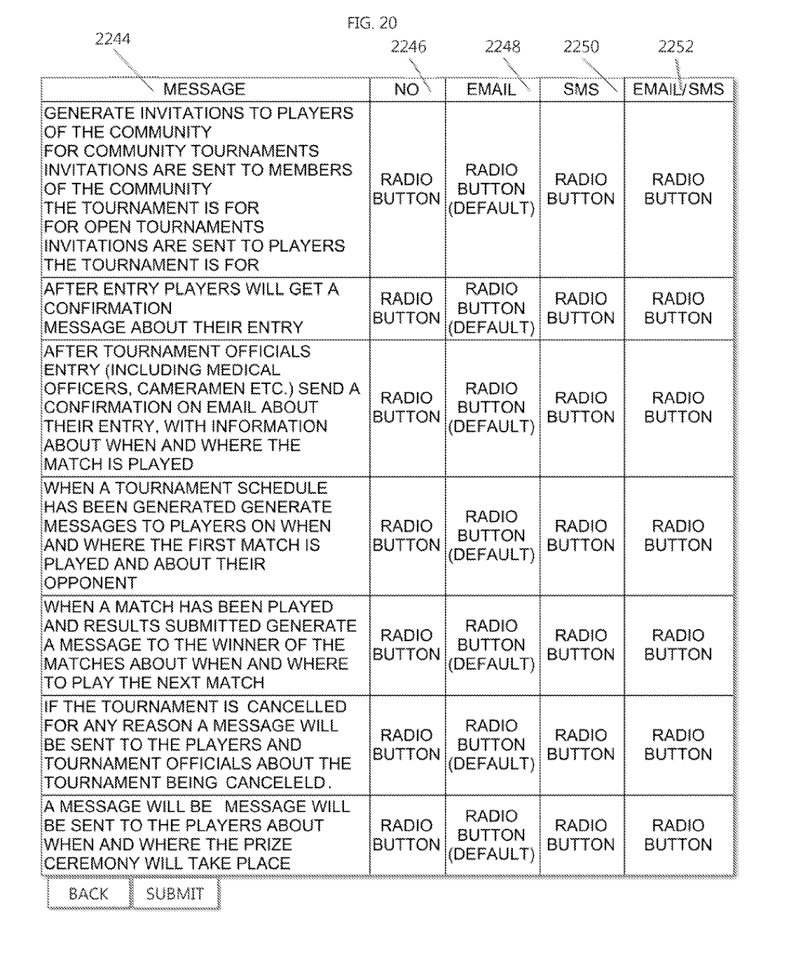

Selecting set messages 1504 in step 9 the tournament director will proceed to a page illustrated in FIG. 20. The page contains a table with the columns [message] 2244, [no message] 2246, [email] 2248, [sms] 2250 and [email/sms] 2252. As illustrated in the table the tournament director can do different settings for messages to be generated throughout a tournament.

When selecting the set option 1506 in step 10 the tournament director will proceed to a page as depicted in FIG. 21 showing different income, costs and result for the tournament.

FIG. 22A illustrates a page with a menu 2291 with the options reservations 2292, agreements 2293 and archive 2294. A user will enter this page when selecting Private reservations 536 in FIG. 5D. FIG. 22A also illustrates a page with with a menu 2296 with the options Reservations 2292, agreements 2293, requests sent 2299, new offers 2300, offers accepted 2301, offers declined 2302, expired offers 2303, expired requests 2304, declined requests 2305 and archive 2294.

When selecting reservations 2292 in FIG. 22A the user will proceed to a page with a table of reservations 2308 illustrated in FIG. 22B. The table can contain columns such as [day], [date], [time from-to], [sport], [arena name/court name] 2309, [payment due] and [options]. In FIG. 22A it is illustrated that the page looks the same when proceeding to the page from private reservations 536 as when proceeding to the page from Community reservations 537. The difference is that reservations 2292 in the menu for private reservations 2291 depicts private reservations made by a user, while reservations 2292 in the menu for a community 2296 depicts reservations made by the community. Each reservation will be added in table 2308 with a link to the arena main page FIG. 61B by the arena name and a link to court details by the court name Paid reservations are marked with the text paid while reservations not paid are marked with the due date of the payment (in the payment column).

When selecting the agreements option 2293 the menu 2291 in private reservations or in the menu 2296 reservations by community the user will proceed to a page with a table 2312 as illustrated in FIG. 22B with columns such as [day/time from-to], [agreement from-to], [sport], [Arena, court], [cost] and [options]. If a user, either privately or on behalf of a community, wants frequent booking at the arena, eg. every Monday from 1400-1500 in 2012 then such an agreement is saved in table 2312. Each agreement will have a details and delete option and selecting the details option the user will proceed to a page with a table 2313 with all reservations under the agreement with columns such as [day], [date], [time from-to], [sports], [arena/court], [cost], [invoice date] and [invoice due date]. All reservations under an agreement will be listed in the table with reservations 2308. Selecting the delete option all unpaid reservations under the agreement will be deleted.

When selecting archive 2294, either in the menu 2291 for private reservations or in the menu 2296 for a community the user will proceed to a page with a table 2315 with columns such as [day], [date], [time from-to], [sport], [arena, court], [status] and options. The details option 2316 is a link to the receipt of the reservation.

When selecting the request sent option 2299 in the menu of 2296 of a community in FIG. 22A the user will enter a page with a table 2320 in FIG. 22C with columns such as [to arena], [sport/discipline], [type], [date/time sent], [due date] and [options]. When a tournament director requests an offer from arena on courts for a tournament, in FIG. 18M-FIG. 18o, then details of the request sent is added in the table 2320 of requests sent. For each request sent there will be a details option 2324 and a delete option 2326. The details option will lead to a page illustrated in FIG. 22E.

When selecting new offers 2300 in the menu 2296 of a community in FIG. 22A the user will proceed to a page with a table 2328 with columns such as [from arena], [sport, discipline], [type], [received on date/time], [due date] and [options]. Offers added in the table will have a details option 2329 that leads to details of the offer illustrated in FIG. 22F.

When selecting offers accepted 2301 in FIG. 22A the tournament director will proceed to a page with a table 2330 with columns such as [from arena], [sport, discipline], [type], [date/time accepted] and [Options]. Every offer accepted will have a details option 2331 and a delete link 2332. The details option leads to a page illustrated in FIG. 22H.

When selecting offers declined 2302 in FIG. 22C the tournament director proceeds to a page with a table 2334 as illustrated in FIG. 22C, with columns such as [From arena], [Sport/discipline], [Type], [date/time declined] and [options]. Every declined offer has a details option 2335 and delete option 2336. The details option leads to a page with details about the declined offer as depicted in FIG. 22H.

Selecting expired offers 2303 in FIG. 22A the tournament director will enter a page with a table 2338 as depicted in FIG. 22D with columns such as [From arena], [Sport/discipline], [Type], [offer due date/time] and [options]. Every expired offer will have a details option 2340 and delete option 2342. The details option is link to a page depicted in FIG. 22H.

Selecting expired requests 2304 in FIG. 22A the tournament director will enter a page with a table 2344 as depicted in FIG. 22D with the columns [Arena], [Sport/Discipline], [Type], [request due date/time] and [Details]. Every expired request has a details option 2346 and a delete option 2348. The details option is link to a page illustrated in FIG. 22K.

Selecting declined requests 2305 in FIG. 22A the tournament director will enter a page with a table 2350 as depicted in FIG. 22D with the columns [Arena], [Sport/Discipline], [Type], [Request due date/time] and [Details]. Every declined request has a details option 2352 and a delete option 2354. The details option is link to a page illustrated in FIG. 22K.

FIG. 22E is a page with details of a request sent. It contains a table 2356 with columns such as [match], [match format/minimum required time/recommended time (in minutes)], [bookings to be made on or between the dates] and [bookings to be made on or between times of the day (24H, eg 0900-1700)].Every request sent has a details option 2324 and a delete option 2326. The details option leads to a page illustrated in FIG. 22E.

FIG. 22F is how a page with an offer from an arena can look like. The page will contain details with the offer given by an Arena in FIG. 23P. Details can be due date for offer 2382, sport/discipline 2384, a table 2386 with the columns [select], [match], [minimum required time/recommended time (in minutes)], [bookings to be made on or between the dates] and [bookings to be made on or between times of the day (24H, eg 0900-1700)], [court name], [date], [time from-to] and [price]. If the setting in FIG. 23P was to allow the community to accept only part of the offer a select box can be shown per match in the tournament. The select column will not show if the setting was user must accept all or decline.

FIG. 22H is a page that depicts details of an accepted, declined or expired offer. The page can contain such information as due date for an offer 2434, that the offer is accepted 2440, declined 2441 or expired 2442, the sport/disicipline 2436 and a table 2432 with columns such as [select], [match], [minimum required time/recommended time (in minutes)], [bookings to be made on or between the dates] and [bookings to be made on or between times of the day (24H, eg 0900-1700)], [court name], [date], [time from-to] and [price]. The table will contain data submitted in FIG. 22F.

FIG. 22K depicts a page with details of a declined request. It contains information such as sport/discipline 2468, a table 2466 with columns such as [match], [minimum required time/recommended time (in minutes)], [bookings to be made on or between the dates] and [bookings to be made on or between times of the day (24H, eg 0900-1700)]. The page contains details of a request sent in FIG. 18M-18o.

When a request is submitted by a tournament director in FIG. 18M-FIG. 18o it is added in the community's table of requests sent 2320 in FIG. 22C and in the Arena's table of new requests in table 2762 in FIG. 23N. A representative, a person that received an email with a link to a page within the solution to give an offer on courts to the tournament can click the link to enter a page as illustrated in FIG. 23P to give an offer to the community. When submitting the offer 23P the new request is deleted in the table of new requests 2762 in FIG. 23N and added in the table of offers given 2768. At the same time the offer will be added in the community's table of new offers 2328 in FIG. 22C. When entering the details option 2329 in table 2328 in FIG. 22C the tournament director will enter a page illustrated in FIG. 22F to accept or decline the offer.

If selecting accept, the offer will be deleted in the community's table of new offers 2328 and added to table 2330 in FIG. 22C for accepted offers. The court reservations in the offer will be added to the community's table of court reservations 2308 in FIG. 22B, and copied to the tournament the request was for in table 1932 in FIG. 18C. The offer will also be deleted in the table for offers given 2768 and added in table 2774 for offers accepted in FIG. 23N.

If selecting decline the offer will be deleted in the community's table of new offers 2328 and added to the table for declined offers 2334 in FIG. 22C. The offer will also be deleted in the Arena's table of offers given 2768 in FIG. 23N and added in the Arena's table of offers declined 2780.

If an offer expires it is deleted in the community's table of new offers 2328 in FIG. 22C and added in the community's table of expired offers 2338 in FIG. 22D. The offer is then also deleted in the Arena's table of offers given 2768 and added to the Arena's table with expired offers 3005.

If a request sent by a tournament director is declined by the arena it is deleted from the arena's table of new requests 2762 and added to the table of declined requests 2796 in FIG. 23o. It is also added in the community's table of declined requests 2350 in FIG. 22D.

If a request expires, meaning it is not answered within its due date, then delete the request from the arena's table of new requests 2762 in FIG. 23n and add the request in the arena's table of expired requests 2790 in FIG. 23o.

If selecting decline the offer will be removed from table 2328 and added to table 2334. If the offer is not responded on within the its due date the offer will be deleted in table 2328 and added in the table for expired offers 2338. When the offer is accepted the times in the offer will be added in the community's court reservations table 2308 and in table 1858 of FIG. 18A. If the new request is not answered within its expiry time/date then the new request in table 2750 will be deleted and added in the table 2790 of expired requests. When a request is expired it will be added in the community's table of expired requests 2344 in FIG. 22D and if the request is declined it is added in the table 2350 in FIG. 22D.

FIG. 23A depicts the options in the court tools menu 541 for a user. It contains manage courts 2482, opening hours 2483, arena info 2484, offers 2485, court reservations report 2486, about arena 2487, prices for members/non-members 2488, view booking table 2489, agreements 2490, customers 2591, arena photos 2592, settings 2593 and statistics 2594.

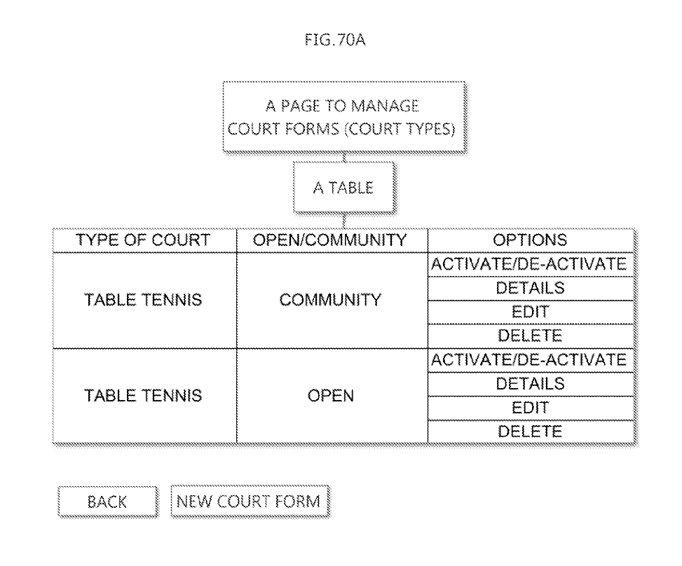

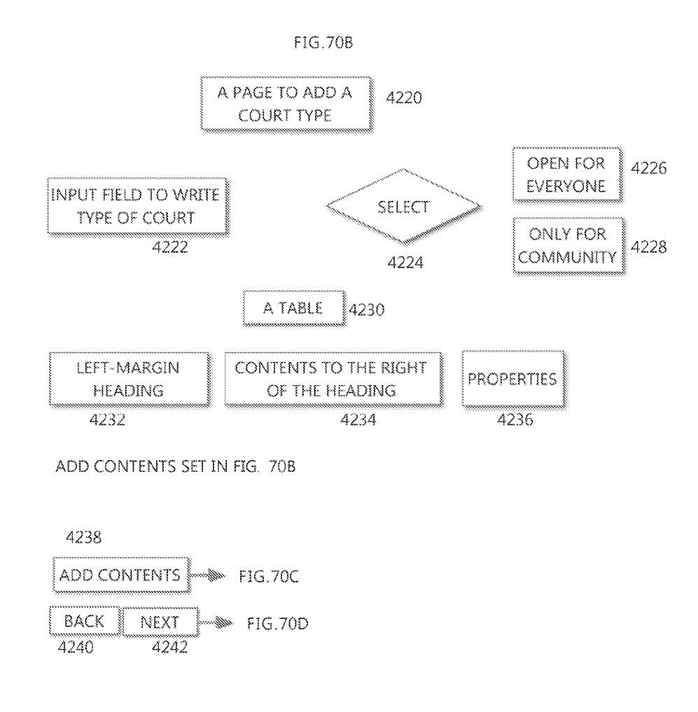

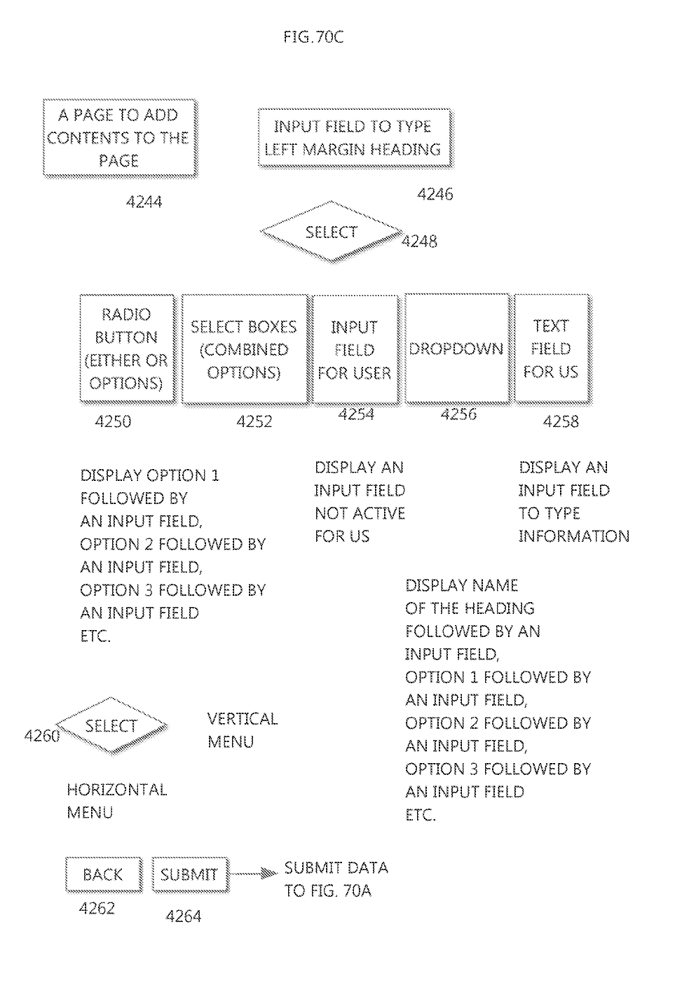

If selecting manage courts 2482 the user will proceed to a page illustrated in FIG. 23B with a table of courts 2497. Columns in the table can be court name, sport/discipline, type 2498, booking intervals 2499, prices 2500, automatic booking 2501, status and options 2502. Selecting the add court option 2503 the user will proceed to a page to add a court 2504, also illustrated in FIG. 23B, to a enter a name on the court and to select 2506 if the court has the same address as the arena . From step 1 the user will proceed to a new page, step 2, 2508 also illustrated in FIG. 23B to select type of court 2509 and if the court shall be open for all or only for members of a community. Options selectable in the type of court select menu 2509 are types of courts listed in FIG. 70A. Open courts comply with the rules of the sport and can be used both for open tournaments and for tournaments within a community. Both members and non-members can book times when automatic court booking is activated. Open courts must be approved by the admin of the solution before they are activated. A community court is only for the community and has no specific requirements. It can only be used for tournaments within a community and only members can book times when automatic court booking is activated.

From step 2 the user will proceed to a page to select/set court details 2519 as illustrated in FIG. 23C. From that page the user will proceed to a new page to upload photos of the court 2521 also illustrated in FIG. 23C. The page contains a table 2526 with columns such as photos 2527, decription, frontpage 2528, order 2529 and options 2530 and it allows the user to browse photos 2522, to describe the photo 2523, to select if the photo shall be shown in the arena frontpage 2524, to upload the photo 2525 and a select option 2531 to proceed to set booking intervals or not. To set booking intervals 2533 the user will proceed to a page to set booking intervals for Monday as illustrated in FIG. 23D.

FIG. 23D depicts a page with different options. To select 2550 if the court is open 2552 or closed 2554 for the day. If open the user can select 2558 to set intervals one by one 2562 or to set intervals with same duration 2560. If selecting set intervals with same duration 2560 the user must set start time of 1^{st} interval 2566, duration of booking intervals 2568 and end time of last interval 2570. Selecting the update table option 2572 will calculate the intervals and update the table 2574. The table contains the columns interval, time from and time to. When the user has set booking intervals for Monday, or having selected closed 2554, the user can select 2580 to copy the settings for Monday to other days of the week. When selecting Next 2578 the user will proceed to a similar page to set booking intervals for Tuesday. The process for setting booking intervals is illustrated from box 2534 to box 2540 in FIG. 23C. When the user enters the page to set booking intervals for Sunday 2584 in FIG. 23E there is also an option 2585 that allows the user to continue to set prices for the booking intervals. As for all days it also shows that the days to copy to 2586 are all the days of the week except for the day the user is setting intervals for.

If the user selects to set intervals one by one 2562 the options [set start time of 1^{st} interval] 2566, [set duration of booking intervals] 2568, [set end time of last interval] 2570, [update table] 2572 and the table 2574 is replaced with table 2589 and the add row option 2596 in FIG. 23F. Table 2589 consists of the columns interval, time from, time to and options.

When booking intervals for all days of the week have been set the user can proceed to set prices as illustrated in FIG. 23G. The page contains a table 2604 with the columns Monday, Tuesday, Wednesday, Thursday, Friday, Saturday and Sunday, where each day shows the intervals set for the day and an input field to set a price. Prices is set in the currency of the community set in FIG. 9P.

When prices have been set the user will proceed to a new page to select 2614 from the options [inflate/deflate prices annually] 2618 and [same prices every year (user can make changes later)] 2616. If selecting inflate price annually the user must also set a percentage 2622 and a date of change 2624. The user is then also given the options to round up to 2620 [nearest 1] 2630, [nearest 5] 2628 and [nearest 10] 2626. If the user selected same prices every year 2616 the fields to set percentage field 2622, date of change 2624, round up to 2620 are de-activated. The user can now submit all the information set about the court to table 2497 in FIG. 23B.

Selecting opening hours 2483 the user will proceed to a page with opening hours of the arena 2639 as illustrated in FIG. 23H. The page contains a table 2640 with the columns day, from and to. In the day column the days Monday, Tuesday, Wednesday, Thursday, Friday, Saturday and Sunday. In the same page another table with special opening hours (like holidays) with the columns date from, date to, time from and time to. By selecting the edit option 2644 the user can make the tables editable.

The offers option in FIG. 23A leads to a page.

The court reservations report 2486 leads to a page illustrated in FIG. 23i. The page contains a select menu 2660 for courts with the options [all], [name of court 1, type of court], [name of court 2, type of court] etc. and a select menu for year 2662, month and day with the default setting current year and month. It also contains a table 2668 with the columns customer, order date/time, date/day/time, sport, court/category, currency and options. In the customer column the user will see name on the community or person (with username) who booked the court, in the order date/time column the date and time of the order, in the date/day/time column the day and time from and to, in the sport column the sport, in the court/category column the court name and category of the court, in the currency column the cost of the booking and in the options column a link to the invoice for the payment. If selecting the invoice link the user will proceed to a page with invoice details as illustrated in FIG. 23J. The page contains invoice details 2676 with information such as date of invoice, due date of invoice, status (paid or not paid) and payment method. It also contains a table 2678 with the columns product 2680, description 2682 and price 2684. If the invoice stems from more than one court reservation all the reservations will be listed in the table 2678 with the text “court reservation” in the product column, court name, sport, category, date, time from and time to in the description column and the price and currency of the community in the price column. The table will also contain a sum of all bookings, a field showing the discount (if the arena differentiates prices for members and non-members) and a field for VAT in case the arena must charge VAT on booking. The invoice also contains customer details 2388 with name, phone number, country with country specific select menus (eg. country, municipality and place/city), address, postal code and email.

View booking table 2489 in FIG. 23A leads to a page with a booking table for the arena illustrated in FIG. 23K. The page contains a select menu for date 2694 and an update button 2695, a day before button 2696, a next day button 2697 and a menu to select sport 2698 and discipline 2699. If an arena's courts have different booking intervals then the page will contain more than table as illustrated 2700. If all the courts use the same intervals then there will be one table 2706. A table will consist of the columns booking intervals, court name 1, court name 2, etc. Reserved times have the text “Reserved” 2064, times that are about to be reserved have the text “Ongoing reservation” 2060 and available times have the text “Book it for customer” 2054.

Selecting prices for members/non-members the user will proceed to FIG. 23L to set prices in percent for members and non-members. Prices for non-members is always set to 100% and are not editable. The numbers in the table can be links to view prices on the courts, so if prices for members is set to 80 percent by a court then the prices for that court is calculated to 80 percent. Selecting the edit option 2728 the user can edit the prices for members.

Selecting about arena 2487 in FIG. 23A the user will proceed to a page with text for About the arena 2648, depicted in FIG. 23H. A user who enters an arena will first see the contents from this page. It contains a heading 2650 and contents 2652. Selecting the edit option 2654 the user can edit the page.

When selecting the agreements option 2490 the user will proceed to a page with agreements 2916 illustrated in FIG. 23X with a table 2917 with columns such as [name of subscriber], [day/time from-to], [agreement date from-to], [sport], [Arena name, court name], [cost] and [options]. The name of the subscriber can be a community or a person. Each agreement will have a details 2918 and delete option and selecting the details option the user will proceed to a page with a table 2314, as illustrated in FIG. 22B, with all reservations under the agreement with columns such as [day], [date], [time from-to], [sports], [arena/court], [cost], [invoice date] and [invoice due date]. Reservations are sorted on month and once a month an invoice is generated to the subscriber on email. Selecting the delete option the user is asked to delete all unpaid reservations under the agreement and given the options yes and no.

If selecting arena photos 2592 in FIG. 23A the user proceeds to a page to manage photos of the arena as illustrated in FIG. 23Y. If the user selects a court 2942 the page will contain a table 2952 with the columns photo, description of photo, frontpage, order and options showing photos of the court. The page will then also contain a link to view court details 2947, a browse option 2944 and an upload option 2946 to upload new photos of the court, a select box 2948 to if the user also wants to upload a new photo for the court to the arena frontpage, and an input field 2949 to type a description of the court. If the user selects arena frontpage 2953 the contents of the page differs slightly. The page then contains an input field 2954 to type the description of a new photo, a browse option 2955 an upload option 2956 and a link to view the arena frontpage 2957. The user can edit the order of photos both for courts and for the arena frontpage.Selecting to delete a photo that has been uploaded both to the arena frontpage and a court, the user is asked “do you want to delete the photo both in the arena frontpage and in the court details?” The user is given options like [yes] and [no, only in court details]. A limit for how many photos that can be uploaded for the arena frontpage and per court can be added.

Selecting the statistics option 2594 in FIG. 23A the user will proceed to a page with statistics 2970 illustrated in FIG. 23Z. The page contains a sub-menu with two options [statistics] 2973 (default selection) and [requests] 2974. Statistics can be the total number of requests received, the number of requests responded on within expiry date, average response time, the number of expired requests and a rate of unanswered requests. Selecting the sub-menu requests 2974 a table 2976 with columns request from, request received, responded on date, status and response time replaces the statistics page.

Selecting settings 2593 in FIG. 23A the user proceeds to a page with settings 2980 for the arena. The page contains a select box 2984 and an input field if the wants to can add a link to a map in the contact/location page for the arena.

The user proceeds to a page illustrated in FIG. 23M when selecting Offers 2485 in FIG. 23A. The page contains a menu with the options [New requests] 2750, [Offers given] 2752, [Offers accepted] 2754, [Declined offers] 2756, [Expired offers] 2758, [Expired requests] 2760 and [Declined requests] 2762.

New requests 2750 leads to a page with a table 2762 illustrated in FIG. 23N with the columns from community, sport/discipline, type, received date/time, due date and options. In the options column a link 2764 to a page to give an offer to the community FIG. 23P.

Offers given 2752 in FIG. 23M leads to a page with a table 2768 as illustrated in FIG. 23N with columns from community, sport/discipline, type, date/time of offer, due date and options. A details option per given offer leads to a page with details about an offer given 2855 in FIG. 23R.

Offers accepted 2754 in FIG. 23M leads to a page with a table 2774 with columns from community, sport/discipline, type, date/time of offer, due date and options. Selecting the details option 2778 by an offer the user can see details of the accepted offer 2860 as illustrated in FIG. 23R.

Declined offers 2756 in FIG. 23M leads to a page with a table 2780 in FIG. 23o with declined offers with columns from community, sport/discipline, type, date, due date and options. Selecting the details option 2784 the user will proceed to a page showing details of the declined offer 2872 in FIG. 23T.

Expired offers 2758 in FIG. 23M leads to a page with a table 2788 in FIG. 23o with expired offers with columns from community, sport/discipline, type, date, due date and options. Selecting the details option 2789 the user will proceed to a page showing details of the expired offer 2886 in FIG. 23T.

Expired requests 2760 in FIG. 23M leads to a page with a table 2790 in FIG. 23o with the columns from community, sport/discipline, type, date, due date and options. Selecting the details option 2794 the user will proceed to a page showing details of the expired request 2896 in FIG. 23V.

Declined requests 2762 in FIG. 23M leads to a page with a table 2796 in FIG. 23o with the columns from community, sport/discipline, type, date, due date and options. Selecting the details option 2797 the user will proceed to a page showing details of the expired request 2906 in FIG. 23V.

FIG. 23P Illustrates a page to give an offer to a community. The user is given the options [decline the request] 2804 and [give offer] 2806. If the user declines the request other menus in the page are de-activated except the back 2840 and submit button 2838. The page contains a table 2814 with columns such as [match], [match format, minimum required time per match/recommended time per match], [courts to be booked on or between the dates], [courts to be booked on or between the times of the day (24H) eg 0900-1700], [court name], [set date], [set time from-to] and [price]. The table contains information from the request sent by the tournament director in FIG. 18M-FIG. 18o with options that enables the user to give an offer. If selecting to give an offer the user must choose to select 2808 court names from a dropdown 2810 or to type court names manually 2812. The contents in the court name column will adjust accordingly with one input field per match to set court names manually 2826 or a dropdown to select a court 2828. The [set date] column contains a select menu for date 2818 per match, the [set time from] and [set time to] columns contains input fields per match for time, and the [price] column contains an input field to set price per match. The page also contains an input field 2832 to set a due date for the offer and a select option 2834 where the person can allow the community to accept only part of the offer.

A page with information about an offer given to a community 2855 can be found in FIG. 23R. It contains information like sport and discipline 2857, the due date for the offer 2858 and a table 2856 with columns such as [match], [minimum required time per match/recommended time per match], [courts to be booked on or between the dates], [courts to be booked on or between the times of the day (24H) eg 0900-1700] [court name], [date], [time from-to] and [price]. The table contains information submitted in FIG. 23P.

Information about an offer accepted by a community 2860 can also be found in FIG. 23R. It contains information like sport and discipline 2868, the due date for the offer 2866 and a table 2856 with columns such as [select], [match], [minimum required time per match/recommended time per match], [courts to be booked on or between the dates], [courts to be booked on or between the times of the day (24H) eg 0900-1700] [court name], [date], [time from-to] and [price]. The table contains information from the given offer.

FIG. 23T is a page with information about an offer declined by a community 2872. It contains information like sport and discipline 2868, the due date for the offer 2866 and a table 2856 with columns such as [select], [match], [minimum required time per match/recommended time per match], [courts to be booked on or between the dates], [courts to be booked on or between the times of the day (24H) eg 0900-1700] [court name], [date], [time from-to] and [price]. The table contains information from the offer given.

FIG. 23T also illustrates a page with information about an expired offer 2886. It contains information like sport and discipline 2868, the due date for the offer 2866 and a table 2856 with columns such as [select], [match], [minimum required time per match/recommended time per match], [courts to be booked on or between the dates], [courts to be booked on or between the times of the day (24H) eg 0900-1700] [court name], [date], [time from-to] and [price]. The table contains information from the offer given.

FIG. 23V illustrates a page with information about an expired request 2896. It contains information like sport and discipline 2902 and a table 2900 with the columns [match], [minimum required time per match/recommended time per match], [courts to be booked on or between the dates] and [courts to be booked on or between the times of the day (24H) eg 0900-1700].

FIG. 23W also illustrates a page with information about a declined request 2906. It contains information like sport and discipline 2910 and a table 2900 with the columns [match], [minimum required time per match/recommended time per match], [courts to be booked on or between the dates] and [courts to be booked on or between the times of the day (24H) eg 0900-1700].

When selecting My tasks 528 in FIG. 5C the user proceeds to a page illustrated in FIG. 31A with select options and a table 3156. Selecting my tasks in the options menu 3142 the table will contain a list of the user's tasks. An example is shown in FIG. 31A with a tournament director having received a tournament director report for a tournament names “Summer cup”. Selecting the report option 3156 the user will proceed to a tournament director report, illustrated as 3534 of FIG. 46B. FIG. 31B further shows an example of a user's my task table with 3 result/absence reports and 3 match referee reports.
The user selecting the report option 3158 proceeding to the results report 3480 for the match/round, as illustrated in FIG. 46A.
The user selecting a report by a match referee report proceeding to the match referee report 3536 for the match/round, as illustrated in FIG. 46B and
The user selecting report by a tournament referee report 3162 proceeding to the tournament referee report 3518 for the match round also illustrated in FIG. 46B.

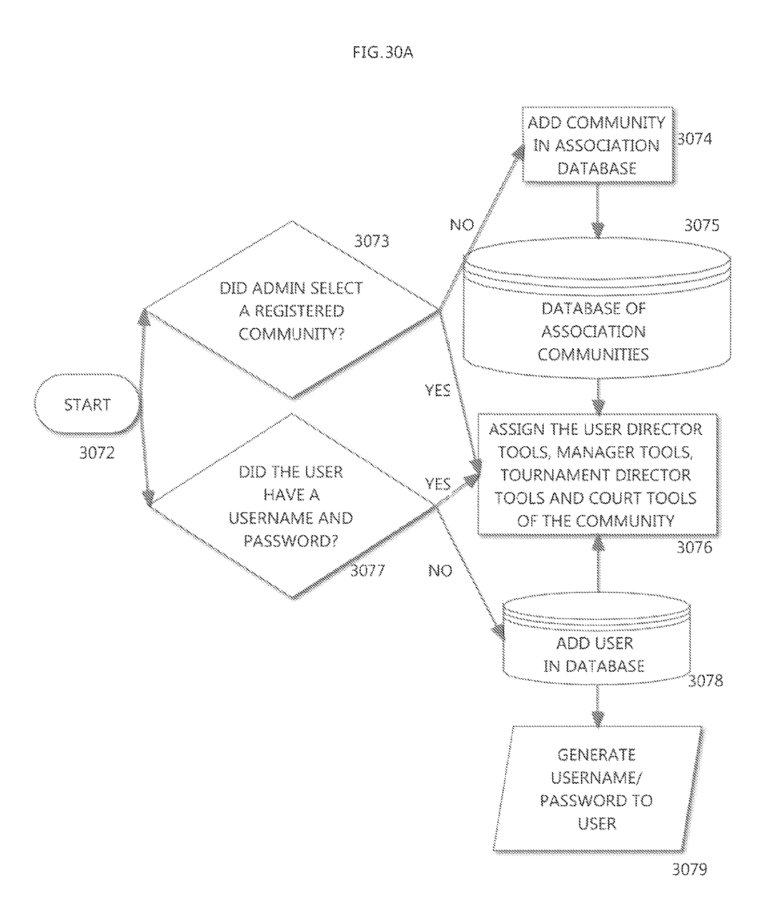

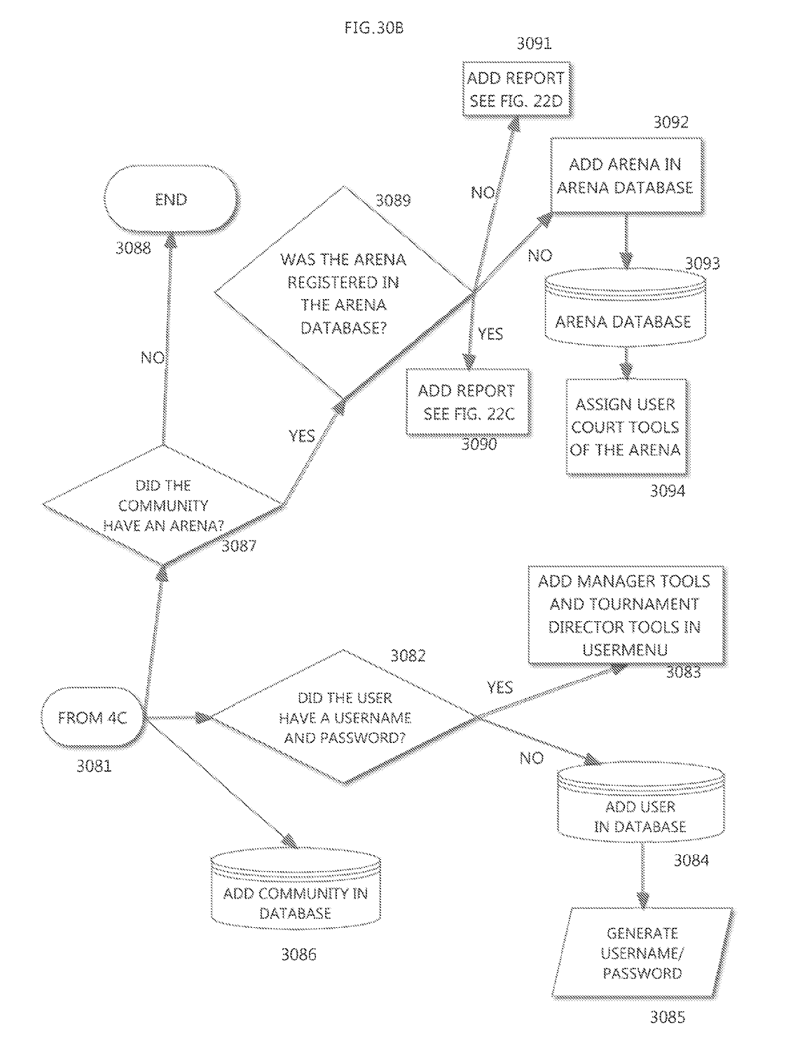

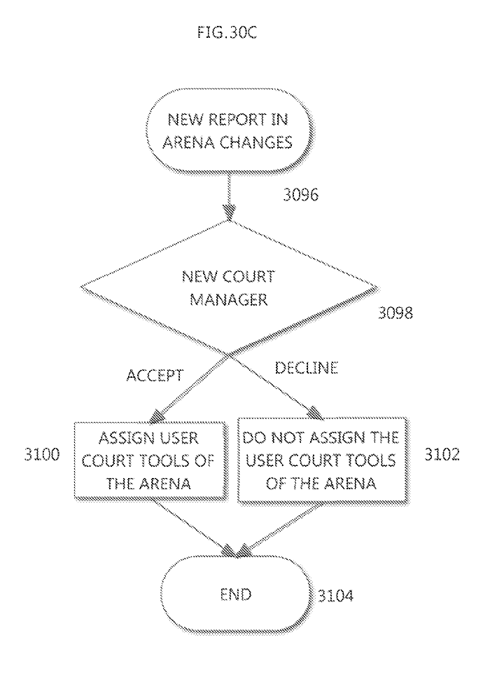

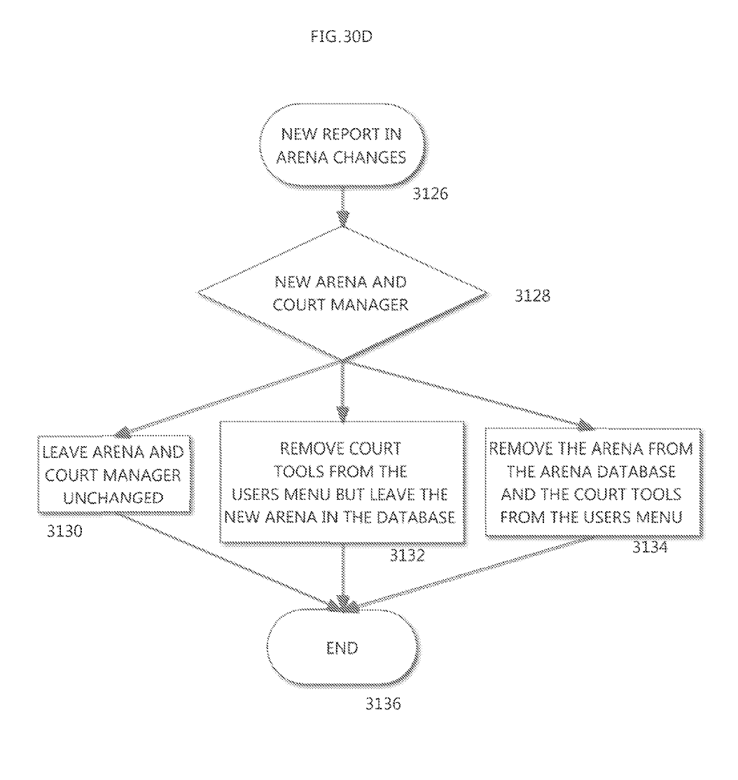

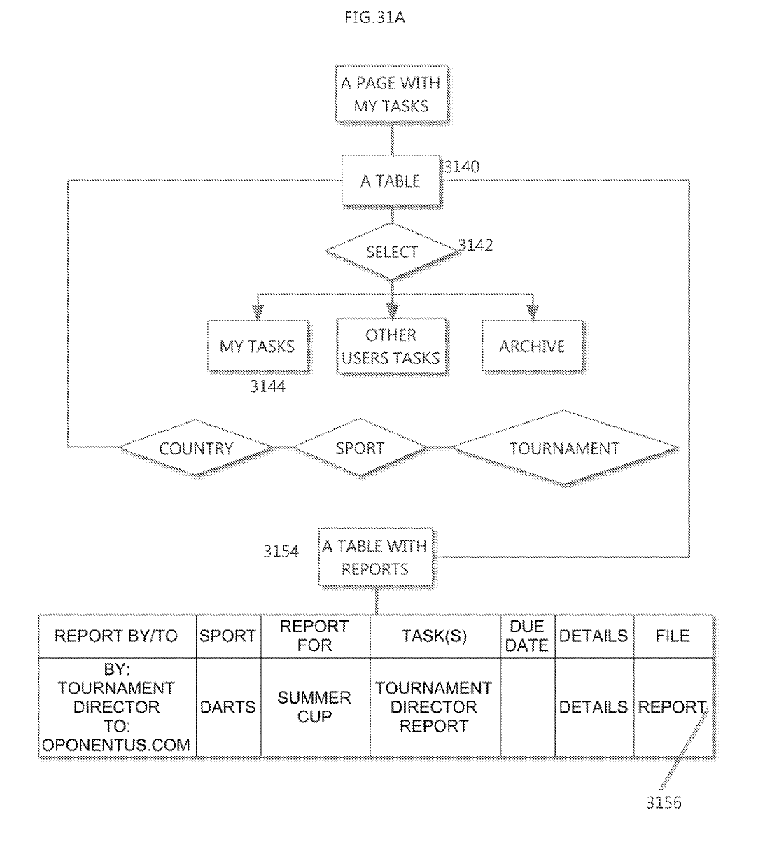

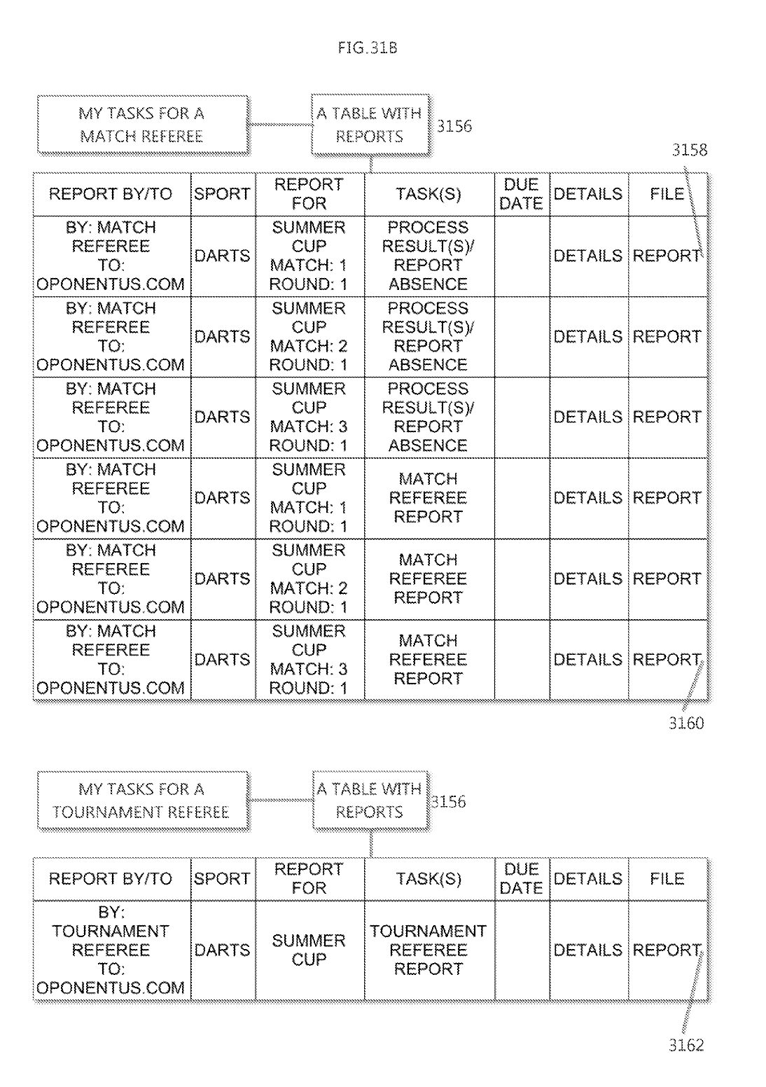

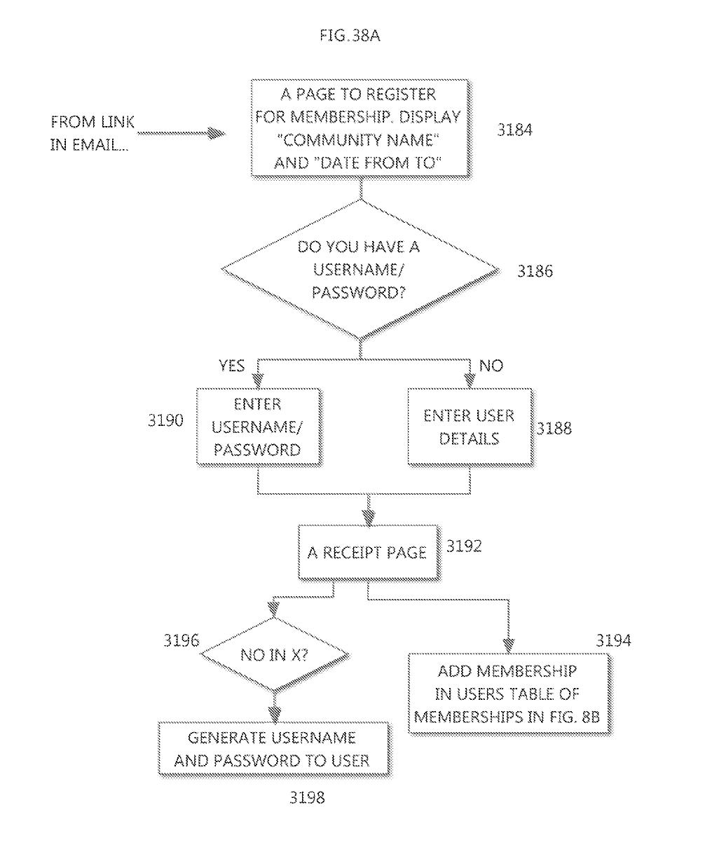

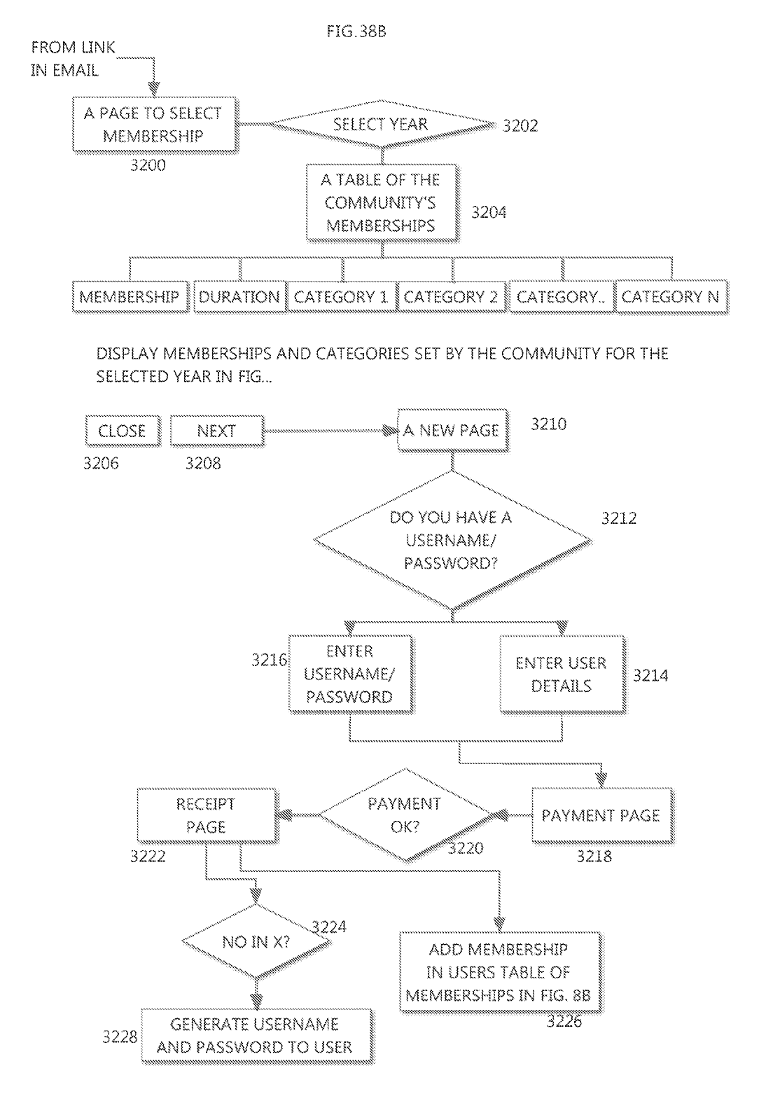

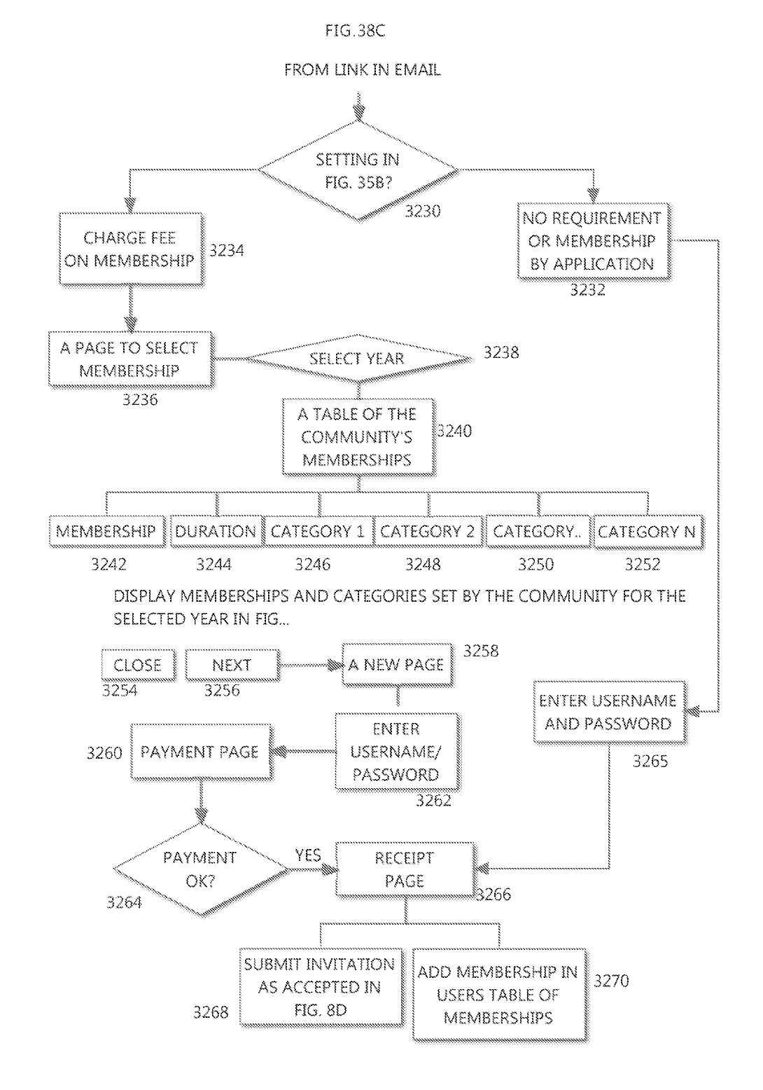

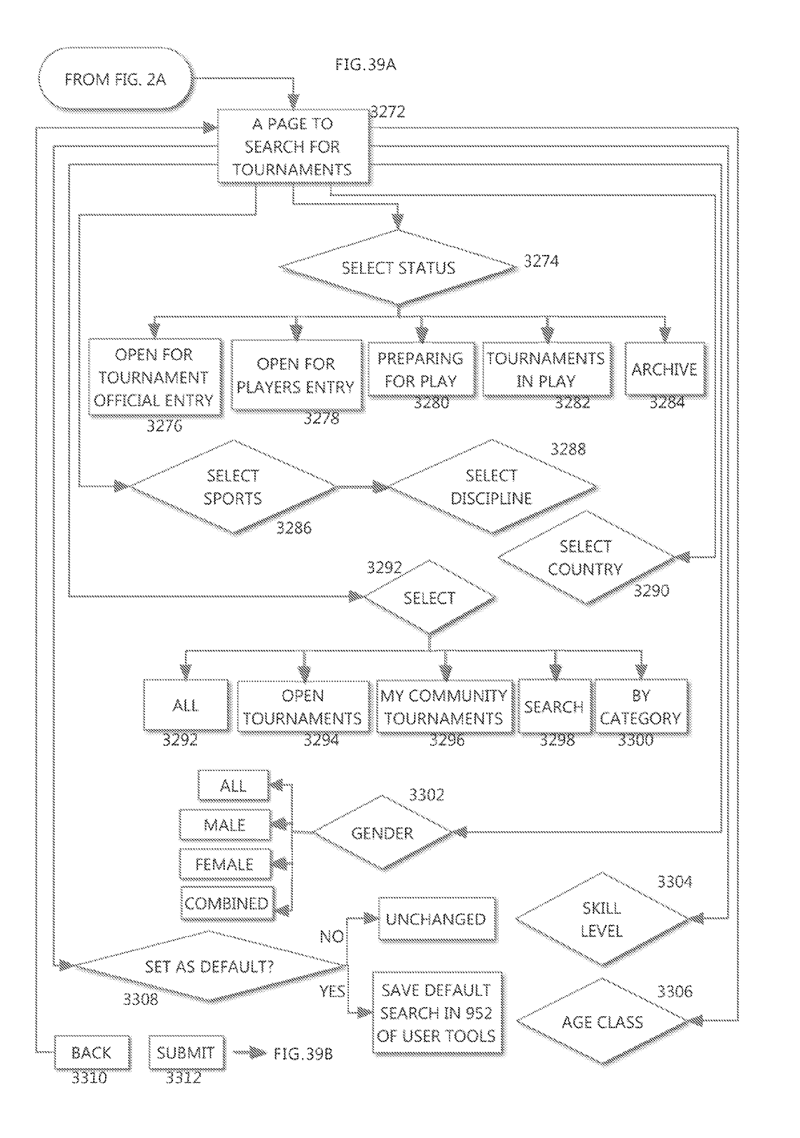

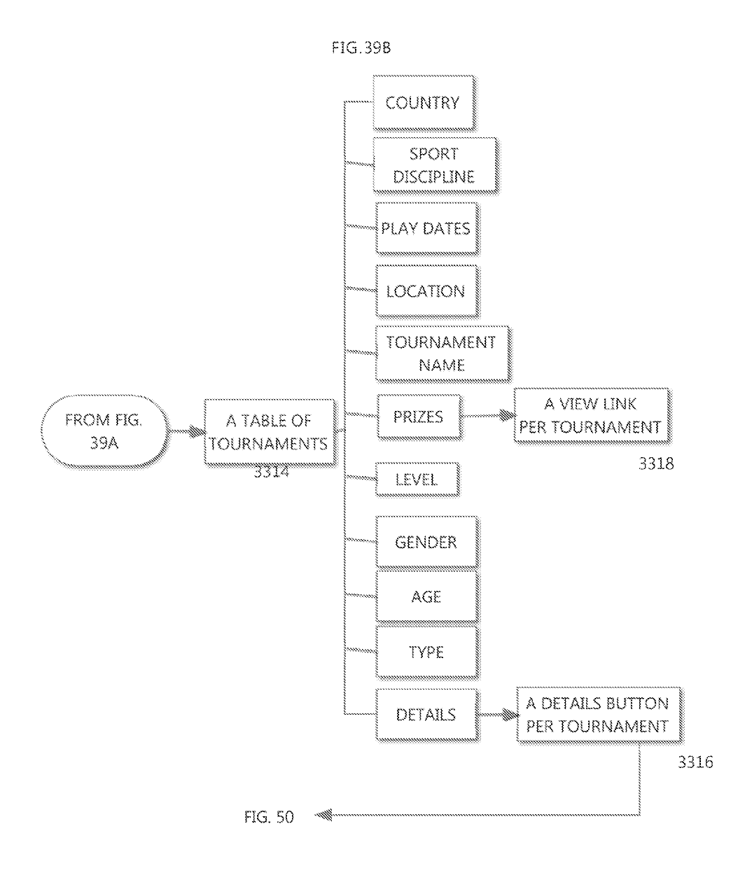

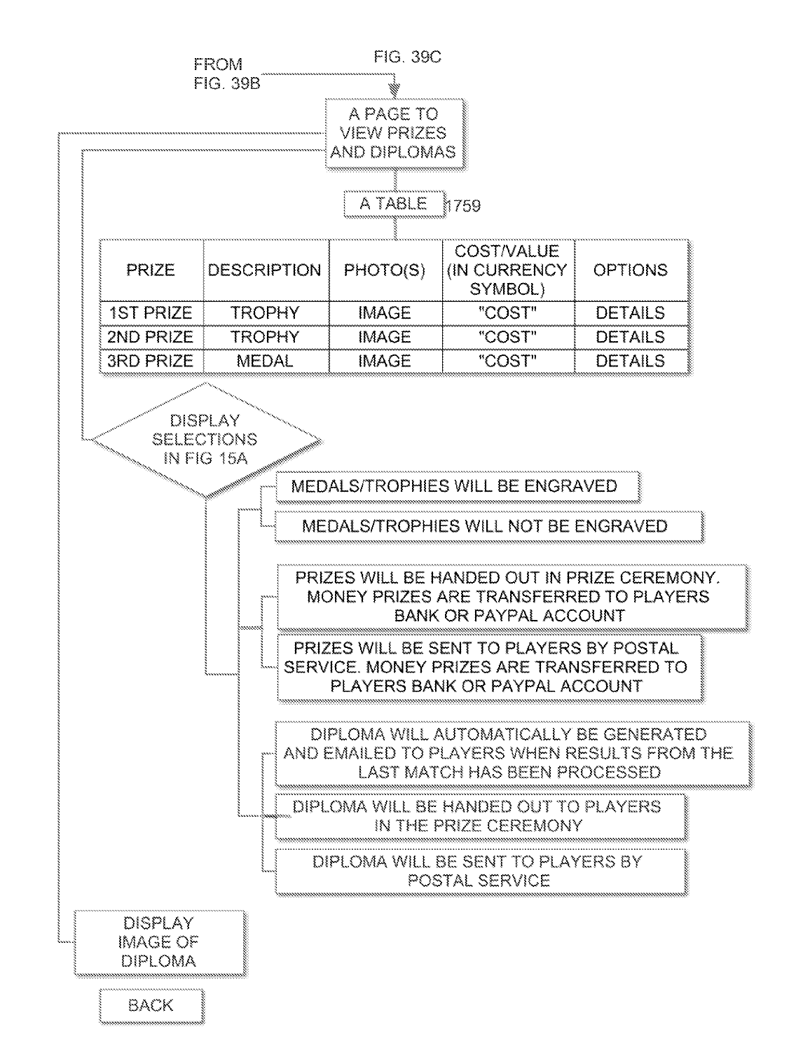

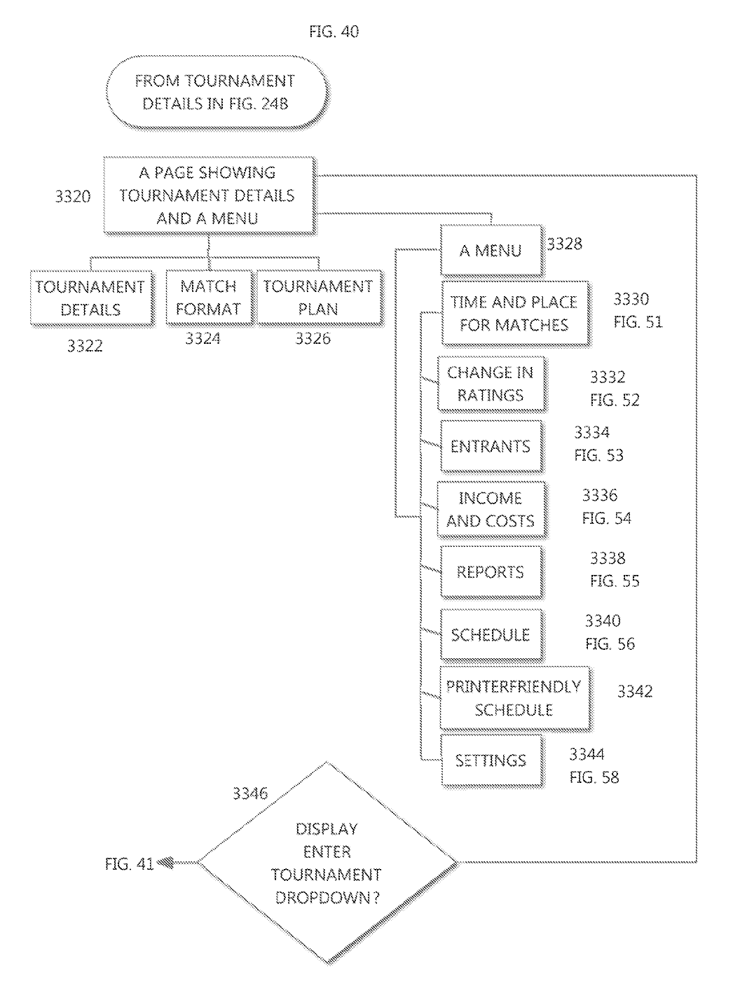

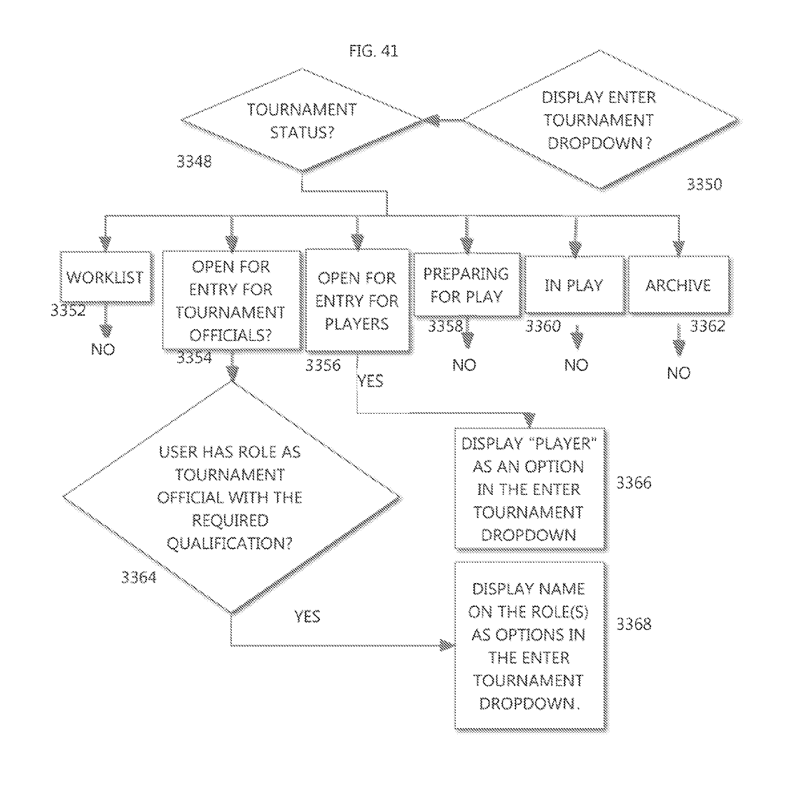

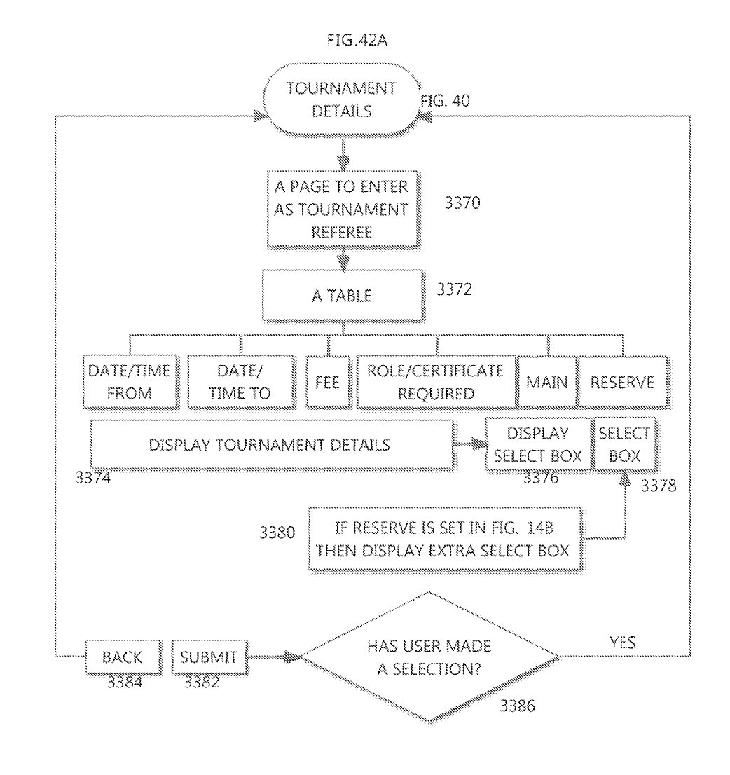

Selecting Tournaments 210 in FIG. 2A the user proceeds to a page to search for tournaments as illustrated in FIG. 39A. The page contains a select menu for tournament status 3274, where possible options are the different steps in the running of a tournament: A tournament can be saved in a worklist, if required by an association it can be waiting approval by the association, a tournament can be open for entry for tournament officials, it can be open for entry for players, it can have the status preparing for play, in play, in the archive and blocked and/or deleted. The page also contains a select menu with options for sport 3286 and discipline 3288, and a further select menu with the options [all] 3292, [open tournaments] 3294, [my community tournaments] 3296, [search] 3298 and [by category] 3300. If selecting [all] further select menus in the page are: a select menu for country 3286, age class 3306, skill level 3304 and gender 3302. Before submitting a search the user can optionally select to save the search selections as a default for future searches. Submitting the search will send a request to the server, then receiving the requested tournament data in a table 3314 as illustrated in FIG. 39B.
For a user to view prizes in a tournament selecting the view prizes link 3318 and proceeding to a view prizes page as illustrated in FIG. 39C. The page contains a table 1759 with prizes and other details from the set prizes data. For
For a user to view detailed information about a tournament, selecting a button 3316 in FIG. 39B will take the user to a page illustrated in FIG. 40.

FIG. 40 illustrates a page that provides a user with detailed information about a tournament 3322, to view match formats 3324, tournament plan 3326, time and place for matches 3330, change in ratings 3332, entrants 3334, income and costs 3336, reports 3338, schedule 3340, printerfriendly schedule 3342 and settings 3344. The page also contains a dropdown for players and tournament officials entry with options as illustrated in FIG. 41.

FIG. 41 is a figurative explanation showing options in dropdown 3346 in FIG. 40. In the entry period for tournament officials display only the name(s) on the tournament official role(s) in the tournament as options, and in the entry period for players display only player.

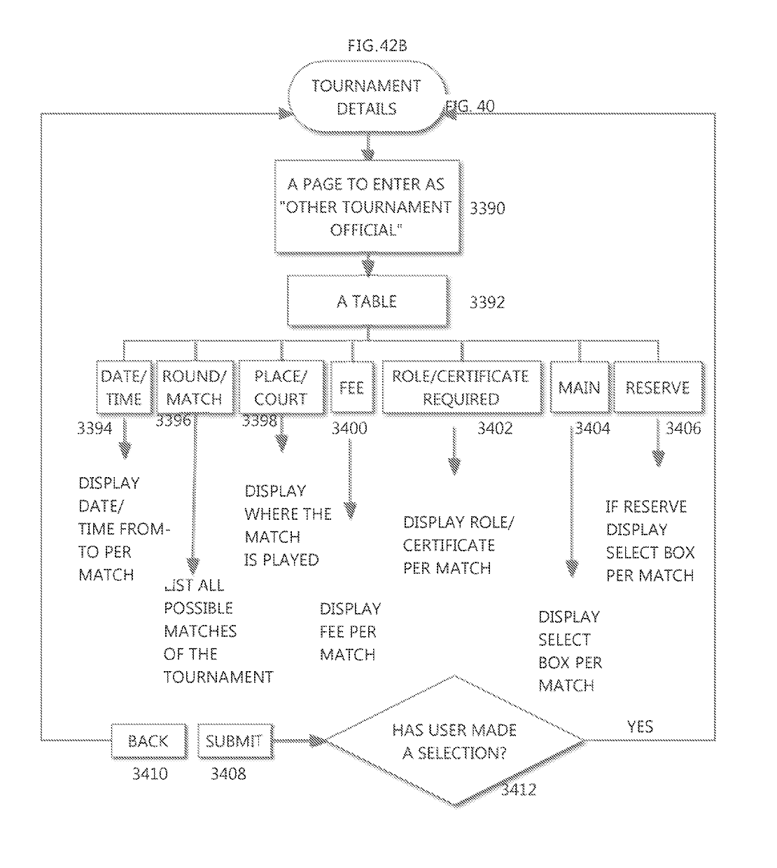

A tournament referee enters a tournament by first selecting his/her role in the enter tournament dropdown 3346 in FIG. 40. The user will then proceed to a page illustrated in FIG. 42A with a table 3372 with columns [date/time from], [date/time to], [fee], [role/certificate required], [main] and [reserve] to enter as tournament referee.

A match referee or other tournament official enters a tournament by first selecting his/her role in the enter tournament dropdown 3346 in FIG. 40. The user will then proceed to a page illustrated in FIG. 42B with a table 3392 with columns [date/time], [match/round], [place/court], [fee], [role/certificate required], [main] and [reserve].

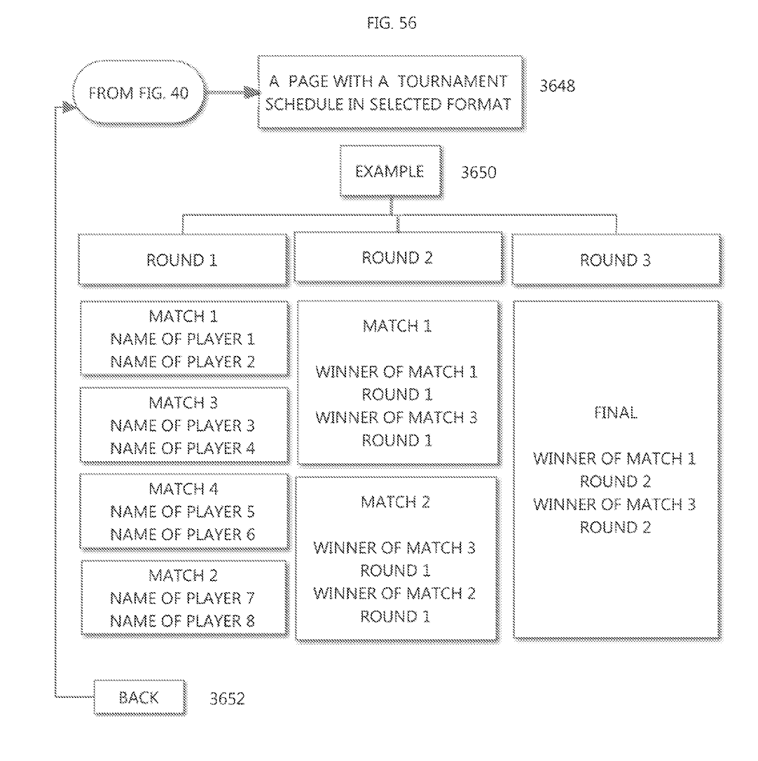

A tournament schedule autogeneration algorithm of the invention is explained in the following by way of a programmed 8ballpool tournament schedule autogeneration algorithm example. An example of an autogenerated tournament schedule using a corresponding programmed tournament schedule autogeneration algorithm is shown in FIG. 56.

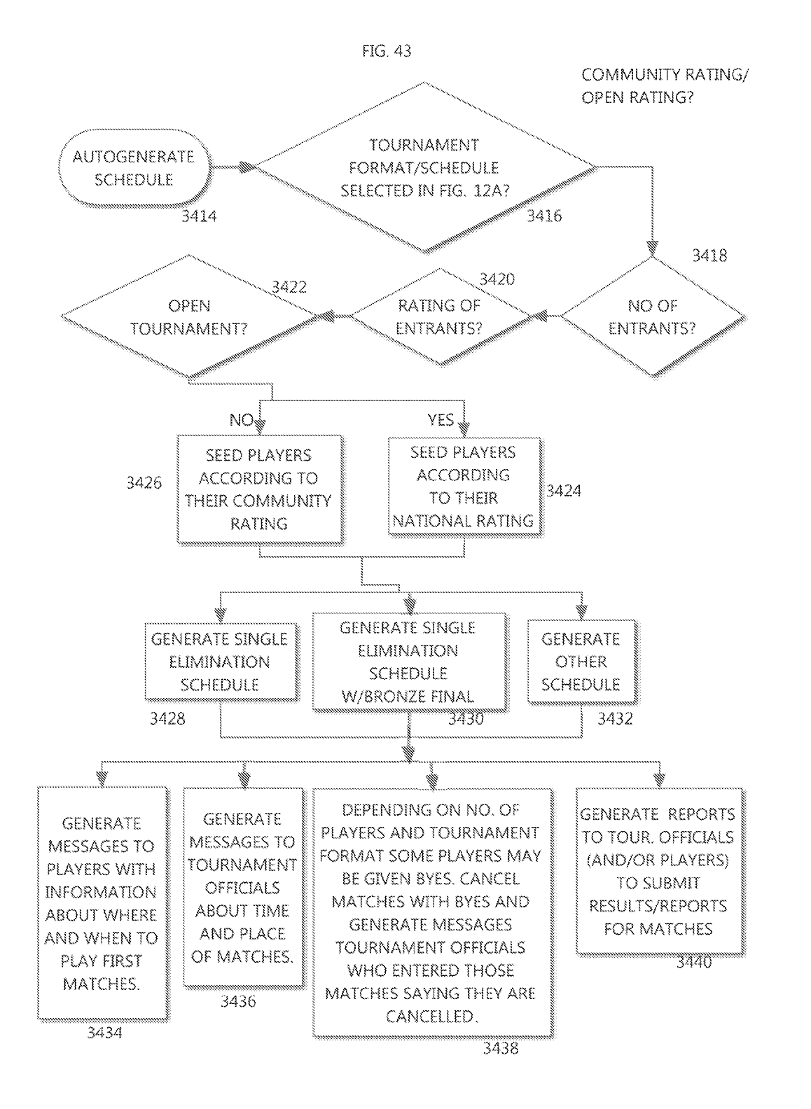

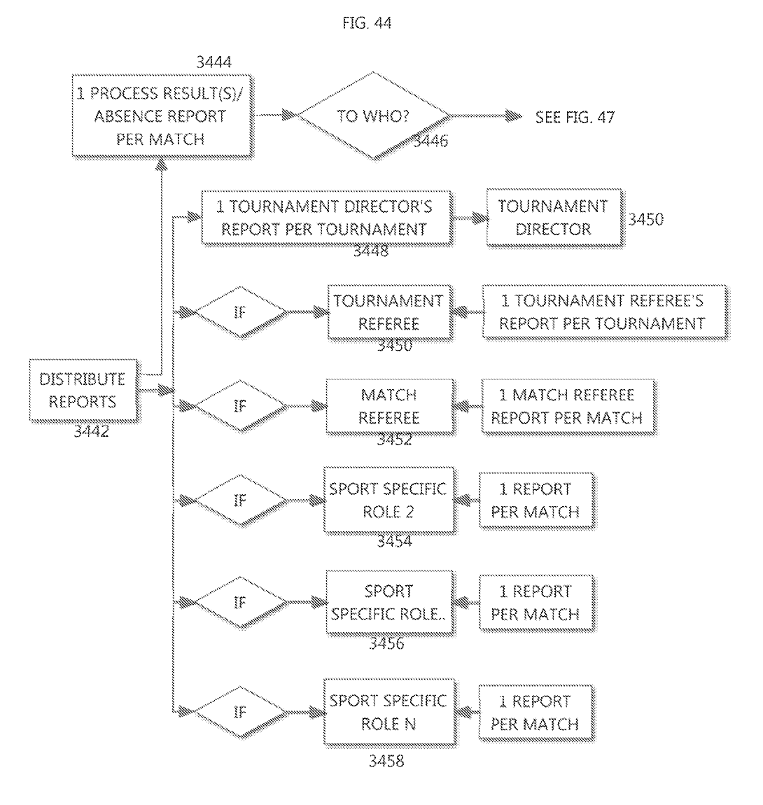

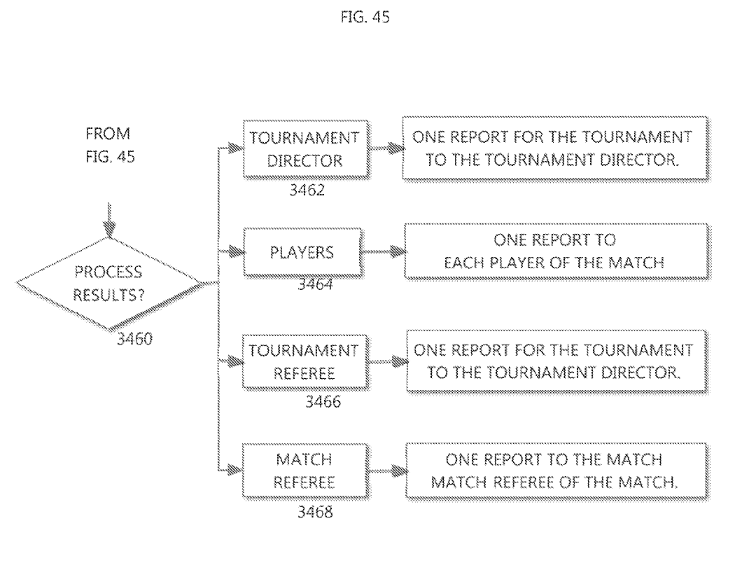

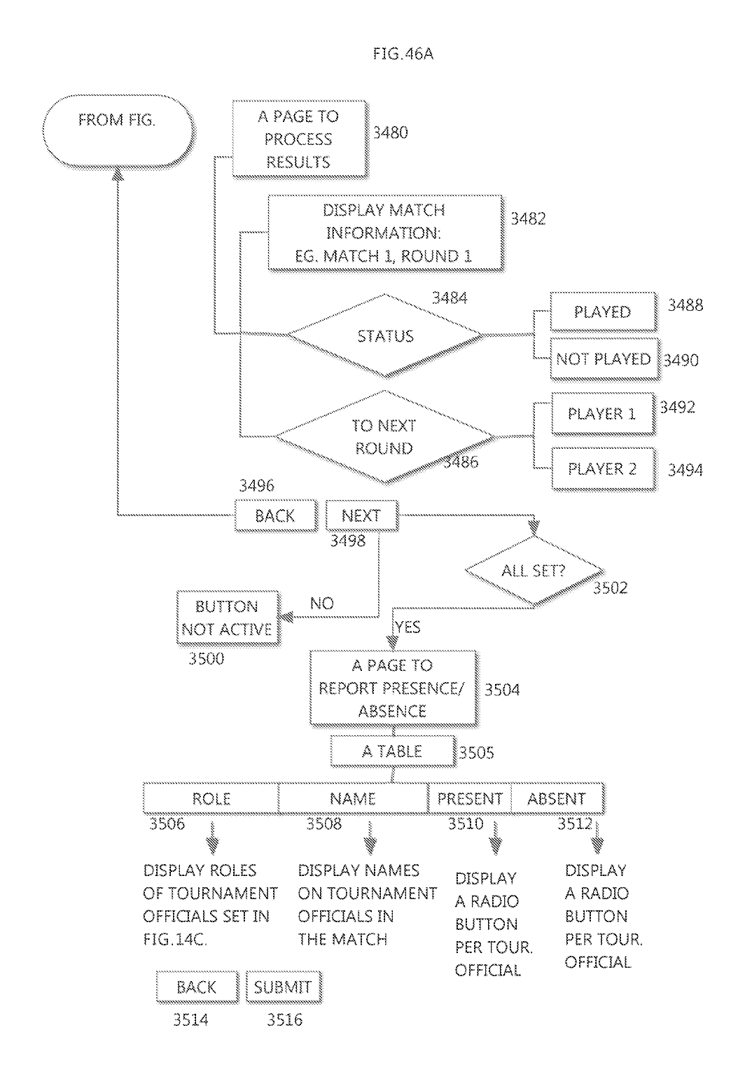

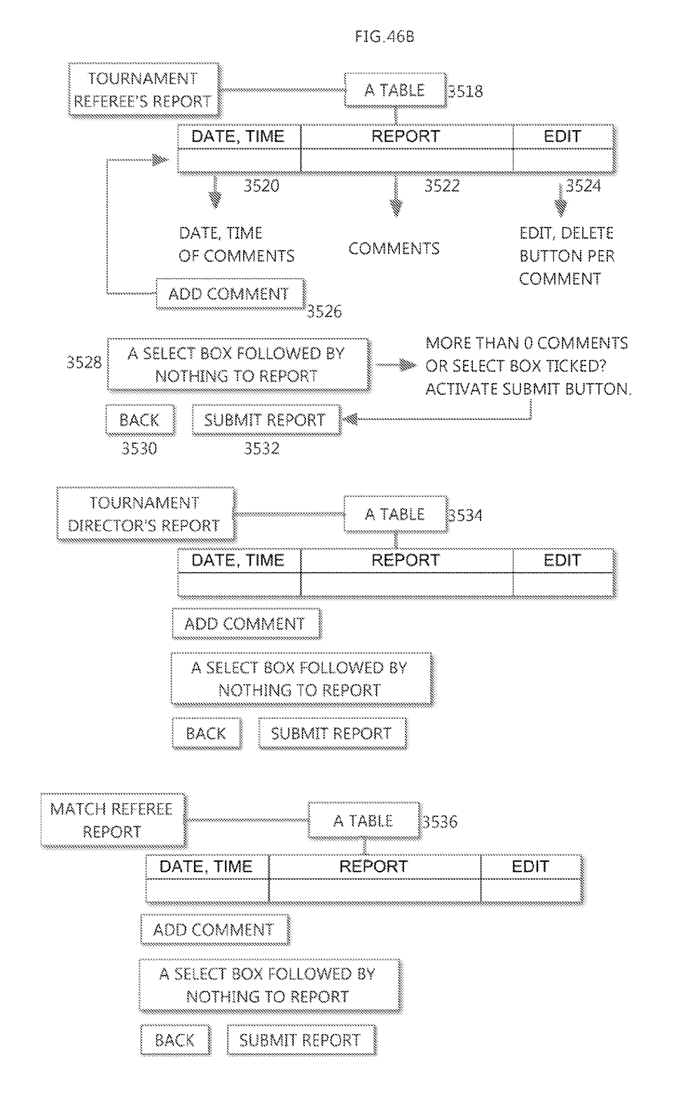

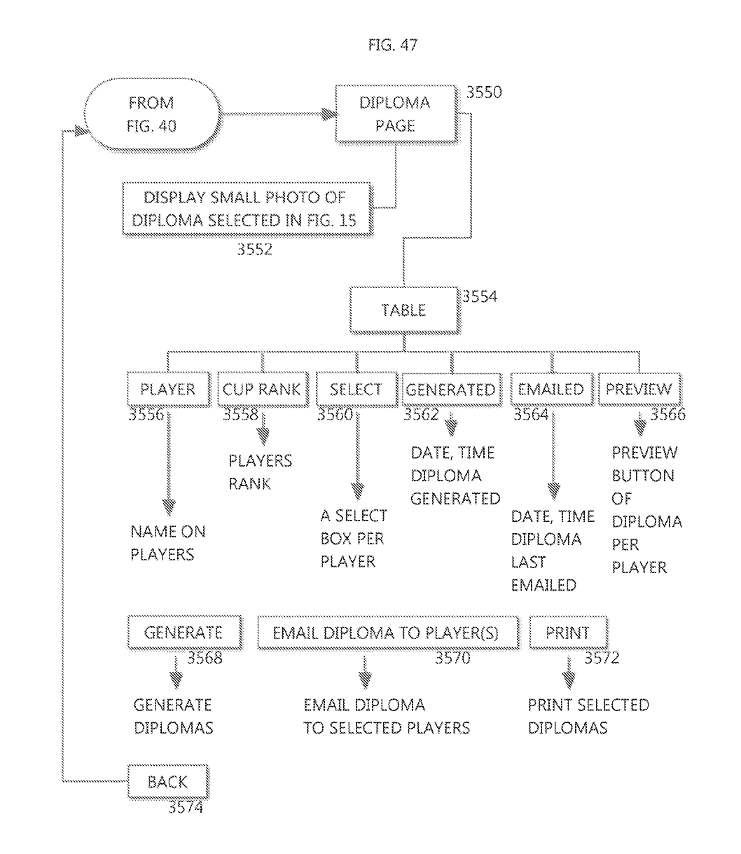

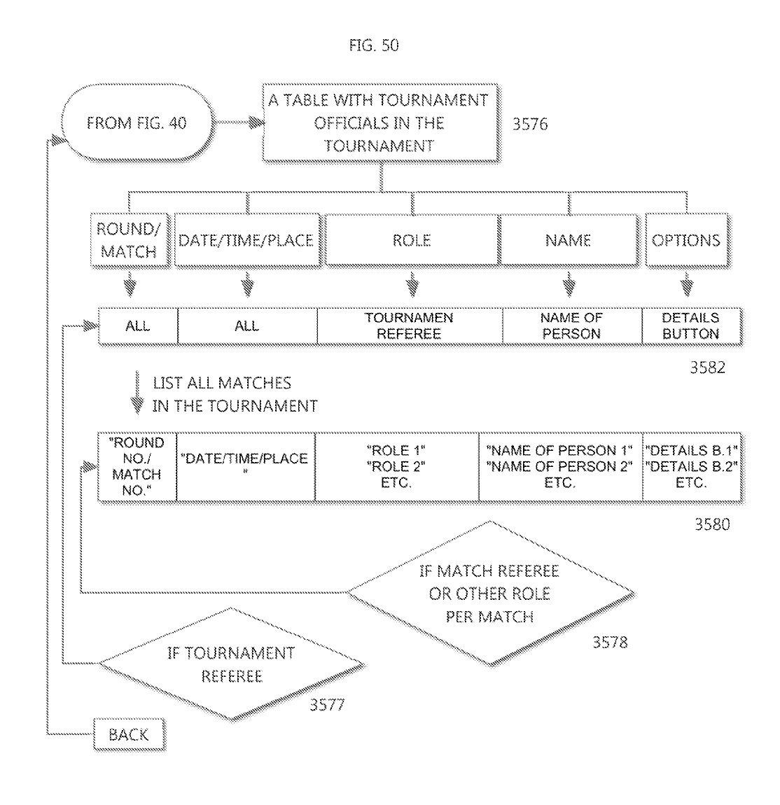

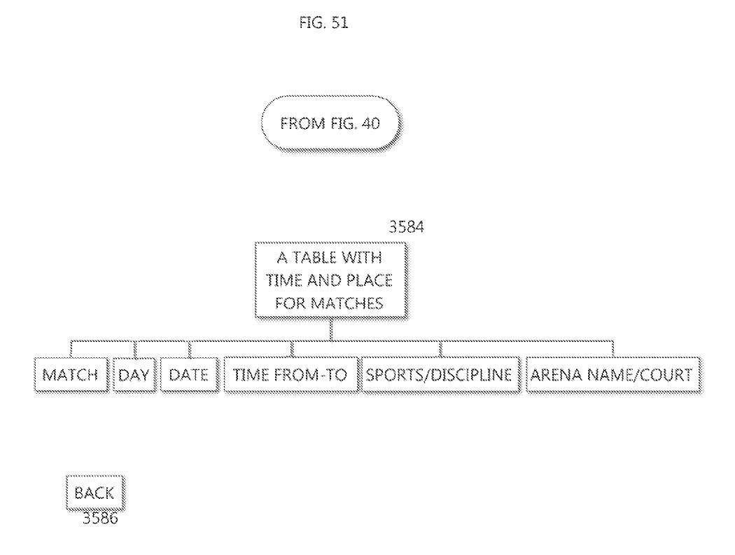

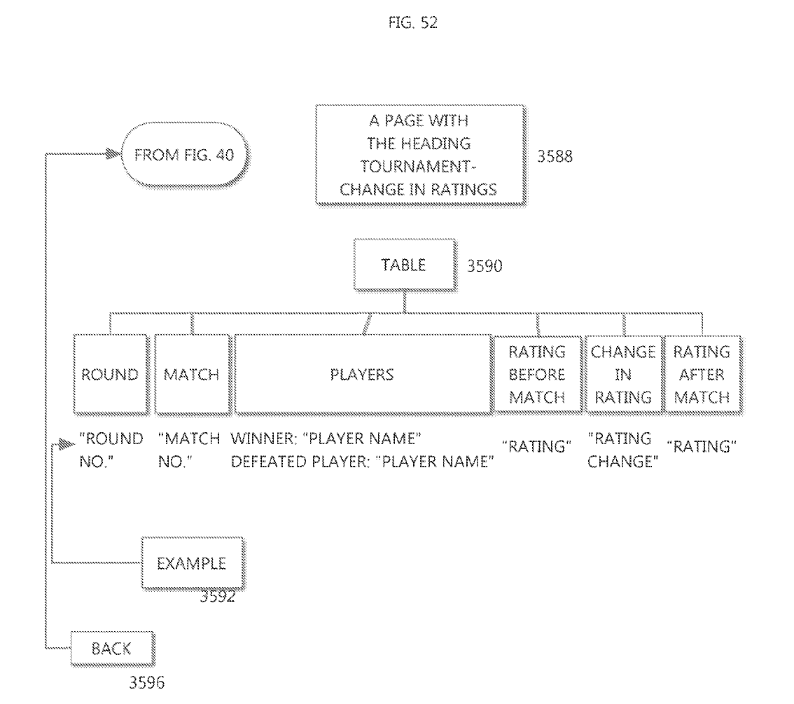

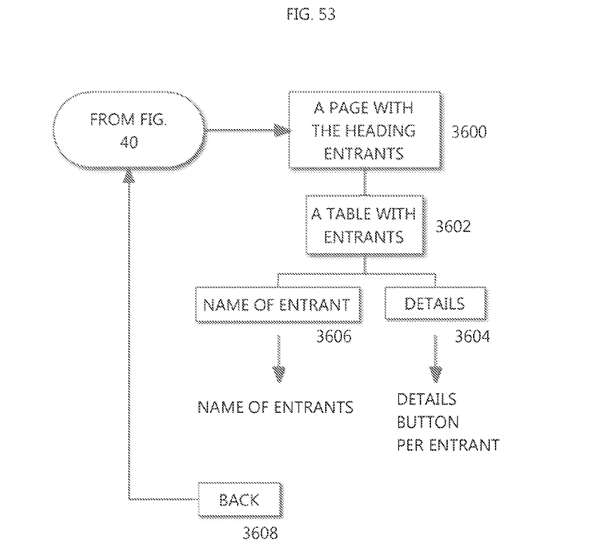

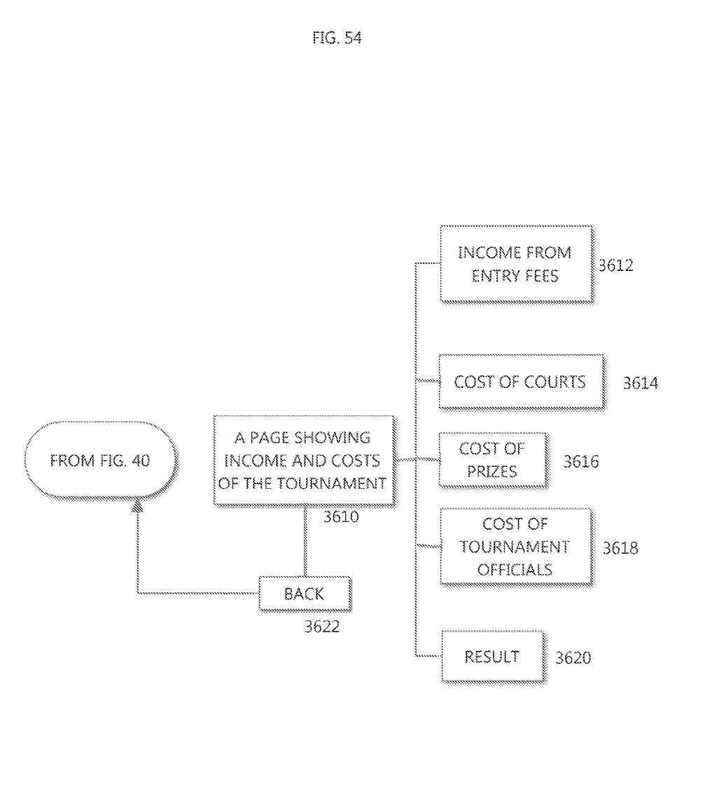

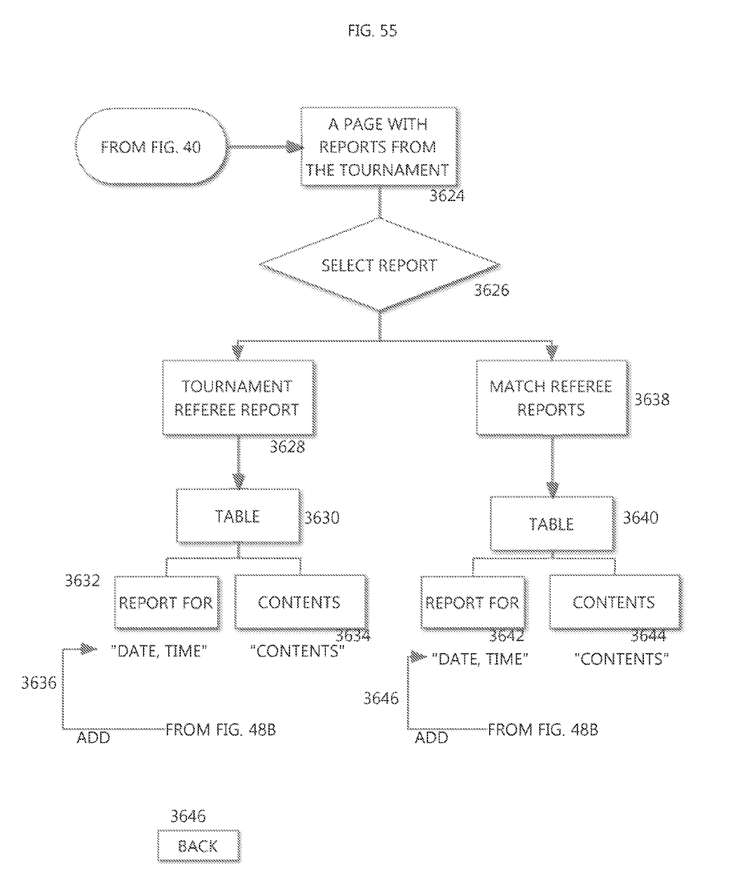

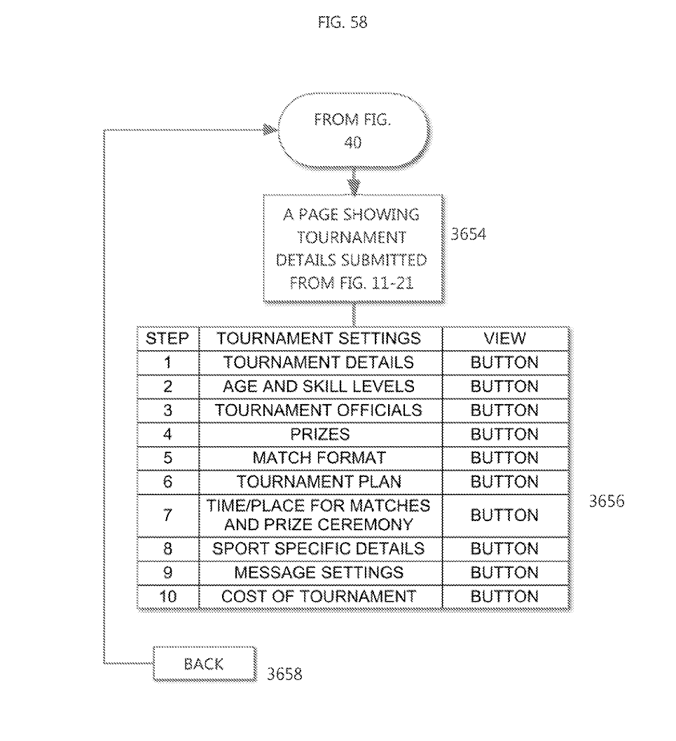

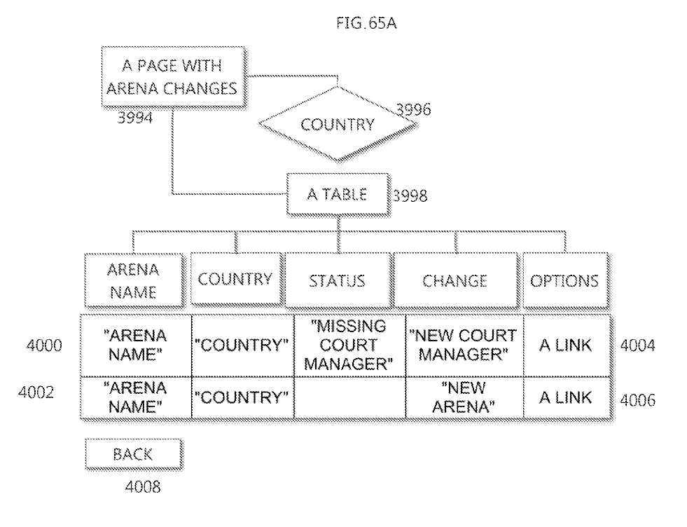

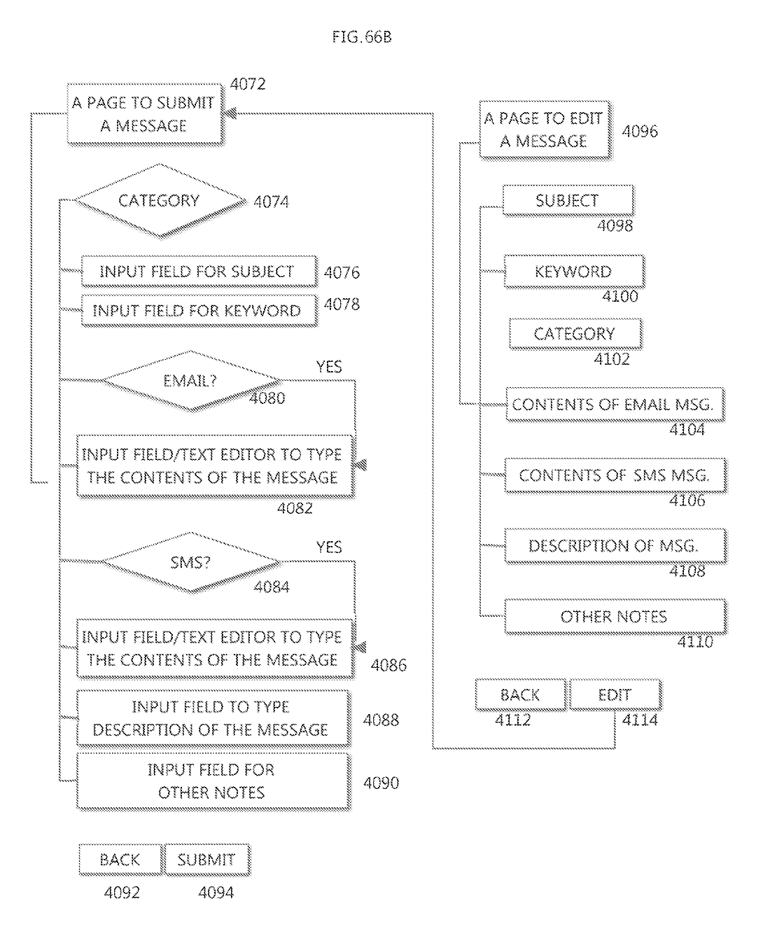

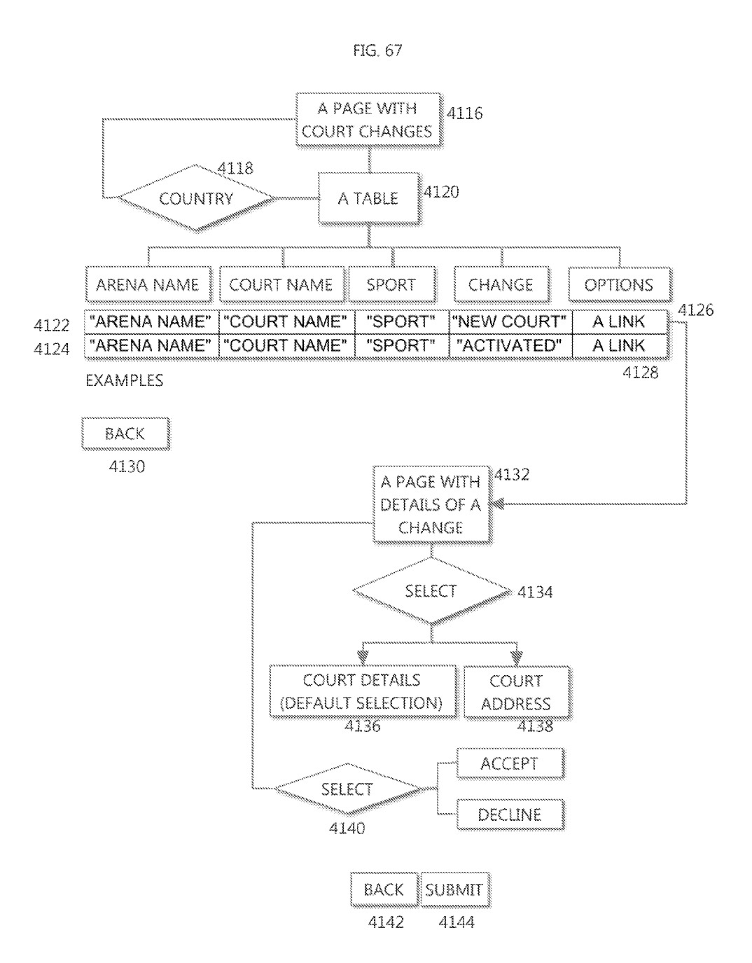

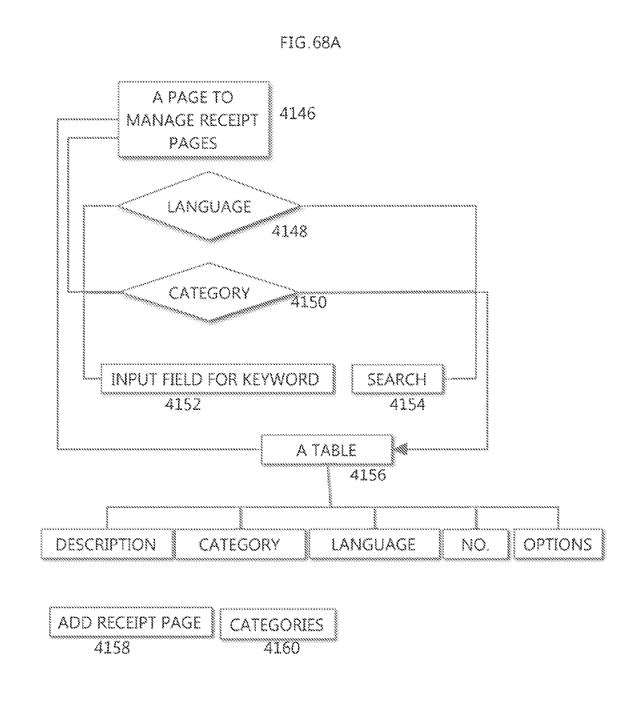

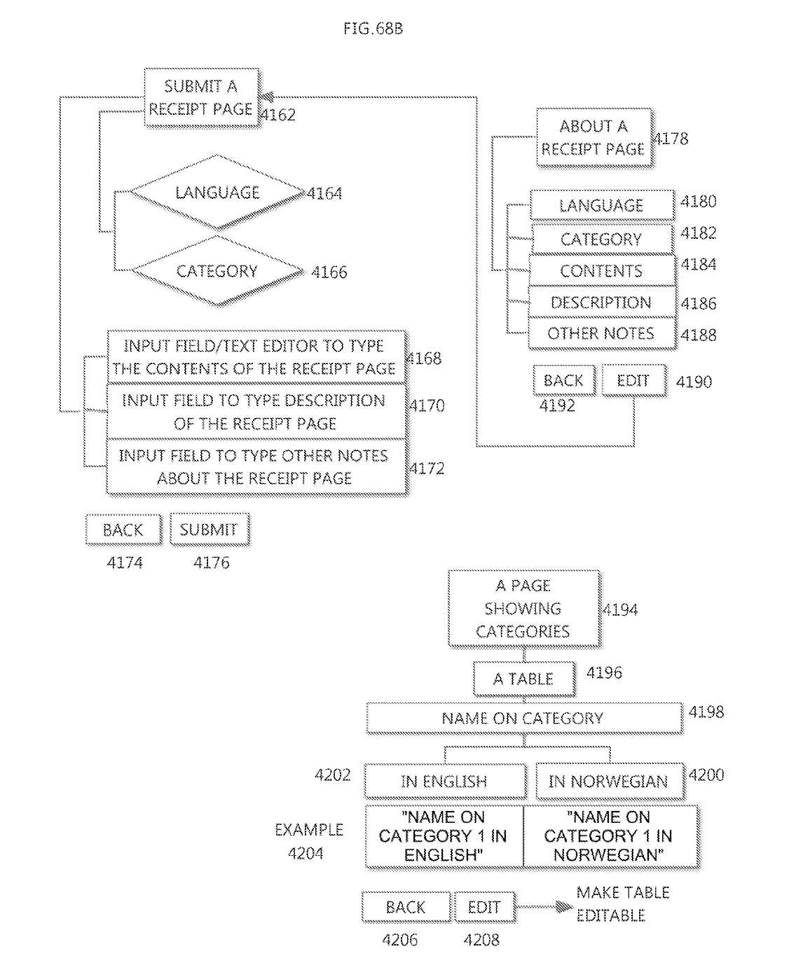

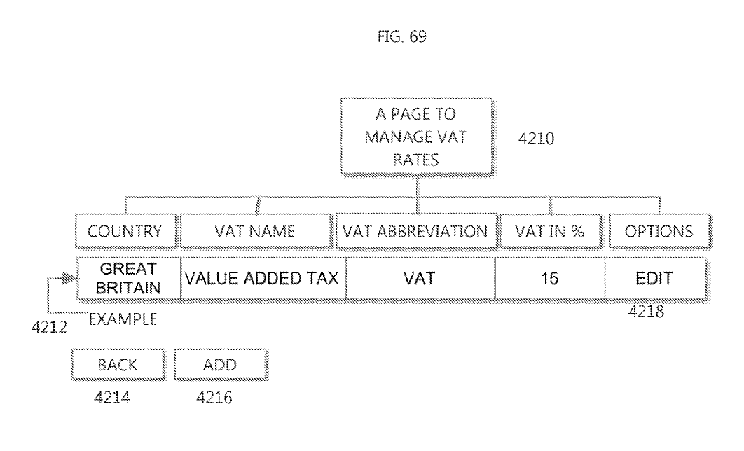

The FIGS. 43-70D are drawings enclosed to provide additional information about the solution, not included in the claims, but relevant for any person to understand how the overall solution works.

Some messages are generated by the solution. Some examples are listed below:
1. An email to be generated when a request has been sent: With the subject [Request offer on courts] and the contents [“Community name” wants to organize a tournament at “arena name”. Click here to give an offer. Best wishes Oponentus.com]
2. An email to be generated to the tournament director of a tournament when an offer is given: With the subject [offer from arena] and the contents [An offer has been submitted by “arena name” and must be accepted or rejected within “the due date”. Click here to accept/reject the offer. Best wishes Oponentus.com].
3. An email to be generated to the arena email address when an offer has been accepted: With the subject [Offer on courts has been accepted] and the contents [“Community name” has accepted the offer on courts from “from date” to “to date”. You can view the details of the accepted offer by clicking the offer button in court tools of the arena at the Oponentus.com. Oponentus is working on, but does not yet offer online payment, so you must send an invoice to the community either in email or by postal service and manage payment separately. Best wishes Oponentus.com].
4. An email to be generated to the arena email address if the community rejects the offer from the arena: With the subject [Offer on courts has been declined] and the contents [“Community name” has rejected the offer on courts from “from date” to “to date”. Best wishes Oponentus.com]
5. An email to be generated to the arena email address when a given offer has not been replied on within due date: With the subject [Offer on courts has expired] and the contents [“Community name” has not accepted the offer within its due date so the offer has now expired”. Best wishes Oponentus.com]
6. An email to be generated to the tournament director of the tournament when a request has expired: With the subject [Request has expired] and the contents [The request you sent to “arena name” has not been responded on within its due date. If you still like to run the tournament, and still need courts, you can enter tournament director tools and send a new request or select another arena (or arenas) for the tournament. Remember you also may have to edit the tournament plan. Be aware that arenas have different properties: Some arenas within the solution offer direct court booking (online), if you own and manage an arena yourself you can set up courts for the tournament manually and some arenas require you to send a request. Best wishes Oponentus.com]
7. An email to be generated to the tournament director of the tournament when a request has been declined: With the subject [Request has been declined] and the contents [If you still like to run the tournament, and still need courts, you can enter tournament director tools and send a new request or select another arena (or arenas) for the tournament. Remember you also may have to edit the tournament plan. Be aware that arenas have different properties: Some arenas within the solution offer direct court booking (online), if you own and manage an arena yourself you can set up courts for the tournament manually and some arenas require you to send a request. Best wishes Oponentus.com]

Associated with the offer part, the user will also get some confirmation messages for different actions. Some examples are listed below:
1. If the user clicks the here link in message 2, and the offer has expired, then show a confirmation page with the contents [If you still like to run the tournament, and still need courts, you can enter tournament director tools and send a new request or select another arena (or arenas) for the tournament. Remember you also may have to edit the tournament plan. Be aware that arenas have different properties: Some arenas within the solution offer direct court booking (online), if you own and manage an arena yourself you can set up courts for the tournament manually and some arenas require you to send a request. Best wishes Oponentus.com]. The page may also contain options like [proceed to main page for creating tournament (If not loged in user must log in)] and [Proceed to Oponentus.com] with a submit option.
2. If the user clicks the here link in message 2, and the offer has already been replied on, then show a confirmation page with the contents [This offer has already been replied on. You can view the details from your court reservations link in your user menu. Best wishes Oponentus.com]. The page may also contain options like [proceed to court tools (If not loged in user must log in)] and [Proceed to Oponentus.com] with a submit option.
3. If the user selects to decline an offer from an arena, then show a confirmation page with the contents [If you still like to run the tournament, and still need courts, you can enter tournament director tools and send a new request or select another arena (or arenas) for the tournament. Remember you also may have to edit the tournament plan. Be aware that arenas have different properties: Some arenas within the solution offer direct court booking (online), if you own and manage an arena yourself you can set up courts for the tournament manually and some arenas require you to send a request. Best wishes Oponentus.com]. The page may also contain options like [proceed to main page for creating tournament (If not loged in user must log in)] and [Proceed to Oponentus.com] with a submit option.
4. If the user has accepted the offer from an arena then show a confirmation page with the contents [You have accepted the offer from “Arena name”. You can now activate the tournament from tournament director tools. “Arena name” will send you an invoice with payment instructions in email or with the postal service. Best wishes Oponentus.com]. The page may also contain options like [proceed to main page for creating tournament (If not loged in user must log in)] and [Proceed to Oponentus.com] with a submit option.
5. When the user has submitted a request to an arena show a confirmation page with the contents [You have successfully sent a request to the arena. You can view the details of the request from the court reservations link in your user menu.] The page may also contain options like [proceed to main page for creating tournament (If not loged in user must log in)] and [Return to Arena main page] with a submit option.
6. When an arena has given an offer to a community show a confirmation page with the contents [You have successfully given an offer to “community name”. You can view the details of the offer from the court tools of the arena at Oponentus.com]. The page may also contain options like [proceed to court tools (If not loged in user must log in)] and [Proceed to Oponentus.com] with a submit option.
7. If an arena declines a request from a community the contents of a confirmation page can be [You have successfully declined to give an offer to “community name”. You can view the details of the declined offer from the court tools of your arena at Oponentus.com]. The page may also contain options like [proceed to court tools (If not loged in user must log in)] and [Proceed to Oponentus.com] with a submit option.

The user will enter a page illustrated in FIG. 29A if selecting applications 245 in FIG. 2B. The page contains a select menu 3006 with the options [applications (default)] 3007 and [archive] 3008. The page also contains a table 3009 with the columns role, association, sport, association type and details. When a person completes registration for an international association in FIG. 4A an application is submitted to table 3009. Selecting the details button 3010 in FIG. 29A the user will proceed to a page illustrated in FIG. 29B with details about the manager 3017, the association 3018 and other details 3019.

A tournament schedule autogeneration algorithm of the invention is explained in the following by way of a programmed 8ballpool tournament schedule autogeneration algorithm example. An example of an autogenerated tournament schedule using a corresponding programmed tournament schedule autogeneration algorithm is shown in FIG. 56.

Code for Autogenerating Tournamentshedule clsTournament
<?php
class clsTournament
{
var $m_nLangId;
var $m_intLangId;
var $m_nTournamentId;
var $m_strTournamentName;
var $m_strTournamentSex;
var $m_nTourAgeClass;
var $m_nTourType;
var $m_strTournamentDesc;
var $m_nTournamentLevel;
var $m_nTournamentIsActive;
var $m_objLanguage;
var $m_nTotalPlayers;
var $m_nOpen;
var $m_nSkill;

1-36. (canceled)

37. A computer implemented method for creating and running a tournament over a network by means of time, a tournament time-schedule, and interactions of a plurality of tournament entrants over a network with a server, comprising the steps of:
a) a server operating a first process of registering user data submitted by at least one user;
b) the server operating a second process of creating a tournament by accepting tournament data including a tournament time-schedule from a user;
c) the server operating a third process of running the tournament by means of time, the tournament time-schedule and interactions of a plurality of tournament entrants, the third process comprising:
1) opening a player entry register for registration of players during a player entry period, the player entry period beginning on a starting date and time and ending on an ending date and time,
2) during the period between the starting date and time and the ending date and time, giving players access to record their own entry data directly in a player entry register by entering the tournament;
3) closing the player entry register for registration of players at an end of the player entry period or after registration of a number of player entries equal to a preset maximum number of players;
4) after closing the player entry register for registration of players, generating a tournament schedule based on tournament data registered when operating the second process and on the player entries in the player entry register;
5) accepting submitted results for a match from a user, the results including at least an indication of a winner of the match;
6) based on the submitted results, the server updating the tournament schedule by indicating a winner for the match on the tournament schedule; and
7) repeating the third process from step (c)(5) until match results data have been received for all matches identified in the tournament.

38. The method of claim 37, wherein the first process further comprises the server assigning at least one role to the user, for the user to engage in the second or third process.

39. The method of claim 37, wherein the first process comprises the steps of:
1)) the server requesting the user to enter at least data required to send and receive messages over a network; and
2) on receiving user data from the user, the server sending the user login details and assigning the user a tool required to operate the second process to start the third process of running a tournament.

40. The method of claim 37, wherein the first process further comprises:
a) the server creating a community based on the user data;
b) the server assigning a manager role to a user for the community; and
c) the server assigning the user who was assigned the manager role a tool to manage the community.

41. The method of claim 40, wherein the first process further comprises, after step (b), the steps of:
d) the server giving the user who was assigned a manager role in step (b) access to a community data register;
e) the server accepting assignments from the user who was assigned a manager role, the assignments assigning a plurality of users to roles selected from a group of roles, the group of roles including at least assigning the user a corresponding tool required to operate the second process to start the third process of running a tournament.

42. The method of claim 37, wherein the second process comprises:
a) the server requesting tournament data from the user;
b) the server accepting tournament data from the user, the tournament data comprising at least a type of tournament schedule and a maximum number of players; a time, date and place for all the possible matches in the set tournament schedule based on the maximum number of players; a plurality of roles to be included in the matches of the tournament, if tournament official roles are included in the tournament, at least one of the plurality of roles being a tournament official role; based on the plurality of roles, assigning the task of submitting results to a role; and
c) the server setting a tournament time-schedule on the basis of the roles accepted in step (b), the step of setting the tournament time-schedule including at least:
i) if the roles include tournament official roles, setting a period from a starting date and time to an ending date and time during which tournament officials can enter; and
ii) setting the starting date and time and ending date and time of the player entry period to be used in the third process.

43. The method of claim 37, wherein the tournament is for a team sport.

44. The method of claim 37, wherein the second process further comprises the steps of:
a) the server requesting the user to select a sport and a discipline, to review whether the time zone setting of the community is correct, and to enter a tournament name;
b) the server accepting data from the user including at least a selected sport and discipline and a tournament name;
c) the server requesting the user to select tournament details comprising rules, gender, registered community data usage, tournament schedule type, maximum number of matches and maximum number of players; and
d) the server accepting tournament details data from the user comprising rules, gender, registered community data usage, tournament schedule type, entry fees, maximum number of matches and maximum number of players;
e) the server requesting the user to set age class and skill levels; and
f) the server accepting data from the user including age class and skill levels data;
g) the server requesting the user to set tournament official roles and required qualifications for the matches in the tournament, based on the maximum number of matches, maximum number of players and tournament schedule type, and to assign to a role a submitting results task;
h) the server accepting data from the user including tournament official roles and required qualifications, and an assignment of the submitting results task to a role;
i) based on the tournament schedule type, the server requesting the user to set prize and prize ceremony data for the tournament; and
j) the server accepting data from the user including prize and prize ceremony data;
k) based on the sport, discipline, tournament schedule type and maximum number of matches, the server requesting the user to set a match format for each of the matches establishing a procedure to obtain a winner in the match;
l) the server accepting the match format from the user;
m) the server requesting the user to set a tournament time-schedule comprising:
i) if the roles include tournament official roles, a period from a starting date and time to an ending date and time during which tournament officials can enter; and
ii) the starting date and time and ending date and time of the player entry period to be used in the third process; and
iii) a starting date and time and an ending date and time for the tournament; and iv);
n) the server accepting the tournament time-schedule from the user;
o) the server requesting that the user set time and place for the matches and, if a prize ceremony is to be held, a date and time for a prize ceremony;
p) the server accepting the times and places for the matches from the user;
q) the server requesting the user to set sport specific equipment details for the tournament;
r) the server accepting the sport specific equipment details data for the tournament;
s) the server requesting the user to set select messages to be generated during the tournament;
t) the server accepting the selected messages to be generated from the user;
u) the server calculating a tournament income based on at least the entry fees, and a tournament cost based on at least the tournament officials data, prizes data and set or book times data;
v) the server requesting the user to review and accept at least the tournament income and the tournament cost calculated by the server in step (u);
w) the server accepting a response from the user accepting the tournament income and the tournament cost cost calculated by the server in step (u);
y) the server validating the data accepted from the user in the preceding steps; and
z) the server starting the third process.

45. The method of claim 37, wherein the third process comprises the steps of:
a) the server opening a tournament official entry register for registration of tournament officials during a tournament official entry period set in the second process, giving tournament officials access to record their own tournament official entry data directly in a tournament official entry register;
b) the server receiving tournament official data entries from tournament officials and storing the data in the tournament official entry register; and
c) the server closing the tournament official entry register on receiving the tournament officials entry data for all of the matches in the tournament, or at an end of the tournament official entry period.

46. The method of claim 45, in which step (c) further comprises the server opening a player entry register on receiving the tournament officials entry data for all the matches in the tournament which have a tournament official role.

47. The method of claim 37, wherein the third process further comprises the step of the server generating and sending messages to players for each match in the tournament, the messages comprising information about when and where to play the match.

48. The method of claim 37, wherein the third process further comprises the server sending data over a network to a tournament entrant's PC or handheld device and the server receiving data over a network from a tournament entrant's PC or handheld device.

49. The method of claim 37, wherein the third process further comprises the step of the server seeding players according to player rating data.

50. The method of claim 37, wherein the third process further comprises the step of, if byes are in the tournament schedule rules, giving at least one player a byes.

51. The method of claim 37, wherein the third process further comprises the server, on opening the player entry period, sending at least one invitation to players based on message data usage, community data usage, and on user provided conditions.

52. The method of claim 37, wherein the third process further comprises the server, on opening a tournament official entry period, sending at least one invitation to tournament officials.

53. The method of claim 37, wherein the third process further comprises the server sending information to tournament officials about cancelled matches due to byes, after the tournament schedule has been generated.

54. The method of claim 37, wherein the third process further comprises the server adding reports for online filing to users' task lists after generating the tournament schedule.

55. The method of claim 42, wherein the third process further comprises the steps of:
after the server generates the tournament schedule, the server adding match result reports to a task list of the user having the role which was assigned the task of submitting results in step (b);
the server giving accepting submitted results from the user having the role which was assigned the task of submitting results, the submitted results including at least an indication of a winner of a match; and
based on the submitted results, the server updating the tournament schedule by indicating a winner for the match on the tournament schedule.

56. The method of claim 55, wherein the third process further comprises, if tournament official roles were set for the tournament, the server requesting at least one user to state whether a tournament official was absent or present during a match.

57. The method of claim 37, wherein the third process further comprises the steps of:
a) if players are set to provide match results, then the server adding reports to players' task lists;
b) if match referees are set to provide match results, then the server adding reports to match referees' task lists; and
c) if tournament directors are set to provide match results then the server adding reports to the tournament director's task lists.

58. The method of claim 37, wherein the third process further comprises the steps of:
a) the server requesting at least one tournament director to send a tournament director report to the server from the tournament;
b) the server requesting at least one tournament referee to send a tournament referee report to the server from the tournament; and
c) the server requesting at least one match referee to send a match referee report to the sever from the match.

59. The method of claim 37, wherein the third process comprises the server sending information to players registered in the player entry register, based upon the prizes settings data, time and place data, and message settings data, about where and when the prize ceremony will take place.

60. The method of claim 58, further comprising the server sending or printing out diplomas to players based on prize settings and match results.

61. The method of claim 37, wherein in the third process, the step of the server generating a tournament schedule is performed by the server using a tournament schedule autogeneration algorithm.

62. The method of claim 37, wherein the third process further comprises the steps of:
a) the server operating a rating formula;
b) on receiving match results data, the server using the rating formula to generate rating data based on the match results data.

63. The method of claim 38, in which at least one user is assigned to multiple roles.

64. The method of claim 62, in which the roles are selected from a group consisting of player, tournament official, medical officer, photographer, cameraman and reporter.

65. The method of claim 37, further comprising the steps of:
a) the server accepting an arena listing from a user;
b) the server storing the arena listing in an arena database; and
c) the server assigning the user a role of court manager with a corresponding tool to manage the arena.

66. The method of claim 64, further comprising the steps of:
a) the server reporting at least one change in the arena database to at least one administrator and requesting the at least one administrator to validate the at least one change;
b) the server accepting a response from the administrator and accepting or rejecting the change based on the response from the administrator.

67. The method of claim 37, wherein the first process further comprises:
a) the server sending a request to a user to select what role or category of community the user wants to register for;
b) the server accepting a role or category of community selection from the user;
c) if the selection accepted from the user was associated with a sports club or a workplace:
i) the server sending a request to the user to select a license version;
ii) the server accepting a license selection from the user;
d) if the selection accepted from the user was associated with a tournament official or player:
i) the server sending a request to the user to enter user data;
ii) the server accepting user data from the user;
e) if the selection from the user was associated with a role associated with an international or national association:
i) the server sending a request to the user to enter user and community data;
ii) the server accepting user and community data from the user; and
iii) the server assigns the user a corresponding tool to manage a sport internationally or within a country and a tool to manage the community of the association.

68. The method of claim 37, wherein the first process further comprises:
a) the server sending a request to the user to input community details;
b) the server accepting community details from the user and storing the community details in a register;
c) the server sending a request to the user to select if the community has an arena;
d) the server accepting a response from the user including the users selection of one of the community has an arena or not: and
e) if receiving the response “the community has no arena”:
i) the server sending a request to the user asking if the user is a registered user;
ii) the server receiving a response from the user indicating yes or no; and
1) if the response was yes, then:
A) the server requesting the user to log in;
2) if the response was no, then:
A) the server sending a request to the user to enter user details;
B) the server receiving user details from the user;
3) the server sending a request to the user to pay for a license if the license is not for free;
4) the server assigning the user a role as manager of the community;
f) if receiving the response “the community has an arena”:
i) the server sending a request to the user to select at least one sport, and to enter a keyword for a search or to select a location of the arena;
ii) the server accepting a response from the user including the keyword or selection of location of the arena;
iii) the server sending the user a list of arenas from an arena database; and a request to the user to select an arena;
iv) the server accepting a selection from the user of an arena listed in the arena data base;
v) the server retrieving an arena record from the arena database;
vi) if the record from the arena database indicates that the arena has management, the server sending information to let the user know the arena already has a management;
g) if the record from the arena database indicates that the arena has no management;
vii) the server sending a request to the user asking if the user is a registered user;
viii) the server receiving a response from the user indicating yes or no; and
1) if the response was yes, then:
A) the server requesting the user to log in;
2) if the response was no, then:
A) the server sending a request to the user to enter user details;
B) the server receiving user details from the user;
3) the server sending a request to the user to pay for a license if the license is not for free;
4) the server assigning the user a role as manager of the community.

69. The method of claim 44, further comprising the steps of:
aa) the server requesting that the user set or book times for the matches in at least one arena and at least one court;
ab) the server accepting a response from the user selecting at least one arena and at least one court;
ac) the server providing the user with match data from the tournament schedule including prize ceremony data, match format data, the minimum required time per match and recommended time per match data, and for each match a date, time and place field for the time and place data;
ad) the server requesting the user to set or book a time for each match;
ae) the server accepting a response from the user setting or booking a time for each match;
af) the server requesting the user to use a pre-booked time for the tournament; or book courts for the tournament;
ag) the server accepting a response from the user to book courts for the tournament;
ah) the server further providing the user with arena data from the arena database, requesting the user make a selection between options selected from a group consisting of list arenas by area; search arenas by keyword; and list arenas managed by the server;
ai) the server accepting a response from the user;
aj) the server providing the user with arena data from the arena database, including arena name, location data;
ak) the server requesting that the user select an arena; and
al) the server accepting a selection of an arena from the user; and
am) the server providing the user with arena-specific data based on the selection of an arena from the user.
an) The server requsting the user to make a selection of an online booking option;
ao) the server accepting a selection of online booking option from the user
ap) the server opening the arena's booking registry;
aq) the server providing the user with an online booking registry with court and booking information comprising time intervals, court names, cost data, and court availability;
ar) the server accepting a selection of a booked time from the user;
as) the server making a change in the status of the booked time in the arena booking registry based on the selection of booked time from the user.

70. A computer apparatus for managing and running a tournament, the apparatus comprising a server and one or more databases, wherein the apparatus further comprises a server programmed to perform a method comprising:
a) the server operating a first process of registering user data submitted by at least one user;
b) the server operating a second process of creating a tournament by accepting tournament data and a tournament time-schedule from a user;
c) the server operating a third process of running the tournament by means of time, the tournament time-schedule and interactions of a plurality of tournament entrants, the third process comprising:
1) opening a player entry register for registration of players during a player entry period, the player entry period beginning on a starting date and time and ending on an ending date and time,
2) during the period between the starting date and time and the ending date and time, giving players access to record their own entry data directly in a player entry register by entering the tournament;
3) closing the player entry register for registration of players at an end of the player entry period or after registration of a number of player entries equal to a preset maximum number of players;
4) after closing the player entry register for registration of players, generating a tournament schedule based on tournament data registered when operating the second process and on the player entries in the player entry register;
5) accepting submitted results for a match from a user, the results including at least an indication of a winner of the match;
6) based on the submitted results, the server updating the tournament schedule by indicating a winner for the match on the tournament schedule; and
7) repeating the third process from step (c)(5) until match results data have been received for all matches identified in the tournament.

71. A computer program product for creating and running a tournament over a network by means of time, a tournament time-schedule and interactions of a plurality of tournament entrants over a network with a server, the computer program product comprising:
one or more computer-readable, tangible storage devices;
program instructions, stored on at least one of the one or more storage devices, to be executed on the server to perform a method comprising:
a) the server operating a first process of registering user data submitted by at least one user;
b) the server operating a second process of creating a tournament by accepting tournament data and a tournament time-schedule from a user;
c) the server operating a third process of running the tournament by means of time, the tournament time-schedule and interactions of a plurality of tournament entrants, the third process comprising:
1) opening a player entry register for registration of players during a player entry period, the player entry period beginning on a starting date and time and ending on an ending date and time,
2) during the period between the starting date and time and the ending date and time, giving players access to record their own entry data directly in a player entry register by entering the tournament;
3) closing the player entry register for registration of players at an end of the player entry period or after registration of a number of player entries equal to a preset maximum number of players;
4) after closing the player entry register for registration of players, generating a tournament schedule based on tournament data registered when operating the second process and on the player entries in the player entry register;
5) accepting submitted results for a match from a user, the results including at least an indication of a winner of the match;
6) based on the submitted results, the server updating the tournament schedule by indicating a winner for the match on the tournament schedule; and
7) repeating the third process from step (c)(5) until match results data have been received for all matches identified in the tournament.
